(19) United States
(12) Patent Application Publication
(10) Pub. No.: US 2012/0284105 A1
(43) Pub. Date: Nov. 8, 2012

(54) APPARATUSES, METHODS, AND COMPUTER PROGRAM PRODUCTS ENABLING ASSOCIATION OF RELATED PRODUCT DATA AND EXECUTION OF TRANSACTION

(75) Inventor: Lehmann Li, Darien, CT (US)

(73) Assignee: EZSAV Inc., Darien, CT (US)

(21) Appl. No.: 13/502,028

(22) PCT Filed: Oct. 13, 2010
(86) PCT No.: PCT/US10/52497

§ 371 Date: Apr. 13, 2012

Related U.S. Application Data
(60) Provisional application No. 61/251,284, filed on Oct. 13, 2009.
(60) Provisional application No. 61/304,636, filed on Feb. 15, 2010.
(60) Provisional application No. 61/321,870, filed on Apr. 7, 2010.

(51) Int. Cl. G06Q 30/02; G06Q 30/06

(52) U.S. Cl. 705/14.23

(57) ABSTRACT

Upon receiving a request for an object of interest, a client device can automatically: (a) display the combination of a retailer, the selection of a payment account, any qualifying offers, and any qualifying rewards which can yield the lowest net price; and/or (b) execute a purchase of the object of interest using the selected payment account and redeeming the qualifying offers and/or rewards.

### RELATED APPLICATIONS

This application claims the benefit of and priority to the following provisional applications: (a) U.S. Provisional Patent Application No. 61/251,284, “Apparatus, methods, and computer program products enabling association of related product data on one or more devices”, filed Oct. 13, 2009; (b) U.S. Provisional Patent Application No. 61/304,636, “Apparatus, methods, and computer program products enabling association of related product data on one or more devices”, filed Feb. 15, 2010; and (c) U.S. Provisional Patent Application No. 61/321,870, “Apparatuses, methods, and computer program products enabling association of related product data and execution of transaction”, filed Apr. 7, 2010. This application incorporates all of these applications by reference herein in their entirety.

This application is related to the following applications: (a) U.S. patent application Ser. No. 12/107,649, “Methods and apparatus related to content sharing between devices”, filed Apr. 22, 2008; and (b) U.S. patent application Ser. No. 12/370,536, “Systems and methods to enable interactivity among a plurality of devices”, filed Feb. 12, 2009. This application incorporates all of these applications by reference herein.

### BACKGROUND

When a person is interested in an object for purchase, he/she can be interested in finding the retailer offering the object for the lowest price, any qualifying offer which can decrease the price, any qualifying reward for using a payment account of which he/she is a holder, and/or any related or competitive products. Even on a data processing system with a large display, a large keyboard, and a broadband communications channel, e.g., a personal computer, the user can consume considerable time searching for the retailer offering the object for the lowest price, any qualifying offers, any qualifying rewards, and/or any related and/or competitive objects. On a data processing system with a small display, a small keypad, and a narrowband communications channel, e.g., most wireless devices, it can be impractical for the user to search for savings. Even after finding the savings on a personal computer, the user can consume additional time buying the object by having to input object attribute data, offer data, and payment account data. On a wireless device, the user can find it difficult to input object attribute data, offer data, and payment account data on a small keypad.

### SUMMARY

The invention can enable a client device to: (a) receive one or a few words describing an object of interest, record an image of an object of interest, and/or receive an event selecting an object of interest; (b) receive data and/or instructions enabling the display of one or more retailers offering the object of interest at a desirable price, one or more qualifying offers, one or more qualifying rewards, one or more related and/or competitive objects, and/or a function whose selection can execute the purchase of the object of interest; (c) receive an event selecting the function of executing the purchase of the object of interest; (d) execute the purchase of the object of interest without having to input any further data, including object attributes, offer and/or reward codes, and/or payment account data; and/or (e) output transaction data to one or more computer program products.

For example, a user of a wireless device can: (a) say or text “Buy XYZ”; (b) view on the wireless device display a window displaying retailer XYZ offering the XYZ object for a low price, a qualifying coupon, cash back on the payment account held by the user, and an image whose selection can enable the purchase of the XYZ object; (c) say or text “Buy”; (d) buy the XYZ object without having to select at the retailer any object attributes, enter any offer and/or reward codes, and/or enter any payment account data; and/or (e) have transaction data formatted and outputted to one or more computer program products, e.g., an application automatically preparing tax returns, an application automatically filling out an employee expense reimbursement form, and/or an application automatically storing a patient health record.

In one embodiment, a computer-implemented method is executed on a particular machine programmed to execute functions, including, but not limited to:

(a) receiving and storing data from a user of one or more client devices specifying any data required to execute a purchase at a plurality of retailers;
(b) receiving from a client device a request related to an object of interest in any form, including, but not limited to: (i) speech and/or text describing the object of interest; (ii) an image of the object of interest; (iii) detection of the selection of an image representing the object of interest, e.g., a mouseover, a mouse click, a key press, a touch, the detection of any object, e.g., a finger, in proximity to the display, or an electromagnetic field carrying an instruction and/or data, e.g., an infrared signal; and/or (iv) other data received by, stored in, and/or computed by the client device which can increase the probability of identifying the object of interest, e.g., ambient audio and/or client device location;
(c) querying one or more data structures for data which can increase the probability of identifying the object of interest;
(d) executing a method to identify the most likely object of interest;
(e) identifying one or more retailers offering the object of interest at a desirable price;
(f) identifying one or more qualifying offers and their associated codes;
(g) identifying any qualifying reward associated with the registered payment account;
(h) transmitting the data and/or instructions to the client device;
(i) receiving from client device an event selecting the function of buying the object of interest;
(j) retrieving from a data structure the data registered by the client device user;
(k) transmitting to a retailer web site data specifying: (i) object attributes; (ii) any codes representing one or more offers; and/or (iii) payment account data;
(l) populating the fields required automatically to redeem the one or more offers and execute a purchase of the object of interest;
(m) executing the purchase of the object of interest;
(n) parsing a transaction record to determine if the object purchased is in one or more classes;
(o) formatting the transaction data depending on the type of computer program product to which the data will be output; and/or
(p) outputting the formatted transaction data to one or more computer program products for automatic storage, processing, and/or population.

### BRIEF DESCRIPTION OF THE DRAWINGS

The accompanying drawings, which are incorporated herein and form a part of the specification, illustrate the invention described herein and, together with the description, further serve to explain the principles of the invention and to enable any person with ordinary skill in the art to make and use the invention. In the drawings, the two leftmost digits of a reference number identifies the drawing in which the reference number first appears.

FIG. 1 depicts a block diagram of an exemplary data processing system that can be used to implement the entities described herein.

FIG. 2A1 and FIG. 2A2 depict a flowchart of an exemplary method enabling the execution of any type of request to purchase an object, e.g., a non-contingent purchase by the user, a contingent purchase by the user, or a contingent purchase by a plurality of users, in any type of retailer, e.g., an online retailer or a physical retailer, according to one embodiment.

FIG. 2B depicts a block diagram of an exemplary apparatus enabling one or more devices to exchange data associating related transaction data on the one or more devices, according to one embodiment.

FIG. 3A depicts an exemplary presentation on a client device of data related to an object of interest, according to one embodiment.

FIG. 3B depicts an exemplary presentation on a client device of data, including logos, related to an object of interest, according to one embodiment.

FIG. 3C depicts an exemplary presentation on a client device of data, including logos, related to an object of interest displayed in a viewfinder, according to one embodiment.

FIG. 3D depicts an exemplary presentation on a client device of data related to an object of interest displayed in a messaging format, e.g., text or multimedia, according to one embodiment.

FIG. 3E depicts an exemplary presentation on a client device of data comparing the net price of an object of interest at an online retailer with the net price of the object of interest at a physical retailer, according to one embodiment.

FIG. 3F depicts an exemplary presentation on a client device of data comparing the net price an object of interest at a retailer with the net price negotiated with a preferred retailer, according to one embodiment.

FIG. 3G depicts an exemplary presentation on a client device of data comparing the net prices of a plurality of objects of interest with similar attributes, according to one embodiment.

FIG. 3H depicts an exemplary presentation on a client device of data displaying the net price of a plurality of objects of interest, according to one embodiment.

FIG. 4 depicts a flowchart of an exemplary method enabling the presentation on a client device of data related to an object of interest, according to one embodiment.

FIG. 5 depicts a flowchart of an exemplary method enabling the identification of an object of interest displayed in a viewfinder and presentation of data related to the object of interest, according to one embodiment.

FIG. 6A, FIG. 6B, and FIG. 6C depict a flowchart of an exemplary method enabling the association of data related to an object of interest across two or more devices, according to one embodiment.

FIG. 7 depicts an exemplary set of object attributes whose selection can enable a user to narrow a plurality of objects to an object of interest, according to one embodiment.

FIG. 8 depicts a block diagram of an exemplary apparatus enabling the automatic generation of queries whose responses can narrow a plurality of objects in a class of objects to an object of interest or a plurality of equivalent objects of interest, according to one embodiment.

FIG. 9 depicts a flowchart of an exemplary method enabling the automatic generation of queries whose responses can narrow a plurality of objects in a class of objects to an object of interest or a plurality of equivalent objects of interest, according to one embodiment.

FIG. 10 depicts a flowchart of an exemplary method enabling the association of data related to an object of interest on one device, e.g., a personal computer, a television, or a wireless device, according to one embodiment.

FIG. 11 depicts a block diagram of an exemplary apparatus enabling the identification of an object of interest, the display of data related to the object of interest on one or more devices and/or execution of a transaction involving the object of interest, according to one embodiment.

FIG. 12 depicts a block diagram of an exemplary apparatus enabling the automatic registration of data utilized to execute one or more methods described herein, according to one embodiment.

FIG. 13 depicts a flowchart of an exemplary method enabling the automatic registration of data utilized to execute one or more methods described herein, according to one embodiment.

FIG. 14 depicts a block diagram of an exemplary apparatus enabling the identification of a code uniquely identifying an object of interest and association of the code with one or more retailers and/or offers related to the object of interest, according to one embodiment.

FIG. 15 depicts an exemplary data structure specifying one or more codes associated with an object of interest, according to one embodiment.

FIG. 16 depicts a flowchart of an exemplary method utilizing and processing codes to recognize an object of interest, according to one embodiment.

FIG. 17 depicts a block diagram of an exemplary apparatus enabling the identification of a spoken word string related to an object of interest, according to one embodiment.

FIG. 18A and FIG. 18B depict a flowchart of an exemplary method enabling the identification of a spoken word string related to an object of interest, according to one embodiment.

FIG. 18C depicts a block diagram of an exemplary apparatus enabling the identification and/or determining of a candidate object of interest and/or any attributes of the object of interest by analyzing prior user transactions and/or prior user sample transactions, according to one embodiment.

FIG. 18D, FIG. 18E, and FIG. 18F depict a flowchart of an exemplary method enabling the identification and/or determining of a candidate object of interest and/or any attributes of the object of interest by analyzing prior user transactions and/or prior user sample transactions, according to one embodiment.

FIG. 19 depicts a block diagram of an exemplary apparatus enabling the identification of an image, still or moving, of an object of interest, according to one embodiment.

FIG. 20 depicts a flowchart of an exemplary method enabling the identification of an image, still or moving, of an object of interest, according to one embodiment.

FIG. 21 depicts a block diagram of an exemplary apparatus enabling the transformation of an object, an electronic image of an object, and/or data representing an object displayed on a first device or second device into a different state, i.e., data representing characteristics of or associated with the object, e.g., the display and redemption of one or more offers related to the object and/or the execution of a transaction related to the object, through a second device receiving one or more inputs of speech and/or ambient audio, according to one embodiment.

FIG. 22A and FIG. 22B depict a flowchart of an exemplary method enabling the transformation of an object, an electronic image of an object, and/or data representing an object displayed on a first device or second device into a different state, i.e., data representing characteristics of or associated with the object, e.g., the display and redemption of one or more offers related to the object and/or the execution of a transaction related to the object, through a second device receiving one or more inputs of speech and/or ambient audio, according to one embodiment.

FIG. 23 depicts a block diagram of an exemplary apparatus enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a first device or second device receiving one or more inputs of an infrared signal, according to one embodiment.

FIG. 24 depicts a flowchart of an exemplary method enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a first device or second device receiving one or more inputs of an infrared signal, according to one embodiment.

FIG. 25 depicts a block diagram of an exemplary apparatus enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a first device or second device receiving one or more inputs of an electromagnetic field signal, according to one embodiment.

FIG. 26 depicts a flowchart of an exemplary method enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a first device or second device receiving one or more inputs of an electromagnetic field signal, according to one embodiment.

FIG. 27 depicts a block diagram of an exemplary apparatus enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a second device receiving one or more inputs of an image, still or moving, according to one embodiment.

FIG. 28 depicts a flowchart of an exemplary method enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a second device receiving one or more inputs of an image, still or moving, according to one embodiment.

FIG. 29 depicts a block diagram of an exemplary apparatus enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a first device or second device receiving one or more inputs of an electrical signal, according to one embodiment.

FIG. 30 depicts a flowchart of an exemplary method enabling the transformation of an object, an electronic image of an object, and/or data representing an object displayed on a first device into a different state, i.e., data representing characteristics of or associated with the object, e.g., the display and redemption of one or more offers related to the object and/or the execution of a transaction related to the object, through a first device or second device receiving one or more inputs of an electrical signal, according to one embodiment.

FIG. 31 depicts a block diagram of an exemplary apparatus enabling the transformation of an object, an electronic image of an object, and/or data representing an object displayed on a device into a different state, i.e., data representing characteristics of or associated with the object, e.g., the display and redemption of one or more offers related to the object and/or the execution of a transaction related to the object, through the device receiving one or more inputs of an electrical signal representing the position and/or motion of any part of the user of the device, according to one embodiment.

FIG. 32 depicts a flowchart of an exemplary method enabling the transformation of an object, an electronic image of an object, and/or data representing an object displayed on a device into a different state, i.e., data representing characteristics of or associated with the object, e.g., the display and redemption of one or more offers related to the object and/or the execution of a transaction related to the object, through the device receiving one or more inputs of an electrical signal representing the position and/or motion of any part of the user of the device, according to one embodiment.

FIG. 33 depicts a block diagram of an exemplary apparatus enabling the transformation of an object, an electronic image of an object, and/or data representing an object displayed on a device, e.g., a personal computer, a television, or a wireless device, into a different state, i.e., data representing characteristics of or associated with the object, e.g., the display and/or redemption of one or more offers related to the object and/or the execution of a transaction related to the object, through the selection by any means of the object, an electronic image of the object, or data representing the object, according to one embodiment.

FIGS. 34A-34D depict a flowchart of an exemplary method enabling the transformation of an object, an electronic image of an object, and/or data representing an object displayed on a device, e.g., a personal computer, a television, or a wireless device, into a different state, i.e., data representing characteristics of or associated with the object, e.g., the display and/or redemption of one or more offers related to the object and/or execution of a transaction related to the object, through the selection by any means of the object, an electronic image of the object, or data representing the object, according to one embodiment.

FIG. 35 depicts a block diagram of an exemplary article of manufacture or computer program product capable of identifying one or more objects of interest or classes of interest, according to one embodiment.

FIG. 36A1 and FIG. 36A2 depict a flowchart of an exemplary method enabling the identification of one or more objects of interest, according to one embodiment.

FIG. 36B1, FIG. 36B2, and FIG. 36B3 depict a flowchart of an exemplary method enabling the identification of one or more objects of interest promoted by a media object, according to one embodiment.

FIG. 37 depicts a block diagram of an exemplary article of manufacture or computer program product enabling the transformation of an object, an electronic image of an object, and/or data representing an object into a different state, i.e., the automatic identification of one of more qualifying offers related to an object of interest and/or a class of interest, according to one embodiment.

FIG. 38A and FIG. 38A2 depict a flowchart of an exemplary method enabling the automatic identification of one or more qualifying offers related to an object of interest and/or a class of interest, according to one embodiment.

FIG. 38B1 and FIG. 38B2 depict a flowchart of an exemplary method enabling the identification and/or redemption of one or more qualifying offers on a second object of interest if a user purchases a first object of interest, according to one embodiment.

FIG. 39 depicts a block diagram of an exemplary article of manufacture or computer program product enabling the transformation of an object, an electronic image of an object, and/or data representing an object into a different state, i.e., the automatic selection of a payment account, deposit or transfer of cash into a payment account, and/or the redemption of earned reward currency related to a purchase of the object of interest, according to one embodiment.

FIG. 40A depicts a flowchart of an exemplary method enabling the transformation of an object, an electronic image of an object, and/or data representing an object into a different state, i.e., the automatic selection of a payment account whose reward value, in combination with the price offered by a retailer and/or the value of one or more offers and/or other rewards related to the object of interest, can achieve a desirable level of savings, according to one embodiment.

FIG. 40B depicts a flowchart of an exemplary method enabling the transformation of an object, an electronic image of an object, and/or data representing an object into a different state, i.e., the automatic selection of a payment account whose reward values and the equivalent cash value of non-price features, in combination with the price offered by a retailer and/or the value of one or more offers and/or other rewards related to the object of interest, can achieve a desirable level of savings, according to one embodiment.

FIG. 40C depicts a flowchart of an exemplary computer-implemented method enabling the transformation of an object, an electronic image of an object, and/or data representing an object into a different state, i.e., automatic selection of a payment account based on a predefined rule which can identify the set of candidate payment accounts and select a payment account based on one or more codes associated with an object of interest, class of interest, and/or any other element in a user request, according to one embodiment.

FIG. 41A depicts a block diagram of an exemplary article of manufacture or computer program product enabling the transformation of an object, an electronic image of an object, and/or data representing an object into a different state, i.e., the automatic redemption of one of more qualifying offers, rewards, and/or any other price reducing means related to an object of interest, according to one embodiment.

FIG. 41B depicts a block diagram of an exemplary apparatus enabling the creation of, writing to, storage of, processing of, and/or reading from a secure folder storing any data identifying one or more payment accounts, one or more offers, one or more loyalty accounts, one or more accounts describing organizations of which a user is a member, one or more accounts describing insurance plans under which a user has coverage, and/or one or more forms of identification, according to one embodiment.

FIG. 41C1 depicts a block diagram of an exemplary apparatus enabling the classification of each offer, reward, and/or other price reduction means to one or more classes of objects and/or classes of retailers, according to one embodiment.

FIG. 41C2 depicts a block diagram of an exemplary apparatus enabling the classification a plurality of offers to one or more classes of objects and/or classes of retailers, according to one embodiment.

FIG. 41D depicts a block diagram of an exemplary apparatus enabling the identification and/or determination of a set of qualifying offers, rewards, and/or other price reduction means by exchanging data with one or more components and/or computer program products of a wireless device, according to one embodiment.

FIG. 41E depicts a block diagram of an exemplary apparatus enabling the identification and/or determination of a set of qualifying offers, rewards, and/or other price reduction means by exchanging data with one or more components and/or computer program products of a data processing system other than a wireless device, according to one embodiment.

FIG. 41F depicts a diagram of an exemplary specification of a type of application data transmitted in compliance with a standard data exchange format, e.g., the NFC Data Exchange Format, according to one embodiment.

FIG. 42A depicts a flowchart of an exemplary method enabling the transformation of an object, an electronic image of an object, and/or data representing an object into a different state, i.e., the automatic redemption of one or more qualifying offers related to an object of interest, according to one embodiment.

FIG. 42B1 and FIG. B2 depict a flowchart of an exemplary method enabling the assignment of each offer, reward, and/or other price reduction means to one or more classes of objects and/or classes of retailers, according to one embodiment.

FIG. 42C depicts a flowchart of an exemplary method enabling the identification of one or more retailers, one or more qualifying offers and/or rewards, selection of a payment account, and/or identification of any other price reduction means related to at least one object of interest by reading a data structure, according to one embodiment.

FIG. 43 depicts a block diagram of an exemplary article of manufacture or computer program product enabling the transformation of an object, an electronic image of an object, and/or data representing an object into a different state, i.e., (a) the automatic processing, identification, and/or classification of transactions into one or more classes; (b) the automatic population of a form with data related to the transaction; and/or (c) the output to one or more other articles of manufacture or computer program products of data related to the transaction, according to one embodiment.

FIG. 44 depicts a flowchart of an exemplary method enabling the transformation of an object, an electronic image of an object, and/or data representing an object into a different state, i.e., (a) the automatic processing, identification, and/or classification of transactions into one or more classes; (b) the automatic population of a form with data related to the transaction; and/or (c) the output to one or more articles of manufacture or computer program products of data related to the transaction, according to one embodiment.

FIG. 45 depicts a flowchart of an exemplary method enabling the determination if an object of interest is associated with a group price, according to one embodiment.

### DETAILED DESCRIPTION

### Data Processing System

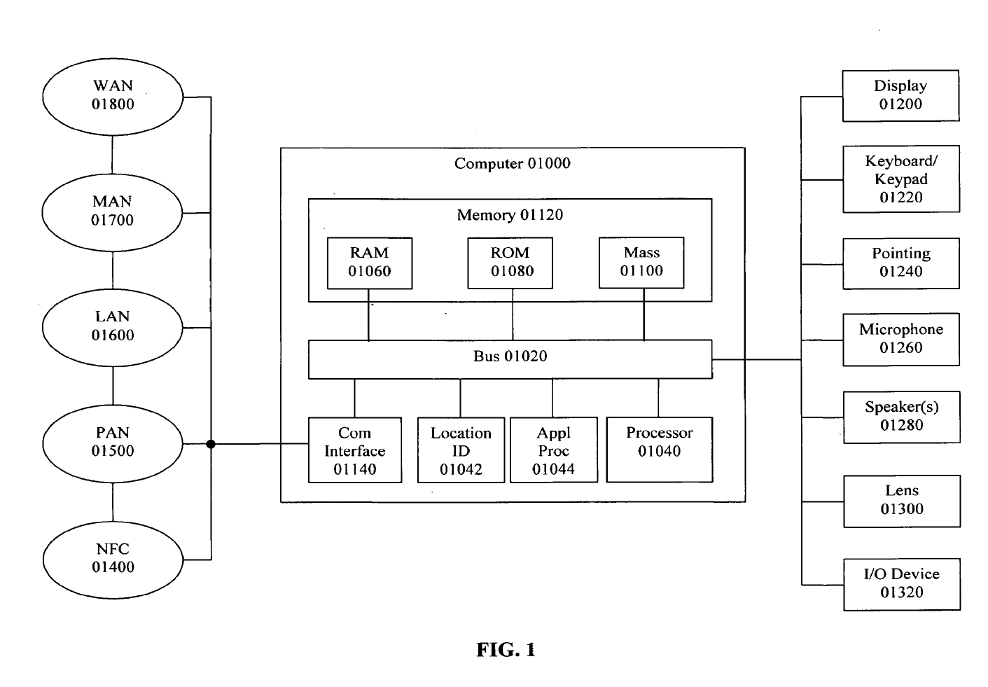

FIG. 1 depicts a block diagram of an exemplary Data Processing System 01000 that can be used to implement the entities described herein. Any number and/or type of data processing systems can implement the entities described herein and the configuration actually used depends on the specific implementation.

Data Processing System 01000 can be any type of device which can process data, including, but not limited to: a personal computer, a set-top box (STB), a portable computer, a hand-held computer, a personal digital assistant, a portable media device, a videogame player, a wireless device (which can include, but is not limited to, a wireless phone with access to a data network, e.g., the Internet, and/or a wireless phone without access to a data network, e.g., the Internet), a “smart card”, a server, a workstation, a mainframe computer, and/or any other type of machine (which can include, but is not limited to, a machine located in a home, a motor vehicle, an office, a factory, and/or any other location). The type of data processing system used to implement the entities described herein depends on the specific implementation.

Any Data Processing System can communicate with one or more other devices utilizing any protocol over any network, including, but not limited to: Hypertext Transport Protocol (HTTP), File Transport Protocol (FTP), Simple Mail Transport Protocol (SMTP), Post Office Protocol (POP), and/or Internet Mail Access Protocol (IMAP) over a network, e.g., the Internet.

Data Processing System 01000 can comprise one or more components, including, but not limited to: (a) any communications medium, wired and/or wireless (e.g., a Bus 01020), or any other means of transmitting and/or receiving data among components; (b) a general- or special-purpose Processor 01040 or any other means of processing instructions and/or data; (c) a random access memory (RAM) Device 01060 coupled to Bus 01020 capable of storing data and/or instructions executed by Processor 01040, temporary variables, and/or other intermediate data during the execution of instructions by Processor 01040; (d) a read-only memory (ROM) Device 01080 coupled to Bus 01020 capable of storing data and/or instructions executed by Processor 01040; (e) a Mass Storage Device 01100 (which can be a non-removable device, e.g., a hard disk drive, or a removable device, e.g., a floppy disk drive, a compact disc drive, a flash drive, a tape drive, a magneto-optical disc drive, or a chip, e.g., a chip as part of a Subscriber Identity Module (SIM) card) coupled to Bus 01020 or Data Processing System 01000 capable of storing data and/or instructions executed by Processor 01040; (f) a Display Device 01200 (which can detect one or more finger contacts, determine a command, and/or process the command) coupled to Bus 01020 or Data Processing System 01000 capable of displaying data to a user; (g) a Keyboard or Keypad Device 01220 coupled to Bus 01020 or Data Processing System 01000 capable of executing a variety of functions and/or instructions, including, but not limited to, inputting any alphanumeric character, communicating data, and/or enabling command selection to Processor 01040; (h) a Pointing Device 01240 coupled to Bus 01020 or Data Processing System 01000 capable of communicating data and/or position/direction information and/or enabling command selection to Processor 01040; (i) a Microphone 01260 coupled to Bus 01020 or Data Processing System 01000 capable of communicating data and/or direction information and/or enabling command selection to Processor 01040; (j) one or more Speakers 01280 coupled to Bus 01020 or Data Processing System 01000 capable of receiving data from Processor 01040 and/or transmitting audio signals; (k) a Lens 01300 coupled to Bus 01020 or Data Processing System 01000 capable of transmitting data and/or direction information and/or enabling command selection to Processor 01040; (l) an I/O Device 01320 (which can enable any other type of input and/or output) coupled to Bus 01020 or Data Processing System 01000 capable of communicating data and/or direction information and/or enabling command selection to Processor 01040; and/or (m) a Communications Interface 01140 coupled to Bus 01020 or Data Processing System 01000 capable of transmitting data to and/or receiving data from other Data Processing Systems through any type of wireline and/or wireless network, including, but not limited to, a contactless network, e.g., near-field communications (NFC) 01400, a personal area network (PAN) 01500, a local area network (LAN) 01600, a metropolitan area network (MAN) 01700, and/or a wide area network (WAN) 01800, e.g., the Internet. Processor 01040 can reside at a single physical location or be distributed across a multiple physical locations, e.g., on one client and one server. The following components can include any device coupled to Bus 01020 capable of storing data and/or instructions executed by Processor 01040, including, but not limited to: RAM Device 01060, ROM Device 01080, Mass Storage Device 01100, a data cache, a data object, and/or any other type of short-, medium-, or long-term storage device (“Data Storage Device”). A Data Storage Device can reside at a single physical location or be distributed across multiple physical locations.

Location ID 01042 can process instructions and/or data related to determining the location of Data Processing System 01000. Location ID 01042 can determine the location through any method, including, but not limited to: (a) measuring and/or comparing signals received from one or more satellites; (b) measuring and/or comparing signals received from one or more terrestrial base transceiver stations (BTS); and/or (c) measuring and/or comparing signals received from any combination of satellites and/or BTS. In another embodiment, the invention can determine the location of Data Processing System 01000 through measuring and/or comparing data at Data Processing Systems other than Data Processing System 01000, e.g., at one or more BTS or at Data Processing Systems exchanging data with the BTS. In another embodiment, the invention can determine the area in which a Data Processing System 01000 is located by identifying the BTS with which Data Processing System 01000 is exchanging data.

Communications Interface 01140 can include a modem, a network interface card, and/or any other device capable of coupling Data Processing System 01000 to any Contactless 01400, PAN 01500, LAN 01600, MAN 01700, and/or WAN 01800. Communications Interface 01140 can include an antenna enabling wireless communication utilizing any wireless protocol with Contactless 01400, PAN 01500, LAN 01600, MAN 01700, and/or WAN 01800. The application defines an Antenna to include any of the components necessary to transmit and/or receive an electromagnetic field, e.g., a radio signal. Such components can include not only a physical material capable of conducting such a signal, but also any component which can execute any function needed to process such signal, including, but not limited to: modulation, demodulation, spreading, despreading, analog-to-digital conversion (ADC), digital-to-analog conversion (DAC), compression, decompression, upconversion, and/or downconversion. Contactless 01400, PAN 01500, LAN 01600, MAN 01700, and/or WAN 01800 can enable communication through a wired, wireless, or combination of wired and wireless signals.

Data Processing System 01000 can implement any or all of the steps of the methods described herein through programmable logic, hard-wired logic, any combination of programmable and hard-wired logic, and/or any other type of logic. Control logic or software may be stored in a Data Storage Device and/or computer program products. In one embodiment, Data Processing System 01000 can have one or more Processors 01040 execute one or more instructions stored in RAM 01060. RAM 01060 can retrieve the instructions from any other Computer/Machine Readable/Accessible Medium, e.g., Mass Storage 01100. In another embodiment, Data Processing System 01000 can have one or more Processors 01040 execute one or more instructions that are predefined or hard-wired. In another embodiment, Data Processing System 01000 can have one or more Processors 01040 execute one or more instructions utilizing a combination of programmable and hard-wired logic.

The instructions can include code from any computer-programming language and/or scripts, including, but not limited to: C, C++, Basic, Java, JavaScript, Pascal, Perl, Smalltalk, Structured Query Language (SQL), VBScript, and/or Visual Basic.

In one embodiment, the steps in any of the methods disclosed herein can be embodied in machine-executable instructions. The methods can process instructions using one or more techniques, including, but not limited to: utilizing one or more general- or special-purpose Processors 01040 programmed with the instructions to execute the steps in any of the methods described herein, equivalent or related steps, other or additional steps, or any subset thereof; utilizing one or more hardware components that contain hardwired logic to execute the steps in any of the methods described herein, equivalent or related steps, other or additional steps, or any subset thereof; or utilizing any combination of programmed processors and/or hardware components to execute the steps in any of the methods described herein, equivalent or related steps, other or additional steps, or any subset thereof. The software can execute on any type of hardware located at or distributed among one or more entities, including, but not limited to: an advertiser, a media buyer, a media operator, a program operator, a media device, a wireless device, a wireline device, a retailer, a payment operator, and/or any third party.

The application describes the illustrated logical blocks, devices, components, modules, routines, and steps in methods in terms of their functionality and/or capability. The invention can implement the illustrated logical blocks, devices, components, modules, routines, and steps in methods as hardware, firmware, software, or any combination thereof, depending on the particular design and application.

In general, a computer program product (CPP) comprises any of the functions enabling or causing the execution of one or more methods described herein. When loaded in a Data Processing System 01000, in general, or a Computer/Machine Readable/Accessible Medium, in particular, a CPP can execute the functions described herein and cause a computer, general- or special-purpose Processor 01040, and/or other hardware to execute any of the steps and/or instructions described herein.

The computer- or machine-readable or -accessible medium can include, but is not limited to: (a) any type of magnetic storage, e.g., floppy disks, or hard disks; (b) optical disks, e.g., compact disk (CD), CD-ROMs, or digital versatile disk (DVD); (c) any type of magneto-optical disks; (d) any type of memory, flash memory, cache, and/or registers, e.g., RAM, static RAM (SRAM), dynamic RAM (DRAM), ROM, programmable ROM (PROM), erasable programmable ROM (EPROM), electrically erasable programmable ROM (EEPROM), NOR flash memory, or NAND flash memory; (e) magnetic or optical cards; and/or (f) any type of media capable of storing, transmitting, and/or receiving instructions and/or data, including, wireless channels, wired channels, and/or a combination of wireless and wired channels; and/or (g) any other type of media or computer- or machine-readable or -accessible media capable of storing logic, instructions, and/or data causing the execution of one or more methods described herein (“Computer/Machine Readable/Accessible Medium”).

The functionality described herein can be distributed and/or downloaded as a CPP. Methods described herein can be distributed from a remote computer, e.g., a server, to another computer, e.g., a client, through any wired and/or wireless channel over a network, e.g., the Internet.

An Object of Interest can be a product, brand, retailer, currency, and/or any other object related to executing a transaction in which the user of the client device is interested. A Transaction can be the purchase of one or more Objects of Interest. A Class of Interest can be a class of products, brands, retailers, currencies, and/or any other objects related to executing a Transaction in which the client device user is interested. An Object can include any type of product, including, but not limited to: (a) a good, which can include, but is not limited to: (i) a physical good, e.g., a motor vehicle, a DVD, a computer, or a physical currency in the form of paper or metal; and/or (ii) a digital good, e.g., data representing music, a video, cash, or virtual good used for an application; and/or (b) a service, which can include, but is not limited to: (i) a service related to a physical good, e.g., renting a car, renting a room in a hotel, subscribing to a communications plan with a TV or phone, or eating a meal in a restaurant; and/or (ii) a service related to a non-physical good, e.g., providing or receiving advice, or transferring cash from a first account to a second or other account.

### Overview

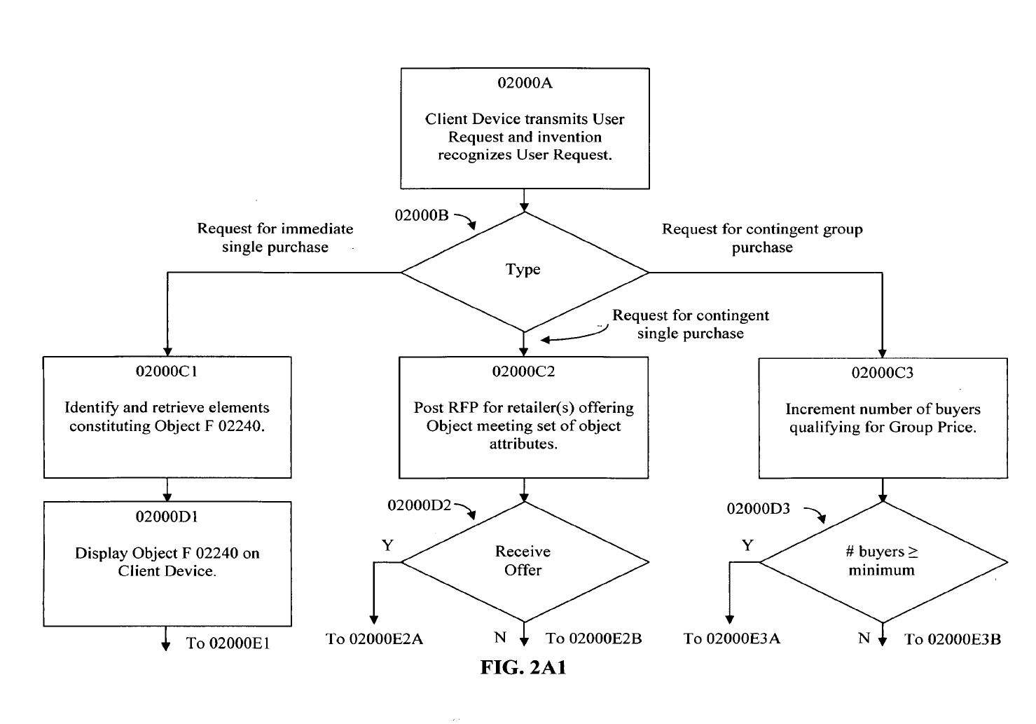

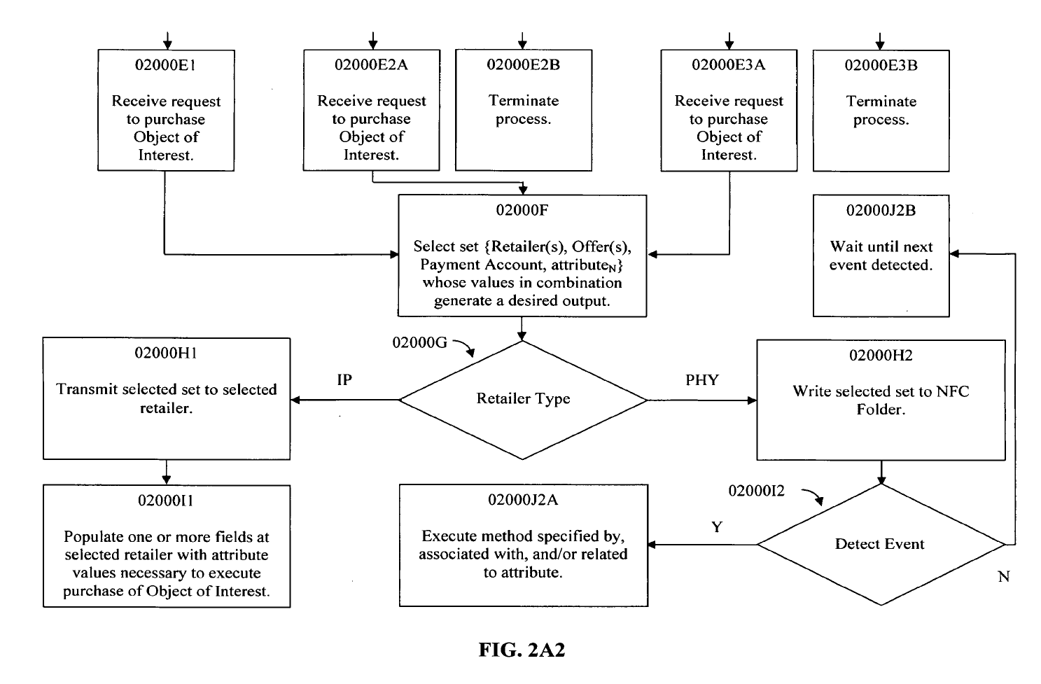

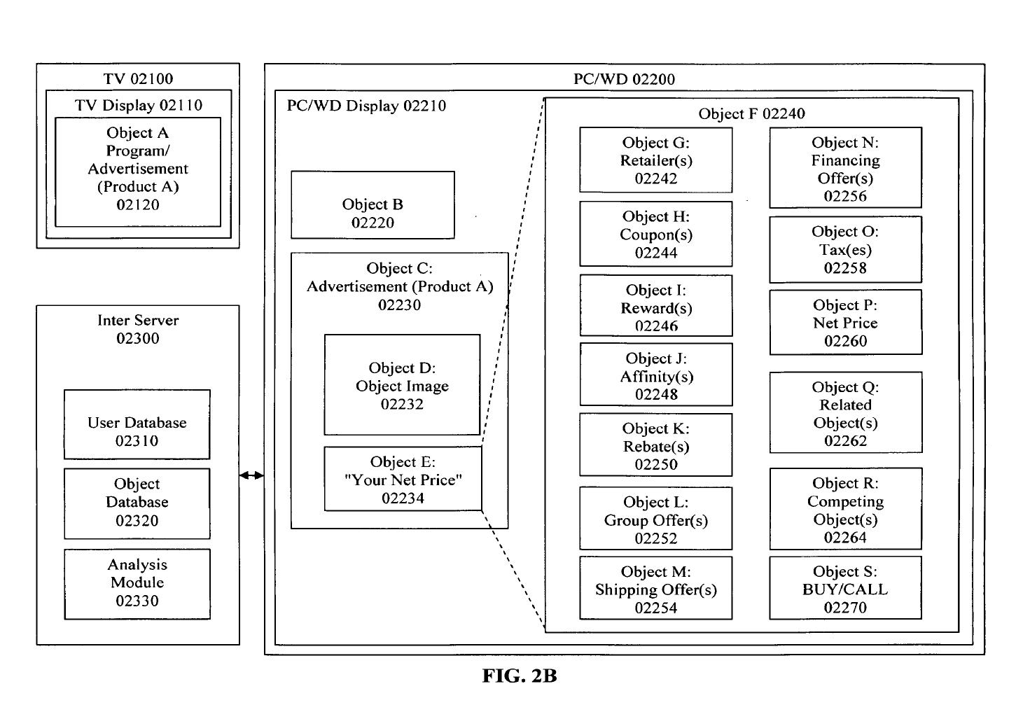

FIG. 2A1 and FIG. 2A2 depict a flowchart of an exemplary computer-implemented method, Method 02000, that when executed can enable the execution of any type of request to purchase an object, e.g., a non-contingent purchase by the user, a contingent purchase by the user, or a contingent purchase by a plurality of users, in any type of retailer, e.g., an online retailer or a physical retailer, according to one embodiment. The flowchart refers to the apparatuses and structures depicted in the application. However, the method is not limited to those embodiments. The method can implement the steps described herein utilizing a subset of the components, any combination of the components, or additional, related, alternative, and/or equivalent components depicted in the application. The method can execute a subset of the steps, any combination of the steps, the steps in different order, and/or additional, related, alternative, or equivalent steps.

At 02000A, Method 02000 can receive a User Request (defined at 06120) from a Client Device 14200 and recognize the User Request utilizing any method described herein.

At 02000B, Method 02000 utilizes any method to classify the User Request as either: (a) a request to purchase the Object of Interest specified in the User Request not contingent on any condition (“Immediate Single Purchase”); (b) a request to purchase the Object of Interest specified in the User Request contingent on the reception of a proposal by at least one retailer offering the Object of Interest or another object meeting the set of specified object attributes (“Contingent Single Purchase”); or (c) a request to purchase the Object of Interest specified in the User Request contingent on the number of buyers meeting a predefined threshold set by a retailer (“Contingent Group Purchase”). In one embodiment, Method 02000 can classify the User Request as a request for an Immediate Single Purchase, a Contingent Single Purchase, or a Contingent Group Purchase by utilizing a recognition engine to recognize any word in a set of predefined words and applying predefined rules to classify the User Request. For example, the recognition in a User Request, e.g., “Buy XYZ if . . . ” of a word “if” and application of a predefined rule to assign the User Request to a contingent type of User Request can classify the User Request as either a Contingent Single Purchase or a Contingent Group Purchase.

At 02000C1, Method 02000 can identify and retrieve the set of elements constituting Object F 02240.

At 02000D1, Method 02000 can display Object F 02240 on Client Device 14200.

At 02000E1, Method 02000 can receive from Client Device 14200 a request to purchase the Object of Interest specified in the User Request.

At 02000C2, Method 02000 can post to one or more Data Processing Systems a request for proposal (RFP) for any retailer offering the Object of Interest meeting the set of attributes specified in the RFP.

At 02000D2, Method 02000 can either: (a) receive an offer from one or more retailers offering the Object of Interest meeting the set of attributes specified in the RFP (“Qualifying Offer”), of which one attribute can specify the value of a timestamp by which an offer must be received; or (b) not receive at least one Qualifying Offer.

At 02000E2A, Method 02000 can receive from Client Device 14200 a request to purchase the Object of Interest specified in the User Request or automatically proceed to 02000F if there is at least one Qualifying Offer. If Method 02000 does not receive at least one Qualifying Offer, Method 02000 can at 02000E2B terminate the process.

At 02000C3, Method 02000 can increment the number of buyers qualifying for a price offered by a retailer if the number of buyers meets a predefined threshold set by the retailer (“Group Price”).

At 02000D3, either: (a) the number of buyers meets the predefined threshold; or (b) the number of buyers does not meet the predefined threshold.

At 02000E3A, Method 02000 can receive from Client Device 14200 a request to purchase the Object of Interest specified in the User Request or automatically proceed to 02000F if the number of buyers meets the predefined threshold. If the number of buyers does not meet the predefined threshold, Method 02000 can at 02000E3B terminate the process.

At 02000F, Method 02000 can select the set of values which generates a desirable output, e.g., a minimum price of the Object of Interest. For example, the set of Retailer A, Offer B, Payment Account C, and value(attribute_{N})) can generate a price representing the minimum of any combination of values. In one embodiment, Method 02000 can determine the value for each attribute such that Method 02000 can yield a desired net price for the Object of Interest, e.g., a minimum price by minimizing the following function comprising one or more Price Attributes, i.e., any action, event, property, and/or entity which can affect the price of an Object of Interest:

f(Price_{OOI})={(Price_{RETAILER}),(Reward_{PA}),(Offer₁),(Offer₂), . . . (Offerₙ),(Reward₁),(Reward₂), . . . (Rewardₙ),(Tax),(Cost(Transportation)} Equation (1)

where

Price_{RETAILER} is the price of the Object of Interest offered by a Retailer, which, combined with one or more other Price Attributes including, but not limited to, Reward_{PA}, the value of one or more Offers, the value of one or more Rewards, any tax assessed on the purchase of the Object of Interest, and/or any cost of transporting the Object of Interest to the point of consumption by the user, can yield a desired net price of the Object of Interest, e.g., a minimum price yielded by minimizing f(Price_{OOI});

Reward_{PA} is the value of any Reward associated with executing a purchase of the Object of Interest using a Payment Account, which, combined with Price_{RETAILER}, the value of one or more Offers, the value of one or more Rewards, any tax, and/or any cost of transportation, can yield a desired net price of the Object of Interest, e.g., a minimum price yielded by minimizing f(Price_{OOI});

Offerᵢ is the value of any Offer by an entity i, which, combined with Price_{RETAILER}, Reward_{PA}, the value of one or more Rewards, any tax, and/or any cost of transportation, can yield a desired net price of the Object of Interest, e.g., a minimum price yielded by minimizing f(Price_{OOI}); and

Rewardᵢ is the value of any Reward by an entity i other than a Reward associated with a Payment Account which, combined with Price_{RETAILER}, Reward_{PA}, the value of one or more Offers, any tax, and/or any cost of transportation, can yield a desired net price of the Object of Interest, e.g., a minimum price yielded by minimizing f(Price_{OOI}).

At 02000G, Method 02000 can determine utilizing any method the type of retailer selected at 02000F. If the retailer is an IP Retailer (defined herein), Method 02000 can proceed to 02000H1. If the retailer is a PHY Retailer (defined herein), Method 02000 can proceed to 02000H2.

At 02000H1, Method 02000 can transmit the selected set of attributes and values to the IP Retailer selected, e.g., Web Server 11910.

At 02000I1, Method 02000 can populate one or more fields at the selected IP Retailer with the values necessary to execute a purchase of the Object of Interest.

At 02000H2, Method 02000 can write the selected set of attributes and values to any data structure which can be accessed directly or indirectly by PHY point of sale (POS) 11920. In a first embodiment, Method 02000 can write the selected set to any data structure located in WD 02202, e.g., a folder in NFC Module 11574. In a second embodiment, Method 02000 can write the selected set to any data structure located in any Data Processing System other than WD 02202, e.g., Inter Server 02300 which can transmit the selected set to a PHY POS 11920 to execute the purchase of the Object of Interest, or Retailer Server 11620 which can execute the purchase of the Object of Interest utilizing one or more of the attributes and values in the selected set.

At 02000I2, Method 02000 can detect one or more events related to or can be associated with any attribute and/or value in the selected set. These events can include, but are not limited to: (a) the location of WD 02202 is within a predefined range of the location of a physical store of PHY Retailer; (b) the reading by an NFC-enabled device, e.g., WD 02202 including a Transceiver 11590, of data stored in an NFC tag; and/or (c) the occurrence of an event in any CPP, e.g., a calendar CPP located in WD 02202 generating an event like a birthday triggering a reminder to purchase an object for the person associated with the birthday or a date triggering a reminder of the expiration of an Offer specified in the selected set.

At 02000J2A, Method 02000 can execute one or more methods specified by an event handler associated with a detection of the event at 02000I2 and specified by, associated with, and/or related to one or more attributes and/or values in the selected set. These methods can include any methods described herein related to a purchase of the Object of Interest at PHY POS 11920.

If Method 02000 does not detect at 02000I2 a specified event, it can at 02000J2B wait for the occurrence of a specified event.

In another embodiment, Method 02000 can after identifying an Object of Interest, e.g., at 02000C1, 02000E2A, or 02000E3A, determine at 02000F the set of Retailer, Payment Account, one or more Offers, one or more Retailers, and any other action whose values in combination can generate a desired output, e.g., the lowest price. That is, Method 02000 can enable a user to execute automatically one or more actions which can yield the lowest price for an Object of Interest.

FIG. 2B depicts a block diagram of an exemplary apparatus, Apparatus 02000, enabling one or more devices to exchange data associating related transaction data on the one or more devices, according to one embodiment. The apparatus can implement the entities described herein by utilizing a subset of the following components, any combination of the components, or additional, related, alternative, and/or equivalent components. The apparatus can include, but is not limited to, the following components not disclosed earlier.

TV Display 02110 can be any Data Processing System capable of displaying content in one or more forms, including, but not limited to: video; audio; image; text; applet; script; Flash; and/or any combination thereof. Content is any information expressed in any form. While the application illustrates 02110 as a TV Display, the invention is not limited to that embodiment. The application defines 02110 as a first device viewed, heard, or otherwise experienced by a user of a second device, e.g., PC/WD Display 02210.

Object A 02120 can be Content in any form promoting an Object, e.g., Product A. An Object can be displayed in any form, including, but not limited to: video, audio, image, text, an applet, an ActiveX control, a script, Flash, and/or any combination thereof. Object A can be, but is not limited to: (a) Content in the form of a discrete message promoting Product A, e.g., an Advertisement; (b) Content in the form of a discrete program, e.g., entertainment, sports, and/or news, in which Product A appears visually and/or to which Product A is orally referred, either of which event can be paid for by an advertiser, commonly referred to as Product Placement, or not paid for by an advertiser; and/or (c) any combination of (a) and (b).

PC/WD 02200 can be one or more Data Processing Systems, e.g., Wireless Device 02202 or Personal Computer 11800 (while the application uses the term “Personal Computer”, it does not limit 11800 to computers commonly referred to as “PCs”; the term Personal Computer can include any type of computer which can be used by an individual), capable of executing a variety of functions and/or instructions, including, but not limited to: (a) receiving voice and/or data, including, but not limited to, any Content; (b) storing voice and/or data; (c) processing voice and/or data; (d) displaying or outputting voice and/or data to the user of the device; and/or (e) transmitting to one or more other Data Processing Systems voice and/or data. PC/WD 02200 can be any device, including, but not limited to: (a) a device which can transmit and/or receive data through a wired connection, e.g., a personal computer or phone with a cable connecting the device to a network; (b) a device which can transmit and/or receive data through a wireless connection, e.g., a PC 11800 or phone with one or more antennas or comparable devices transmitting and/or receiving any electromagnetic field; and/or (c) a device which can transmit and/or receive data through both a wired and wireless connection.

While FIG. 2B depicts PC/WD 02200 as a second Data Processing System separate from a first Data Processing System, e.g., TV 02100, the invention is not limited to that embodiment. FIG. 2B depicts PC/WD 02200 as an exemplary second Data Processing System a user can utilize to exchange data with any Data Processing System, e.g., Inter Server 02300 and/or web sites, after viewing Content displayed on a first device. A user can utilize PC/WD 02200 to interact with Content displayed on a first device, e.g., TV 02100, for any reason, including, but not limited to, finding it easy to interact with PC/WD 02200, and/or finding it hard to interact with TV 02100. In another embodiment, a user can interact directly with Content displayed on a first device, e.g., TV 02100, through any means, including, but not limited to: (a) inputting data into a remote control device which can exchange data with TV 02100; (b) inputting data into a PC/WD 02200 which can exchange data with TV 02100; and/or (c) inputting speech directly into TV 02100. In this embodiment, a first device, e.g., TV 02100, can display the same type of data included in Object F 02240 associated with a Product A displayed in TV Display 02110. In another embodiment, a user can interact directly with Content displayed on the second device, e.g., viewing Object 02120 on PC/WD Display 02210. PC/WD Display 02210 can be any Data Processing System capable of displaying Content in any form.

Object B 02220 can be any indicator, e.g., a cursor, displayed in PC/WD Display 02210 which can respond to input from any pointing device.

Object C 02230 can be Content in any form promoting an object, e.g., Product A.

In a first embodiment, Object C 02230 is Content promoting the same Product A as the Product A promoted in Object A 02120. The display of Object C 02230 on PC/WD Display 02210 can be synchronized with the display of Object A 02120 on TV Display 02110. That is, at or after the time TV Display 02110 displays Object A 02120 promoting Product A, PC/WD Display 02210 can display Object C 02230 for a predefined time period. The invention can produce a useful and concrete result by enabling a second device, e.g., PC/WD Display 02210, to display additional information about Product A which a first device, e.g., TV Display 02110, cannot because of any limitation, e.g., time and/or space.

In a second embodiment, Object C 02230 is Content promoting a Product A, which may or may not be related to Product A promoted in Object A 02120. For example, a user of PC/WD Display 02210 may not be viewing TV Display 02110 and PC/WD Display 02210 can display Object C 02230 promoting a Product A.

Object D 02232 can be Content in any form describing any feature of Product A except its price. For example, the Content can be video, audio, image, text, applet, and/or Flash describing or illustrating any non-price feature, e.g., its color, size, shape, material, mass, velocity, and/or accessories.

Object E 02234 can be Content in any form describing the price of Product A. The price can include, but is not limited to: the retail price; any data describing a decrease in the retail price, e.g., a coupon directly decreasing the retail price or a reward providing cash back for using a specific payment method or account which effectively decreases the retail price; any data describing an increase in the retail price, e.g., shipping expense or sales tax; and the net price.

Object F 02240 can be a pop-up, mouseover, hover box, or any other displayed image or element caused by the selection, detection, or occurrence of any event, which can include, but is not limited to: (a) the movement of a cursor or pointer over Object C 02230 and/or Object D 02232, a mouse click, a key press, a touch, the detection of any object, e.g., a finger, in proximity to the display, the detection of any object, e.g., a product package, including a transceiver, e.g., a NFC tag, a speech input, an image input, a video input, and/or any other input related to Object C 02230 and/or Object D 02232; and/or (b) the retrieval of a document through any communications protocol, e.g., HTTP, collectively “Client Event”.

Object G 02242 can receive, process, store, display, and/or transmit any Content in any form describing any data associated with one or more retailers offering Product A, including, but not limited to: (a) the name and/or logo of the retailer; (b) the price at which it offers Product A; (c) the price at which it offers Product A to any set of customers, e.g., members of a Loyalty Program (defined herein); (d) the price at which it offers Product A bundled with one or more other objects; (e) the availability of Product A at a given physical store; and/or (f) the directions for traveling from the location of PC/WD 02200 to one or more physical stores. A Retailer is any entity which can sell one or more objects. The Retailer can offer Product A through any means, including, but not limited to: (a) a Retailer offering Product A through executing a Transaction in a physical store (“PHY Retailer”); (b) a Retailer offering Product A through executing a Transaction over a data communications network, e.g., the Internet, (“IP Retailer”); (c) a Retailer offering Product A through executing a Transaction over a voice communications network, e.g., connecting a customer with a sales person over a public switched telephone network and/or a data communications network, e.g., the Internet, (“Voice Retailer”); and/or (d) a Retailer offering Product A through executing a Transaction over a physical delivery network, e.g., receiving an order through a physical delivery network like a postal service, (“Mail Order Retailer”).

Object H: Coupon 02244 through Object O: Tax(es) 02258 can be objects of the class Offer, which represents or comprises any type of code, identifier, or data specifying: (a) a value directly or indirectly decreasing the unit price of the object or related objects offered and/or increasing the number of units of the object or related objects offered for a given price; and/or (b) the means of enabling a particular machine processing a Transaction including the Offer directly or indirectly to decrease the unit retail price paid for the object and/or increase the number of units of the object or related objects purchased for a given price. Each Object can receive, process, store, display, and/or transmit any type of code, identifier, and/or data which can be associated with a Transaction to enable a particular machine, e.g., PHY POS 11920 and/or Web Server 11910, to deduct the value of the Offer from the Transaction price. For example, Object H 02244 can include not only a text and/or image description of the value of a coupon, but also the code, which may or may not be displayed to the user of PC/WD 02200, to be associated with a Transaction to enable a particular machine to deduct the value of the coupon from the Transaction price.

Object H 02244 can be Content in any form describing one or more coupons decreasing the unit price of Product A or related objects and/or increasing the number of units of Product A or related objects offered for a given price. A Coupon is an Offer provided by a manufacturer, Retailer, or third party related to the purchase of an object sold by the manufacturer or Retailer. Each Coupon can include a code or identifier specifying a standard subcode uniquely identifying: (a) Product A and/or the Retailer selling Product A; and (b) the value of the Coupon associated with Product A and/or the Retailer selling Product A.

Object I 02246 can be Content in any form describing one or more rewards directly or indirectly decreasing the unit price of Product A or related objects and/or increasing the number of units of Product A or related objects offered for a given price. In a first embodiment, a Reward is an Offer provided by any entity for a method of payment for Product A. The entity can include, but is not limited to: (a) any entity enabling payment for an object and decreasing the unit price of the object and/or increasing the number of units of the object for a given price, e.g., by offering cash back for using the entity's payment method and/or payment account to purchase the object; and/or (b) any entity enabling payment for an object and decreasing the unit price of related objects and/or increasing the number of units of the related objects for a given price, e.g., by offering points for using the entity's payment method to purchase a Product A that can be redeemed for goods or services other than Product A, like travel services. The entity can include, but is not limited to: (a) any entity enabling payment for an object or related objects through linking the payment to an account not stored on the device executing the Transaction, e.g., a card offered by an issuer of credit and/or debit; and/or (b) any entity enabling payment for an object or related objects through linking the payment to an account stored on the device executing the Transaction, which can include, but is not limited to: (i) a payment method commonly referred to as a stored value card, e.g., a prepaid card or a gift card; and/or (ii) a payment method including payment account data stored on the device executing the Transaction, e.g., data which can be stored on NFC Module 11574. An issuer of a credit card or debit card, e.g., a bank, and/or a card association can provide its customer a Reward for utilizing the issuer and/or association credit/debit card to purchase an object. The Reward can be in any form, which can include, but is not limited to: a specific amount decrease in the price of the object purchased; a specific percentage decrease in the price of the object purchased; a percentage of the Transaction value returned at the time of Transaction or the end of a predefined period, e.g., “cash back”; specific points redeemable for objects and/or cash at the time of or separate from the Transaction; and/or miles redeemable for travel, hotel, and/or other types of expenses. Object I 02246 can display an estimate of the discount for a generic user of PC/WD 02200 or an estimate of the discount for the specific user of PC/WD 02200. If the user of PC/WD 02200 is associated with one or more credit/debit cards issued by one or more entities, Object I 02246 can display the discount applicable to the purchase of Product A and the name of the specific credit/debit card whose use would enable the applicable discount.

Object I 02246 can display any data related to any benefits or features not directly affecting the price paid for the object purchased or other objects (“Non-Price Feature”) which can accrue to the user for selecting an account of the user stored or operated by any entity enabling payment of the Object of Interest, either alone or with other objects in the same Transaction (“Payment Account”). The Payment Account can be operated by any one or more entities. The value or balance in Payment Account can be stored in one more Data Processing Systems, including, but not limited to: (a) a Client Device 14200, e.g., the value of a stored value card in a secure data structure as part of NFC Module 11574 in WD 02202; (b) a Payment Issuer Server 11600, e.g., a bank issuing the user of Client Device 14200 a credit/debit card; and/or (c) a Retailer Server 11620, e.g., a Retailer at which a user of Client Device 14200 purchased a stored value card whose value or balance is stored at Retailer Server 11620.

The Non-Price Features of a Payment Account can include, but are not limited to: (a) any type of warranty on the object purchased; (b) any type of insurance on the object purchased, e.g., rental car insurance; (c) partial or full reimbursement for any type of service related to the object purchased, e.g., travel assistance; (d) the length of time and/or the amount in excess of the purchase price a Retailer will place a hold on the Payment Account; and/or (e) any fee charged or not charged associated with the purchase of the Object of Interest, which can include, but is not limited to: (i) the charge of an overdraft fee, if the purchase causes the Payment Account balance to exceed a predefined threshold; (ii) the waiving of a periodic, e.g., monthly, fee, if the Object of Interest is paid with a specific payment method, e.g., a debit card, and the purchase causes the number of Transactions using the payment method to exceed a predefined threshold; (iii) the charge of a fee for converting an amount from the Payment Account balance in the home currency, i.e., the currency in which the Payment Account balance is denominated (“Home Currency”), to the local currency, i.e., the currency in which the Object of Interest is denominated (“Local Currency”); and/or (iv) the charge of a fee for withdrawing an amount from the Payment Account, e.g., the withdrawal of cash from an automatic teller machine (ATM).

Object I 02246 can display any data related to one or more Payment Accounts. The user can find it useful to see Payment Account data and/or any data relating the Payment Account to the Object of Interest in the vicinity of any object, e.g., Object D 02232. Enabling the user to view Payment Account data and data related to the Object of Interest in the same view can make it easier for the user to decide whether to purchase the Object of Interest or which Payment Account to use for the purchase. The Payment Account data can include, but is not limited to: (a) the amount of cash back received by the user for purchasing the Object of Interest using the Payment Account; (b) the number of Reward points the user would earn by purchasing the Object of Interest using the Payment Account; (c) the current amount of Reward points earned so far by the user; (d) the number of Reward points available to reduce the price of the Object of Interest; (e) the balance in the Payment Account, e.g., the amount of cash in a checking or savings account or the remaining credit available; and/or (f) any fees associated with the Payment Account, e.g., the amount of an overdraft fee.

Object I 02246 can display any data related to one or more payment methods whose use would qualify for an incentive payable to the user by a Retailer, an issuer, or any other entity. A Payment Method can include any type of method of paying for the purchase of an Object of Interest, including, but not limited to: (a) a credit card issued by any entity, e.g., a bank; (b) a debit card issued by any entity, e.g., a bank, which can include, but is not limited to: (i) an online debit card which can be secured with a personal identification number (PIN) authentication system; (ii) an offline debit card which can be associated with a user signature; and/or (iii) an electronic purse card which can store the value on the card chip; (c) a charge card issued by any entity; (d) a stored value card; (e) debiting funds directly from a Payment Account, e.g., a bank account; and/or (f) billing an user for payment at a time after the purchase of the Object of Interest. Object I 02246 can display the value and/or type of incentive payable by a Retailer, an issuer, or any other entity to the user of a Client Device 14200 for using a specific type of Payment Method. Object I 02246 can display the value, e.g., x percent of the Transaction value, and the type, e.g., in the form of a cash discount, of the example. In a first example, the fee for a Retailer accepting an offline debit card can be higher than the fee for accepting an online debit card. In the example, a Retailer can offer a user of Client Device 14200 an incentive, e.g., a cash discount, to use an online debit card to pay for the purchase of an Object of Interest. In a second example, an issuer can offer a user of Client Device 14200 an incentive, e.g., cash back, to use an offline debit card to pay for the purchase of an Object of Interest. In a second embodiment, a Reward is an Offer provided by any entity for purchasing one or more objects offered by the entity at least twice. The entity can include, but is not limited to: (a) any entity producing an object; (b) any entity selling an object; (c) any entity enabling the payment for an object; and/or (d) any other entity. The form of the Reward can include, but is not limited to: (a) a decrease in the unit price of Product A or related objects at the time of purchase of Product A; (b) the awarding of points which can be converted to cash value for part or all of the purchase of Product A, related objects, and/or non-related objects; and/or (c) any other form of decreasing the unit price of Product A, related objects, and/or non-related objects.

Object J 02248 can be Content in any form describing one or more discounts directly or indirectly decreasing the unit price of Product A or related objects and/or increasing the number of units of Product A or related objects offered for a given price through any type of Affinity Program, which is defined as any type of program which can offer discounts to members of a group on one or more objects, which in turn may or may not be provided by the program. There exist a wide variety of Affinity Programs, including, but not limited to: (a) programs based on activities, e.g., one for travel or emergency auto repair; (b) programs based on experiences, e.g., attendance at an educational institution or service as a veteran; (c) programs based on membership of a demographic group, e.g., senior citizens or students; (d) programs based on employment, e.g., discounts offered to employees of a business on one or more objects which may or may not be provided by the business; and/or (e) programs based on insurance, e.g., discounts offered to members of an insurance plan on one or more objects which may or may not be provided by the insurance carrier. For example, a health insurance vendor can offer to its members a discount on the price of its insurance policy for joining a qualified exercise club or a home insurance carrier can offer its members a discount on the price of its insurance policy for purchasing and installing a qualified home security system. Object J 02248 can display an estimate of the discount decreasing the price of Product A or the related object(s). In the prior example, Object J 02248 can display an estimate of the discount directly decreasing the unit price of Product A, e.g., the qualified exercise club, or decreasing the unit price of Product B, e.g., the premium for a health insurance policy. Also, Object J 02248 can display an estimate of the discount for a generic user of PC/WD 02200 or an estimate of the discount for the specific user of PC/WD 02200.

Object K 02250 can be Content in any form describing any type of rebates directly or indirectly decreasing the unit price of Product A or related objects and/or increasing the number of units of Product A or related objects offered for a given price.

Object L 02252 can be Content in any form describing any type of group offers directly or indirectly decreasing the unit price of Product A or related objects and/or increasing the number of units of Product A or related objects offered for a given price. An entity can offer to sell Product A for a discount to the regular price (“Group Price”) if a minimum number of customers agree to purchase Product A at the Group Price. Object L 02252 can display any data related to the Group Price, including, but not limited: (a) the Group Price; (b) the number of customers who have agreed at any given time to purchase Product A at the Group Price; and/or (c) the entit(ies) offering to sell Product A at the Group Price.

Object M 02254 can be Content in any form describing the expense of transporting Product A, either: (a) from a Retailer to an address of the user of PC/WD 02200, e.g., a shipping expense when purchasing Product A from Web Server 11910; or (b) from the location of the PC/WD 02200 to the location of one or more Retailers, e.g., the actual or estimated expense of gasoline and other travel expenses when purchasing Product A at PHY POS 11920. Object M 02254 can display an estimate of the shipping expense for a generic user of PC/WD 02200 or an estimate of the shipping expense for the specific user of PC/WD 02200. If PC/WD 02200 is associated with a shipping address provided by the user of PC/WD 02200 and stored in a data structure, e.g., 02302, Object M 02254 can display the shipping expense specific to the purchase of Product A and delivered to the address of the user of PC/WD 02200. Object M 02254 can display one or more offers from any party, e.g., the Retailer offering Product A, a shipper shipping Product A, and/or a third party, decreasing the expense of shipping Product A.

Object N 02256 can be Content in any form describing any type of financing applicable to the purchase of Product A. The type of financing can include, but is not limited to: reduced or no interest for a predefined period; reduced fees associated with the purchase, e.g., an origination fee for a mortgage; cash back at the purchase or any time after the purchase of Product A; and/or credit applied toward the purchase of another object.

Object O 02258 can be Content in any form describing the effect of any tax levied on the purchase of Product A. Object O 02258 can include the effect of any program implemented by any government entity which can either directly or indirectly increase or decrease the unit price paid for Product A or related objects and/or increasing the number of units of Product A or related objects offered for a given price. For example, a governmental entity, e.g., a state government, can levy a sales tax on the purchase of Product A. In another example, a governmental entity, e.g., the federal, state, and/or local government, can provide a tax deduction or tax credit reducing the after-tax cost of the purchase of Product A.

Object G 02242 through Object O 02258 can include any data describing the value of one or more Offers decreasing the price of Product A and/or related objects. In one embodiment, the above objects can include a string, e.g., an alphanumeric string representing a coupon code or identifier in the form of a virtual token, whose input into a field at any Retailer, e.g., Web Server 11910 and/or PHY POS 11920, can reduce the price of Product A and/or related objects by a predefined amount. In another embodiment, the above objects may not include a string which a Retailer can receive to reduce the price of Product A and/or related objects. To redeem the Offer, a user typically would have to speak with a representative of the Retailer, who would manually associate the Offer with the purchase. In the embodiment, the invention can describe the value of the Offer and enable the user to originate a communication with the Retailer to request the redemption of the Offer.

Object P 02260 can be Content in any form describing the net price of Product A, which can equal the retail price (actual or suggested) less the value of one or more Offers decreasing the price of Product A.

Object Q 02262 can receive, process, store, display, and/or transmit Content in any form describing discounts available on one or more objects related to Product A. For example, a first device, e.g., a television, can display an advertisement promoting Product A, e.g., a fast food meal, whose purchase would be accompanied by a free or discounted Product B, e.g., a toy from a movie. Object Q 02262 can display Content describing Product B.

Object R 02264 can receive, process, store, display, and/or transmit Content in any form describing one or more objects competing with Product A and/or one or more Offers related to the competitive object(s).

Object S: BUY/CALL 02270 can be any module whose selection can enable the transmission of voice and/or data to one or more Data Processing Systems for executing the purchase of the Object of Interest. In a first embodiment, selection of Object S 02270 when Object G 02242 displays an IP Retailer can enable the transmission to one or more Data Processing Systems, e.g., Web Server 11910, of a User Request to purchase the Object of Interest. In a second embodiment, selection of Object S 02270 when Object G 02242 displays a Voice Retailer can enable the calling module of PC/WD 02200 to originate a voice and/or data transmission, e.g., voice over IP (“VOIP”), to one or more Data Processing Systems, e.g., Web Server 11910 configured to receive a voice and/or VOIP transmission, of a User Request to speak about the Object of Interest. In a third embodiment, selection of Object S 02270 when Object G 02242 displays a PHY Retailer can execute a variety of instructions, including, but not limited to: (a) displaying one or more PHY Retailers selling the Object of Interest at the price displayed in Object G 02242; (b) storing data associated with the PHY Retailer which can be displayed on WD 02202 when its location is within a predefined range of the location of a physical store of PHY Retailer; and/or (c) storing one or more Offers in Object F 02240 which can be automatically redeemed when WD 02202 executes a purchase of the Object of Interest at a physical store of PHY Retailer.

A Client Device 14200 can detect the selection in any form of Object S: BUY/CALL 02270, whose selection can be executed by methods including, but limited to, the following. First, Client Device 14200 can include any type and form of executable instructions to detect any event related to Object S: BUY/CALL 02270, including, but not limited to, a mouse click, a key press, a touch, a speech input, and/or a change in the properties of a display or any section of a display meeting any threshold, e.g., the detection by a display like a TV screen of a minimum level of energy like Infrared Signal 11522 from a source device like a remote control device. For example, while Client Device 14200 displays Object F 02240 as an active window, e.g., Window 33230, the detection of any event by Client Device 14200 can trigger an event handler associated with Object S: BUY/CALL 02270.

Second, Client Device 14200 can include any type and form of executable instructions to receive any data meeting any predefined criteria related to Object S: BUY/CALL 02270, including, but not limited to: (a) receiving one or more values describing an event detected by Client Device 14200. For example, while Client Device 14200 displays Object F 02240 as an active window, e.g., Window 33230, the detection of a minimum or maximum value for a set of coordinates measuring the position of an object like Gesture Detection Device 11564 can trigger an event handler associated with Object S: BUY/CALL 02270.

Third, Client Device 14200 can include any type and form of executable instructions to receive any instruction related to Object S: BUY/CALL 02270, including, but not limited to: (a) receiving one or more predefined instruction signals from any component of Client Device 14200. For example, an instruction from NFC Module 11574 when Client Device 14200 is in the vicinity of PHY POS 11920 to execute any instructions and/or transmit any data associated with one or more objects in Object F 02240 can trigger an event handler associated with Object S: BUY/CALL 02270.

An event handler associated with Object S: BUY/CALL 02270 can execute any function (“Object S 02270 Function”), including, but not limited to: (a) transmit to another Data Processing System, e.g., Inter Server 02300, a request to purchase the object of interest from the Retailer specified in Object G 02242; (b) transmit to another Data Processing System, e.g., Inter Server 02300, one or more selected values of object attributes presented to the user of Client Device 14200, e.g., an X monitor size, a Y memory size, and a Z estimated battery life (the application defines an Object Attribute as a property or characteristic of an object, e.g., an attribute of an object “computer” can be the amount of memory); (c) transmit to another Data Processing System, e.g., Inter Server 02300 or Payment Issuer Server 11600, a request to redeem one or more coupons specified in Object H 02244; (d) transmit to another Data Processing System, e.g., Inter Server 02300 or Payment Issuer Server 11600, a request to redeem one or more rewards specified in Object I 02246; (e) transmit to another Data Processing System, e.g., PHY POS 11920, a request to redeem one or more coupons specified in Object H 02244; (f) transmit to another Data Processing System, e.g., Inter Server 02300, a request to populate automatically a form for a rebate specified in Object K 02250; (g) transmit to another Data Processing System, e.g., Inter Server 02300, a request to make an offer to purchase an object of interest as part of a group specified in Object L 02252; and/or (h) transmit to another Data Processing System, e.g., Inter Server 02300 or Payment Issuer Server 11600, a request to select a Payment Account specified in Object I 02246 to execute the purchase of an object of interest.

An event handler associated with Object S: BUY/CALL 02270 can provide logic for handling one or more events detected by a Client Device 14200 related to Object S: BUY/CALL 02270. In one embodiment, an event handler can receive one or more values describing an event detected by Client Device 14200, e.g., an event flag, when Client Device 14200 displays Object F 02240 as an active window, e.g., Window 33230. The event handler can apply logic to compare the received value(s) against predefined values to determine if the received value(s) meets a predefined criterion. If the received value(s) meet the predefined criterion, the event handler can execute one or more of the Object S 02270 Functions.

Object S: BUY/CALL 02270 can be associated with a communications address, e.g., a phone number or email address of Inter Server 02300, of a Data Processing System to which Client Device 14200 can transmit instructions and/or data associated with the Object S 02270 Functions. Selection of the Object S: BUY/CALL 02270 can trigger an event handler which can call any method in any module of Client Device 14200 enabling the transmission of instructions and/or data to the communications address associated with Object S: BUY/CALL 02270.

While the application illustrates Object F 02240 as comprising the above objects, e.g., Object G 02242 through Object S 02270, the invention is not limited to that embodiment. The invention can include any subset of the above objects, or additional, related, alternative, and/or equivalent objects. Object F 02240 can include one or more additional objects which can decrease the price of Product A and is not a Coupon, Reward, and/or rebate, or related to shipping or financing.

Object F 02240 can include one or more additional objects which can display and/or enable the automatic redemption of one or more Non-Price Features related to the Object of Interest. The Non-Price Features can include any feature not directly affecting the price paid for the Object of Interest and any feature related to the above objects, e.g., Object G 02242 through Object S 02270, including, but not limited to, any feature related to: (a) Object G 02242, e.g., the location, hours of operation, or parking availability of one or more Retailers; (b) Object H 02244, e.g., the range of dates for which an Offer can be redeemed or the number of units which can be purchased by a single user; (c) Object I 02246, e.g., the attributes described earlier for the Non-Price Features of a Payment Account; (d) Object J 02248, e.g., the range of ages for which an Offer can qualify; (e) Object K 02250, e.g., the terms and conditions which must be met to qualify for a rebate; (f) Object L 02252, e.g., the range of dates for which an Offer can be redeemed; (g) Object M 02254, e.g., the requirement of a signature for delivery; (h) Object N 02256, e.g., the range of dates for which a financing Offer can qualify; (i) Object O 02258, e.g., the terms and conditions which must be met to qualify for a tax credit or tax deduction; (j) Object Q 02262, e.g., the Retailer(s) at which a related object can be purchased; and/or (k) Object R 02264, e.g., the Retailer(s) at which a competitive object can be purchased.

While the application illustrates Object F 02240 as displaying one or more objects, e.g., Object G 02242 through Object S 02270, in one order and format, the invention is not limited to that embodiment. The invention can display one or more objects, e.g., Object G 02242 through Object S 02270, in any order and/or any format. For example, the invention can display Object I 02246 above Object H 02244. In another example, the invention can display one or more objects in any format, including, but not limited to: a text string, a numerical string, an image, a video, and/or a graph. The invention may or may not display the logo and/or trademark of the entity providing an Offer near the value of the Offer. The invention can display an image, static or moving, of Product A, any related object(s), and/or any competitive object(s).

While the application illustrates Object F 02240 as displaying one or more objects, e.g., Object G 02242 through Object S 02270, related to Product A, the invention is not limited to that embodiment. The invention can display one or more objects, e.g., Object G 02242 through Object S 02270, related to an object which competes with or complements Product A. A user of PC/WD 02200 can be interested in seeing one or more Offers related to an object competing with Product A. For example, a PC/WD 02200 user can view Content displayed on TV 02100 or PC/WD 02200 promoting a motor vehicle model XYZ offered by vendor A or transmit a User Request independent of any Content displayed. The PC/WD 02200 user can be interested in Object F 02240 including one or more Offers related to one or more other motor vehicle models ABC offered by other vendors. Currently, a user must visit a third party web site which aggregates and organizes data about different objects within a class of objects. The invention can enable the user to view at the point of promotion one or more related objects and associated Offers. Even if the invention did not display one or more Offers decreasing the unit price of an object competitive with Product A, the invention can display data related to the competitive object at Object R 02264. For example, there may be a generic object which has many or all of the features of a brand object and may not have any associated Offers decreasing the unit price of the generic object. In this example, the invention can display data describing the generic object and its unit price, as well as the brand object and its unit price.

Inter Server 02300 can be any Data Processing System capable of executing a variety of functions and/or instructions, including, but not limited to: (a) receiving inputs from one or more Data Processing Systems, including, but not limited to, a Client Device 14200, e.g., PC/WD 02200; (b) storing data received from one or more Data Processing Systems and/or any data output from instructions executed by Inter Server 02300; (c) processing data in accordance with stored instructions; and/or (d) transmitting data and/or instructions to one or more Data Processing Systems, including, but not limited to, a PC/WD 02200.

The application illustrates Inter Server 02300 as the device exchanging data with, storing data received from, and/or processing data received from one or more other Data Processing Systems, which can include, but are not limited to: (a) Payment Issuer Server 11600; (b) Payment Association Network Server 11610; (c) Retailer Server 11620; (d) Advertisement Server 11630; and/or (e) Other Server 11700. However, the invention is not limited to that embodiment. The invention can: (a) utilize a Client Device 14200, e.g., PC/WD 02200, to execute the functions executed by Inter Server 02300; (b) utilize any other Data Processing System to execute the functions executed by Inter Server 02300; and/or (c) distribute the functions executed by Inter Server 02300 among a plurality of Data Processing Systems. User Database 02310 can be a data structure capable of enabling at least the writing, storage, and/or reading of data related to the user of PC/WD 02200, including, but not limited to: (a) data identifying and/or related to Content displayed on any device used by and/or in the vicinity of the user of PC/WD 02200; (b) word strings queried by the user of PC/WD 02200 in one or more search requests (word strings can comprise one or more words); (c) data identifying and/or related to objects and/or object categories purchased by the user of PC/WD 02200; and/or (d) data related to the user of PC/WD 02200. The data structure can include data related to purchases paid through any type of payment, including, but not limited to: credit card; debit card; check; and/or loan.

Object Database 02320 can be a data structure capable of enabling at least the writing, storage, and/or reading of data related to objects and/or object categories, including, but not limited to: (a) the name of objects and/or object categories; (b) the set of data, e.g., phonemes in the case of speech, associated with the name; (c) any standard codes uniquely identifying each object and/or object category; (d) one or more retailers offering for sale the object and/or object category; and/or (e) one or more objects related to and/or complementing each object.

While the application illustrates the reception, writing, storage, recognition, identification, classification, comparison, matching, parsing, reading, transmission, and/or other processing of the names of objects, products, brands, vendors, Retailers, classes of objects, classes of products, classes of vendors, classes of Retailers, and/or currencies (collectively “Commerce Objects”), the invention is not limited to processing of actual names. The invention can process similar names. Typically, people can refer to a Commerce Object by not only the name assigned by an entity producing the Commerce Object, but also by names which have become commonly associated with the Commerce Object. For example, people can refer to the brand, “Mercedes-Benz®”, also as “Benz” or the brand, “Dallas Cowboys”, also as “The Boys”. Where any apparatus, method, and/or CPP described herein processes a name of any Commerce Object, the invention can enable the processing of a similar name by utilizing any method identifying names similar to a name inputted. For example, the invention in any apparatus, method, and/or CPP described herein can compare a set of candidate object names against not only the object name assigned by a vendor producing the object, but also object names generated by any method identifying similar names.

Analysis Module 02330 can be any article of manufacture (AOM) or CPP capable of executing a variety of functions and/or instructions, including, but not limited to: (a) receiving data from one or more sources of data, e.g., PC/WD 02200, User Database 02310, and/or Product Database 02320; (b) utilizing an acoustic model and/or language model to recognize a speech utterance; (c) querying one or more data structures to identify data associated with a given word string, e.g., an object name; and/or (d) transmitting data to one or more devices, e.g., PC/WD 02200.

Analysis Module 02330 can comprise and/or execute the functions performed by one or more articles of manufacture or CPPs, including, but not limited to: (a) Object ID Engine 33310; (b) Offer ID Engine 33320; (c) Payment ID/Transaction Engine 33330; (d) Offer Redemption Engine 33340; and/or Transaction-to-AOM/CPP Engine 33350.

While the application illustrates Analysis Module 02330 as stored in Inter Server 02300, the invention is not limited to that embodiment. The invention can store Analysis Module 02330 in any Data Processing System, e.g., PC/WD 02200 or TV 02100, and/or distribute the functions executed across a plurality of Data Processing Systems, e.g., Inter Server 02300 and PC/WD 02200, or TV 02100 and PC/WD 02200.

Apparatus 02000 can comprise: (a) a memory, e.g., Memory 01120; (b) a processor, e.g., Processor 01040; (c) an analysis module, e.g., Analysis Module 02330, stored in the memory and executable on the processor which can execute one or more of the following functions and/or instructions: (i) identify one or more Objects of Interest and/or one or more Classes of Interest; (ii) identify and/or redeem one or more Offers associated with the Object of Interest; and/or (iii) select a Payment Account and/or redeem earned reward currency related to the purchase of the Object of Interest; and/or (d) a display module stored in the memory and executable on the processor which can display in any display, e.g., PC/WD Display 02210, Object F 02240 and/or Object S 02270. In another embodiment, Apparatus 02000 can comprise one or more of the above components located in another Data Processing System, e.g., TV 02100.

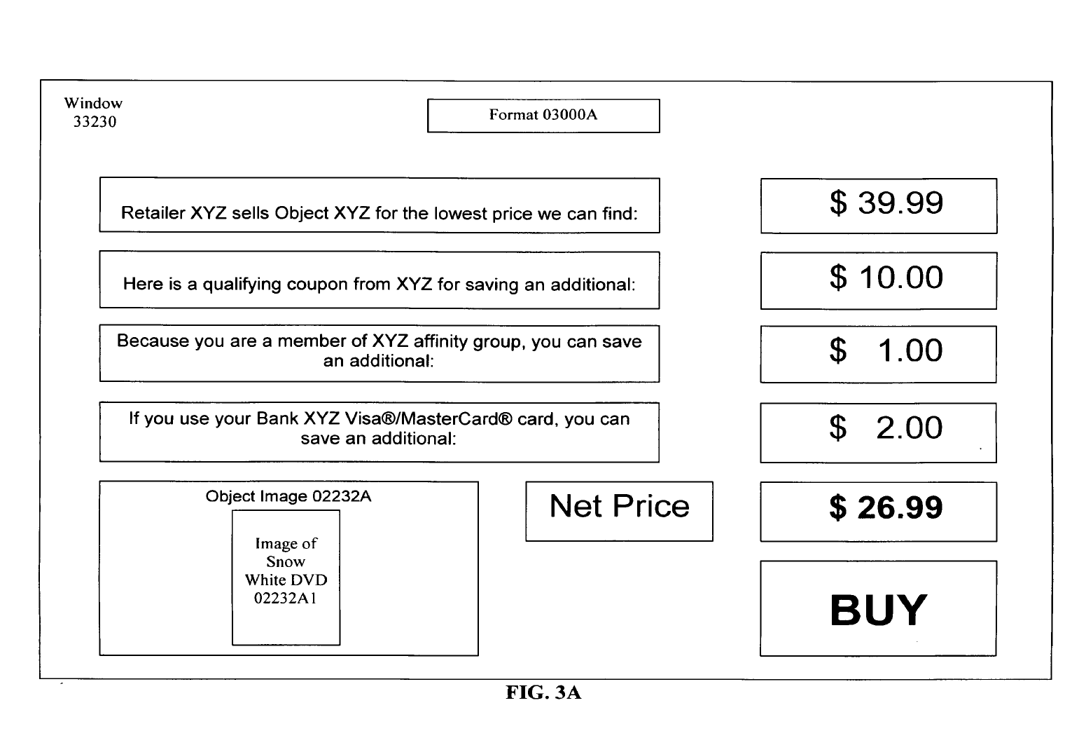

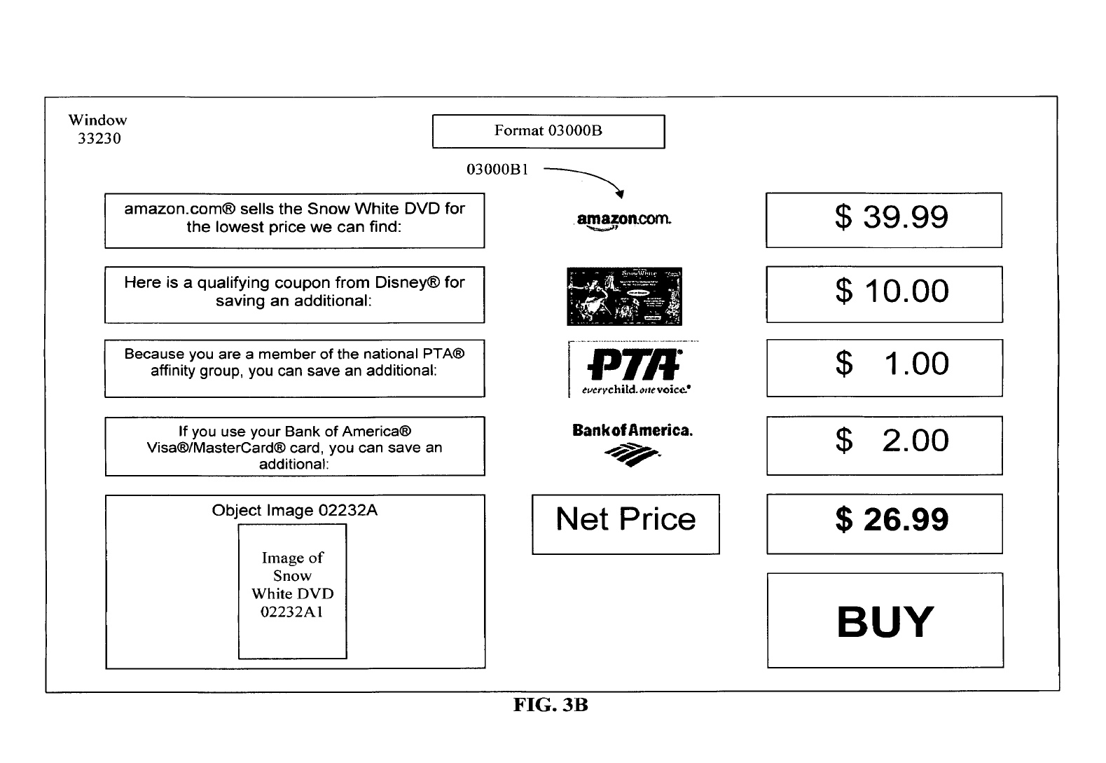

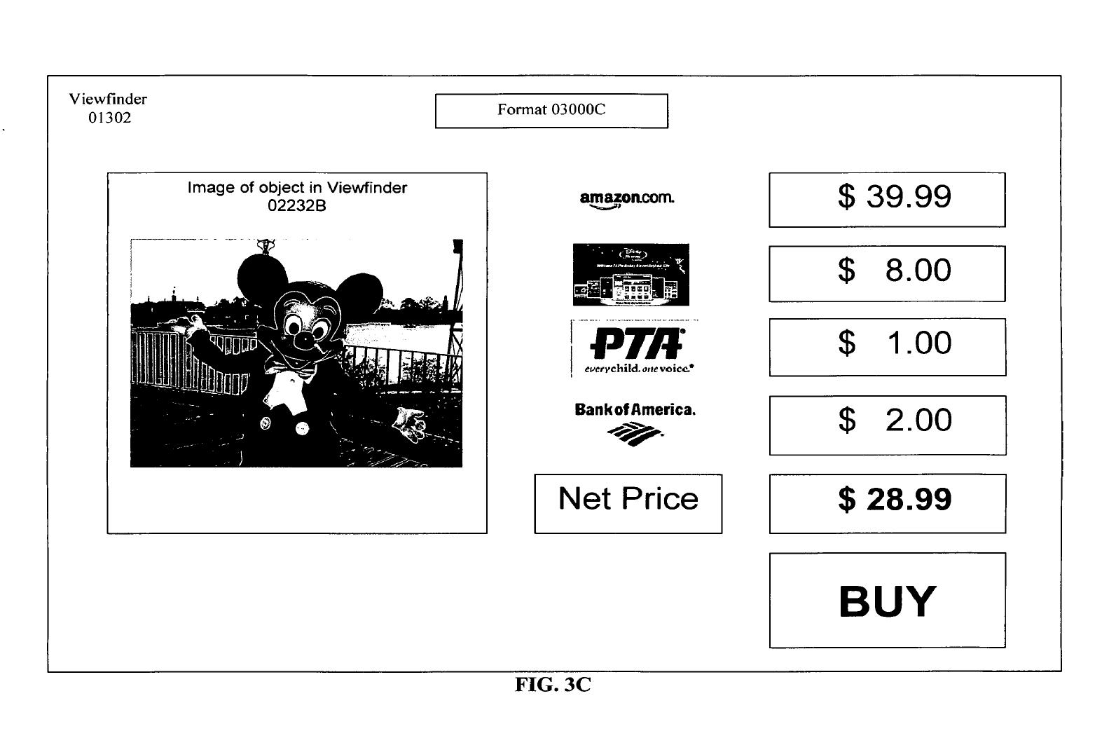

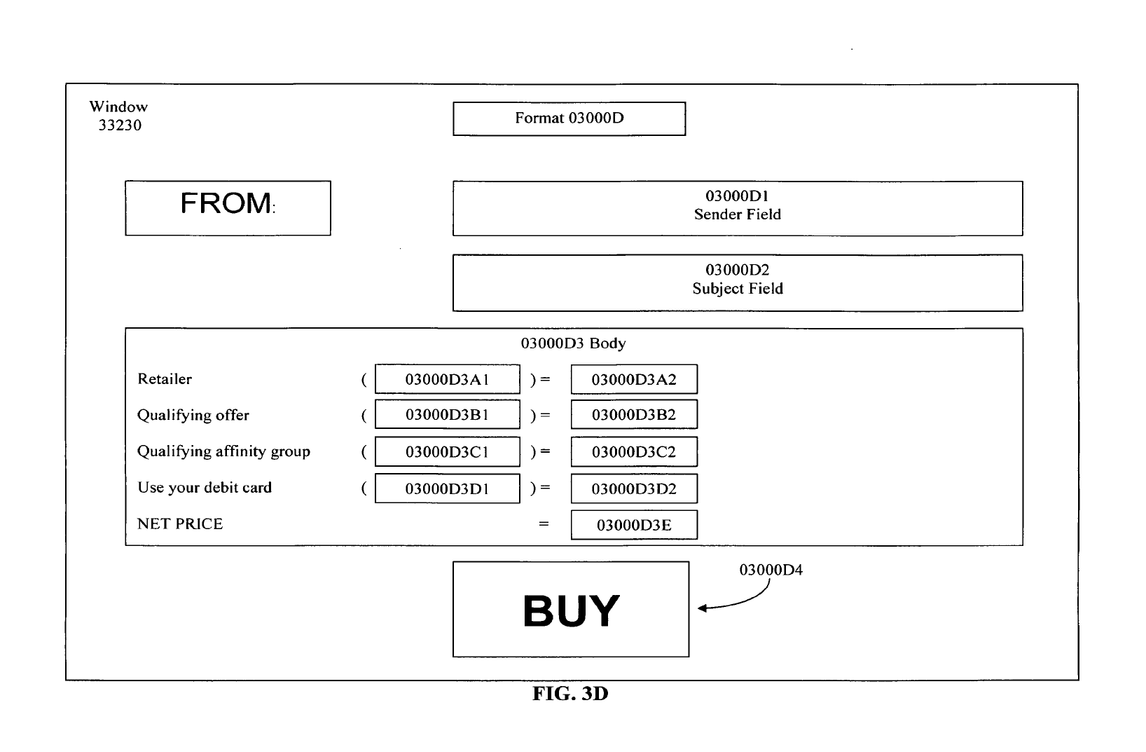

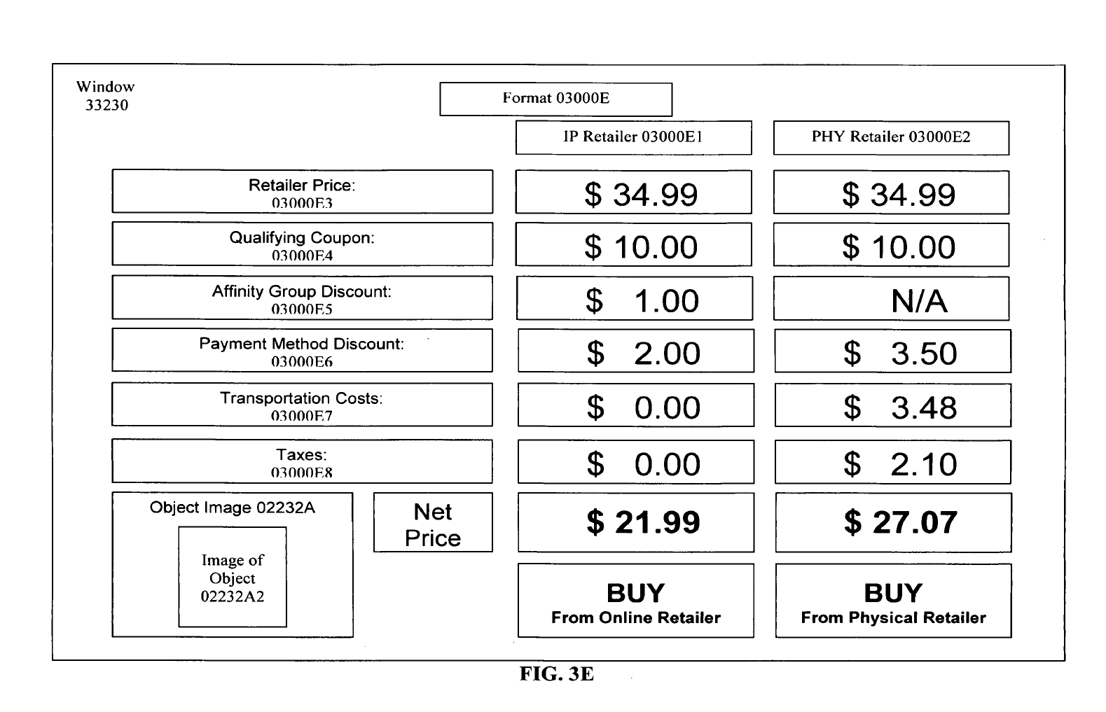

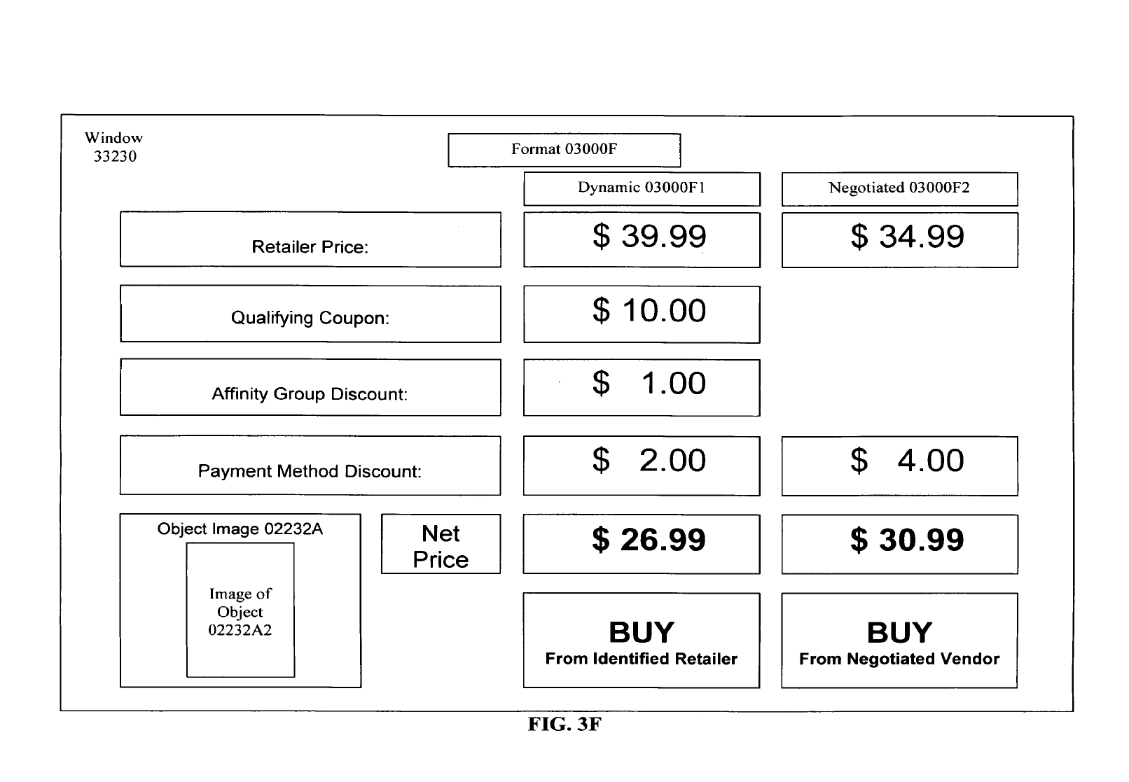

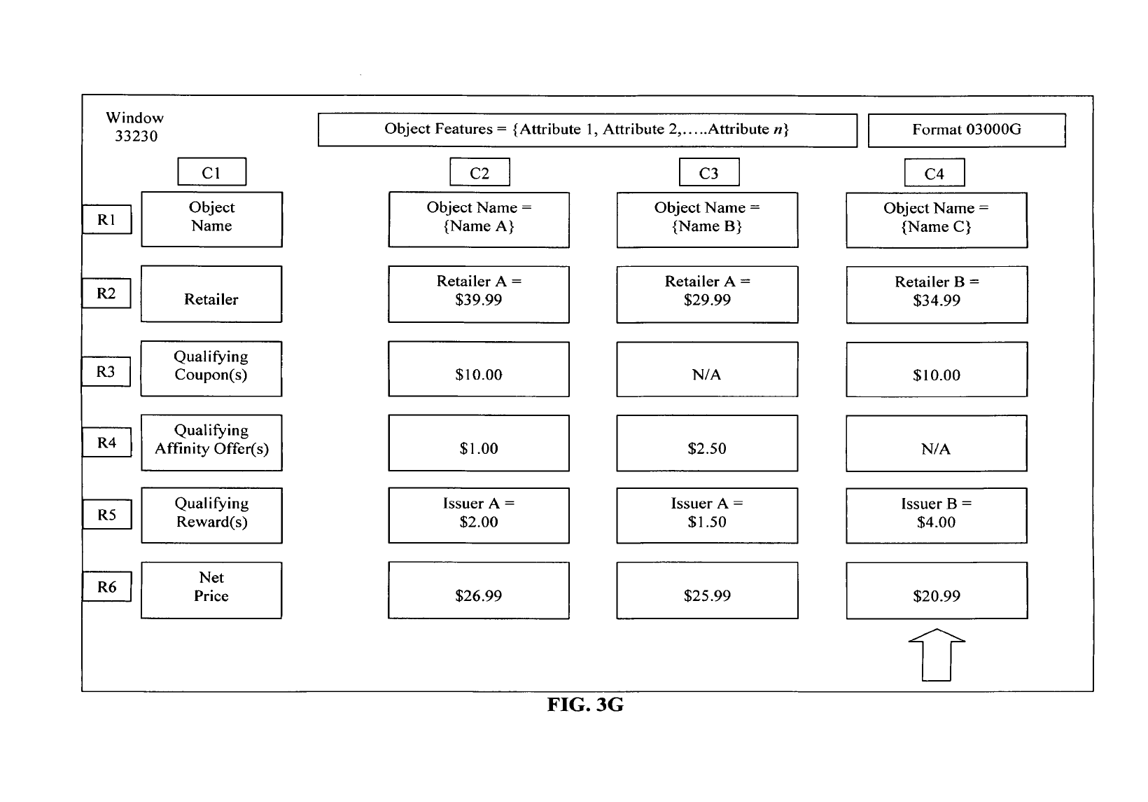

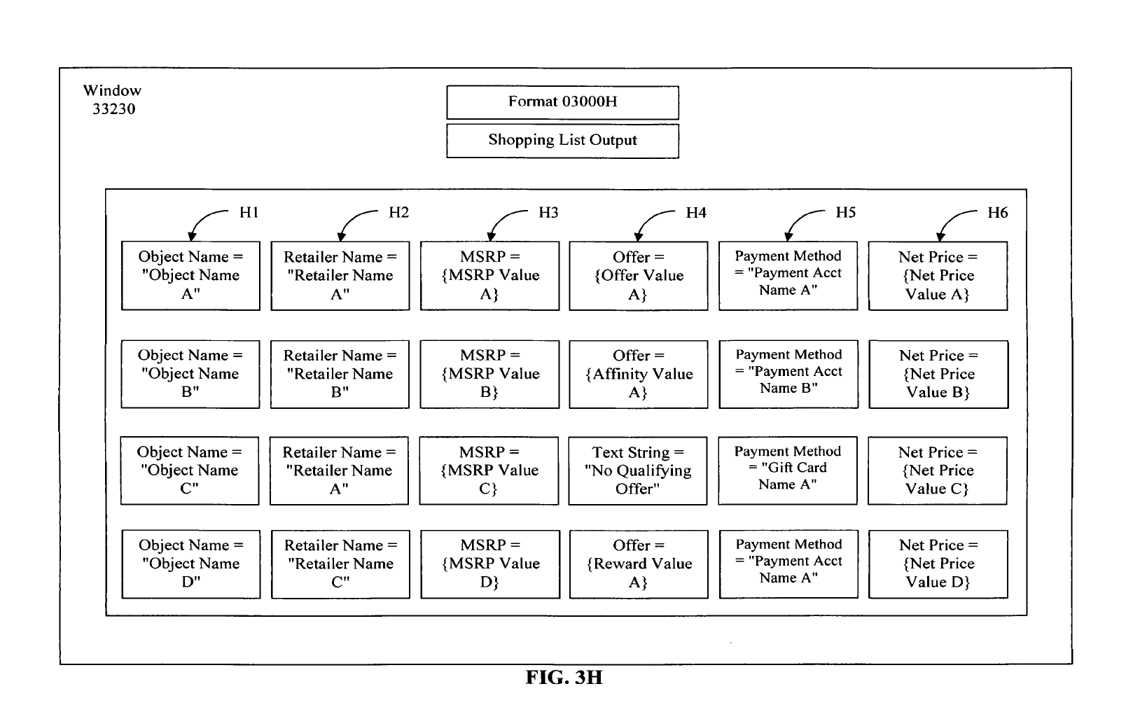

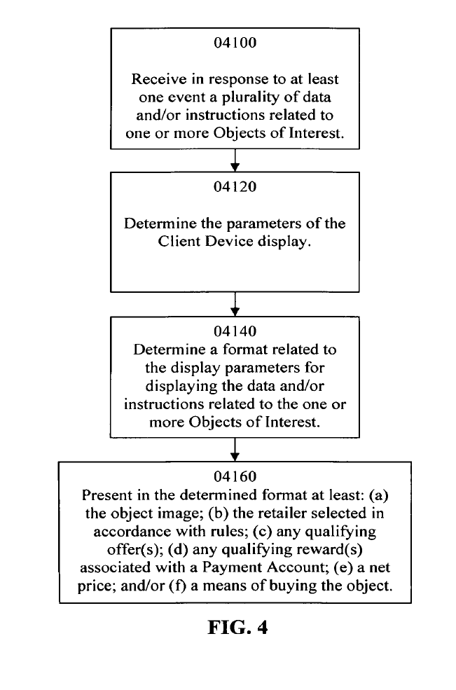

FIG. 4 depicts a flowchart of an exemplary computer-implemented method, Method 04000, that when executed can enable the presentation in a defined format on a client device of data related to an object of interest, according to one embodiment. The flowchart refers to the apparatus and structures depicted in FIG. 2B and FIGS. 3A-3F. However, the method is not limited to those embodiments. The method can implement the steps described herein utilizing a subset of the components, any combination of the components, or additional, related, alternative, and/or equivalent components depicted in FIG. 2B, FIGS. 3A-3F, and/or elsewhere in the application. The method can execute a subset of the steps, any combination of the steps, the steps in different order, and/or additional, related, alternative, or equivalent steps.

At 04100, Method 04000 can receive in response to at least one event a plurality of data and/or instructions related to one or more Objects of Interest. The event can be any Client Event receiving data, instructions, and/or commands on a Client Device 14200 related to an Object of Interest. For example, a user of PC/WD 02200 can move a cursor over any object representing an Object of Interest or speak a word string representing an Object of Interest. In response to at least one event, Method 04000 can use any method described herein to generate a plurality of data and/or instructions related to an Object of Interest, e.g., Object F 02240, and transmit the data and/or instructions to a Client Device 14200.

At 04120, Method 04000 can determine the parameters of Display 01200 of Client Device 14200, e.g., PC/WD Display 02210. The parameters can include, but are not limited to: the display size; the font(s) of characters displayed; the color(s) of text and/or objects displayed; and/or the position of objects within the display.

At 04140, Method 04000 can determine a format related to the parameters of Display 01200 for displaying the data and/or instructions related to the one or more Objects of Interest. Determining a format related to the display parameters can yield a variety of benefits, including, but not limited to: (a) enabling the generation of a format of one or more objects, e.g., Object F 02240, which is proportional to the display size; (b) enabling the generation of a format which can enable the user of Client Device 14200 to view the offer(s) and their corresponding value(s) in a manner that can be familiar, easy to view, and/or easy to understand; and/or (c) enabling the display of one or more objects, e.g., Object F 02240, in any position desired by the user of Client Device 14200 relative to the image of the one or more Objects of Interest.

At 04160, Method 04000 can present in the determined format one or more of the following data: (a) the image of the Object of Interest; (b) the Retailer selected in accordance with Rules Data Structure 37200; (c) any qualifying Offer(s) identified by Offer ID Engine 33320; (d) any qualifying Reward(s) associated with a Payment Account identified by Payment ID/Transaction Engine 33330; (e) a net price, e.g., Object P 02260; and/or (f) an object whose selection can enable the user to buy the Object of Interest, e.g., Object S 02270. While the application illustrates 04160 as including the preceding elements, the invention is not limited to that embodiment. The invention can include any combination of elements, fewer elements, more elements, and/or different elements. The invention can include any and all variations of the embodiments described herein.

In a first embodiment illustrated by FIG. 3A and FIG. 3B, the format can include: (a) the image of the Object of Interest, e.g., Object D 02232, Object Image 02232A, Image of Snow White DVD 02232A1, or Image of object in Viewfinder 02232B; (b) text and/or an image, e.g., a logo 03000B1, of the Retailer offering the Object of Interest at a desired price level, e.g., the minimum price, and the price offered on the same horizontal line, e.g., Object G 02242; (c) text and/or an image, e.g., a logo 03000B1, of one or more entities making an Offer, Reward, and/or Non-Price Feature associated with the Object of Interest, and the value of the Offer on the same horizontal line, e.g., one or more Object H 02244 through Object O 02258; (d) the net price reflecting one or more Offers, e.g., Object P 02260; and/or (e) an object whose selection can enable the user to buy the Object of Interest, e.g., Object S 02270. The format can present the one or more entities offering the Object of Interest and/or an Offer related to the Object of Interest in a vertical, horizontal, or any other type of alignment. The format can present the one or more values associated with each entity in a vertical, horizontal, or any other type of alignment. The format can present the alphanumeric characters constituting the text describing the entities and/or values in any manner, including, but not limited to: (a) same type or size of font; and/or (b) different type or size of font depending on any criteria, e.g., the largest value relative to the net price. FIG. 3A depicts a first exemplary format, Format 03000A. FIG. 3B depicts a second exemplary format, Format 03000B, which can add the logo(s) 03000B1 of: (a) any Retailer offering the Object of Interest; and/or (b) any entity making an Offer, Reward, and/or Non-Price Feature associated with the Object of Interest.

In a second embodiment illustrated by FIG. 3C, a format, Format 03000C, can include the same or different objects as the first embodiment, except the objects can be organized in a manner, alignment, and/or format which reflect the display of the Object of Interest in a Viewfinder 01302. Client Device 14200 can include a Viewfinder 01302 enabling the user to view any object through a Lens 01300. In the embodiment, the invention can organize the objects in any manner, e.g., to position one or more objects constituting Object F 02240 surrounding the Object of Interest. For example, the user of Client Device 14200 probably does not want any data related to an Object of Interest displayed in Viewfinder 01302 to obscure the Object of Interest. Format 03000C can organize the objects in any manner, including, but not limited to: (a) surrounding the Object of Interest with the objects constituting Object F 02240; and/or (b) placing the objects constituting Object F 02240 on the top, left, right, or bottom of or any combination of locations relative to the Object of Interest.

In a third embodiment illustrated by FIG. 3D, a format, Format 03000D, can include the same or different objects as the first embodiment, except the objects can be in any electronic messaging format, including, but not limited to: (a) a form of text displayed in a message, e.g., a text message, instant message, or email; and/or (b) a form of multimedia objects displayed in a message, e.g., a multimedia message, instant message, or email.

In Format 03000D, Window 33230 can display components, including, but not limited to: (a) Sender Field 03000D1, which can display a communications address of the sender, e.g., a phone number or email address of Inter Server 02300; (b) Subject Field 03000D2, which can display any word string describing the content included in Body 03000D3; (c) Body 03000D3, which can display one or more objects in Object F 02240, which can include, but are not limited to: (i) 03000D3A1, which can display any data stored in Object G 02242 describing the identity of a Retailer offering the Object of Interest; (ii) 03000D3A2, which can display any data stored in Object G 02242 related to the price at which a Retailer offers the Object of Interest; (iii) 03000D3B1, which can display any data stored in Object F 02240 describing the identity of an entity making an Offer related to the Object of Interest, e.g., data stored in Object H 02244; (iv) 03000D3B2, which can display any data stored in Object F 02240 related to the value of the Offer related to the Object of Interest; (v) 03000D3C1, which can display any data stored in Object F 02240 describing the identity of an entity making an Offer to members of a group related to the Object of Interest, e.g., data stored in Object J 02248; (vi) 03000D3C2, which can display any data stored in Object F 02240 related to the value of the Offer related to the Object of Interest; (vii) 03000D3D1, which can display any data stored in Object F 02240 describing the identity of a Payment Issuer offering a Reward and/or Non-Price Feature related to the Object of Interest, e.g., data stored in Object I: Reward 02246; (viii) 03000D3D2, which can display any data stored in Object F 02240 related to the value of the Reward and/or Non-Price Feature related to the Object of Interest; (ix) 03000D3E, which can display any data stored in Object P: 02260; and/or (d) 03000D4, which can be an object whose selection can represent a Command to buy the Object of Interest and redeem the one or more Offers displayed.

In a fourth embodiment illustrated by FIG. 3E, a format, Format 03000E, can include the same or different objects as the first embodiment, except the format can display the values of an Object of Interest offered by a plurality of Retailers. That is, Format 03000E can enable the comparison of the same Object of Interest among a plurality of Retailers. In Format 03000E, Window 33230 can display one or more objects in Object F 02240, which can include, but are not limited to: (a) a plurality of Retailers, e.g., a first Retailer like IP Retailer 03000E1 and a second Retailer like PHY Retailer 03000E2; (b) a row 03000E3 for the price offered by a plurality of Retailers for the Object of Interest, which can display in a field associated with each Retailer any data stored in Object G 02242 related to the price at which each Retailer offers the Object of Interest; (c) a row 03000E4 for any coupons associated with the Object of Interest, which can display in a field associated with each Retailer any data stored in Object H 02244 related to an Offer which can be redeemed by each Retailer; (d) a row 03000E5 for any discounts associated with the Object of Interest and an affinity group of which the user of Client Device 14200 is a member, which can display in a field associated with each Retailer any data stored in Object J 02248 related to an Offer which can be redeemed by each Retailer; (e) a row 03000E6 for any Rewards associated with a Payment Account of the user of Client Device 14200 and each Retailer, which can display in a field associated with each Retailer any data stored in Object I 02246 related to a Reward which can be redeemed by each Payment Issuer Server 11600; (f) a row 03000E7 for the estimated costs of transporting (i) the Object of Interest from a Retailer to the user of Client Device 14200, or (ii) the user of Client Device 14200 to the Retailer offering the Object of Interest, which can display in a field associated with each Retailer any data stored in Object M 02254 where the type of Retailer is an IP Retailer or any data estimating the distance between the location of Client Device 14200 and the Retailer where the type of Retailer is a PHY Retailer and the estimated cost of traveling the distance; (g) a row 03000E8 for the taxes associated with purchasing the Object of Interest at each Retailer, which can display in a field associated with each Retailer any data stored in Object O 02258; and (h) a row displaying in a field associated with each Retailer any data and/or instructions stored in Object S BUY/CALL 02270.

In a fifth embodiment illustrated by FIG. 3F, a format, Format 03000F, can include the same or different objects as the first embodiment, except the format can display the values of an Object of Interest offered by: (a) at least one Retailer with which an entity negotiated in advance a price and through which an user of Client Device 14200 can purchase an Object of Interest (“Advance Negotiated Retailer”), e.g., a Retailer offering the price in column Negotiated 03000F2; and (b) at least one Retailer which is not an Advance Negotiated Retailer, e.g., a Retailer offering the price in column Dynamic 03000F1. That is, Format 03000F can enable a user of Client Device 14200 who can purchase an Object of Interest through an entity negotiating in advance a price, e.g., an organization offering the Retailer the ability to sell the Object of Interest in large volume, to determine if another Retailer offers the Object of Interest at a lower total cost.

In a sixth embodiment illustrated by FIG. 3G, a format, Format 03000G, can include the same or different objects as the first embodiment, except the format can display the values of one or more objects with a specific configuration, i.e., a set of attributes with equal values or values within a specified range (“Equivalent Objects of Interest”). A user of Client Device 14200 can be interested in an Object of Interest or an object with one or more attributes equivalent to the Object of Interest. For example, a user of Client Device 14200 can be interested in an object which has certain values for a set of attributes and be less interested in a specific Object of Interest. In the example, the user of Client Device 14200 can be more interested in an object with the certain values for a set of attributes and a lower price and be less interested in the value of the brand associated with the object. In many examples, an object commonly referred to as a Private Label object can have the same values for a set of attributes as an object supplied by a vendor but at a lower price. When a user of Client Device 14200 specifies the values for a set of attributes, the invention can display in Format 03000G the values of one or more Equivalent Objects of Interest.

In one embodiment generating Format 03000G and/or any other format comparing a plurality of objects in a Class of Objects, the invention can utilize any method, e.g., Method 09000, to generate one or more queries to the user of Client Device 14200 whose responses can narrow a plurality of objects in a Class of Objects to an Object of Interest or a plurality of Equivalent Objects of Interest. The application defines a Class of Objects as any group of objects, which can include, but is not limited to: (a) a Class of Objects defined by an open standard, e.g., NAICS; and/or (b) a Class of Objects defined by a proprietary standard. In one example of a Class of Objects defined by a proprietary standard, the invention can identify a Class of Objects as follows. First, the invention can determine one or more entities, e.g., Consumer Reports®, which offer an object for sale and/or data related to the object, e.g., a company which rates objects in a Class of Objects on any criteria like price or safety. Second, the invention can parse any data structure, e.g., a web site produced by Consumer Reports® or a leading Retailer, which offers a user the ability to select an object, e.g., a motor vehicle model like the Mitsubishi Eclipse®, to obtain data related to the Eclipse or to buy the Eclipse. Parsing the web site can identify the set of motor vehicle models classified by Consumer Reports® or a leading Retailer in a Class of Objects, e.g., “New Cars”. Third, the invention can write to any data structure, e.g., one located at Inter Server 02300, the New Cars Class of Objects and the set of motor vehicle objects, e.g., Mitsubishi Eclipse®, classified by Consumer Reports® or a leading Retailer in the Class of Objects.

The invention can execute a method, Method 03000G, to enable the presentation of Format 03000G. Method 03000G can execute the following steps, a subset of the steps, any combination of the steps, the steps in different order, and/or additional, related, alternative, or equivalent steps.

First, Method 03000G can receive a User Request for an Object of Interest or a Class of Interest.

Second, Method 03000G can identify a set of attributes associated with the specified Object of Interest, the class of which the Object of Interest is a member, or the specified Class of Interest. The set of attributes can comprise one or more attributes whose selection can narrow a plurality of objects in a Class of Objects to one Object of Interest or a plurality or any desired number of Equivalent Objects of Interest. For example, a User Request for a Class of Interest “Laptop Computers” can cause Method 03000G to identify a set of attributes associated with the Class of Interest, e.g., monitor size, memory or RAM, and estimated battery life.

Third, Method 03000G can identify the set of values associated with each identified attribute. The set of values can comprise those values of attributes associated with any object in the Class of Interest. For example, the Class of Interest “Laptop Computers” can include 100 vendors manufacturing the object “laptop computers” classified within the North American Industry Classification System (NAICS) code 334111. Method 03000G can then execute Method 09000, e.g., steps 09100 to 09240A to determine the attributes and/or values for each attribute for presentation to the user of Client Device 14200.

Fourth, Method 03000G can query and receive from the user of Client Device 14200 for his/her selection of the values associated with each identified attribute.

Fifth, Method 03000G can process the selections to narrow a plurality of objects in a Class of Objects to an Object of Interest or a plurality of Equivalent Objects of Interest. For example, the selection of specific values for each of the attributes can generate a set of Equivalent Objects of Interest of, e.g., two, different and unique Objects of Interest that have the equivalent monitor size, memory or RAM, and estimated battery life.

Sixth, Method 03000G can generate a set of Equivalent Objects of Interest, each of which has values of attributes related to an Object of Interest selected by the user of Client Device 14200. For example, the objects displayed in FIG. 3G each have the set of Object Attributes, each of which has values specified by the user of Client Device 14200. That is, Name A, Name B, and Name C are Equivalent Objects of Interest, even though each is a unique and different object.

Seventh, Method 03000G can display in Format 03000G for each generated Equivalent Object of Interest the values specified in one or more rows, R1 through R6. That is, Method 03000G can identify and display the values for any object in Object F 02240 associated with each generated Equivalent Object of Interest. For example, Name C, an Equivalent Object of Interest can be: (a) offered by Retailer B identified by Object G 02242, which specifies the value $34.99 in R2; (b) be associated with a Qualifying Coupon identified by Object H 02244, which specifies the value $10.00 in R3; (c) not be associated with any Qualifying Affinity Offer identified by Object J 02248, which displays a null value in R4; (d) be associated with a Qualifying Reward offered by Issuer B identified by Object I 02246, which displays the value $4.00 in R5; and (e) have a net price computed by Object P 02260, which displays the value $20.99 in R6.

In a seventh embodiment illustrated by FIG. 3H, a format, Format 03000H, can include the presentation on any Client Device 14200 of data displaying the net price of each Object of Interest among a plurality of Objects of Interest. A user can be interested in seeing the net price of each Object of Interest among a plurality of Objects of Interest, e.g., the net price of a plurality of objects on a shopping list. Typically, a user will generate a list of Objects of Interest before visiting a Physical Retailer. However, a single Physical Retailer is unlikely to offer the lowest price for each Object of Interest on the list. A user can pay a lower total price for the plurality of Objects of Interest on the list by purchasing each Object of Interest at the Retailer which, combined with one or more Offers, offers the minimum Net Price.

Format 03000H can display a variety of data associated with each Object of Interest on a list, including, but not limited to: (a) the name of the Object of Interest, e.g., “Object Name A”; (b) the name of the Retailer which, combined with one or more Offers and payment utilizing a Payment Account, offers the minimum Net Price, e.g., “Retailer Name A”; (c) the value of the Manufacturer Suggested Retail Price (MSRP) or any other value indicating the price offered by a Retailer, e.g., “MSRP Value A”; (d) the value of one or more Offers associated with the Object of Interest, e.g., “Coupon Value A”; (e) the name of the Payment Account whose selection in payment for the Object of Interest in combination with a Retailer and one or more Offers results in the minimum Net Price, e.g., “Payment Account A”; and/or (f) the value of the net price of the Object of Interest after deducting the value of one or more qualifying Offers, e.g., “NP Value A”.

The invention can execute a method, Method 03000H, to enable the presentation of Format 03000H. Method 03000H can execute the following steps, a subset of the steps, any combination of the steps, the steps in different order, and/or additional, related, alternative, or equivalent steps.

First, Method 03000H can receive through any means an Object Identifier of each of one or more Objects of Interest, where the means can include, but are not limited to: (a) receiving from Microphone 01260 a speech utterance specifying the name of each Object of Interest, executing any method to recognize the Object of Interest, and/or associating with the Object of Interest an Object Identifier; (b) receiving from an I/O Device 01320, e.g., a barcode reader, an Object Identifier of each Object of Interest; (c) receiving from Lens 01300 an image of each Object of Interest, executing any method to recognize the Object of Interest, and/or associating with the Object of Interest an Object Identifier; (d) receiving from Lens 01300 an image of a list of one or more Objects of Interest in any form, e.g., handwriting, executing any method to recognize the form of input, e.g., a method of recognizing handwriting, extracting from the recognized form the Object of Interest, and/or associating with the Object of Interest an Object Identifier; (e) receiving from Display 01200 a set of data specifying the location of any object, e.g., a Flash object, and/or the object itself, from which an image of each Object of Interest can be extracted, executing any method to recognize the Object of Interest, and/or associating with the Object of Interest an Object Identifier; and/or (f) receiving from any Data Processing System data specifying an Object Identifier identifying each Object of Interest, e.g., a refrigerator transmitting data specifying an Object Identifier identifying an Object of Interest like a container of eggs whose supply falls below a predefined threshold of units like number of eggs remaining, or a motor vehicle transmitting data specifying an Object Identifier identifying an Object of Interest like motor oil whose supply falls below a predefined threshold of units like volume of motor oil remaining. After identifying the Object of Interest, Method 03000H can output to an object in Format 03000H, e.g., H1, the name of the Object of Interest, e.g., “Object Name A”.

Second, Method 03000H can execute any method, including any method described herein, to identify a Retailer offering the Object of Interest, in combination with one or more qualifying Offers and payment utilizing a Payment Account, at a desired price level, e.g., the minimum price. For example, Method 03000H can: (a) compute the sum of: (i) the price of the Object of Interest offered by a Retailerᵢ; (ii) the value of one or more qualifying Offers associated with the Object of Interest; and/or (iii) the value of the Reward associated with utilizing a Payment Accountᵢ; (b) rank the sums; and/or (c) select that sum which is the minimum. After identifying the Retailer offering the Object of Interest, in combination with one or more qualifying Offers and payment utilizing a Payment Account, at a desired price level, e.g., the minimum price among a plurality of prices, Method 03000H can output to an object in Format 03000H, e.g., H2, the name of the Retailer, e.g., “Retailer Name A”.

Third, Method 03000H can execute any method, including any method described herein, to identify one or more qualifying Offers associated with the Object Identifier. For example, Method 03000H can query any data structure for one or more Offers specifying that the Offer can be redeemed with the purchase of the Object of Interest. If the attribute values of the Transaction meet any predefined threshold set by the Offer, e.g., the timing of the Transaction, the number of units of the Object of Interest purchased, and/or the Retailer executing the Transaction, Method 03000H can output to an object in Format 03000H, e.g., H4, any data related to the Offer, which can include, but are not limited to: (a) the type of Offer, e.g., “Coupon”, “Reward Points”, “Cash Back”, and/or a text string like “No Qualifying Offer”, and/or (b) the value of the Offer, e.g., “Couple Value A”, “Affinity Value A”, and/or “Reward Value A”.

Fourth, Method 03000H can execute any method, including any method described herein, to identify the Payment Account whose selection for purchasing the Object of Interest, in combination with a Retailer and/or one or more qualifying Offers, would execute a Transaction at a desired price level, e.g., the minimum price. For example, Method 03000H can: (a) compute the sum of: (i) the price of the Object of Interest offered by a Retailerᵢ; (ii) the value of one or more qualifying Offers associated with the Object of Interest; and/or (iii) the value of the Reward associated with utilizing a Payment Accountᵢ; (b) rank the sums; and/or (c) select that sum which is the minimum. After identifying the Payment Account whose selection for purchasing the Object of Interest, in combination with a Retailer and one or more qualifying Offers, would execute a Transaction at a desired price level, e.g., the minimum price among a plurality of prices, Method 03000H can output to an object in Format 03000H, e.g., H5, the name of the Payment Account, e.g., “Payment Account Name A”.

Fifth, Method 03000H can execute any method, including any method described herein, to compute the Net Price of the Object of Interest. After computing the Net Price for the Object of Interest, Method 03000H can output to an object in Format 03000H, e.g., H6, the Net Price.

Sixth, Method 03000H can execute any method, including any method described herein, to enable the automatic: (a) purchase of each Object of Interest at the selected Retailer; (b) redemption of the one or more Offers associated with each Object of Interest; and/or (c) selection of the Payment Account for purchase of each Object of Interest.

Method 03000H can associate through any means with Format 03000H the data and/or instructions required to redeem automatically the one or more qualifying Offers, where the means can include, but are not limited to: (a) displaying in Format 03000H for viewing by the user of Client Device 14200, e.g., WD 02202, the data required to redeem each Offer, e.g., the coupon code associated with the Offer, and/or instructions required to redeem each Offer, e.g., a set of instructions enabling the population of a field displayed at a Retailer web site; (b) associating with Format 03000H in a form not viewable by the user of Client Device 14200 the data and/or instructions required to redeem automatically the Offer which can be executed by any computer program product located at the Client Device 14200, e.g., Offer Redemption Engine 33340; and/or (c) storing in a Data Processing System other than Client Device 14200, e.g., Inter Server 02300, the data and/or instructions required to redeem automatically the Offer which can be executed by any computer program product at the Data Processing System, e.g., Offer Redemption Engine 33340.

Method 03000H can associate through any means with Format 03000H the data and/or instructions required to select automatically the one Payment Account, where the means can include, but are not limited to: (a) displaying in Format 03000H for viewing by the user of Client Device 14200, e.g., WD 02202, the name of the selected Payment Account, e.g., the name of the Payment Issuer Server 11600, e.g., a bank issuing the user of Client Device 14200 a credit/debit card, or the name of a stored value card, and/or instructions required to select the Payment Account, e.g., a set of instructions enabling the automatic selection of a Payment Account at a Retailer web site; (b) associating with Format 03000H in a form not viewable by the user of Client Device 14200 the data and/or instructions required to select automatically the Payment Account which can be executed by any computer program product located at the Client Device 14200, e.g., Offer Redemption Engine 33340; and/or (c) storing in a Data Processing System other than Client Device 14200, e.g., Inter Server 02300, the data and/or instructions required to select automatically the Payment Account which can be executed by any computer program product at the Data Processing System, e.g., Offer Redemption Engine 33340.

While the application illustrates in Format 03000H the data related to each Object of Interest in a list of Objects of Interest, the invention is not limited to that embodiment. The invention can include in Format 03000H any data related to each Object of Interest, including, but not limited to, any object included in Object F 02240.

In one example generating Format 03000H, Method 03000H can: (a) receive through any means, e.g., a user of Client Device 14200 speaking into Microphone 01260: (i) an Object Identifier of each of one or more Objects of Interest; and/or (ii) data specifying the name of one or more Objects of Interest, which the invention can recognize utilizing any method described herein and with which the invention can associate an Object Identifier; (b) identify a Retailer offering each Object of Interest, in combination with one or more qualifying Offers, at a desired price level, e.g., the minimum price; (c) identify one or more qualifying Offers associated with the Object Identifier of each Object of Interest; (d) identify a Payment Account whose selection for purchasing each Object of Interest, in combination with a Retailer and/or one or more qualifying Offers, would execute the Transaction at a desired price level, e.g., the minimum price; (e) compute the Net Price for each Object of Interest; and/or (f) associate with Format 03000H the data and/or instructions enabling the automatic: (i) purchase of each Object of Interest at the selected Retailer; (ii) redemption of the one or more Offers associated with each Object of Interest; and/or (iii) selection of the Payment Account for the purchase of each Object of Interest.

In the exemplary embodiment illustrated in FIG. 3H, a shopping list can include four Objects of Interest and display the set of Retailer, one or more Offers, and Payment Account for each Object of Interest. Instead of purchasing all four Objects of Interest at one Retailer, a user of Client Device 14200 can execute a function automatically purchasing each Object of Interest at the Retailer which, combined with the one or more Offers and the selected Payment Account, would execute a Transaction for the Object of Interest at a desired price level, e.g., the minimum price. In the example, the user can minimize the total price paid for all four Objects of Interest by purchasing: (a) the Objects of Interest “Object Name A” and “Object Name C” at “Retailer Name A” and paying for “Object Name A” with “Payment Account Name A” and “Object Name C” with “Gift Card Name A”; (b) Object of Interest “Object Name B” at “Retailer Name B” and paying for “Object Name B” with “Payment Account Name B”; and (c) Object of Interest “Object Name D” at “Retailer Name C” and paying for “Object Name D” with “Payment Account Name A”.

In any embodiment illustrated in FIGS. 3A-3H, the invention can include one or more objects constituting Object F 02240 as stationary or moving as enabled by any standard, e.g., HTML5 or Flash.

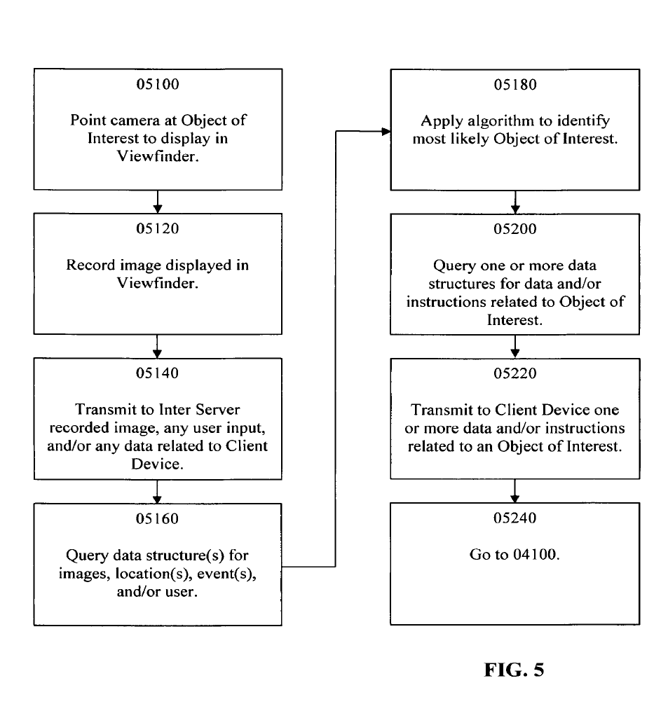

FIG. 5 depicts a flowchart of an exemplary computer-implemented method, Method 05000, that when executed can enable the presentation in a defined format on a client device of data related to an object of interest, according to one embodiment. The flowchart refers to the apparatus and structures depicted in FIG. 2B and FIGS. 3A-3F. However, the method is not limited to those embodiments. The method can implement the steps described herein utilizing a subset of the components, any combination of the components, or additional, related, alternative, and/or equivalent components depicted in FIG. 2B, FIGS. 3A-3F, and/or elsewhere in the application. The method can execute a subset of the steps, any combination of the steps, the steps in different order, and/or additional, related, alternative, or equivalent steps.

At 05100, a user of Client Device 14200 can point a Lens 01300 at an Object of Interest to display in Viewfinder 01302.

At 05120, Method 05000 can record an image displayed in Viewfinder 01302.

At 05140, Method 05000 can transmit to another Data Processing System, e.g., Inter Server 02300, the recorded image, any input of the user of Client Device 14200, and/or any data related to Client Device 14200.

At 05160, Method 05000 can utilize Object ID Engine 33310 to query one or more data structures to retrieve data which can help identify the likely Object of Interest displayed in the recorded image.

At 05180, Method 05000 can apply any method to identify the likely Object of Interest displayed in the recorded image.

At 05200, Method 05000 can utilize Offer ID Engine 33320 and/or Payment ID/Transaction Engine 33330 to query one or more data structures to identify one or more Offers and/or Payment Accounts related to the Object of Interest.

At 05220, Method 05000 can transmit to Client Device 14200 one or more data and/or instructions, e.g., Object F 02240.

At 05240, Method 05000 can proceed to 04100.

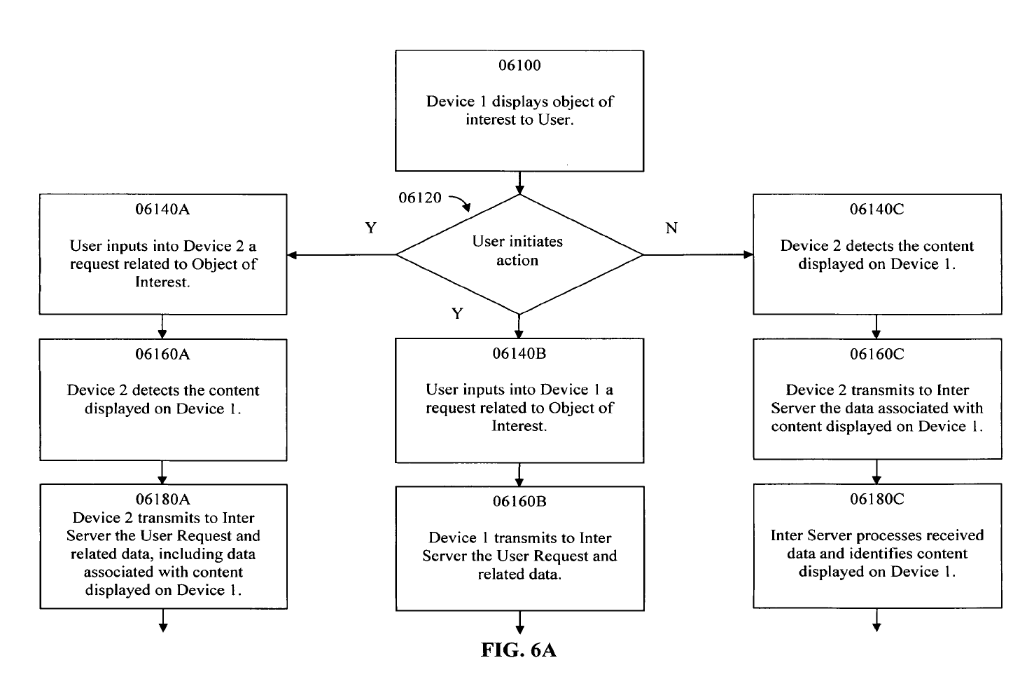

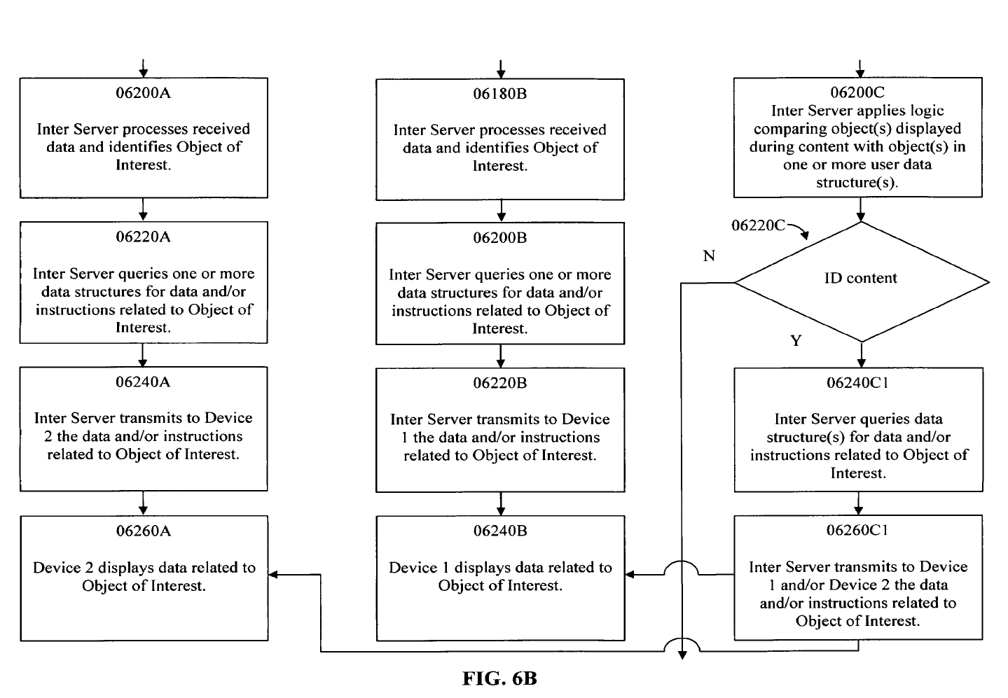

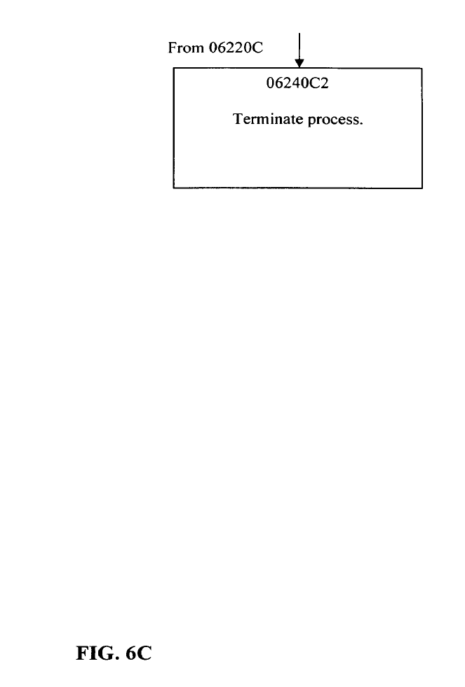

FIG. 6 depicts a flowchart of an exemplary computer-implemented method, Method 06000, that when executed can enable the association of data related to an object of interest across two or more devices, according to one embodiment. The flowchart refers to the apparatus and structures depicted in FIG. 2B. However, the method is not limited to those embodiments. The method can implement the steps described herein utilizing a subset of the components, any combination of the components, or additional, related, alternative, and/or equivalent components depicted in FIG. 2B and/or elsewhere in the application. The method can execute a subset of the steps, any combination of the steps, the steps in different order, and/or additional, related, alternative, or equivalent steps.

At 06100, a first device can display Content describing an Object of Interest in which the user of the first device and/or a second device is interested. For example, a first device can be a TV Display 02110 displaying any Content promoting an Object of Interest. The application illustrates a first device as a TV Display 02110. However, the invention is not limited to that embodiment. A first device can be any device which displays Content that stimulates the interest of a user, including, but not limited to: (a) any Data Processing System, e.g., a television, a personal computer, a radio, a digital billboard, a print publication, and/or a product package including some means of enabling digital transmission and/or reception of data; and/or (b) any device which is not a Data Processing System, e.g., a print publication not including some means of enabling digital transmission and/or reception of data like a conventional newspaper or magazine, a non-digital billboard, and/or a product package. In a first example, a Data Processing System not physically connected to an Object of Interest can display Content promoting the Object of Interest, e.g., a television or a newspaper. In a second example, a first Data Processing System physically connected to an Object of Interest can store and/or display Content describing an Object of Interest, e.g., a NFC tag physically connected to the Object of Interest whose Content can be read by a second Data Processing System including a NFC Module 11574.

At 06100 and 10100, the invention can display Content describing an Object of Interest. However, the invention is not limited to that embodiment. Any method described herein can enable the association of data related to an Object of Interest in response to a User Request without a first, second, or other device displaying Content describing an Object of Interest. That is, a user can transmit a User Request related to an Object of Interest without exposure to Content, in general, or Content describing an Object of Interest, in particular.

At 06120, the user of a second device, e.g., PC/WD 02200, viewing the Content displayed on a first device can either initiate or not initiate a User Request, which can be any data and/or event related to at least one Object of Interest and/or Class of Interest, which can include, but is not limited to: (a) a request for more information about the Object of Interest and/or any related objects; (b) a request for the identification of and/or information about one or more Retailers offering the Object of Interest and/or Class of Interest; (c) a request for one or more Offers and/or Rewards associated with the Object of Interest and/or Class of Interest; (d) a request for the automatic redemption of one or more Offers and/or Rewards associated with the Object of Interest and/or Class of Interest; (e) a request to purchase the Object of Interest for delivery/transmission to the user; (f) a request to purchase the Object of Interest for delivery/transmission to a person other than the user; (g) a request to purchase any type of account in physical or non-physical form enabling the holder of the account to purchase the Object of Interest, e.g., a gift card or a stored-value card, either of which can be in the form of a physical card or data representing the value of the card; (h) a request to sign up for, register, and/or subscribe to any type of service related to the Object of Interest, including, but not limited to; communications service, electric or gas utility, media subscription, any type of financial product, e.g., credit and/or insurance, and/or delivery service; and/or (i) a request to enter a contest, sweepstakes, or equivalent type of event enabling the user to receive the Object of Interest for free or at any type of discount.

A User Request can include any data representing the user's intent relating to an Object of Interest, Equivalent Objects of Interest, and/or Class of Interest, which can include, but are not limited to: (a) a word string representing a Command (which can be distinguished from a command or instruction detected or received by a Processor 01040) or other action related to the Object of Interest, Equivalent Objects of Interest, and/or Class of Interest, e.g., “get”, “find”, “download”, “save”, “purchase”, “buy”, “send”, “sign up”, “register”, “print”, and/or “enter”; (b) an object of the Command, e.g., an Object of Interest; (c) a word string specifying one or more attributes of the Object of Interest; (d) a word string specifying the date/time related to the Command and/or object, e.g., “this Friday”, or “October 13”; (e) a word string specifying the location of the Command and/or object, e.g., “my home”, “my office”, and/or “my default shipping address”; and/or (f) a word string specifying an intended recipient of the Command and/or object, e.g., “Bill” or “Mary”. For example, a User Request can include the word string “Buy and send flowers to Mary this Valentine's Day”. The word string “buy and send” can be Commands, the word “flowers” can be an object, the word “Mary” can be an intended recipient, and the word string “this Valentine's Day” can be a date/time. In another example, a User Request can include the word string, “Send money to Bill on his birthday”. The word “send” can be a Command, the word “money” can be an object, the word “Bill” can be an intended recipient, and the word string “his birthday” can be a date/time. In another example, a User Request can include the word string “Find the cheapest gas station within five miles”. The word “find” can be a Command, the word “gas station” can be a class, the word “cheapest” can be an attribute of the class “gas station”, and the word string “within five miles” can be another attribute of the class “gas station”.

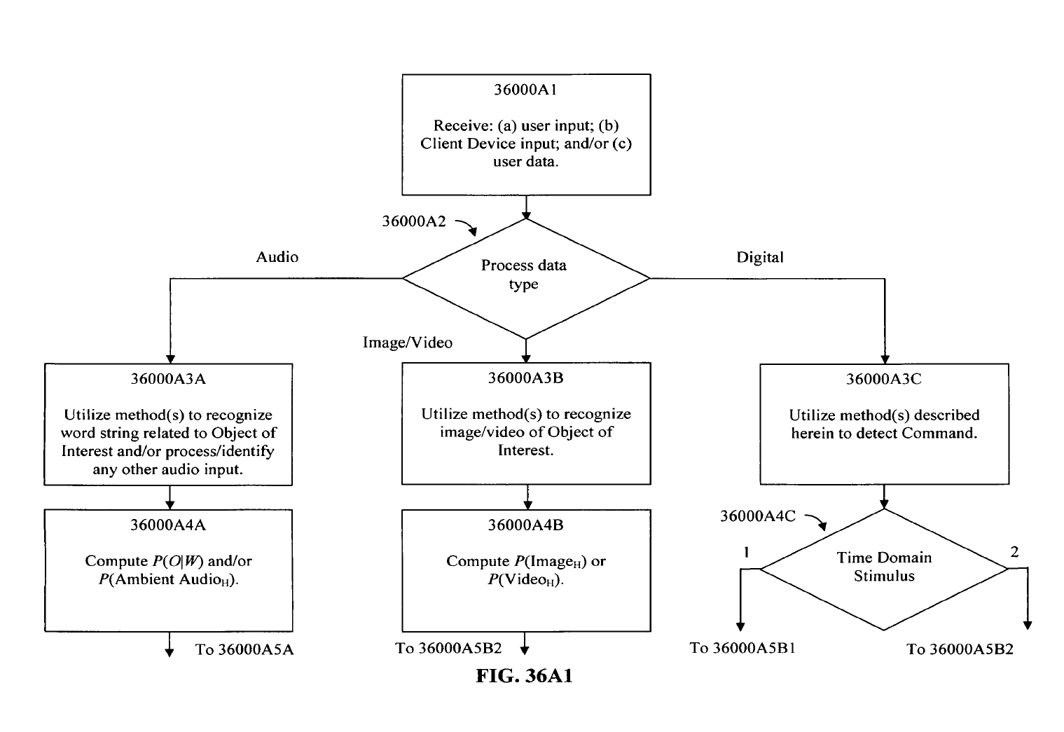

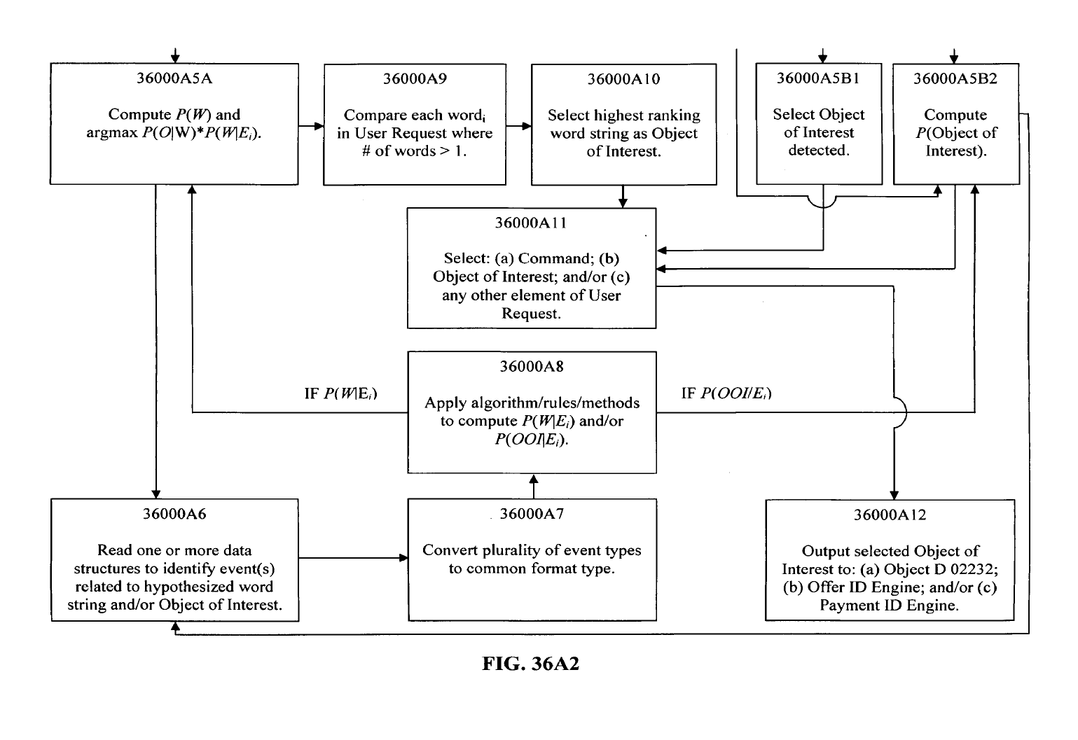

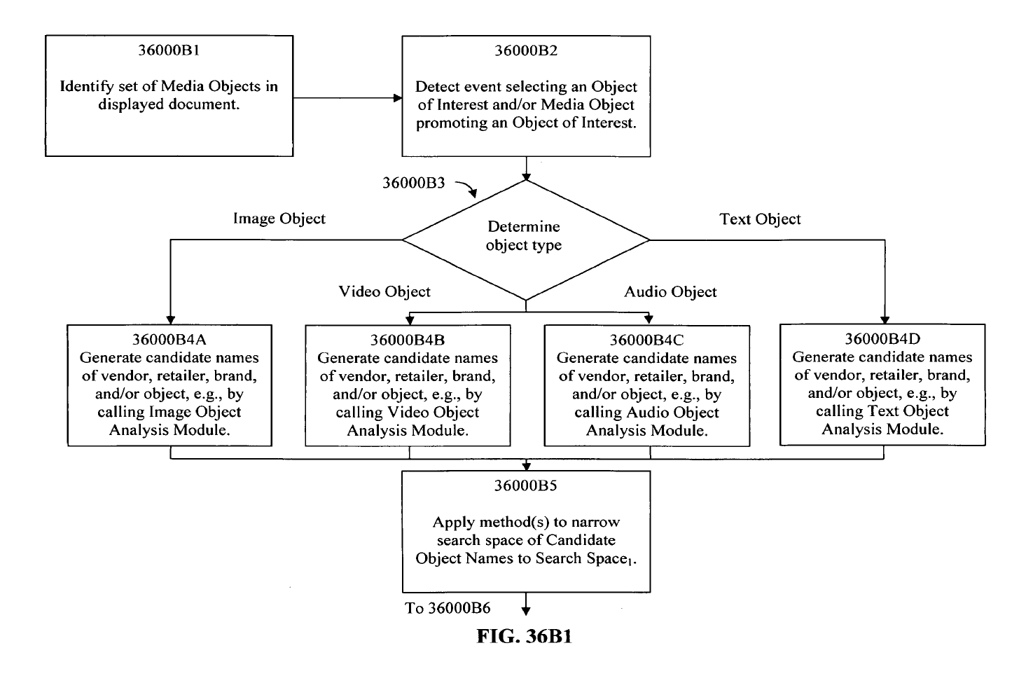

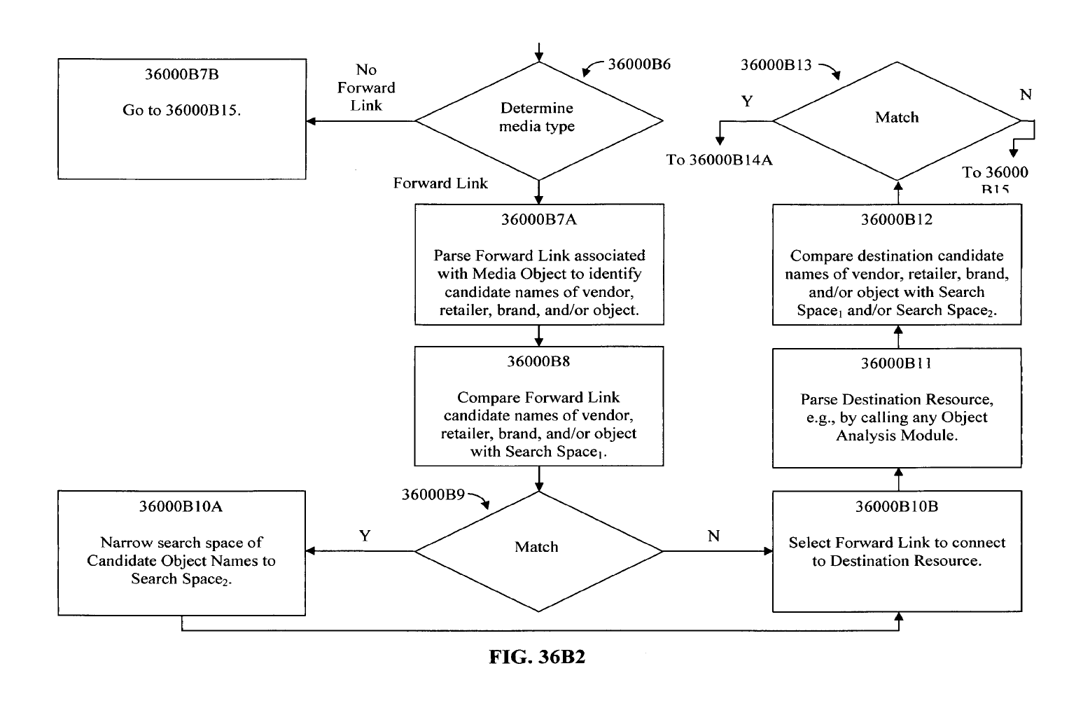

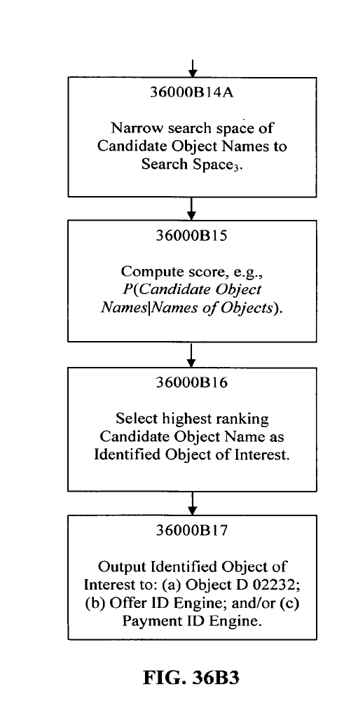

A User Request can comprise one or more attributes of an Object of Interest and/or a Class of Interest. A user of a Client Device 14200 may not know the name of a specific Object of Interest, but may know one or more attributes of an Object of Interest or Class of Interest in which he/she is interested. That is, a user of Client Device 14200 may want help narrowing a Class of Interest to one Object of Interest or one or more Equivalent Objects of Interest. For example, a user of Client Device 14200 can transmit a User Request including the attributes: (a) a type of Retailer, i.e., “gas station”; (b) a location of the Retailer, i.e., “within five miles”; (c) a type of object, i.e., “diesel”; and (d) a desired price range, i.e., “cheapest”. The user can transmit the one or more attributes all at once in one User Request or serially in a plurality of User Requests. The invention includes an apparatus and methods enabled by Object ID Engine 33310, which can process a User Request comprising one or more attributes of an Object of Interest and/or a Class of Interest (described in FIG. 36J).

While the application illustrates in one embodiment a User Request transmitted by a human user of a Client Device 14200 in the form of speech, the invention is not limited to that embodiment.

The invention can enable the processing of a User Request transmitted by a human user of a Client Device 14200 in any form other than speech. The invention can enable a human user to transmit a User Request in any form, including, but not limited to: (a) audio other than speech encoding data representing data and/or instructions related to one or more Objects of Interest; (b) text through any application, e.g., email, a text message, or a text search box, describing one or more Objects of Interest; (c) an object not in the form of text, e.g., an n-dimension code (defined herein) encoding data representing data and/or instructions related to one or more Objects of Interest; and/or (d) an image, still or moving, of one or more Objects of Interest.

The invention can enable the processing of a User Request transmitted by any Data Processing System, even if the User Request is not directly transmitted by a human user. The invention can enable a Data Processing System to transmit a User Request without the involvement of a human user. The Data Processing Systems transmitting a User Request can include, but are not limited to: (a) any machine located in a home, e.g., a refrigerator, or a device monitoring objects and/or their supply in a cupboard or a medicine cabinet; (b) any machine located in a motor vehicle, e.g., a device monitoring components of the motor vehicle like containers of motor oil or status of a tire; (c) any machine located in an office, e.g., a device monitoring objects and/or their supply like paper in a printer or copier; and/or (d) any machine located in a factory, e.g., a device monitoring objects and/or their supply like a machine manufacturing a product.

The Data Processing System can transmit a User Request in response to any event, which can include, but is not limited to: (a) when the supply of a component falls below a predefined threshold, e.g., if the amount of the motor oil in the container falls below a predefined percentage of capacity; (b) when the condition of a component meets a predefined threshold, e.g., if the tread-wear indicator on a tire meets a predefined criteria; and/or (c) when the price of an Object of Interest meets a predefined threshold, e.g., if the price of gasoline offered by a Retailer of gasoline falls below a desired price level even if the supply of remaining gasoline has not fallen below a predefined threshold.

At 06140A, the user of a second device can input into the second device through any means a User Request. The means can include, but are not limited to: (a) user speech into a Microphone 01260; (b) the reception of a static image, e.g., a picture, or a moving image, e.g., a video, of a physical object, e.g., PHY Object 11200, or some portion of the physical object, which is the Object of Interest or data representing the Object of Interest, e.g., any representation of a code identifying or containing data related to the Object of Interest, where the code representation can include, but is not limited to: (i) a one-dimension code, e.g., a barcode; (ii) a two-dimension code, e.g., a matrix code like a QR code; and/or (iii) an n-dimension code (collectively “N-Dimension Code”); (c) user selection of one or more keys on a Keyboard/Keypad 01220, a means which can include, but is not limited to: (i) the user selecting one or more keys in response to an interactive voice response (IVR) system; and/or (ii) the user selecting one or more keys in generating a text message; and/or (d) user touch or the detection of the user proximity to of a set of pixels on a touch-sensitive display 01200.

At any step, e.g., 06140A or 06140B, a user of a first or second device can specify one or more features defining an Object of Interest. That is, a user can input into a first or second device a User Request for an object without specifying a particular brand or vendor. For example, a user can request a class of objects like: (a) “buy movie ticket”, instead of “buy XYZ movie ticket”; (b) “buy jeans”, instead of “buy Levi's® jeans”; or (c) “sign up for credit card”, instead of “sign up for XYZ credit card”. Since a user probably prefers to purchase a specific object instead of a class of objects, the invention discloses methods enabling the user to narrow the class of objects to an object with a specific set of features. That is, a user typically wants to buy a movie ticket with a specific set of features like movie title, theater location, date, and time, not a generic movie ticket; buy a pair of jeans with a specific set of features like gender, size, color, and fabric, not a generic pair of jeans; or apply for a credit card issued by a specific issuer, not a credit card issued by a generic issuer.

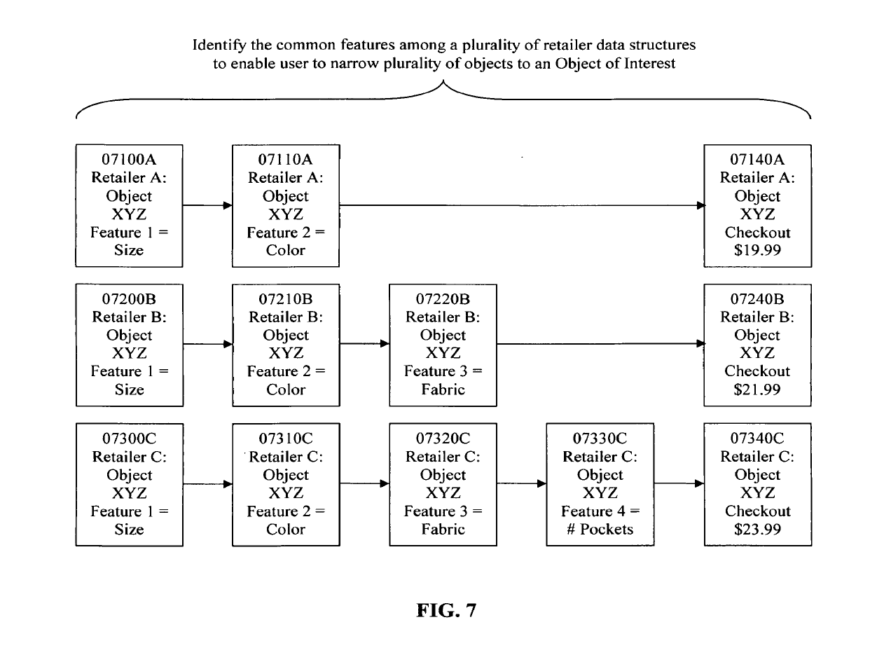

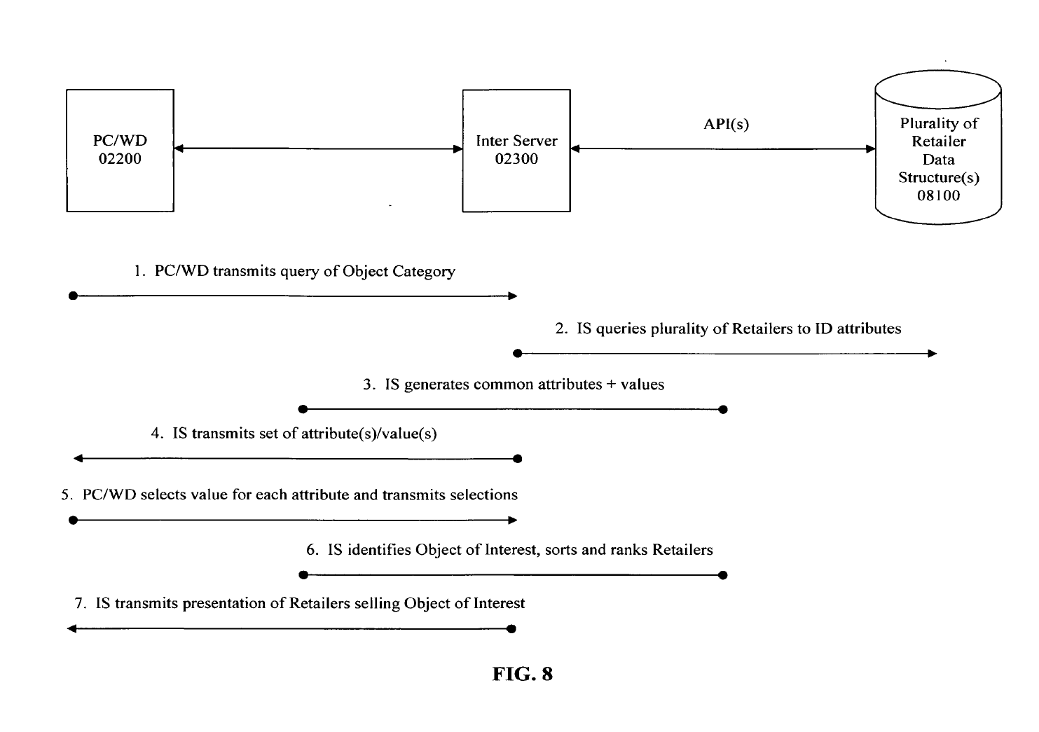

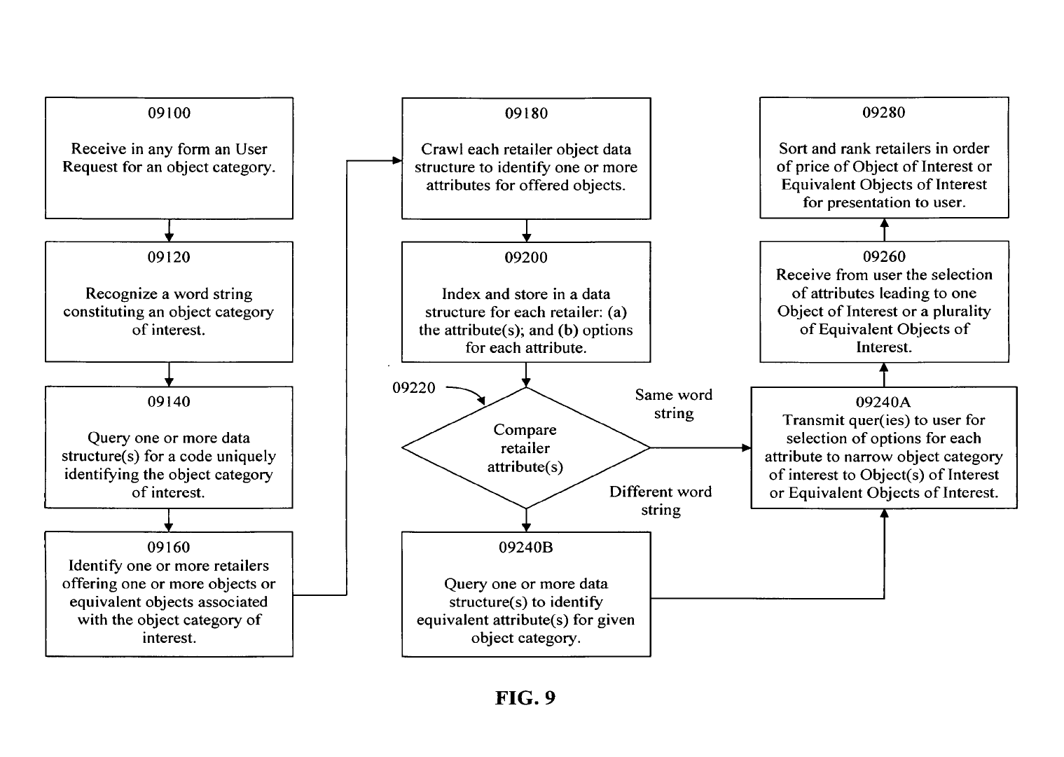

FIG. 9 depicts a flowchart of an exemplary computer-implemented method, Method 09000, that when executed can enable the automatic generation of queries whose responses can narrow a plurality of objects in an object category to an object of interest or a plurality of Equivalent Objects of Interest, according to one embodiment. The flowchart refers to the components depicted in FIG. 7 and FIG. 8. However, the method is not limited to those embodiments. The method can implement the steps described herein utilizing a subset of the components, any combination of the components, or additional, related, alternative, and/or equivalent components depicted in FIG. 7, FIG. 8, and/or elsewhere in the application. The method can execute a subset of the steps, any combination of the steps, the steps in different order, and/or additional, related, alternative, or equivalent steps.

At 09140, after recognizing a class of objects, e.g., “movie ticket”, “jeans”, or “credit card” at 09020, Method 09000 can enable the user to narrow the class of objects to an object with specific features he/she can purchase through any means, including, but not limited to: (a) user speech in response to a series of queries presented in the form of speech, e.g., user speech “medium” in response to a speech query “What jeans size?”; (b) user speech in response to viewing one or more web pages, e.g., user speech “medium” after viewing a web page displaying a plurality of jeans sizes; (c) user speech in response to a display of a plurality of jeans sizes presented in a message, e.g., a text message; and/or (d) user selection of a feature through any means, including, but not limited to: (i) user touch on a touch-sensitive display; and/or (ii) user selection of one or more keys.

After recognizing the class of objects, Method 09000 can associate with the class of objects a code uniquely identifying an object category. For example, the NAICS includes the following codes associated with “jeans”: (a) code 315211, which is associated with the NAICS Title “Men's and Boys' Cut and Sew Apparel Contractors”; (b) code 315212, which is associated with the NAICS Title “Women's Girls', and Infants' Cut and Sew Apparel Contractors”; (c) code 315225, which is associated with the NAICS Title “Men's and Boys' Cut and Sew Work Clothing Manufacturing”; (d) code 315239, which is associated with the NAICS Title “Women's and Girls' Cut and Sew Other Outerwear Manufacturing”; and (e) code 315291 which is associated with the NAICS Title “Infants' Cut and Sew Apparel Manufacturing”.

At 09160, after associating with the recognized class of objects a code uniquely identifying an object category, Method 09000 can identify one or more Retailers offering one or more objects associated with the identified Object Category. For example, Method 09000 can identify 100 Retailers offering at least one jeans object manufactured by a vendor within the NAICS codes 315211, 315212, 315225, 315239, and 315291. Identifying one or more Retailers associated with an Object Category code can reduce the search space of potential solutions and/or increase the accuracy of searching potential solutions compared to a generic search of any Retailer for the word string constituting the Object Category. For example, a generic search of the Internet, in general, or even a set of Retailers, in particular, for the word string “hamburger” can generate a result including a book Retailer selling books about hamburger. However, it is more likely that only Retailers selling cooked hamburgers will be classified in the NAICS Class of Objects code 722211 “Fast Food Restaurants”. Method 09000 can further increase the accuracy of potential solutions by confirming a Class of Objects across a plurality of Class of Objects code systems. For example, a Retailer selling hamburgers classified in both NAICS Class of Objects code 722211 “Fast Food Restaurants” and Merchant Category Code (MCC) Class of Objects code 5814 “Fast Food Restaurants” is more likely to be a Retailer which actually sells fast food than Retailers presented in the results of a search of web pages for the keyword query “hamburger”.

The type of Object Attributes will typically vary among object categories. For example, a specific pair of jeans offered by a Retailer typically requires the selection of the gender of the user, while a movie ticket offered by a Retailer typically does not. In another example, an airline ticket offered by a Retailer typically requires the selection of a destination city or airport, while a breakfast cereal offered by a Retailer typically does not.

At 09180, after identifying one or more Retailers offering one or more objects associated with the identified Object Category, Method 09000 can crawl any data structure storing data related to the objects offered by each Retailer. The data structures can include, but are not limited to: (a) data stored and displayed on a web page accessible to any client; and/or (b) data stored in a database accessible to a client through an application programming interface (API).

In one embodiment, Method 09000 can identify, read, and store one or more attributes of any object stored in the object data structure. An attribute can be equivalent to an object feature. Method 09000 can limit the types of attributes read and stored to those attributes a user would select to narrow a plurality of objects in an object category to an Object of Interest. That is, an object data structure can include many attributes, some of which: (a) a user would typically not consider in identifying an Object of Interest, e.g., the name of the movie distributor in a data structure for a movie ticket Retailer; and/or (b) are not in a form a user would select to identify an Object of Interest, e.g., a numerical code identifying a movie title like “1234”, when a user would typically select the name of the movie title in alphanumeric form like “Movie XYZ, the sequel”. Method 09000 can utilize any criteria and/or require the meeting or exceeding of any threshold to limit the types of attributes read and stored.

At 09200, Method 09000 can store one or more attributes of the object data structure and one or more values for each attribute for each Retailer in a data structure stored in any device, e.g., a data structure at Inter Server 02300. Method 09000 can store the attributes and values in any form, including, but not limited to, raw, and/or compressed.

At 09220, Method 09000 can apply logic to compare and/or utilize any comparator component capable of comparing the set of attributes retrieved from each Retailer object data structure. While most Retailers selling a given object probably associate the same types of attributes, each Retailer can use a different word string defining a given attribute and offer different values or set of values for any given attribute. For example, one Retailer selling a laptop computer can associate with each computer Product ID the attribute “Monitor Screen Size”, while another Retailer selling the same laptop computer can use the attribute “Screen Size”. One Retailer can assign each computer Product ID to one of three values for screen size, “14” and under”, “15″-16″”, and “17” and over”, while another Retailer can assign each computer Product ID to a set of values with screen size categories different from those of the first Retailer.

Method 09000 can apply logic and/or utilize any comparator component capable of comparing data to determine equivalent attributes. That is, to enable a user to narrow a plurality of objects in a given Object Category to an Object of Interest, Method 09000 should ensure that it compares objects against the same attribute across a plurality of Retailers. For example, to enable a user to narrow a set of laptop computers to a laptop computer of interest, the user can be interested in the set of laptop computers with a 13″ screen size. Method 09000 could identify the wrong set of laptop computers if it filtered objects in a first Retailer data structure with the attribute “screen size” and the value of 12″ and objects a second Retailer data structure with the attribute “dimension: width” and the value of 12″.

To determine equivalent attributes across a plurality of Retailers, Method 09000 can use any method, including, but not limited to, the following methods. In one embodiment, Method 09000 can read the set of attributes for one Product ID, e.g., “screen size” and “memory” for laptop computer Retailer A and “monitor size” and “RAM” for laptop computer Retailer B. Method 09000 can generate a table listing a plurality of equivalent terms for any given attribute, e.g., associating with the attribute measuring the size of the screen the attribute names, “screen size”, “monitor size”, “diagonal size”, etc. Method 09000 can compare the set of attributes for each of Retailer A and Retailer B against the table, e.g., at 09240B. In another embodiment, Method 09000 can look up for each Product ID listed in any Retailer data structure the specifications in any data structure which includes the name-value pairs for each attribute. That is, the web site of the manufacturer or a third-party reviewer can list the specifications associated with a Product ID and identify the name of each attribute and the associated value of the attribute. For example, manufacturer XYZ can list for Product ID “123456789012” the name of one attribute, “monitor size,” and the value associated with that attribute, “12″”. Method 09000 can look up each Retailer data structure to identify the value “12″” and the associated attribute name to confirm that the attribute defined by the Retailer is equivalent to the attribute defined by the manufacturer. After identifying the equivalent attributes across a plurality of Retailers, Method 09000 can generate a table listing for each equivalent attribute the plurality of Retailers offering Product ID. Generating and accessing the table can enable Method 09000 to identify accurately and quickly the plurality of Retailers offering the objects within an object category with a given value for the same attribute name.

At 09240A, Method 09000 can transmit in any form one or more queries to the user requesting the selection of a value for each of one or more attributes which can narrow a plurality of objects to the Object of Interest or a plurality of Equivalent Objects of Interest. For example, Method 09000 can transmit to the user a speech query, “What is the name of the movie you would like to see?” or “What monitor size do you want for your laptop computer?” Alternatively, Method 09000 can transmit to the user one or more queries in the form of a web page or a text message asking the user to select the values for each attribute.

At 09260, Method 09000 can receive from the user the responses to each query. In a first example, the user can select, “XYZ the sequel”, “New York City”, “April 23”, and “around 8:00 pm”, the combination of which can narrow the set of movie ticket Retailers to two Retailers selling tickets meeting and/or exceeding any predefined threshold. In a second example, the user can select in response to one or more queries related to a class of interest, e.g., laptop computers, “What monitor size do you want?”, “How much memory or RAM do you want?” and/or “How long an estimated battery life do you want?” The combination of the responses can narrow the set of Equivalent Objects of Interest to, e.g., two, Objects of Interest meeting and/or exceeding any predefined threshold of values for the attributes queried. That is, the selection of specific values for each of the attributes can narrow the set of Equivalent Objects of Interest to, e.g., two, different and unique Objects of Interest that have the equivalent monitor size, memory or RAM, and estimated battery life.

At 09280, Method 09000 can sort and rank along any criteria, e.g., price, a plurality of Retailers selling the Object of Interest or a plurality of Equivalent Objects of Interest.

Enabling the automatic definition of equivalent Object Attributes for any given Object Category across a plurality of Retailers can yield a variety of benefits, including, but not limited to, the following benefit. Currently, a Retailer can enable a user to select one or more Object Attributes to narrow a plurality of objects in a given Object Category to an Object of Interest or Equivalent Objects of Interest. However, current Retailers typically generate a list of qualifying objects and manually define one or more Object Attributes to which each object is assigned. Method 09000 can automatically define the Object Attributes for any given Object Category enabling a user to select an Object of Interest or Equivalent Objects of Interest classified within the Object Category.

Enabling the automatic selection of one or more Objects of Interest or Equivalent Objects of Interest from one or more Retailers in response to the user selection of values of one or more attributes defining the object(s) of interest can yield a variety of benefits, including, but not limited to, the following benefit. Currently, a Retailer can enable a user to narrow the number of potential Objects of Interest by manually selecting one or more features. For example, a Retailer offering television sets can enable a user to narrow the number of potential television sets by manually selecting a given price range and a given diagonal screen size. In another example, a Retailer offering jeans can enable a user to narrow the number of potential jeans by manually selecting a given size and a given color. While searching one or more Retailers on a PC 11800 with significant data channel capacity and a large display capable of showing many potential Objects of Interest is typically not a problem for most users, searching on a WD 02202 for a comparable number of Retailers can consume scarce wireless channel capacity and a significant amount of time and showing many potential Objects of Interest on a small WD 02202 display can be impractical. Enabling a device which does not face comparable constraints, e.g., Inter Server 02300, to convert the user selections of one or more features to narrow the number of Retailers offering the Object of Interest or Equivalent Objects of Interest can, inter alia, save the user time and consume less wireless channel capacity. Enabling the automatic determination of the Object Attributes to be selected for any given Object Category can obviate the need for a user to search manually a plurality of Retailers.

Returning to FIG. 6A, at 06160A, the second device can detect the Content displayed on the first device through any means. Identifying the set of Content displayed on a first device which could have stimulated a user of a second device to initiate a User Request (“Device 1 Identifying Data”) can increase the probability of accurately recognizing the User Request. For example, Method 06000 can identify the set of advertisements promoting Product A displayed on a first device, e.g., TV Display 02110, to which a user of a second device, e.g., PC/WD 02200, was exposed or probably exposed. The combination of data identifying the number and/or type of advertisements promoting Product A and an utterance of a word string approximating “Product A” can increase the probability of generating a hypothesized word string “Product A”, which is the word string intended by the user. While the invention utilizes the identification of Content displayed on a first device to increase the probability of accurately recognizing the User Request, it is not limited to that embodiment. The invention can utilize any data increasing the probability of accurately recognizing the User Request, which can include, but are not limited to: (a) the network or channel displaying the Content, e.g., a television network or the logical or physical television channel; (b) the device displaying the Content, e.g., a television, personal computer, radio, and/or any other device; (c) the history of objects purchased by the user of PC/WD 02200; and/or (d) the history of search queries made by the user of PC/WD 02200.

At 06180A, the second device can transmit to Inter Server 02300 the User Request, Device 1 Identifying Data, and/or any other data which can increase the probability of accurately recognizing the User Request (“Other Identifying Data”), including, but not limited to: (a) a timestamp of the User Request; (b) the location of the first device and/or the second device; (c) any demographic data related to the user of the second device; and/or (d) any activity data related to the user of the second device.

At 06200A, Inter Server 02300 can process the User Request, Device 1 Identifying Data, and/or Other Identifying Data to accurately recognize the User Request.

At 06220A, Inter Server 02300 can query one or more data structures for any data and/or instructions related to the Object of Interest. For example, if the User Request is a request to buy a ticket for movie XYZ, then Inter Server 02300 can query one or more data structures to retrieve the data necessary, e.g., credit/debit card data, to execute a purchase of a movie XYZ ticket. If the User Request is a request to download a Coupon for the purchase of object XYZ, then Inter Server 02300 can query one or more data structures to retrieve the data necessary, e.g., a coupon code, to enable the redemption of a Coupon for the purchase of object XYZ.

At 06240A, Inter Server 02300 can transmit to the second device the data and/or instructions executing the User Request.

At 06260A, the second device can display the data executing the User Request. The second device, e.g., PC/WD 02200, can display the data in any manner, including, but not limited to: (a) opening an active window displaying the related data, e.g., Object F 02240; and/or (b) transmitting a HTTP request to retrieve a document displaying the related data, e.g., Object F 02240. For example, the second device, e.g., PC/WD 02200, can receive from Inter Server 02300 and display Object F 02240, which can include, but is not limited to, one or more objects, e.g., Object G 02242 through Object Q: Related Product(s) 02260.

In another embodiment, Method 06000 can enable the user to a first device to input a User Request into the first device, instead of the second device as in the steps starting with 06140A.

At 06140B, the user of a first device can input into the first device a User Request through any means equivalent to the means utilized at 06140A. For example, at 06140A, a user can view a first device, e.g., TV 02100, displaying an Object of Interest and input into a second device, e.g., PC/WD 02200, a User Request. At 06140B, the user viewing the first device can input directly into the first device a User Request, e.g., by selecting a function on a device remotely controlling the first device or touching a touch-sensitive display of the first device.

At 06160B, the first device can transmit to Inter Server 02300 the User Request and any data related to the User Request which can help increase the accuracy of recognizing the User Request.

At 06180B and 06200B, Inter Server 02300 can execute the same instructions and/or data as it can at 06200A and 06220A, respectively.

At 06220B, Inter Server 02300 can transmit to the first device the data and/or instructions executing the User Request.

At 03222B, the first device can display the data executing the User Request through any means equivalent to the means utilized at 06260A.

In another embodiment, Method 06000 can enable the automatic generation of data related to an Object of Interest displayed on a first device and transmit the data to either the first device or second device.

At 06140C, the second device can detect the Content, e.g., Object A 02120, displayed on a first device. The second device can utilize any I/O Device, e.g., Microphone 01260, to receive the Content in any form, e.g., the audio signal carrying the Content. For example, TV 02100 can broadcast an audio signal carrying speech and background music for an advertisement or a program describing an object XYZ. Microphone 01260 can receive the audio signal and the second device can at 06160C transmit to Inter Server 02300 any data associated with the Content displayed on the first device.

At 06180C, Inter Server 02300 can receive, store, and/or process the data associated with the Content to identify the Content. Inter Server 02300 can apply logic to compare and/or utilize any comparator component capable of comparing the data received from the second device against data describing any Content displayed on the first device.

At 06200C, Inter Server 02300 either: (a) determines the probable identity of the Content displayed on the first device; or (b) cannot determine the probable identity of the Content displayed on the first device. In the second condition, Method 06000 can proceed to 06240C2 where Inter Server 02300 can execute no action. In the first condition, Method 06000 can proceed to 06240C1 where Inter Server 02300 can query one or more data structures for any data related to the identified Object of Interest.

At 06260C1, Inter Server 02300 can transmit to the first device and/or the second device any data and/or instructions related to the identified Object of Interest.

The invention implements Method 06000 by enabling Inter Server 02300 to receive, store, process, and/or transmit the data used to execute a User Request received from PC/WD 02200. However, the invention is not limited to that embodiment. In another embodiment, the invention can implement Method 06000 and other methods described herein by enabling the device receiving the User Request to receive, store, process, and/or transmit the data used to execute the User Request. That is, a client device, e.g., PC/WD 02200 or TV 02100, can execute a User Request locally, instead of transmitting the User Request to another Data Processing System like Inter Server 02300. For example, PC/WD 02200 can receive data from one or more Data Processing Systems including, but not limited to, Payment Issuer Server 11600, Retailer Server 11620, Ad Server 11630, and/or Other Server 11700. PC/WD 02200 can utilize the data to execute locally a variety of functions and/or instructions, including, but not limited to, recognizing the User Request, associating a hypothesized word string with an identifier of an Object of Interest, looking up one or more data structures for one or more Offers associated with the identifier of the Object of Interest, and/or displaying the Offers on PC/WD Display 02210.

In another embodiment, the invention can implement Method 06000 and other methods described herein by distributing the execution of a User Request across a plurality of Data Processing Systems. For example, the invention can implement the methods described here by executing one or more of the steps on the client device, e.g., PC/WD 02200 or TV 02100, and other steps on a server device, e.g., Inter Server 02300.

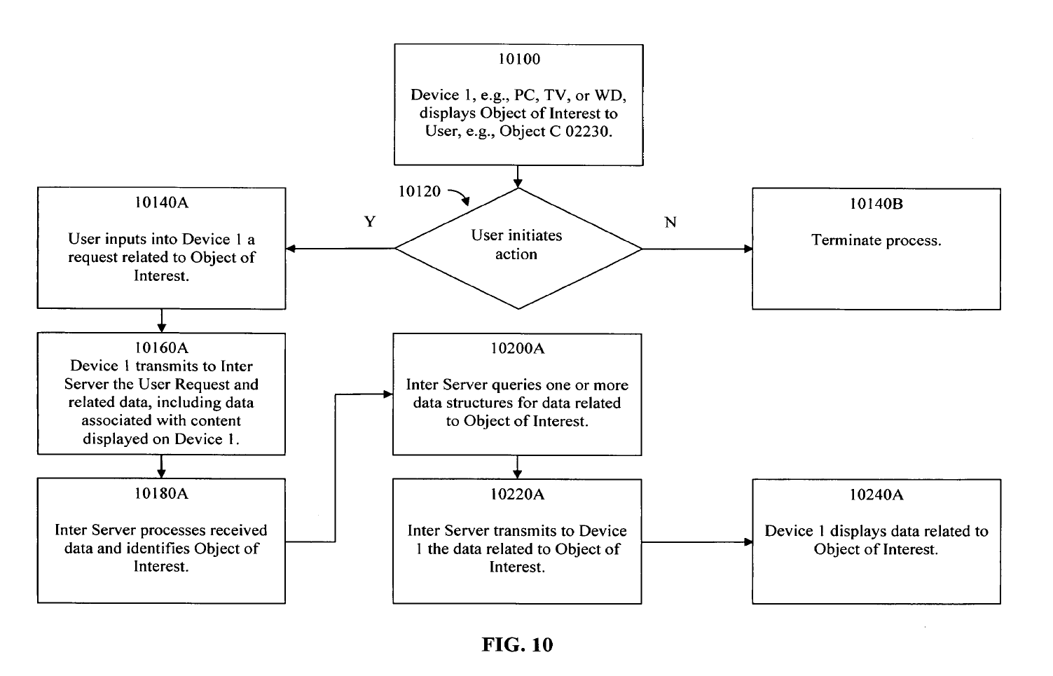

FIG. 10 depicts a flowchart of an exemplary computer-implemented method, Method 10000, that when executed can enable the association of data related to an object of interest on one device, e.g., a personal computer, a television, or a wireless device, according to one embodiment. The flowchart refers to the apparatus and structures depicted in FIG. 2B. However, the method is not limited to those embodiments. The method can implement the steps described herein utilizing a subset of the components, any combination of the components, or additional, related, alternative, and/or equivalent components depicted in FIG. 2B and/or elsewhere in the application. Method 10000 can execute a subset of the steps, any combination of steps, the steps in different order, and/or additional, related, alternative, or equivalent steps described in Method 06000, except execute the steps in the example where a user inputs into a first device a User Request related to an Object of Interest displayed on the first device. For example, Method 10000 can enable the input into a PC/WD 02200 a User Request related to an Object of Interest displayed on PC/WD Display 02210.

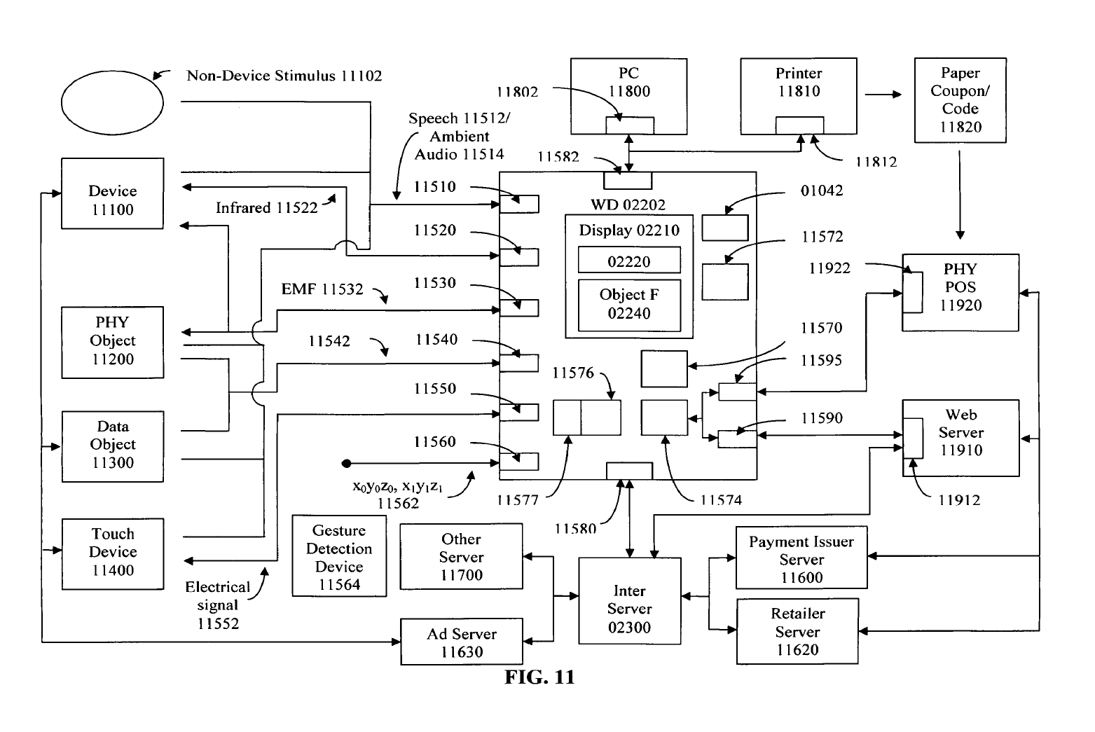

FIG. 11 depicts a block diagram of an exemplary apparatus, Apparatus 11000, enabling the identification of an object of interest, the display of data related to the object of interest, and/or execution of a transaction involving the object of interest, according to one embodiment. The apparatus can implement the entities described herein by utilizing a subset of the following components, any combination of the components, or additional, related, alternative, and/or equivalent components. The apparatus can include, but is not limited to, the following components not disclosed earlier.

Non-Device Stimulus 11102 can be any object or event which can stimulate a user of a device, e.g., WD 02202 or PC 11800, to initiate a User Request. The user of a device can initiate a User Request upon interacting with Non-Device Stimulus 11102 in any manner, which can include, but is not limited to: (a) viewing it; (b) hearing it; and/or (c) touching it. A device can receive a User Request related to Non-Device Stimulus 11102 in any manner, which can include, but is not limited to: (a) Microphone 11510, which can receive any type of audio input, including, but not limited to, Speech 11512 of the user of the device, e.g., WD 02202, and/or Ambient Audio 11514, which can be any audio signal other than audio signal carrying speech of the user of the device, which can include, but is not limited to: (a) an audio signal carrying audio from one or more Data Processing Systems, e.g., TV 02100; (b) an audio signal carrying audio from one or more speakers other than the user of WD 02202; and/or (c) any other audio signal, including noise, e.g., additive white Gaussian noise (AWGN). Receiving and processing Ambient Audio 11514 can enable the identification of Content displayed on any first device, e.g., 11100, 11102, 11200, 11300, and/or 11400, whose audio signal is of sufficient strength to be received by any second device, e.g., WD 02202 or PC 11800. Identifying the Content displayed on any first device can generate data increasing the probability of accurately recognizing a User Request related to the Content.

Device 11100 can be any Data Processing System capable of executing a variety of functions and/or instructions, including, but not limited to: (a) receiving any type of data; (b) storing any type of data; (c) processing any type of data; (d) displaying or outputting any type of data, e.g., audio and/or video outputted by a TV Display 02110; and/or (e) transmitting any type of data. The user of a second device can initiate a User Request upon interacting with a first Device 11100 in any manner, which can include, but is not limited to: (a) viewing it; (b) hearing it; and/or (c) touching it. A second device can receive a User Request related to Device 11100 in any manner, which can include, but is not limited to: (a) Microphone 11510 receiving any type of audio input, including, but not limited to, Speech 11512 of the user of the second device, and/or Ambient Audio 11514; (b) Infrared Transceiver 11520, which can transmit and/or receive an Infrared Signal 11522 to and/or from a first Device 11100, which can receive and/or transmit an Infrared Signal 11522; and/or (c) Radio Transceiver 11530, which can transmit and/or receive any type of electromagnetic field EMF 11532, e.g., a radio wave, to and/or from a first Device 11100, which can receive and/or transmit an EMF 11532. EMF 11532 can carry any data, including, but not limited to: (a) data identifying Device 11100; and/or (b) data identifying any Content displayed on Device 11100, e.g., the channel displayed on a TV Display 02110, the program displayed on the channel, and/or an object displayed on the program.

WD 02202 can be any Data Processing System capable of transmitting Infrared Signal 11522 to and/or receiving Infrared Signal 11522 from a Device 11100. For example, WD 02202 can be: (a) a separate remote control device specifically programmed to execute the function of transmitting an Infrared Signal 11522 to a Device 11100, e.g., a TV 02100; or (b) a WD 02202 programmed to execute the function of transmitting an Infrared Signal 11522 to a Device 11100, e.g., a TV 02100. PHY Object 11200 can be any physical object stimulating a user of a device, e.g., WD 02202 or PC 11800, to initiate an User Request. The user of a device can initiate a User Request upon interacting with PHY Object 11200 in any manner, which can include, but is not limited to: (a) viewing it; (b) hearing it; (c) touching it; and/or (d) moving Client Device 14200 in the vicinity of it. A device can receive a User Request related to PHY Object 11200 in any manner, which can include, but is not limited to: (a) Microphone 11510, which can receive any type of audio input, including, but not limited to, Speech 11512 of the user of the device, e.g., WD 02202, and/or Ambient Audio 11514; (b) Radio Transceiver 11530, which can transmit and/or receive any type of EMF 11532 to and/or from a PHY Object 11200, which can receive and/or transmit an EMF 11532; and/or (c) Image Transceiver 11540, which can execute a variety of functions and/or instructions, including, but not limited to: (i) capturing of Image/Video 11542, e.g., one or more images, still or moving, of PHY Object 11200; (ii) processing of one or more images, still or moving; (iii) conversion from an analog signal to a digital signal of one or more images, still or moving; and/or (iv) outputting of a processed image and/or video. For example, Radio Transceiver 11530 can transmit and/or receive any type of EMF 11532, e.g., a signal carrying data utilizing the NFC protocol, to and/or from a PHY Object 11200, e.g., a product package, including a transceiver, e.g., a NFC tag, capable of having data read and/or transmitting data.

Data Object 11300 can be any object stimulating a user of a device, e.g., WD 02202 or PC 11800, to initiate a User Request. Data Object 11300 can be an object of the class PHY Object 11200. For example, Data Object 11300 can be particular type of PHY Object 11200 which cannot transmit and/or receive any type of EMF 11532. A Print Publication, e.g., a newspaper or magazine, excluding any device which can transmit and/or receive any type of EMF 11532 can be a Data Object 11300.

A device can receive a User Request related to Data Object 11300 in any manner, which can include, but is not limited to: (a) Microphone 11510, which can receive any type of audio input, including, but not limited to, Speech 11512 of the user of the device, e.g., WD 02202, and/or Ambient Audio 11514; and/or (b) Image Transceiver 11540, which can receive any type of Image/Video 11542, still or moving, of Data Object 11300, e.g., capturing an image, still or moving, of any Content like Object A 02120 displayed in a Print Publication or any symbol representing an Object of Interest or an Offer like a barcode displayed in a Print Publication.

Touch Device 11400 can be any Data Processing System capable of executing a variety of functions and/or instructions upon the detection, receiving, sensing, and/or monitoring of any type of input, which can include, but is not limited to, pressure (in EMF form or non-EMF form), from any source of input, which can include, but is not limited to, a stylus, a pen, and/or one or more fingers simultaneously touching a display. The user of a second device can initiate a User Request upon interacting with a first Touch Device 11400 in any manner, which can include, but is not limited to: (a) viewing it; (b) hearing it; and/or (c) touching it. A second device can receive a User Request related to Touch Device 11400 in any manner, which can include, but is not limited to: (a) Microphone 11510, which can receive any type of audio input, including, but not limited to, Speech 11512 of the user of the device, e.g., WD 02202, and/or Ambient Audio 11514; (b) Transceiver 11550, which can receive any type of Electrical Signal 11552 from Touch Device 11400. Touch Device 11400 can be a device: (a) integrated with a second device, e.g., a Display 01200 which displays output for a second device, e.g., WD 02202 or PC 11800; or (b) separate from a second device, e.g., a Touch Device displaying output for a first device, e.g., an appliance.

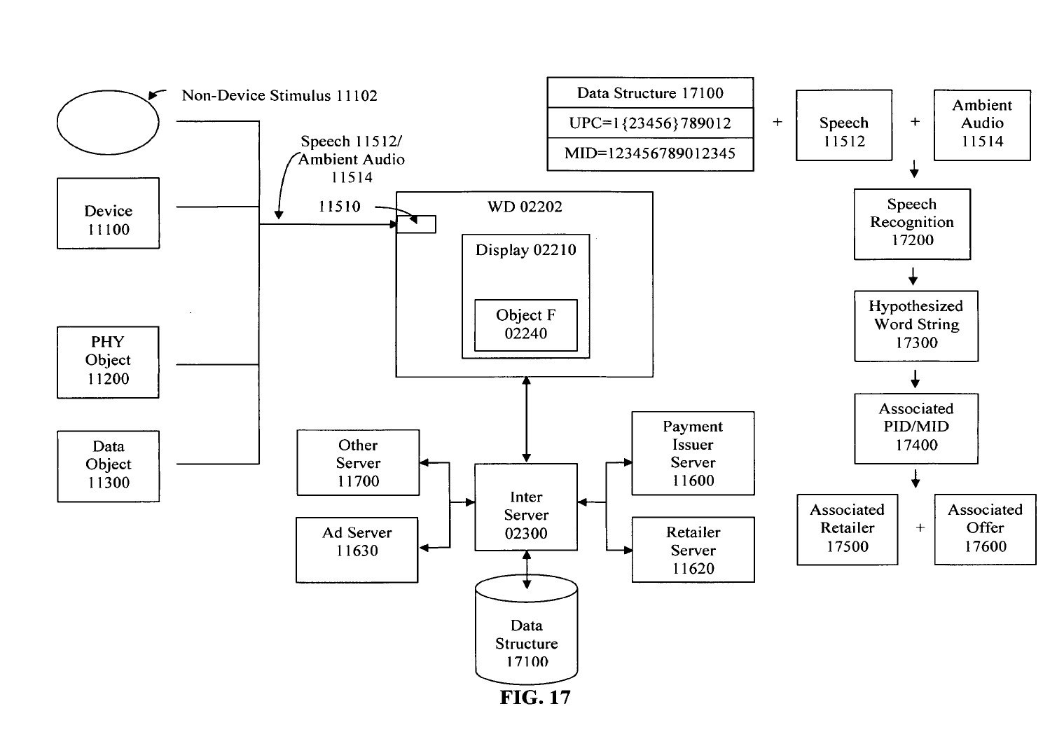

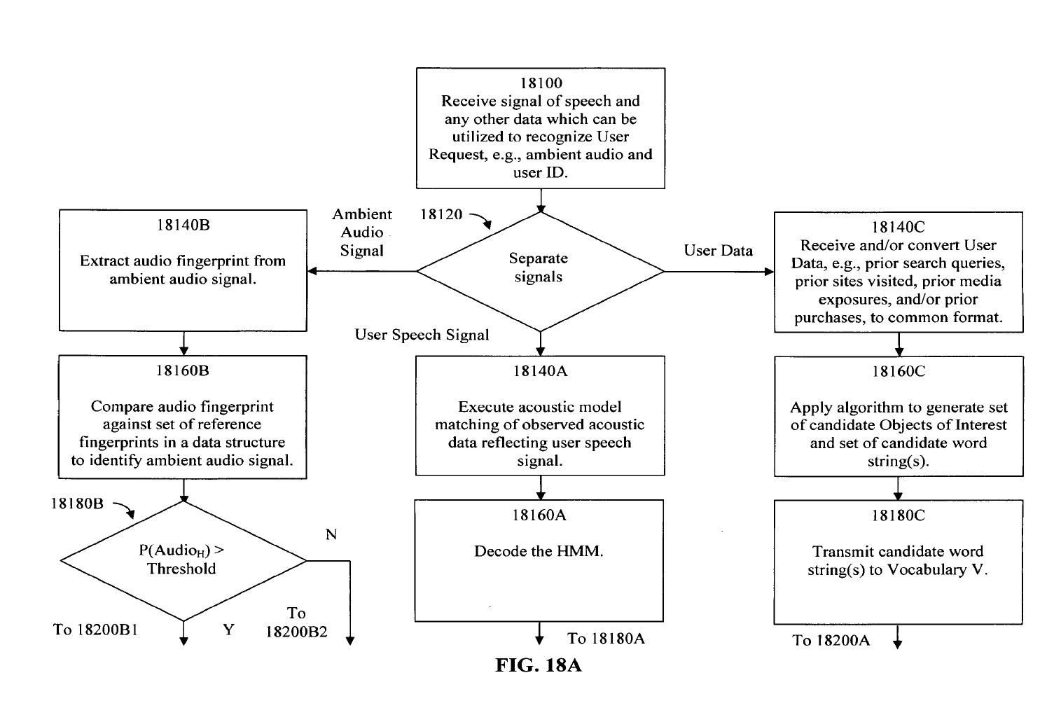

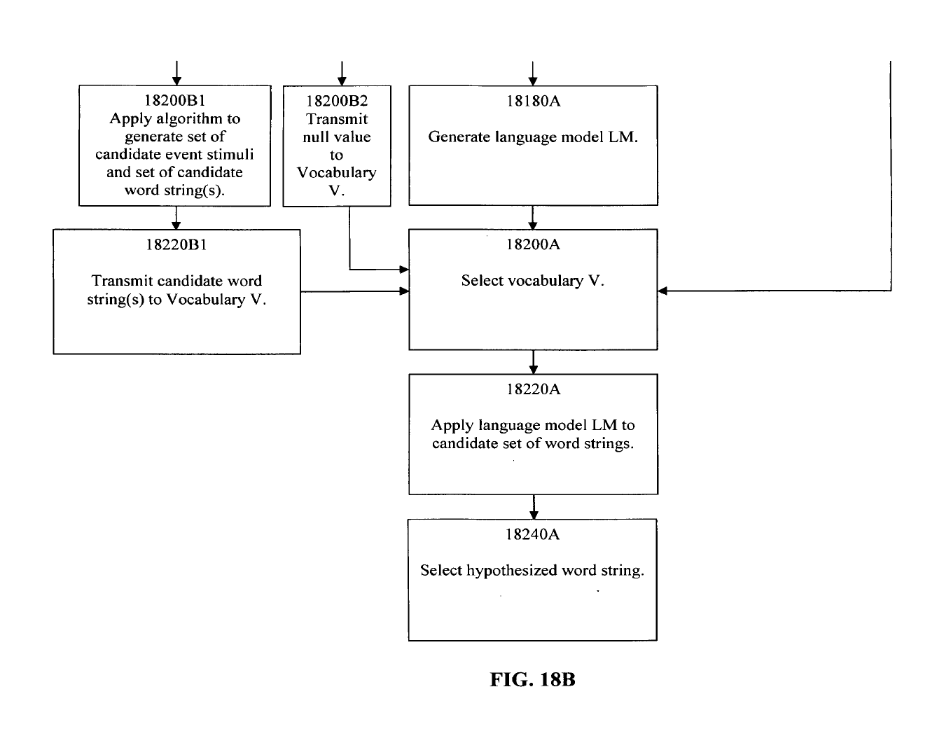

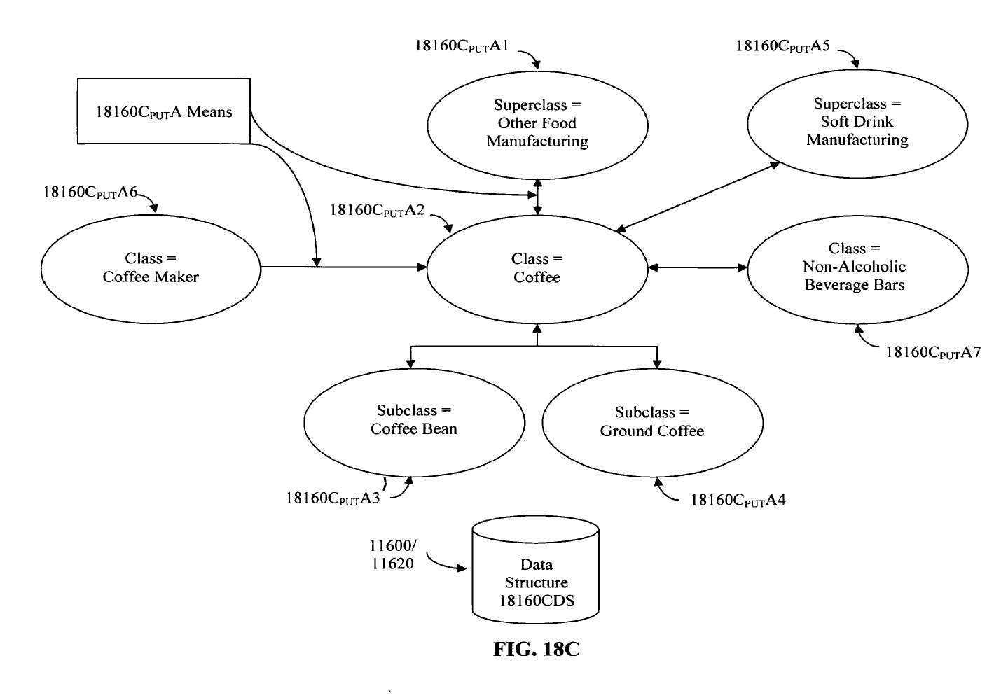

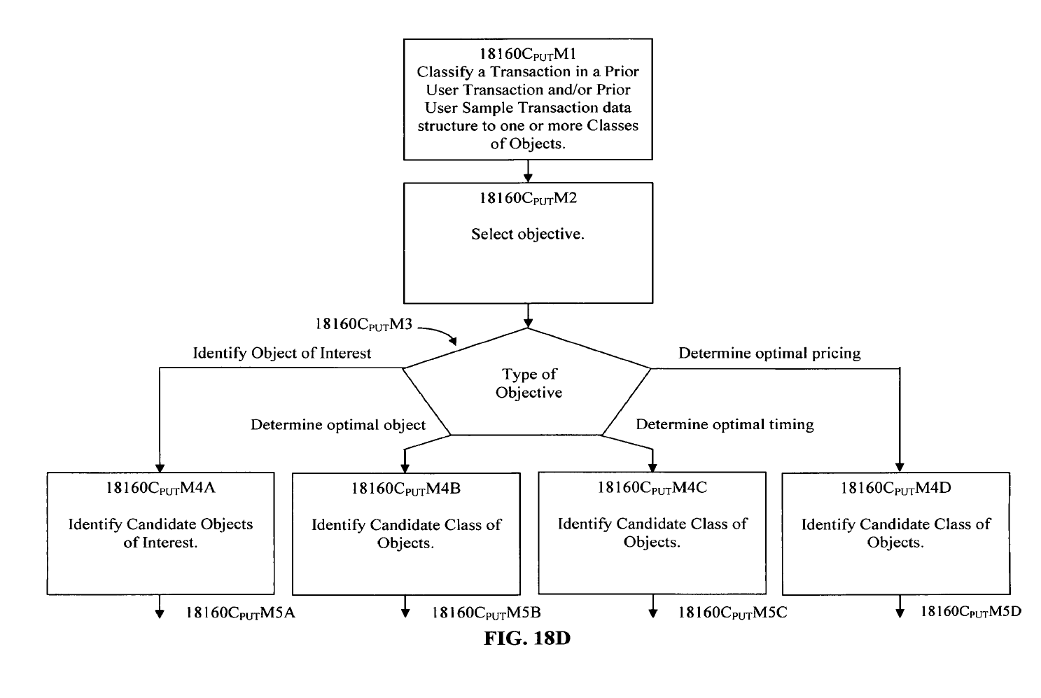

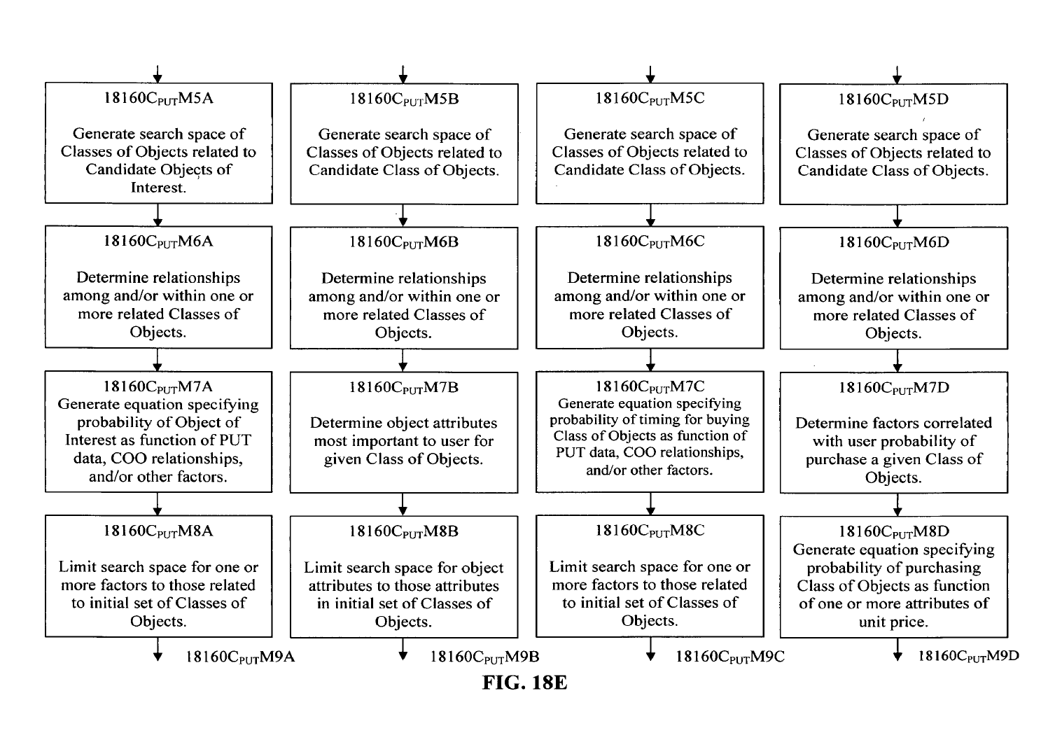

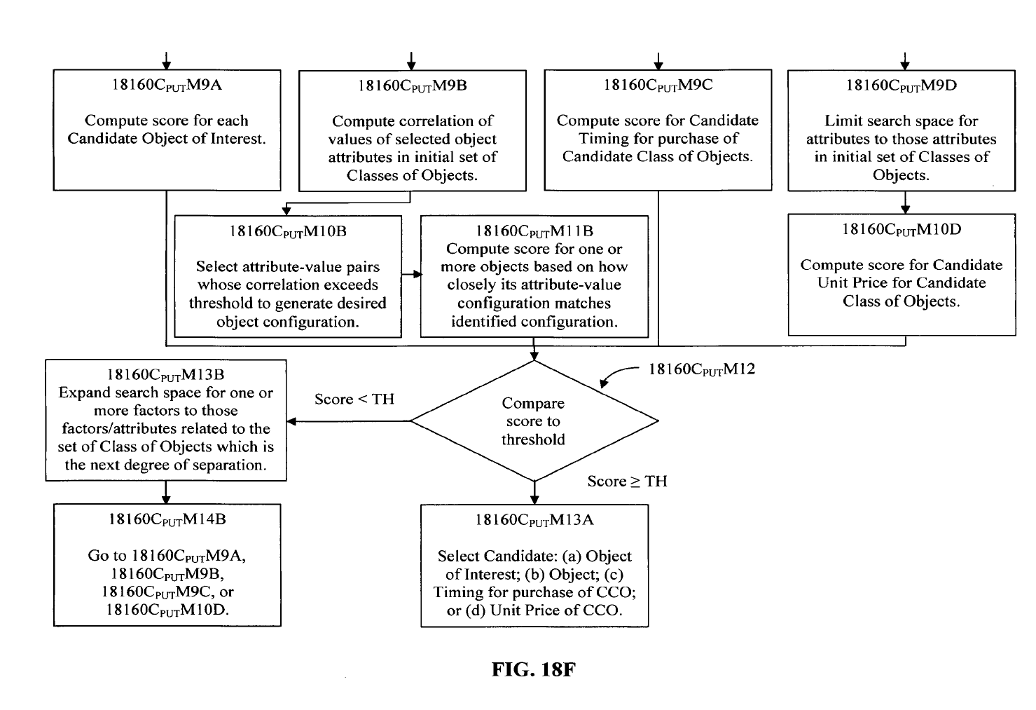

Speech 11512 can be any word string spoken by the user of a device, e.g., WD 02202. While the application illustrates Speech 11512 in various embodiments as associated with a User Request, the invention is not limited to that embodiment. The invention can execute any function and/or instruction related to Speech 11512 whether or not Speech 11512 comprises a User Request. For example, the invention includes apparatuses and methods described in FIG. 17, FIG. 18A, and FIG. 18B which can separate a user speech component from an ambient audio component. In those embodiments, Speech 11512 can comprise any word string, including, but not limited to: (a) a word string related to an Object of Interest; (b) a word string related to Content displayed on a media device, e.g., an answer to a question posed during a game show; (c) a word string related to an interactive voice response system; and/or (d) a word string constituting any communications between two or more people.

Gesture Detection Device 11564 can collect, measure, and/or detect any data representing one or more positions along x y z axes and along at dimension (“Object Space-Time Data” 11562) and transmit 11562 to Gesture Detection Transceiver 11560. Detecting an x coordinate, y coordinate, and z coordinate at time t₀ can enable the identification of the position of, e.g., the user's finger or hand at one point. Detecting an x coordinate, y coordinate, and z coordinate at time t₁ can enable the identification of the position of any part of the user at a subsequent point, i.e., the movement along a time dimension of any part of the user. Gesture Detection Transceiver 11560 can execute a variety of functions and/or instructions, including, but not limited to: (a) receiving the data; (b) processing the data; (c) mapping the data to the coordinates of an Object 02230 displayed in Display 02210, e.g., a cursor; and/or (d) outputting the data to a processor, e.g., Processor 11570, which can then execute: (i) any function capable of rendering in Display 02210 the movement of the cursor in synchronization with Object Space-Time Data 11562; and/or (ii) any other event handler capable of processing Object Space-Time Data 11562.

Gesture Detection Transceiver 11560 and Gesture Detection Device 11564 can enable the user of a device, e.g., WD 02202 or PC 11800, to view data on Display 02210, e.g., a web page including Content, and navigate around the web page in a three-dimensional space and without having to utilize a Touch Device 11400.

While the application illustrates the system in FIG. 11 as receiving data from and/or transmitting data to one or more illustrated devices and/or objects, the invention is not limited to that embodiment.

The invention can enable the reception of data from and/or transmission of data to any type of device and/or object, including, but not limited to, the following. First, a Data Processing System transmitting data to and/or receiving data from a Client Device 14200, e.g., WD 02202, where the data can include, but is not limited to, a User Request. For example, an appliance, e.g., a refrigerator, including a Data Processing System can transmit through any means data like a User Request related to one or more Objects of Interest, e.g., eggs, to a Client Device 14200, e.g., WD 02202. Second, a Data Processing System transmitting data to and/or receiving data from a Data Processing System not a Client Device 14200, e.g., Inter Server 02300, where the data can include, but is not limited to, a User Request. For example, an object, e.g., a motor vehicle, including a Data Processing System can transmit through any means data like a User Request related to one or more Objects of Interest, e.g., motor oil, to a Data Processing System not a Client Device 14200, e.g., Inter Server 02300.

While FIG. 11 depicts WD 02202 as the device capable of executing the functions described herein, the invention is not limited to that embodiment. The invention can utilize any Data Processing System, e.g., PC 11800 or a TV 02100, capable of receiving, storing, processing, and transmitting data to execute the functions described herein.

Processor 11570 can execute a variety of functions and/or instructions, including, but not limited to: (a) receiving input from any device in WD 02202; (b) storing instructions and/or data in memory; (c) processing instructions and/or data; (d) outputting results to Display 02210; and/or (e) transmitting data to any other Data Processing System.

Keypad 11572 can execute any functions which can be executed by Keyboard/Keypad 01220. The user of WD 02202 can utilize Keypad 11572 to create and/or transmit to Inter Server 02300 any type of message, including, but not limited to: (a) a text message; (b) a multimedia message; and/or (c) an email. The message can include Content representing a User Request (“Messaging Data 11572A”).

NFC Module 11574 can execute any functions and/or receive, process, store, and/or transmit any data related to the NFC protocol. In a first example, NFC Module 11574 can receive an Offer, e.g., data specifying the value of a Coupon, process the Offer, store the Offer, and/or transmit the Offer through NFC Transceiver 11595 to PHY POS 11920 when WD 02202 is exchanging data with PHY POS 11920 in accordance with the NFC protocol. In a second example, NFC Module 11574 can transmit data to any device with the capability of receiving a signal utilizing the NFC protocol, e.g., a NFC tag, read data from the device, e.g., a NFC tag, and/or store the read data.

While the application illustrates the exchange of data between a WD 02202 and a PHY POS 11920 in accordance with the NFC protocol, the invention is not limited to that embodiment. The invention can exchange through any communications protocol any data between: (a) a Client Device 14200, e.g., a WD 02202; and one or more (b) a PHY POS 11920, Web Server 11910, and/or any other Data Processing System.

The invention can exchange any data over any radio frequency (RF) channel or band, including, but not limited to: (a) the 13.56 MHz band utilized by the NFC standard; (b) the 13.56 MHz or 2.4 GHz band utilized by the RFID standard; (c) any RF channel utilized by a WLAN standard; and/or (d) any RF channel utilized by a WWAN standard.

The invention can exchange between any Client Device 14200, e.g., WD 02202, and a terminal, e.g., PHY POS 11920 or Web Server 11910, any data utilizing any payment standard, including, but not limited to: (a) the EMV™ payment standard specified by EMVCo, LLC enabling interoperability between a client device and a terminal; and/or (b) any other payment standard enabling interoperability between a client device and a terminal.

Component 11576 can be any component configured to receive, process, store, and/or transmit data in accordance with any computing, memory, storage, and/or communications protocol. Component 11576 can be a component capable of exchanging data with one or more other components in WD 02202 through an Interface 11577: (a) to which Component 05876 can be attached and/or detached; or (b) from which Component 05876 cannot be attached or detached. In one embodiment, a detachable Component 11576 can be a user identity module (UIM), which can include one or more applications, including, but not limited to: (a) universal SIM (USIM); (b) SIM; and/or (c) CDMA Subscriber Identity Module (CSIM). In another embodiment, a detachable Component 11576 can be a device dedicated to an application, e.g., a SIM card or a Universal Integrated Circuit Card (UICC). In another embodiment, a detachable Component 11576 can be a removable flash memory card, which can support any format, including, but not limited to: (a) Secure Digital (SD); (b) Secure Digital High Capacity (SDHC); (c) Secure Digital eXtended Capacity (SDXC); (d) microSD; and/or (e) miniSD. Component 11576 can exchange data with any Data Processing System, e.g., PHY POS 11920, through any communications protocol, e.g., NFC and/or Bluetooth. Component 11576 can store one or more data structures, including, but not limited to: (a) Data Structure 35100; (b) Rules Data Structure 35200; (c) Data Structure 37100; (d) Rules Data Structure 37200; (e) Data Structure 39100; (f) Rules Data Structure 39200; (g) Data Structure 41100; (h) Rules Data Structure 41200; (i) Data Structure 43100; and/or (j) Rules Data Structure 43200.

Transceiver 11580 can transmit and/or receive any data to and/or from Inter Server 02300 and/or any other Data Processing System utilizing any wireless and/or wireline communications protocol, which can include, but is not limited to, any protocol over: (a) any WAN 01800; (b) any MAN 01700; (c) any LAN 01600; (d) any PAN 01500; and/or (e) any NFC 01400.

Transceiver 11590 can transmit and/or receive any data to and/or from Web Server 11910 and/or any other Data Processing System capable of executing a Transaction related to an Object of Interest utilizing any wireless and/or wireline communications protocol, which can include, but is not limited to, any protocol over: (a) any WAN 01800; (b) any MAN 01700; (c) any LAN 01600; (d) any PAN 01500; and/or (e) any NFC 01400.

Payment Issuer Server 11600 can be any Data Processing System capable of executing a variety of functions and/or instructions, including, but not limited to: (a) receiving data specifying the characteristics of any given Transaction, including, but not limited to: (i) an identifier of an object which can be purchased in the Transaction, e.g., a code used to identify one or more objects like the Universal Product Code (UPC), a Stock Keeping Unit (SKU), and/or a code used to identify a specific object within one class of objects like the National Drug Code (NDC), International Statistical Classification of Diseases and Related Health Problems (commonly known as ICD), International Standard Book Number (ISBN), Vehicle Identification Number (VIN), an identifier used to identify a specific real property, e.g., any identifier used in the Multiple Listing Service (MLS) or the proposed Real Property Unique Identifier (RPUID), and/or an identifier provided by Cinema Source to identify a specific movie (“MovieID”) (collectively “Object Identifier”); (ii) an identifier of the Retailer selling the object, e.g., a Merchant ID (MID); (iii) an identifier of the Acquirer processing the Transaction for the Retailer, e.g., an Acquirer ID (AID); and/or (iv) an identifier of the category of the object purchased in the Transaction, the category of the vendor manufacturing the object, or the category of the Retailer selling an object, e.g., the MCC, the Standard Industrial Classification (SIC), the NAICS; or the North American Product Classification System (NAPCS); (b) storing the data described herein in a data structure, e.g., Data Structure 33700; (c) querying the data structure to identify data in one or more Transactions; (d) transmitting to any Data Processing System, e.g., Inter Server 02300, the results of a query; and/or (e) receiving and processing a request from any Data Processing System, e.g., Payment Association Network Server 11610 or Retailer Server 11620, to enable, authorize, and/or settle the purchase of an object by a user of Client Device 14200 holding one or more Payment Accounts with the entity operating Payment Issuer Server 11600. Payment Issuer Server 11600 can process for an object any type of Transaction, including, but not limited to: (a) paying for an object by debiting a Payment Account and withdrawing an amount equal to the purchase price, e.g., payment with a debit card, check, or stored value card; (b) paying for an object by adding in accordance with a predefined rule a liability to a Payment Account an amount equal to the purchase price, e.g., payment with a credit card or through incurring a liability with the entity paying for the purchase like an operator of a wireless network (“Mobile Network Operator”); and/or (c) paying for an object by adding in accordance with an authorization for the specific purchase a liability to a Payment Account an amount equal to the purchase price, e.g., payment for a motor vehicle in part or whole with a loan or payment for real property in part or whole with a loan.

While FIG. 11 depicts Payment Issuer Server 11600 as the device capable of executing the functions described herein, the invention is not limited to that embodiment. The invention can utilize a Data Processing System operated by any entity processing a Transaction by PHY POS 11920 and/or Web Server 11910, including, but not limited to: (a) an Acquirer, which can process the Transaction for a Retailer; and/or (b) a Payment Association Network Server 11610, which can process, authorize, and/or settle Transactions among Retailer Servers, Acquirers, and Payment Issuers.

Retailer Server 11620 can be any Data Processing System capable of executing a variety of functions and/or instructions, including, but not limited to: (a) receiving from any device, which can include, but is not limited to, PHY POS 11920 and/or Web Server 11910, any data related to the purchase of one or more objects in a Transaction; (b) receiving data related to one or more Offers, which can be associated with a customer for which Retailer Server 11620 has at least one identifier of the customer, e.g., an identifier for a member of a frequent shopper or a frequent flyer program, registered in a program making Offers to the customer (“Loyalty Program”); (c) storing in a data structure any data related to one or more objects purchased by the customer, including, but not limited to, (i) an identifier of each of one or more objects purchased by the customer, e.g., any of the codes utilized by Payment Issuer Server 11600 to identify uniquely an object purchased and/or the category of the object purchased in the Transaction like the UPC and/or MovieID; (ii) the date and/or time of the purchase; and/or (iii) the method of payment for the purchase; (d) querying the data structure to identify data in one or more Transactions; (e) storing in a data structure, e.g., Data Structure 33500, any data related to one or more objects available for sale by the Retailer, where the data can include, but is not limited to: (i) a description of the object in any form, including, but not limited to, text, image, video, and/or sound; (ii) an identifier of the object, e.g., the UPC and/or MovieID; (iii) availability of the object in one or more locations of the Retailer; (iv) pricing of the object, in general; and/or (v) pricing of the object for one or more sets of customers, e.g., members of a Loyalty Program; (f) querying the data structure to identify any data related to the one or more objects; (g) computing any change in the price of the object upon receiving a code, identifier, and/or data describing one or more Offers and/or Rewards; (h) returning to any Data Processing System, e.g., POS 11920 or Web Server 11910, the net price charged for the object; and/or (i) transmitting to any Data Processing System, e.g., Inter Server 02300, the results of any query of the customer, any Transaction, any object, and/or any other data stored in one or more data structures. Ad Server 11630 can be any Data Processing System capable of executing a variety of functions and/or instructions, including, but not limited to: (a) storing in a data structure data specifying one or more advertisements; (b) querying the data structure to identify any data uniquely identifying an advertisement, e.g., the Ad-ID code; and/or (c) transmitting to any Data Processing System, e.g., Inter Server 02300, the results of a query.

While the application illustrates Ad Server 11630 as capable of storing in a data structure data specifying one or more advertisements, the invention is not limited to that embodiment. Ad Server 11630 can store any data specifying any Content displayed on one or more Data Processing Systems, e.g., TV 02100, in the vicinity of a user transmitting a User Request. Storing any data specifying any Content can enable the invention to identify the Content displayed through any method, e.g., audio fingerprinting.

Other Server 11700 can be any Data Processing System capable of executing a variety of functions and/or instructions, including, but not limited to: (a) storing in a data structure data specifying one or more Offers; (b) querying the data structure to identify any identifier of an object associated with an Offer, which can include, but is not limited to: (i) an identifier of an object, e.g., the UPC; (ii) an identifier of a Retailer, e.g., the MID; (iii) a word string identifying the name of the object or brand; and/or (iv) a word string identifying the name of the Retailer; (c) transmitting to any Data Processing System, e.g., Inter Server 02300, the results of a query; and/or (d) displaying in a manner accessible to an entity over a network, e.g., on a web page, one or more Offers to enable a server to query the web page for the Offer(s).

Transceiver 11582 can transmit and/or receive any data to and/or from a Data Processing System which can be accessed by the user of WD 02202, e.g., a PC 11800, or a Printer 11810. Transceiver 11582 can enable a WD 02202 to exchange data with a PC 11800 or Printer 11810 utilizing any wired communications protocol, e.g., Universal Serial Bus (USB), and/or wireless communications protocol, e.g., Bluetooth.

Paper Coupon/Code 11820 is any type of Offer printed on any type of paper, which a user of WD 02202 can redeem at a PHY POS 11920.

Web Server 11910 can be any Data Processing System capable of executing a variety of functions and/or instructions, including, but not limited to: (a) displaying one or more web pages, which can present one or more fields whose input and/or one or more items whose selection can enable the purchase of an object; (b) displaying one or more web pages, which can present one or more fields whose input and/or one or more items whose selection can enable the transmission or display of an Offer; and/or (c) displaying one or more web pages, which can present one or more fields whose input and/or one or more items whose selection can enable the execution of any other action related to an Object of Interest.

PHY POS 11920 can be any Data Processing System in a PHY Retailer capable of executing a variety of functions and/or instructions, including, but not limited to: (a) executing a Transaction related to an Object of Interest; and/or (b) exchanging through Transceiver 11922 any data with a WD 02202 related to one or more Offers related to an Object of Interest. While a PHY POS is commonly associated with a physical cash register, the invention is not limited to that embodiment. A PHY POS 11920 can be any Data Processing System in a physical Retailer that can communicate with another Data Processing System, e.g., Retailer Server 11620, which can enable the processing of a payment for the Object of Interest. For example, an Object of Interest can be a motor vehicle for which a user of Client Device 14200 can pay through the execution with an auto dealer of a loan contract or lease contract. In the example, the PHY POS 11920 can be a Data Processing System enabling the transmission of data, e.g., a coupon code reducing the price of the motor vehicle, from a Client Device 14200, e.g., WD 02202, to a Retailer Server 11620 executing the Transaction for the auto dealer.

Apparatus 11000 can comprise: (a) a memory, e.g., Memory 01120; (b) a processor, e.g., Processor 01040 or Processor 11570; (c) a module, e.g., Object ID Engine 33310, stored in the memory and executable on the processor which can identify one or more Objects of Interest, one or more Equivalent Objects of Interest, and/or one or more Classes of Interest; (d) a module, e.g., Offer ID Engine 33320, stored in the memory and executable on the processor which can automatically identify one or more Offers associated with the Object of Interest and/or Class of Interest; (e) a module, e.g., Payment ID/Transaction Engine 33330, stored in the memory and executable on the processor which can automatically select a Payment Account, deposit or transfer cash into a Payment Account, and/or redeem earned reward currency related to the purchase of the Object of Interest; (f) a module, e.g., Offer Redemption Engine 33340, stored in the memory and executable on the processor which can automatically redeem one or more Offers associated with the Object of Interest and/or Class of Interest; and/or (g) a display module stored in the memory and executable on the processor which can display in PC/WD Display 02210 Object F 02240. In another embodiment, Apparatus 11000 can comprise one or more of the above components located in another Data Processing System, e.g., Inter Server 02300.

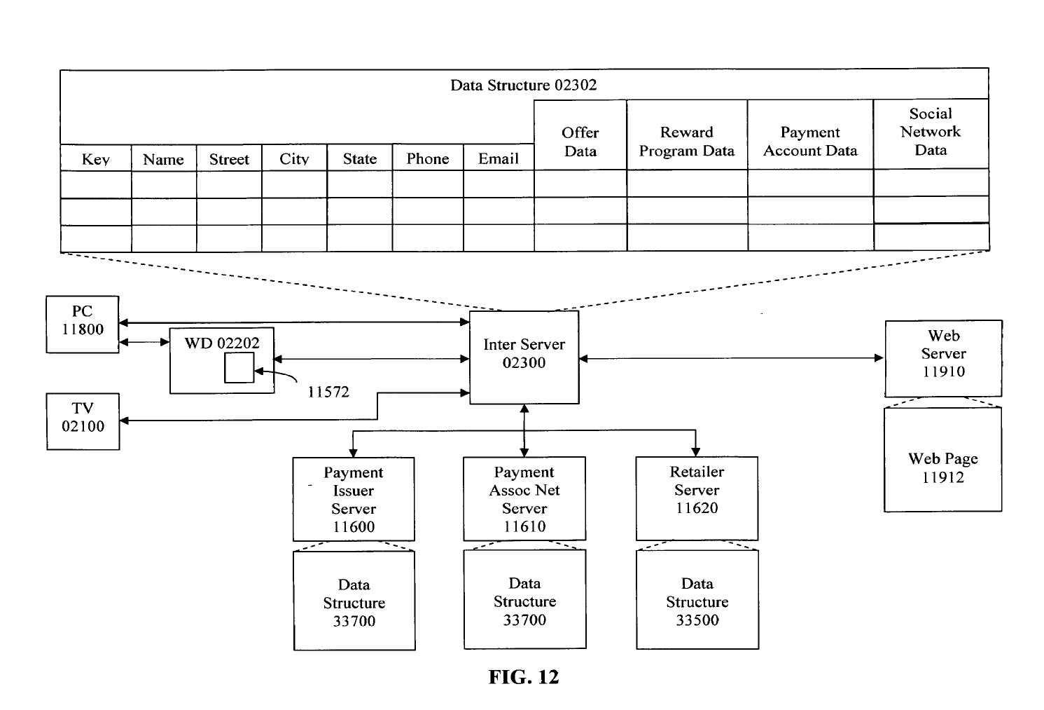

FIG. 12 depicts a block diagram of an exemplary apparatus, Apparatus 12000, enabling the registration and/or processing of data used to execute the methods described herein, according to one embodiment. The apparatus can implement the entities described herein by utilizing a subset of the following components, any combination of the components, or additional, related, alternative, and/or equivalent components. The apparatus can include, but is not limited to, the following components not disclosed earlier.

Inter Server 02300 can be any Data Processing System capable of executing a variety of functions and/or instructions, including, but not limited to: (a) writing, storing, processing, and/or reading data in a data structure which can include, but is not limited to, the following data: (i) data used to register in and/or data specifying existing registration in one or more reward programs operated by one or more Payment Issuers, where a Reward Program is any program offering a user an incentive to use a Payment Account, which is any type of Payment Method, e.g., a type of credit/debit card or a charge card issued by a particular entity or a method of billing to an account operated by a particular entity, to execute a Transaction; (ii) data used to register in and/or data specifying existing registration in one or more Loyalty Programs; (iii) data used to register in and/or data specifying existing registration in one or more other Offer programs, e.g., membership in an Affinity Program like one for emergency auto repair, another for an educational institution, another for a demographic group, or another for an insurance program; and/or data specifying one or more existing credit/debit cards issued by one or more Payment Issuers.

While FIG. 12 depicts Inter Server 02300 as the device capable of executing the functions described herein, the invention is not limited to that embodiment. The invention can utilize a Data Processing System operated by any entity to execute the functions, including, but not limited to: (a) WD 02202; (b) PC 11800; and/or (c) a Payment Association Network Server 11610.

Data Structure 02302 can store a variety of data, including, but not limited to: (a) a Key, which uniquely identifies a record; (b) data enabling the communication with a user of a Data Processing System, including, but not limited to, WD 02202, PC 11800, and/or TV 02100, where the data can include, but is not limited to, name, street address, city, state, zip code, phone number, and/or email address; (c) data related to one or more Offers; (d) data related to one or more Reward Program enabling the association of a plurality of data, including, but not limited to, a user of a Data Processing System, a Payment Account, and/or an Offer; (e) data related to one or more Payment Accounts associated with a user of a Data Processing System; (f) data related to one or more social networks of which a user of a Data Processing System is a member, where a Social Network is any entity which has a plurality of members.

Data Structure 02302 can include Social Network data to enable the execution of a variety of functions and/or instructions, including, but not limited to: (a) utilizing Social Network data, e.g., demographic data, Transaction data, and/or interests of a member, to increase the accuracy of recognizing an input by the user of a Data Processing System; and/or (b) executing a Transaction related to a member of a Social Network, e.g., if the user of a Data Processing System wants to buy and send an object to a member of his/her Social Network, accessing the Social Network can help identify the name and shipping address of the recipient. For example, if any method described herein receives a User Request “Buy and send flowers to Mary this Valentine's Day”, the method can add to a vocabulary of a language model any name included in user's Social Network Data stored in Data Structure 02302.

While FIG. 12 describes Data Structure 02302 as storing Reward Program Data, the invention is not limited to that embodiment. Data Structure 2302 can store any data related to a program which provides its users one or more Offers if the user registers for the program. These programs can include, but are not limited to: (a) a Loyalty Program offered by a Retailer; (b) a Frequent Flyer program offered by a travel company, e.g., an airline or hotel; and/or (c) an Affinity Program.

The invention can utilize any of the data in Data Structure 02302 and/or any other data structure described herein to execute any methods described herein. Some users of Client Device 14200 may object to the use of the data because they prefer not to make certain data public. The invention can maintain the privacy of user data through any means, including, but not limited to: (a) requiring that the user of Client Device 14200 opt-in, i.e., affirmatively give permission for the use of such data, before any method described herein can use the data; and/or (b) using only data which has been classified to a level of Class of Objects in which the object purchased or the Class of Objects purchased cannot be identified. In a first example, if the user purchased an object A, the invention can be limited to utilize only data constituting the Class of Objects in which object A is classified. In a second example, if the user purchased an object A in the Class of Objects A which the user also prefers not to disclose, the invention can be limited to utilize only data representing a super class of Class of Objects A, e.g., Class of Objects B in which Class of Objects A is classified. In the second example, Object A can be associated with an identifier associated with a specific prescription drug. Class of Objects A can be the class of prescription drugs which the user prefers not to disclose. The invention can be limited to utilizing only data representing a super class of Class of Objects A, e.g., Class of Objects B “Prescription Drugs” from which Class of Objects A cannot be identified. The invention can map the Class of Objects A to, e.g.: (a) a NDC 12345XXXXYY, where the first NDC segment represents the 5-digit Labeler Code segment and the second NDC segment represents the 3- or 4-digit Product Code segment, and where the specific code cannot identify the object drug produced by the Labeler; or (b) a NDC ZZZZZXXXXYY, where neither the Labeler Code nor the Product Code can be identified.

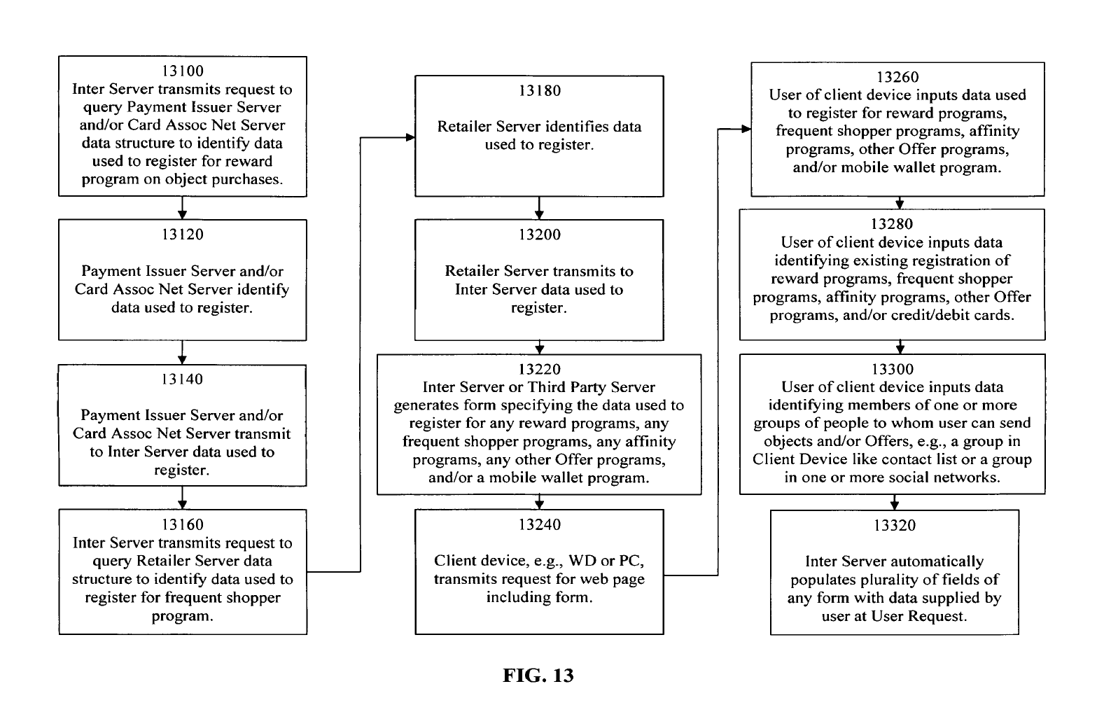

FIG. 13 depicts a flowchart of an exemplary computer-implemented method, Method 13000, that when executed can enable the registration of data used to execute the methods described herein, according to one embodiment. The flowchart refers to the apparatus and structures depicted in FIG. 12. However, the method is not limited to those embodiments. The method can implement the steps described herein utilizing a subset of the components, any combination of the components, or additional, related, alternative, and/or equivalent components depicted in FIG. 12 and/or elsewhere in the application. The method can execute a subset of the steps, any combination of the steps, the steps in different order, and/or additional, related, alternative, or equivalent steps.

Enabling a user of a Data Processing System to input at one time the data related to a plurality of accounts and/or programs can yield a variety of benefits, including, but not limited to: (a) saving the user time from inputting the same data multiple times at different web sites; (b) the generation of one or more Offers which can increase the amount of savings accruing to a given user; and/or (c) the identification of one or more Offers of which the user may not be aware. For example, having one or related data structures storing Payment Account data, Reward Program data, and Social Network data can enable the generation of an Offer which increases savings for a user purchasing a given object at a given Retailer using a given Payment Account.

In another example, having one or related data structures storing data related to membership of one or more Affinity programs can help automatically identify an Offer of which the user may not be aware. If a user is a member of an health insurance program which offers its members a discount on membership of qualifying exercise clubs, then: (a) Object J 02248 can display an estimate of the discount decreasing the price of membership of an exercise club; and/or (b) the methods described herein can enable the selection of Object S 02270 associated with an Object A 02120 or Object C 02230 promoting the exercise club to: (i) associate automatically the discount from the health insurance program with Object S 02270; and/or (ii) populate automatically any field for inputting an Offer at a Web Server 11910 selling the exercise club membership.

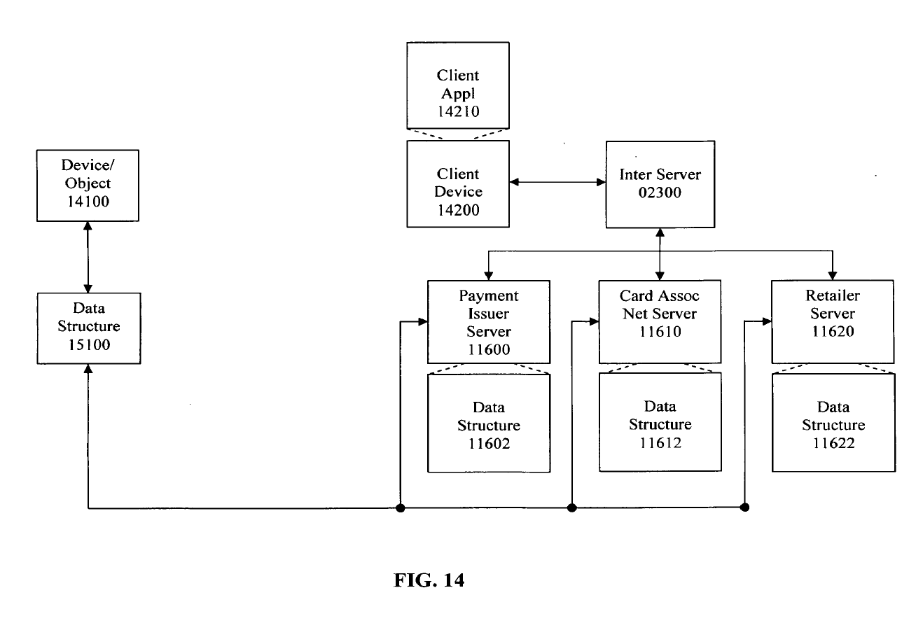

FIG. 14 depicts a block diagram of an exemplary apparatus, Apparatus 14000, enabling the identification of a code uniquely identifying an object of interest and/or association of the code with one or more Retailers and/or Offers related to the object of interest, according to one embodiment. The apparatus can implement the entities described herein by utilizing a subset of the following components, any combination of the components, or additional, related, alternative, and/or equivalent components. The apparatus can include, but is not limited to, the following components not disclosed earlier.

Payment Association Network Server 14160 can be any Data Processing System capable of executing the same type of functions as Payment Issuer Server 11600.

Data Structure 15100 can be any data structure including, but not limited to, the following types of data: (a) any identifier of an advertisement, e.g., an Ad-ID code; (b) any identifier of an object, e.g., an UPC or SKU number; (c) any identifier of a Retailer, e.g., a MID; (d) any identifier of the category of the object purchased in the Transaction or the Retailer executing the Transaction, e.g., a MCC or NAICS; (e) any identifier of an Offer, e.g., a GS-1 128 Coupon Extended Code; and/or (f) any other identifier of a characteristic related to an Object of Interest. Any of the Data Processing Systems disclosed herein can read, store, process, and/or write one or more types of data included in Data Structure 15100. Any of the data structures disclosed herein can include one or more types of data included in Data Structure 15100.

Client Device 14200 can be any Data Processing System used by an individual to transmit a User Request, e.g., WD 02202, PC 11800, or TV 02100. Client Device 14200 can have at least the capability of enabling the user to input a User Request through at least one I/O Device, e.g., Microphone 01260, Keypad 01220, and/or Display 01200. In the preferred embodiment, Client Device 14200 has the capability of receiving and/or detecting not only one or more types of input of the user, e.g., speech into Microphone 01260, but also one or more other data whose processing can help identify any Content which could have stimulated the user to make the User Request. These data can include, but are not limited to: (a) any signal received from one or more Data Processing Systems in the vicinity of Client Device 14200, e.g., an audio signal; (b) any data received from any device displaying Content in the vicinity of Client Device 14200, e.g., an image from a print publication, or a barcode; (c) and/or any data specifying the location of Client Device 14200. Client Device 14200 can transmit any voice and/or data signal to any other Data Processing System over any network, e.g., the Internet.

Client Application 14210 can be any AOM/CPP capable of executing a variety of functions and/or instructions, including, but not limited to: (a) storing in a file any data specifying one or more values associated with a purchase of one or more objects; (b) reading one or more files the values associated with a purchase of one or more objects; (c) reading one or more search requests through a browser; (d) storing in a file any data specifying one or more keywords searched through a browser; (e) reading one or more files the keywords searched through a browser; (f) receiving and/or processing instructions and/or data required to recognize any input representing an Object of Interest and/or any input representing any Content related to an Object of Interest; (g) transmitting to another Data Processing System the instructions and/or data in (f); (h) accessing any calling module or dialing module which can enable Client Device 14200 to originate and/or terminate a connection with any Data Processing System; (i) reading any data, e.g., an universal resource locator (URL) and/or a domain name, associated with and/or included in any object, hyperlink, and/or data in a document displayed in Client Device 14200; (j) retrieving instructions and/or data from a server, e.g., Inter Server 02300, for display in Client Device 14200; and/or (k) displaying data in Client Device 14200.

Client Application 14210 can be any AOM/CPP located and operating on any client device, including, but not limited to: (a) a personal computer, e.g., PC 11800; and/or (b) a Wireless Device, e.g., a WD 02202.

Client Application 14210 can be any AOM/CPP which is separate from or integrated with another CPP, e.g., an operating system or a browser, located and operating on: (a) any client device; (b) any server to which the client device can access data and/or instructions, e.g., in client-server computing; and/or (c) any Data Processing System in cloud computing. Client Application 14210 can interact with another CPP, e.g., a browser, in any form, including, but not limited to: an add-on, extension, plug-in, theme, and/or toolbar.

While FIG. 14 describes Inter Server 02300 exchanging data with one or more servers like 11600, 11610, and/or 11620 and/or processing the received data, the invention is not limited to that embodiment. The invention can enable any Data Processing System, including Client Device 14200 or Device Object 14100, to exchange data directly with one or more servers like 11600, 11610, and/or 11620 and process directly the received data. In one embodiment, servers like Payment Issuer Server 11600 and Retailer Server 11620 can enable the user of Client Device 14200 to access directly the part of their respective data structures storing data on Transactions executed by the user of Client Device 14200. For example, most Payment Issuers already transmit to the user of Client Device 14200 statements detailing the Transactions executed by the user. By enabling a Client Device 14200 to access directly the data on Transactions executed by the user, the invention can enable the Client Device 14200 to execute many, if not all, of the methods described herein executed by Inter Server 02300.

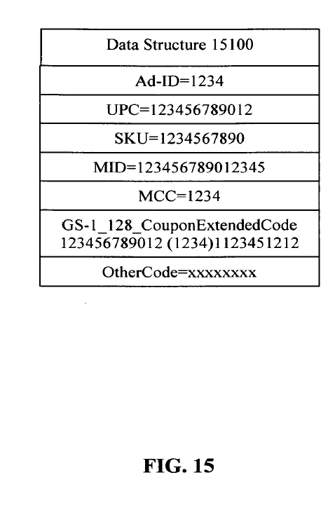

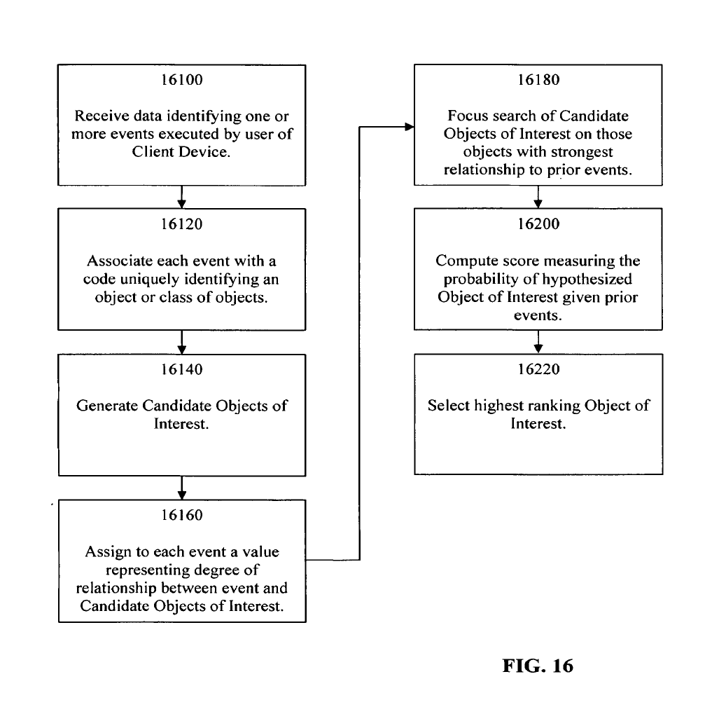

FIG. 16 depicts a flowchart of an exemplary computer-implemented method, Method 16000, that when executed can utilize and process codes to recognize an object of interest, according to one embodiment. The flowchart refers to the apparatus and structures depicted in FIG. 14 and FIG. 15. However, the method is not limited to those embodiments. The method can implement the steps described herein utilizing a subset of the components, any combination of the components, or additional, related, alternative, and/or equivalent components depicted in FIG. 14, FIG. 15, and/or elsewhere in the application. The method can execute a subset of the steps, any combination of the steps, the steps in different order, and/or additional, related, alternative, or equivalent steps.

At 16100, Method 16000 can receive data from one or more Data Processing Systems utilized by a user, e.g., Client Device 14200. The data can be related to and help identify one or more events executed by the user. These events can include any event related to an object and/or class of objects, including, but not limited to: (a) exposure to Content displayed on any Data Processing System, e.g., TV 02100, related to an object and/or class of objects, e.g., a programming and/or advertisement promoting a specific exercise club XYZ and/or the class of exercise clubs; (b) queries to a search engine related to an object and/or class of objects, e.g., a query for a specific exercise club XYZ and/or the class of exercise clubs; (c) visits to a web site related to an object and/or class of objects, e.g., a visit to a web site promoting a specific exercise club XYZ and/or a web site evaluating the class of exercise clubs; (d) prior purchases of an object and/or other objects in the class of objects, e.g., a prior purchase of a one-year membership at exercise club ABC; and/or (e) prior purchases of an object related to the potential Objects of Interest described in a User Request, e.g., a prior purchase of a health insurance policy which offers members a discount on the purchase of membership at a qualifying exercise club.

At 16120, Method 16000 can associate with each event an identifier of an object and/or class of objects. Method 16000 can associate with the events executed by the user of Client Device 14200 an identifier of the object and/or class of objects related to the event. For example, the user of Client Device 14200 can be exposed to Content promoting an exercise club XYZ and have recently executed a purchase at a sporting goods Retailer XYZ. Method 16000 can associate with the Content promoting exercise club XYZ both the MID assigned to exercise club XYZ and an object category code for exercise clubs, e.g., NAICS code 713940, which includes “Health Club Facilities” and “Weight Training Centers”. Method 16000 can associate with the recent purchase at sporting goods Retailer XYZ both the MID assigned to sporting goods Retailer XYZ and an object category code for sporting goods Retailers, e.g., NAICS code 451110, which includes “Athletic Equipment and Supply Stores”, “Exercise Equipment Stores”, “Footwear, Specialty Sports, Stores”, and “Sporting Goods Stores”.

At 16140, Method 16000 can generate through any method a set of Candidate Objects of Interest, which the application defines as a set of potential Objects of Interest which can be narrower than the set of all objects and to which any method can be applied to identify a hypothesized and/or actual Object of Interest. In one embodiment, a speech recognition method can utilize an acoustic model and a language model to generate a set of candidate word strings. For example, a speech recognition method can generate two potential word strings, “Mo-dell” and “More dell”.

At 16160, Method 16000 can assign to each event a value representing the degree of relationship between the event and Candidate Objects of Interest. Method 16000 can generate the value using any function and set and type of parameters. For example, a function can estimate the degree of relationship among an event and a candidate Object of Interest based on the frequency of the events during some period of time before the User Request, or the similarity of the object related to an event and the candidate Object of Interest.

At 16180, Method 16000 can focus the search of Candidate Objects of Interest or narrow the search space for Candidate Objects of Interest to the set of Candidate Objects of Interest with the strongest relationship to prior events executed by the user of Client Device 14200.

At 16200, Method 16000 can utilize any method to sort and/or rank the set of Candidate Objects of Interest. In one embodiment, Method 16000 can compute for each Candidate Object of Interest a score measuring the probability of a hypothesized Object of Interest given the set of prior events executed by the user of Client Device 14200.

At 16220, Method 16000 can select the highest ranking candidate Object of Interest as the hypothesized Object of Interest, which it can present for confirmation to the user of Client Device 14200.

### Improved Recognition

FIG. 17 depicts a block diagram of an exemplary apparatus, Apparatus 17000, enabling the identification of a spoken word string related to an object of interest, according to one embodiment. The apparatus can implement the entities described herein by utilizing a subset of the following components, any combination of the components, or additional, related, alternative, and/or equivalent components. The apparatus can include, but is not limited to, the following components not disclosed earlier.

Data Structure 17100 can include any data which can be utilized by the methods described herein to help identify an Object of Interest. The data can include, but are not limited to: (a) data related to one or more events executed by the user of a Client Device 14200, e.g., WD 02202; and/or (b) data related to Content displayed on a Client Device 14200 and/or one or more Data Processing Systems in the vicinity of the Client Device 14200, e.g., Device 11100, PHY Object 11200, and/or Data Object 11300. For example, data (a) can include the UPC 123456789012 of an object purchased by the user of Client Device 14200 or MID 123456789012 of a Retailer from which the user of Client Device 14200 purchased an object. Data (b) can include data describing any displayed Content which can be mapped against or correlated with Ambient Audio 11514 to identify the Content displayed. The invention can utilize any method, e.g., acoustic or audio fingerprinting, to identify the Content displayed.

Speech Recognition Module 17200 can be any CPP capable of processing a speech input and generating an output of a Hypothesized Word String 17300.

Associated Product ID and/or Merchant ID 17400 can be any identifier of a Hypothesized Object of Interest, e.g., an object and/or a Retailer, inferred from Hypothesized Word String 17300.

Associated Retailer 17500 can be any Retailer offering the Hypothesized Object of Interest. Associated Offer 17600 can be any Offer related to the Hypothesized Object of Interest.

Apparatus 17000 can comprise: (a) a memory, e.g., Memory 01120; (b) a processor, e.g., Processor 01040; and/or (c) a module, e.g., Object ID Engine 33310, stored in the memory and executable on the processor which can: (i) distinguish a speech input, audio from one or more Data Processing Systems, e.g., TV 02100, and/or noise; (ii) generate a set of candidate word strings based on identifying ambient audio and/or analyzing User Data; and/or (iii) recognize a speech input and identify one or more Objects of Interest and/or one or more Classes of Interest. In another embodiment, Apparatus 17000 can comprise one or more of the above components located in another Data Processing System, e.g., Inter Server 02300.

While the application illustrates the invention described herein as executing functions and/or instructions related to WD 02202 acting as a Client Device 14200, the invention is not limited to that embodiment. The invention can enable the apparatuses, methods, and CPPs described herein to execute functions and/or instructions related to any Data Processing System acting as a Client Device 14200, including, but not limited to: (a) WD 02202; (b) a Data Processing System capable of exchanging a speech signal through a wireline RF channel; (c) PC 11800; and/or (d) TV 02100.

FIG. 18A and FIG. 18B depict a flowchart of an exemplary computer-implemented method, Method 18000, that when executed can enable the identification of a spoken word string related to an object of interest, according to one embodiment. The flowchart refers to the apparatus and structures depicted in FIG. 17. However, the method is not limited to those embodiments. The method can implement the steps described herein utilizing a subset of the components, any combination of the components, or additional, related, alternative, and/or equivalent components depicted in FIG. 17 and/or elsewhere in the application. The method can execute a subset of the steps, any combination of the steps, the steps in different order, and/or additional, related, alternative, or equivalent steps.

At 18100, Method 18000 can receive a signal and/or data from any Client Device 14200, e.g., WD 02202, which can comprise one or more of the following, including, but not limited to: (a) a RF signal comprising at least one of the following: (i) the speech utterance of the user of WD 02202, e.g., Speech 11512; and/or (ii) Ambient Audio 11514; and/or (b) any other data Method 18000 can utilize to recognize the User Request, e.g., Data Structure 17100 and/or any data in User Database 02310 (“User Data”).

At 18120, Method 18000 can utilize any method to separate the received RF signal and/or data. In one embodiment, Method 18000 can receive User Data, e.g., prior search queries and/or prior purchases, from a source Data Processing System other than Client Device 14200. For example, Method 18000 can receive User Data from one or more Data Processing Systems, including, but not limited to: (a) Payment Issuer Server 11600; (b) Retailer Server 11620; (c) Ad Server 11630; (d) Other Server 11700; and/or (e) Inter Server 02300, which can be any Data Processing System which can crawl, index, and/or store data to identify, organize, and/or store User Data. In another embodiment, Method 18000 can receive User Data from Client Device 14200 over one or more channels separate from the channels carrying any RF signals, e.g., Speech 11512 and/or Ambient Audio 11514. For example, Method 18000 can: (a) receive User Data over a channel dedicated to exchanging data between Client Device 14200 and Inter Server 02300; and (b) receive any RF signals, e.g., Speech 11512 and/or Ambient Audio 11514, over a channel dedicated to exchanging audio and/or voice between Client Device 14200 and Inter Server 02300. In another embodiment, Method 18000 can receive User Data and any RF signals from Client Device 14200 over the same channel. For example, Method 18000 can receive User Data and any RF signals over a data channel which can carry User Data over IP and any RF signals representing Speech 11512 and/or Ambient Audio 11514 in the form of VOIP. Method 18000 can utilize any method to separate the RF signal received into User Speech 11512 and/or Ambient Audio 11514.

Method 18000 can recognize Speech 11512 by utilizing a speech recognition method based on hidden Markov models (HMM).

At 18140A, Method 18000 can execute acoustic model matching of the observed acoustic data reflecting the user speech signal, e.g., Speech 11512. Method 18000 can apply logic to compare and/or utilize any comparator component capable of comparing one or more feature vectors extracted or observed from the audio signal comprising Speech 11512 against the set of feature vectors in an acoustic model to identify the observed acoustic information O.

At 18160A, Method 18000 can apply any method to decode the HMM, i.e., identify a plurality of potential utterances maximizing p(O|W).

At 18180A, Method 18000 can generate a Language Model LM. A language model can estimate p(W), the a priori distribution of the probability of a given sequence of n-words W.

At 18200A, Method 18000 can build a vocabulary V, which can include one or more words against which a speech recognition engine can compare Speech 11512.

At 18220A, Method 18000 can apply the language model LM to rank the plurality of potential utterances.

At 18240A, Method 18000 can select the most probable word string.

The application illustrates one method of processing user speech and/or ambient audio in a speech recognition method. However, the invention is not limited to that embodiment. The invention can process user speech and/or ambient audio utilizing any speech recognition method.

At 18140B, Method 18000 can extract an audio fingerprint from Ambient Audio 11514 utilizing any method. For example, a typical audio fingerprinting method can extract from an audio signal one or more features in any domain, e.g., the frequency domain, to generate one or more feature vectors.

At 18160B, Method 18000 can compare the audio fingerprint against a set of reference fingerprints in a data structure to identify the Ambient Audio 11514. For example, a typical audio fingerprinting method can compare the hashes constituting one or more feature vectors associated with an audio fingerprint against a data structure including the set of hashes constituting the features associated with reference Content, e.g., programming and/or advertisements displayed on one or more TV networks transmitted in the area of Client Device 14200.

At 18180B, Method 18000 can determine if there is a match enabling the identification of Ambient Audio 11514. For example, Method 18000 can compute if the probability of hypothesized Ambient Audio, P(Ambient Audio_{H}), exceeds a predefined threshold. If Method 18000 can identify Ambient Audio 11514, it can proceed to 18200B1. Otherwise, it can proceed to 18200B2.

At 18200B1, Method 18000 can apply any method to generate a set of candidate events stimulating the User Request and/or a set of candidate word strings associated with the event stimuli. The objective is to identify the set of probable events which could have stimulated the user of Client Device 14200 to transmit the User Request. Identifying the set of probable events can help narrow the search space of Candidate Objects of Interest to the set of Candidate Objects of Interest with a strong relationship to prior events to which the user of Client Device 14200 was exposed. Method 18000 can execute any method and/or algorithm and/or utilize any apparatus to identify the set of candidate event stimuli, including, but not limited to, any methods, algorithms, and/or apparatuses disclosed in U.S. patent application Ser. No. 12/107,649 and/or U.S. patent application Ser. No. 12/370,536.

At 18220B1, Method 18000 can transmit to Vocabulary V the set of candidate word strings identified at 18200B1.

At 18200B2, Method 18000 can terminate or transmit a null value to Vocabulary V.

At 18140C, Method 18000 can receive, convert, and/or process any User Data, e.g., prior search queries, prior media exposures, prior web sites visited, prior purchases, user interests, and/or any other data which can relate to the user interest in Candidate Objects of Interest, to a common format.

At 18160C, Method 18000 can apply any method to generate a set of Candidate Objects of Interest and/or set of candidate word strings associated with the User Data.

A User Request is unlikely to include a set of words randomly selected by the user. When requesting an action related to an Object of Interest and/or Class of Interest, a user typically will select a set of words which bear some relationship with: (a) the Object of Interest and/or Class of Interest; and (b) one or more other words selected in the User Request. If a user wants to get more information about an Object of Interest and/or a Class of Interest or buy an Object of Interest, he/she typically will input one or more words: (a) specifying the name of the Object of Interest and/or Class of Interest; and/or (b) describing the Object of Interest and/or Class of Interest. In a first example, a user wishing to buy a specific object, e.g., a DVD of a movie, is likely to specify the name of the specific movie and/or one or more words describing the specific movie, like “Buy XYZ DVD” where XYZ is the name of the movie or “Buy the DVD with ABC in it” where ABC is the name of a lead actor in the movie. The word “XYZ” can be related to the word “DVD”. In a second example, a user wishing to have identified for him/her a specific object, e.g., XYZ gas station, in a Class of Interest, e.g., “Gas Stations”, can specify specific a request for a gas station meeting a set of attributes, like “Find the cheapest gas station selling diesel within five miles of here”. Each of the words “find”, “cheapest”, “gas”, “station”, “diesel”, “within”, “five”, “miles”, and “here” can be related to one another.

In one embodiment, Method 18000 can generate a score and/or rank for each word or word string to determine the probability of it being the Object of Interest in a search space, which can be expressed as follows:

P(Candidate Object of Interest)=(P(COI|CVNᵢ)*CL_{CVN}*W₁)+(P(COI|CBNᵢ)*CL_{CBN}*W₂)+(P(COI|CON_{PUR})*CL_{PUR}*W₃)+(P(COI|CON_{PMX})*CL_{PMO}*W₄)+(P(COI|CON_{PUT})*CL_{PUT}_{_{—}}_{CON})*W₅)+(P(COI|CCOO_{PUT})*CL_{PUT}_{_{—}}_{CCOO})*W₆)+(P(COI|CON_{UI})*CL_{UI}*W₇)+(P(COI|CON_{UL})*CL_{UL}*W₈)+(P(COI|CON_{UD})*CL_{UD}*W₉) Equation (2)

where P(COI|CVNᵢ) is the conditional probability of a Candidate Object of Interest given any Candidate Vendor Name (CVN) recognized in the User Request; P(COI|CBNᵢ) is the conditional probability of a Candidate Object of Interest given any Candidate Brand Name (CBN) recognized in the User Request; P(COI|CON_{PUR}) is the conditional probability of a Candidate Object of Interest given the set of Candidate Object Names (CON) generated by analyzing the Prior User Requests (PUR); P(COI|CON_{PMX}) is the conditional probability of a Candidate Object of Interest given the set of Candidate Object Names generated by analyzing the Prior Media Exposures (PMX); P(COI|CON_{PUT}) is the conditional probability of a Candidate Object of Interest given the set of Candidate Object Names generated by analyzing the Prior User Transactions (PUT) where the PUT are purchases of any object; P(COI|CCOO_{PUT}) is the conditional probability of a Candidate Object of Interest given the set of Candidate Classes of Objects generated by analyzing the PUT; P(COI|CON_{UI}) is the conditional probability of a Candidate Object of Interest given the set of Candidate Object Names generated by analyzing the User Interest(s) (UI); P(COI|CON_{UL}) is the conditional probability of a Candidate Object of Interest given the set of Candidate Object Names generated by analyzing the User Location(s) (UL); P(COI|CON_{UD}) is the conditional probability of a Candidate Object of Interest given the set of Candidate Object Names generated by analyzing the User Demographic attributes (UD); CLᵢ is the confidence level associated with each Candidate Object Name conditional probability where i can be CVN, CBN, PUR, PMX, PUT given CON, PUT given CCOO, UI, UL, and UD; and Wᵢ is the weight assigned by Method 18000 to each Candidate Object of Interest conditional probability. While Equation (2) specifies a particular sum of products of the terms, the invention is not limited to that embodiment. The invention can generate a score and/or rank for each Candidate Object of Interest through any means or formulae including some, all, additional, different, related, and/or equivalent terms in any combination.

Method 18000 can compute P(COI|CVNᵢ) through any means, including, but not limited to: (a) executing the following steps, including, but not limited to: (i) determining if any word string recognized in the User Request constitutes a Candidate Vendor Name by comparing the recognized word string against a data structure including the names of vendors; (ii) if the recognized word string matches at least one Candidate Vendor Name, comparing the Candidate Object of Interest against a data structure including the names of objects produced by each identified vendor name; (iii) if the Candidate Object of Interest matches at least one name of an object produced by a vendor name, assigning the value of 100% to P(COI|CVNᵢ); and/or (iv) if the Candidate Object of Interest does not match at least one name of an object produced by a vendor name, assigning the value of 0% to P(COI|CVNᵢ); and/or (b) executing Method 36000B at 36000B15 to generate a set of Candidate Vendor Names through any object analysis module parsing the Prior Media Exposures.

Method 18000 can compute P(COI|CBNᵢ) through any means, including, but not limited to: (a) executing the following steps, including, but not limited to: (i) determining if any word string recognized in the User Request constitutes a Candidate Brand Name by comparing the recognized word string against a data structure including the names of brands; (ii) if the recognized word string matches at least one Candidate Brand Name, comparing the Candidate Object of Interest against a data structure including the names of objects associated with each identified brand name; (iii) if the Candidate Object of Interest matches at least one name of an object associated with a brand name, assigning the value of 100% to P(COI|CBNᵢ); and/or (iv) if the Candidate Object of Interest does not match at least one name of an object associated with a brand name, assigning the value of 0% to P(COI|CBNᵢ); and/or (b) executing Method 36000B at 36000B15 to generate a set of Candidate Brand Names through any object analysis module parsing the Prior Media Exposures.

Method 18000 can generate a set of CON_{PUR} through any means, including, but not limited to: (a) counting the number of times any given Candidate Object Name was cited in Prior User Requests over any given time period.

Method 18000 can generate a set of CON_{PMX} through any means, including, but not limited to: (a) counting the number of times any given Candidate Object Name was included in Prior Media Exposures, i.e., any Content to which the user was exposed, over any given time period; and/or (b) executing Method 36000B at 36000B15 to generate a set of Candidate Object Names through any object analysis module parsing the Prior Media Exposures.

Method 18000 can generate a set of CON_{PUT} through any means, including, but not limited to: (a) counting the number of times any given Candidate Object Name was included in PUT, i.e., any Transactions executed by the user, over any given time period; and/or (b) executing Method 18160C_{PUT} herein.

Method 18000 can generate a set of CCOO_{PUT} through any means, including, but not limited to: (a) counting the number of times any given Candidate Class of Objects was included in PUT over any given time period; and/or (b) executing Method 18160C_{PUT} herein.

In generating CON_{PUT}, CCOO_{PUT}, and/or any attribute related to an Object of Interest and/or Class of Objects, e.g., a desired configuration of attribute-value pairs for an Object of Interest, the time when a user can be interested in purchasing an Object of Interest, and/or the unit price at which a user can purchase one or more units of an Object of Interest which can generated a desired level of profit for the seller of the Object of Interest, the invention can take advantage of any relationships among a plurality of Classes of Objects. These relationships can include, but are not limited to, the following.

First, there can be vertical relationships among Classes of Objects, i.e., where class A can be a superclass, parent class, or base class of class B, and class B can be a subclass, child class, or derived class of class A. A subclass of objects can inherit properties and/or methods from a superclass of objects. For example, a container of coffee can be a superclass of objects comprising one or more subclasses of objects, e.g., a container of coffee type A like “Ground Coffee” and a container of coffee type B like “Coffee Beans”. The two subclasses, “Ground Coffee” and “Coffee Bean”, can inherit from the superclass “Coffee” one or more properties, e.g., a component “Caffeine”, and/or one or more methods, e.g., a method of preparing or cooking “Brewing”.

Second, there can be horizontal relationships among Classes of Objects, i.e., where there can be any type of relationship among a plurality of Classes of Objects. These relationships can include, but are not limited to: (a) where a plurality of classes can share one or more similar properties and/or methods; (b) where the purchase of an object from a first Class of Objects can typically precede the purchase of an object from a second Class of Objects; (c) where the purchase of an object from a first Class of Objects can typically occur concurrently with the purchase of an object from a second Class of Objects.

In a first embodiment, the horizontal Classes of Objects can share attributes with values sufficiently comparable such that a user would consider objects in the two or more classes as Equivalent Objects of Interest. For example, class A can be objects offered by vendor A, e.g., a container of coffee offered by vendor A with an exemplary UPC=762111600349 and class B can be objects offered by vendor B, e.g., a container of coffee offered by vendor B with an exemplary UPC=881334000511. The two objects can share one or more attributes, e.g., type of coffee=“Coffee Bean”, and weight=16 ounces, whose values are either equal or within a specified range where a user would consider the two objects as Equivalent Objects of Interest. In a second embodiment, the horizontal Classes of Objects can include a plurality of Classes of Objects where the purchase of an object from a first Class of Objects typically precedes the purchase of an object from a second Class of Objects. For example, the purchase of a motor vehicle XYZ from the Motor Vehicle Class of Objects typically precedes the purchase of service from an auto repair store related to motor vehicle XYZ from the auto repair service Class of Objects.

The invention can exploit the methods and/or properties of one or more systems classifying objects (“Object Classification System”), which can include, but are not limited to, any of the methods of identifying or coding objects described herein, e.g., the systems generating identifiers which can be processed by Payment Issuer Server 11600 and/or Retailer Server 11620. The methods and/or properties of an Object Classification System which the invention can exploit can include, but are not limited to: (a) the classification by a vendor of the objects it offers for sale, e.g., the Product ID represented by a subset of digits in a UPC, typically a five-digit string; and/or (b) the classification by a system of the vendors, e.g., the NAICS classification of a vendor or Retailer to a class like the classification of Starbucks® to the NAICS class 722213 “Snack & Nonalcoholic Beverage Bars” or MCC class 5814 “Fast Food Restaurants”.

The invention can utilize the classification of retailers, vendors, brands, objects, and/or other data related to an Object of Interest and/or a Class of Interest through a variety of means, including, but not limited to: (a) to exploit the assignment of retailers, vendors, brands, and/or objects to classes which share similar attributes; (b) to identify relationships among a plurality of classes; and/or (c) to reduce the search space of factors and/or data, which can increase the accuracy and/or reduce the time to identify an objective. For example, the number of CONs which can include a word “Fast” can be large. However, knowing the name of the vendor or other datum related to an object name can reduce the search space of CONs. Because an Object Classification System like the UPC enables the assignment of a Manufacturer ID and a Product ID to a unique object, knowing the name of a vendor can reduce significantly the search space of CONs identified by the Product ID associated with the Manufacturer ID.

FIG. 18C depicts a block diagram of an exemplary apparatus, Apparatus 18160C_{PUT}A, enabling the identification and/or determining of a candidate object of interest and/or any attributes of the object of interest by analyzing prior user transactions and/or prior user sample transactions, according to one embodiment. The apparatus can implement the entities described herein by utilizing a subset of the following components, any combination of the components, or additional, related, alternative, and/or equivalent components. The apparatus can include, but is not limited to, the following components not disclosed earlier.

Data Structure 18160CDS can be any data structure capable of enabling at least the writing, storage, and/or reading of data related to the PUT of a user transmitting a User Request and/or Prior User Sample Transactions (PUT_{S}), which the application defines as a sample of purchases of the objects in a Class of Objects, e.g., Transactions for a plurality of users in Retailer Data Structure 33500, Payment Data Structure 33700, and/or any other data structure. In one example, Data Structure 18160CDS can be stored at Payment Issuer Server 11600, Retailer Server 11620, and/or distributed across a plurality of servers, e.g., 11600 and 11620.

Apparatus 18160C_{PUT}A can comprise one or more means, including, but not limited to: (a) a means of searching a data structure storing the PUT and/or PUT_{S}; (b) a means of classifying a Transaction to one or more Classes of Objects in accordance with one or more Object Classification Systems, e.g., NAICS and/or MCC; (c) a means of determining one or more relationships among a plurality of Classes of Objects; (d) a means of generating an equation specifying the probability of an objective as a function of the PUT and/or PUT_{S}, relationships among Class of Objects, and/or any other factors; (e) a means of limiting a search space for one or more factors to those objects in an initial set of Classes of Objects and/or expanding the search space in subsequent iterations to those objects in a set of Classes of Objects which is the next degree of separation from the initial set of Classes of Objects; (f) a means of computing a score reflecting the probability that a candidate Object of Interest and/or any attribute of a candidate Object of Interest meets the objective function specified; (g) a means of comparing the score to a predefined threshold; and/or (h) a means of selecting a candidate Object of Interest and/or attribute of a candidate Object of Interest.

In one embodiment, Apparatus 18160C_{PUT}A illustrates an exemplary output of the classification of a plurality of Transactions to a plurality of Classes of Objects in accordance with one or more Object Classification Systems, e.g., NAICS. Apparatus 18160C_{PUT}A can assign each Transaction to one or more Classes of Objects in accordance with the associated code of one or more Object Classification Systems, e.g., NAICS, including, but not limited to, the following: (a) Superclass=Other Food Manufacturing (NAICS code 3119) at 18160C_{PUT}A1; (b) Class=Coffee and Tea Manufacturing (NAICS code 31192) at 18160C_{PUT}A2; (c) Subclass=Coffee Bean (Object Classification System XYZ code) at 18160C_{PUT}A3; (d) Subclass=Ground Coffee (Object Classification System XYZ code) at 18160C_{PUT}A4; (e) Superclass=Soft Drink Manufacturing (NAICS code 31211) at 18160C_{PUT}A5; (f) Class=Coffee Maker (NAICS code 335211) at 18160C_{PUT}A6; and/or (g) Class=Non-Alcoholic Beverage Bars (NAICS code 722213) at 18160C_{PUT}A7.

Apparatus 18160C_{PUT}A can include a means, Apparatus 18160C_{PUT}A Means, of determining one or more relationships among a plurality of Classes of Objects by exploiting the methods and/or properties of the Object Classification System and/or executing methods enabled by the invention. These methods and/or properties can include one or more of, but are not limited to:

(a) determining if a first Class of Objects is a subclass of a second Class of Objects by parsing the Object Classification System to determine if the code associated with the first Class of Objects is a subset of the code associated with the second Class of Objects, e.g., the NAICS code 31192 associated with the class “Coffee and Tea Manufacturing” is a subset of the NAICS code 3119 associated with the class “Other Food Manufacturing;

(b) determining if a first Class of Objects is a superclass of a second Class of Objects by parsing the Object Classification System to determine if the code associated with the first Class of Objects is a superset of the code associated with the second Class of Objects, e.g., the NAICS code 3119 associated with the class “Other Food Manufacturing” is a superset of the NAICS code 31192 associated with the class “Coffee and Tea Manufacturing;

(c) determining if a first Class of Objects can be a class competitive with a second Class of Objects by executing one or more of the following methods, including, but not limited to:

(i) a method of exploiting the hierarchical data structure of an Object Classification System, where the method can include, but is not limited to, the following steps: (1) identifying a plurality of subclasses in each Class of Objects; and/or (2) determining through any means if each subclass is significant, where the means can include, but are not limited to: (a) determining if the objects in the plurality of Classes of Objects are typically offered by a Retailer; (b) determining if the objects in the plurality of Classes of Objects are typically offered in the same location of a Retailer, e.g., the same aisle; and/or (c) determining if there is a significant correlation of Transactions in the plurality of Classes of Objects in a PUT_{S} data structure. For example, Apparatus 18160C_{PUT}A can include a means of: (1) reading the subclasses in each Class of Objects defined by an Object Classification System, e.g., NAICS code 3121 “Beverage Manufacturing” can include the subclasses: (a) NAICS code 312111 “Soft Drink Manufacturing”, (b) NAICS code 312112 “Bottled Water Manufacturing”, (c) NAICS code 312120 “Breweries”, (d) NAICS code 312130 “Wineries”, and (e) NAICS code 312140 “Distilleries”, where the NAICS Object Classification System has determined that the classes “Beverage”, “Bottled Water”, “Breweries”, “Wineries”, and “Distilleries” include objects which can compete with each other; and/or (2) determining if each subclass is significant.

(ii) a method of exploiting the attributes of objects across a plurality of classes in an Object Classification System, where the method can include, but is not limited to, the following steps: (1) associating with each Class of Objects one or more attributes of the objects in the class; (2) assigning a value for each object attribute, e.g., an average value for the objects in the class; (3) identifying the set of Classes of Objects which have common attribute-value pairs; and/or (4) determining the degree of competition between any two Classes of Objects by: (a) ranking the attributes in accordance with any method determining the importance of each attribute to a Class of Objects; and (b) determining if the values of the common attributes are within a predefined range. For example, Apparatus 18160C_{PUT}A can include a means of: (1) associating with NAICS code 31192 “Coffee and Tea Manufacturing” and NAICS code 31211 “Soft Drink Manufacturing” an attribute “Caffeine Content” in units, e.g., milligrams per ounce; (2) measuring the value, e.g., an average value for the objects in the Coffee class, of Caffeine Content for coffee at, e.g., 51, and the value, e.g., an average value for the objects in Soft Drink class or any Soft Drink subclass, of Caffeine Content for XYZ energy drink at, e.g., 60; (3) generating the set of Coffee class and Soft Drink class sharing the “Caffeine Content” attribute; and/or (4) determining that the values of the attribute “Caffeine Content” for the two NAICS codes falls within a predefined range, e.g., 20%.

(d) determining if a first Class of Objects can be a class complementary to a second Class of Objects by executing one or more of the following methods, including, but not limited to:
(i) a method of determining if a first Class of Objects can be a class including at least one object whose purchase must precede the purchase of an object in a second Class of Objects, e.g., the purchase of a Coffee Maker preceding the purchase of Coffee Beans, where the method can include, but is not limited to, the following steps: (1) identifying in a first Object Classification System, e.g., NAICS, a plurality of Classes of Objects; (2) identifying in a system of identifying, organizing, and/or displaying and/or a data structure listing and/or displaying the relationships among objects, e.g., a product specification, the relationship between an object in a first Class of Objects and an object in a second Class of Objects; and/or (3) computing the correlation of Transactions in a PUT and/or PUT_{S} among objects in the first Class of Objects and objects in the second Class of Objects to determine if the correlation exceeds a predefined threshold. For example, Apparatus 18160C_{PUT}A can include a means of: (1) identifying in a first Object Classification System, e.g., NAICS, two Classes of Objects, NAICS code 335211 “Coffee Makers, Household-Type Electric, Manufacturing” and NAICS code 311920 “Coffee and Tea Manufacturing”; (2) identifying in a data structure listing the relationships among objects, e.g., a product specification of a Coffee Makers specifying the type of coffee which can be processed by the Coffee Maker, a product specification of a Motor Vehicle specifying the type of motor oil which can be utilized by the Motor Vehicle, or a product specification of a Dishwasher specifying the type of Dishwasher Detergent which can be processed by the Dishwasher; and/or (3) computing the correlation of Transactions in a PUT or PUT_{S} among objects in a plurality of Classes of Objects, e.g., Coffee Makers and Coffee Beans, to determine if the correlation exceeds a predefined threshold.
(ii) a method of determining if a first Class of Objects can be a class including at least one object whose purchase must follow the purchase of an object in a second Class of Objects, e.g., the purchase of a Motor Vehicle Part following the purchase of a Motor Vehicle, where the method can include, but is not limited to, the following steps: (1) identifying in a first Object Classification System, e.g., NAICS, a plurality of Classes of Objects; (2) identifying in a system of identifying, organizing, and/or displaying and/or a data structure listing and/or displaying the relationships among objects, e.g., a product specification, the relationship between an object in a first Class of Objects and an object in a second Class of Objects; and/or (3) computing the correlation of Transactions in a PUT and/or PUT_{S} among objects in the first Class of Objects and objects in the second Class of Objects to determine if the correlation exceeds a predefined threshold. For example, Apparatus 18160C_{PUT}A can include a means of: (1) identifying in a first Object Classification System, e.g., NAICS, two Classes of Objects, NAICS code 3363 “Motor Vehicle Parts Manufacturing” and NAICS code 3361 “Motor Vehicle Manufacturing”; (2) identifying in a data structure listing the relationships among objects, e.g., a product specification of a Motor Vehicle specifying the type of motor oil which can be utilized by the Motor Vehicle; and/or (3) computing the correlation of Transactions in a PUT or PUT_{S} among objects in a plurality of Classes of Objects, e.g., Motor Vehicle Parts and Motor Vehicles, to determine if the correlation exceeds a predefined threshold.
(iii) a method of determining if a first Class of Objects can be a class including at least one object whose purchase can be associated with the purchase of at least one object in a second Class of Objects because the Classes of Objects are subclasses of a Class of Objects, e.g., the purchase of a Headlight and the purchase of a Brake where both the Headlight Class of Objects and Brake Class of Objects are subclasses of the Motor Vehicle Class of Objects, where the method can include, but is not limited to, the following steps: (1) identifying in a first Object Classification System, e.g., NAICS, a plurality of Classes of Objects which are subclasses of a Class of Objects; (2) identifying in a system of identifying, organizing, and/or displaying and/or a data structure listing and/or displaying the components constituting an object, e.g., a product specification listing the components like a motor vehicle owner's manual listing the motor vehicle components; and/or (3) computing the correlation of Transactions in a PUT or PUT_{S} among objects in the first Class of Objects and objects in the second Class of Objects to determine if the correlation exceeds a predefined threshold. For example, Apparatus 18160C_{PUT}A can include a means of: (1) identifying in a first Object Classification System, e.g., NAICS, two Classes of Objects, NAICS code 336321 “Vehicular Lighting Equipment Manufacturing” and NAICS code 336340 “Motor Vehicle Brake System Manufacturing”; (2) identifying in a product specification of a motor vehicle a list of the components constituting the motor vehicle; and/or (3) computing the correlation of Transactions in a PUT or PUT_{S} among headlights in NAICS code 336321 and brake systems in NAICS code 336340 to determine if the correlation exceeds a predefined threshold.
(iv) a method of determining if a first Class of Objects can be a class including at least one object whose purchase can be associated with the purchase of at least one object in a second Class of Objects because objects in the first Class of Objects are typically offered by Retailers in a second Class of Objects, e.g., the purchase of a container of Coffee Beans and the purchase from a Retailer selling containers of Coffee Beans, where the method can include, but is not limited to, the following steps: (1) identifying in a first Object Classification System, e.g., NAICS, a first Class of Objects; (2) identifying in the first Object Classification System or a different Object Classification System, e.g., MCC, a second Class of Objects, i.e., the class of Retailers offering the objects in the first Class of Objects; (3) parsing a data structure listing the objects offered by Retailers in the first or different Object Classification System to identify one or more objects in the first Object Classification System; and/or (4) computing the correlation of Transactions in a PUT or PUT_{S} among objects in the first Class of Objects and Retailers in the second Class of Objects to determine if the correlation exceeds a predefined threshold. For example, Apparatus 18160C_{PUT}A can include a means of: (1) identifying in a first Object Classification System, e.g., NAICS, a first Class of Objects “Coffee Beans”; (2) identifying in the first Object Classification System or different Object Classification System, e.g., MCC, a second Class of Objects, e.g., NAICS code 722213 “Snack and Non-Alcoholic Beverage Bars” or MCC code 5814 “Fast Food Restaurants” the class of Retailers offering Coffee Beans containers, which can be determined by; (3) parsing a data structure listing the objects offered by one or more Retailers in MCC code 5814 “Fast Food Restaurants”, e.g., a database listing the products sold by Starbucks® to identify the objects in the Class of Objects “Coffee Beans”, e.g., one or more exemplary; and/or (4) computing the correlation of Transactions in a PUT or PUT_{S} among containers of Coffee Beans, e.g., a Transaction of Coffee Beans with an exemplary UPC=762111600349, and Transactions from one or more Retailers selling Coffee Bean containers with an exemplary Manufacturer ID=62111 or an exemplary MID=123456789012 to determine if the correlation exceeds a predefined threshold.

Exploiting the methods and/or properties of one or more Object Classification Systems to identify and/or determine a candidate Object of Interest and/or any attributes of the Object of Interest can yield a variety of benefits, including, but not limited to: (a) enabling the more accurate and/or faster processing of objective functions by limiting the initial search space to the most likely candidate solutions; and/or (b) enabling the expansion of search spaces to candidate solutions which are related to the initial search space, e.g., candidate Objects of Interest in related Classes of Objects.

FIGS. 18D-18F depict a flowchart of an exemplary computer-implemented method, Method 18160C_{PUT}, enabling the identification and/or determining of a candidate object of interest and/or any attributes of the object of interest by analyzing prior user transactions and/or prior user sample transactions, according to one embodiment. The flowchart refers to the apparatus and structures depicted in FIG. 18C. However, the method is not limited to those embodiments. The method can implement the steps described herein utilizing a subset of the components, any combination of the components, or additional, related, alternative, and/or equivalent components depicted in FIG. 18C and/or elsewhere in the application. The method can execute a subset of the steps, any combination of the steps, the steps in different order, and/or additional, related, alternative, or equivalent steps.

The set of PUT is unlikely to include Transactions which are uncorrelated with each other and/or an Object of Interest and/or a Class of Interest in a User Request. For a typical consumer, there is likely a significant correlation along the following dimensions. First, many of the objects purchased by any user can be aggregated into Classes of Objects, e.g., a user can purchase a plurality of objects in the DVD Class of Objects like a Snow White DVD and a Mickey Mouse DVD. Second, the Transactions involving objects in a first Class of Objects can be significantly correlated with Transactions in a second or additional Class of Objects, e.g., a user purchase of an object “XYZ washer” can be significantly correlated with the user purchase of an object “XYZ dryer”. Third, the timing of Transaction of an object within a Class of Objects purchased by any user can be significantly correlated with the timing of Transaction of an object within another Class of Objects, e.g., the timing of the purchase of a first object within the Class of Objects “School Tuition” can be significantly correlated with the timing of the purchase of a second object within the Class of Objects “Textbook”. Fourth, for objects which a user can purchase repeatedly, e.g., milk or soap, the timing of a Transaction of an object a nth time can be significantly correlated with the timing of a Transaction of the object or another object in the same Class of Objects a n+1 time. Fifth, the unit price of a first object purchased by any user relative to the average unit price of an object in the Class of Objects can be significantly correlated with unit price of second or additional object purchased by the user relative to the average unit price of an object in the same Class of Objects. Sixth, the unit price of an object purchased by a user can be significantly correlated with the purchasing power of the user. Seventh, the value of one or more attributes of an Object of Interest purchased in a first Transaction can be significantly correlated with the value of one or more attributes of an Object of Interest purchased in a second or additional Transaction, e.g., an attribute “size” of the object “XYZ pants” purchased in a first Transaction can have the value “medium” which is probably the same value as the “size” attribute of the object “ABC pants” purchased in a second Transaction.

Also, P(COI|COO_{PUT}) is likely to be affected by the use of one or more words selected in the User Request. That is, the use of one or more words can increase or decrease the probability the user refers to one Class of Objects over another Class of Objects. For example, a User Request “Find the cheapest gas station selling diesel within five miles of here” includes at least one word string “within five miles”, which the invention can use to limit the set of COO_{PUT} to those Classes of Objects sold by Retailers within five miles of the location of Client Device 14200.

Also, a User Request for an Object of Interest and/or a Class of Interest can include a plurality of words where a first word can be associated with a higher probability of identifying the Object of Interest and/or Class of Interest than a second word. Classifying a word into different classes, e.g., a primary word, secondary word, tertiary word, etc., can enable the invention to ascribe different levels of importance to any given word in a User Request for any given Object of Interest or Class of Interest.

The invention can compute separately P(COI|CON_{PUT}) and P(COI|COO_{PUT}) because: (a) the larger number of Transactions in a given Class of Objects than Transactions related to a name of a specific object in a set of PUT can increase the reliability of any conditional probability of a Candidate Object of Interest; and (b) there can be Offers related to a Class of Objects instead of a specific Object of Interest, e.g., an Offer to decrease by 20% the price of any DVD.

In one embodiment of Method 18160C_{PUT}, the invention can include the following, but is not limited to the following, one or more steps.

At 18160C_{PUT}M1, Method 18160C_{PUT} can query a data structure including any data related to a user's PUT, e.g., Retailer Data Structure 33500 and/or Payment Data Structure 33700, to find any identifiers of an object purchased and/or a Retailer which executed a Transaction. These identifiers can include, but are not limited to: (a) an identifier of an object, e.g., a UPC or SKU; and/or (b) an identifier of a Retailer executing a Transaction, e.g., a MID. Identifying a Retailer executing a Transaction can enable the invention to identify the PUT because there can be objects or Classes of Objects which can be identified in a data structure by identifying the Retailer executing a Transaction. For example, an identifier of a “gas station”, e.g., its MID or the identifier of the Class of Objects “service stations” to which a Payment Association 11610 assigns a specific MID, in a Payment Data Structure 33700 can enable the invention to determine with high probability that the user purchased the object “gasoline” since gasoline is the object purchased primarily at gas stations.

18160C_{PUT} can classify the identifier associated with each Transaction in a Class of Objects or find a Class of Objects identifier associated with each Transaction. Method 18160C_{PUT} can classify the identifier in a Class of Objects through any means, including, but not limited to: (a) determining if the object identifier or Retailer identifier is associated with a Class of Objects defined by an open standard, e.g., NAICS; and/or (b) determining if the object identifier refers to an object or Retailer included in a Class of Objects defined by a proprietary standard, e.g., a classification system used by a leading Retailer or the MCC assigned by a Payment Association 11610. For example, Method 18160C_{PUT} can look up the identifier of the Class of Objects to which a Payment Association 11610 assigned a specific MID. So a first Transaction executed by Gas Station A and a second Transaction executed by Gas Station B can be assigned to a MCC code 5541 “Service Stations” or a MCC code 5542 “Automated Fuel Dispensers”.

At 18160C_{PUT}M2, Method 18160C_{PUT} can select an objective, which can include, but is not limited to: (a) identifying an Object of Interest which maximizes the probability of generating a received output, which can include, but is not limited to: (i) an acoustic waveform representing an Object of Interest in a User Request, e.g., an acoustic waveform received by Speech Recognition Module 17200; (ii) a string of alphanumeric characters representing an Object of Interest in a User Request, e.g., a character string received by Image Recognition Module 19200; (iii) a sample of handwriting, e.g., block letters or cursive writing, representing an Object of Interest in a User Request; and/or (iv) an image, still or moving, including an Object of Interest in a User Request, e.g., an image of the object received by Image Recognition Module 19200; which can lead Method 18160C_{PUT} to proceed to 18160C_{PUT}M4A; (b) determining the set of attribute-value pairs constituting an Object of Interest which maximizes the probability of a user selecting the Object of Interest, e.g., maximizing the probability that a user will select an advertisement promoting the Object of Interest or a click-through rate; which can lead Method 18160C_{PUT} to proceed to 18160C_{PUT}M4B; (c) determining the time period which maximizes the probability of a user purchasing an Object of Interest; which can lead Method 18160C_{PUT} to proceed to 18160C_{PUT}M4C; and/or (d) determining the price of an Object of Interest which maximizes the probability of a user purchasing an Object of Interest, which can lead Method 18160C_{PUT} to proceed to 18160C_{PUT}M4D.

While the application illustrates the selection of an objective and/or processing of an objective function to find an optimal solution, the invention is not limited to that embodiment. The invention can enable the selection of an objective and/or processing of an objective function to find a solution which can be suboptimal, including, but not limited to: (a) any feasible solution without considering the objective value; and/or (b) one or more local maxima or minima, which can be less optimal than a global maxima or minima.

At 18160C_{PUT}M4A, Method 18160C_{PUT} can identify through any means the set of Candidate Objects of Interest. For example, when receiving an acoustic waveform representing a User Request, Method 18160C_{PUT} can utilize Speech Recognition Module 17200 to decode the acoustic waveform to generate a plurality of hypothesized word strings representing Candidate Objects of Interest.

At 18160C_{PUT}M5A, Method 18160C_{PUT} can generate a search space of Classes of Objects which can have any significant relationship with the Candidate Objects of Interest.

In a first example, Method 18160C_{PUT} can generate the following Candidate Objects of Interest with potential audio waveforms: “Eclipse”, “A Clip”, “Ache Hip” and/or identify the associated Classes of Objects. The Candidate Object of Interest “Eclipse” can be the object “Mitsubishi Eclipse®” in the NAICS code 336211 “Motor Vehicle Body Manufacturing” Class of Objects, the object “The Twilight Saga: Eclipse” in the NAICS code 423990 “Digital Video Discs (DVDs), Prerecorded” Class of Objects, and/or the object “Wrigley Eclipse®” in the NAICS code 311340 “Nonchocolate Confectionery Manufacturing” Class of Objects. The Candidate Object of Interest “A Clip” can be an object “Paper Clip” in the NAICS code 332618 “Other Fabricated Wire Product Manufacturing” Class of Objects, or an object “News Clipping Services” in the NAICS code 519190 “All Other Information Services” Class of Objects. The Candidate Object of Interest “Ache Hip” can be an object “Artificial Hip” in the NAICS code 339112 “Surgical and Medical Instrument Manufacturing” Class of Objects.

In a second example, Method 18160C_{PUT} can determine those Classes of Objects having a significant relationship with a Candidate Object of Interest through any method described herein, including, but not limited to, Apparatus 18160C_{PUT}A Means. For example, after identifying Classes of Objects NAICS codes 336211, 423990, 311340, 332618, 519190, and 339112 that are related to the Candidate Objects of Interest, “Eclipse”, “A Clip”, “Ache Hip”, Method 18160C_{PUT} can execute Apparatus 18160C_{PUT}A Means to determine Classes of Objects related to the identified Classes of Objects, like any Class of Objects related to NAICS code 336211 “Motor Vehicle Body Manufacturing”, e.g., NAICS code 3363 “Motor Vehicle Parts Manufacturing”, any Class of Objects related to NAICS code 423990 “Digital Video Discs (DVDs), Prerecorded”, e.g., NAICS code 334310 “DVD (digital video disc) Players Manufacturing”, any Class of Objects related to NAICS code 311340 “Nonchocolate Confectionery Manufacturing”, e.g., NAICS code 722213 “Snack and Nonalcoholic Beverage Bars”.

At 18160C_{PUT}M6A, Method 18160C_{PUT} can determine the metrics of a given Class of Objects and/or one or more significant relationships among a plurality of related Classes of Objects determined at, e.g., 18160C_{PUT}M5A, as follows. Initially, Method 18160C_{PUT} can generate, collect, and/or compute one or more attributes for each Class of Objects. These Class of Objects Attributes can include, but are not limited to: (a) the number of Transactions in each Class of Objects and/or any related statistical metrics, e.g., mean, median, and/or standard deviation; (b) the unit price of the Transactions in each Class of Objects and/or any related statistical metrics; (c) the average unit price of a Class of Objects in a data structure including PUT_{S} (a reason for computing this datum is that any given user may not purchase enough units of objects in a Class of Objects for the invention to generate an estimate of the unit price which reliably reflects the average unit price of a Class of Objects); (d) the total value of Transactions in each Class of Objects and/or any related statistical metrics; (e) the timing of the Transactions in each Class of Objects and/or any related statistical metrics; (f) the location of the Transactions in each Class of Objects and/or any related statistical metrics; (g) the Retailer(s) executing the Transactions in each Class of Objects and/or any related statistical metrics; (h) the Client Device(s) 14200 executing the Transactions in each Class of Objects and/or any related statistical metrics; (i) any correlation of one or more attributes among a plurality of Classes of Objects in the set of Transactions executed by the user of Client Device 14200; and/or (j) any correlation of one or more attributes among a plurality of Classes of Objects in the set of Transactions executed by a sample of users, e.g., PUT_{S}. For example, a metric measuring the average timing of Transactions in the Class of Objects “Motor Vehicle” and the average timing of Transactions in the Class of Objects “Motor Vehicle Insurance” can have a high covariance. The purchase of a motor vehicle is typically associated with the purchase of a motor vehicle insurance policy. Method 18160C_{PUT} can compute the covariance of any attribute among a plurality of Classes of Objects. After generating, collecting, and/or computing these metrics, Method 18160C_{PUT} can compute one or more of the following steps:

(1) Method 18160C_{PUT} can compute for any set of PUT and/or PUT_{S} the probability of a Transaction related to a Candidate Object of Interest in any Class of Objects, e.g., (Transaction_{COO=i})/ΣᵢⁿTransactions_{COO(i)}, where n is the number of Classes of Objects in a PUT and/or PUT_{S}, along any dimension, including, but not limited to, unit sales, and/or value of Transactions. For example, in a set of 100 Transactions over a given time period, e.g., one year, a user can execute 10 Transactions buying an object with the name “Eclipse DVD” in the Class of Objects “DVD” with an exemplary identifier NAICS code 423990 “Digital Video Discs (DVDs), Prerecorded” and 1 Transaction buying an object with the name “Eclipse Lamp” in the Class of Objects “Lamps” with an exemplary identifier NAICS code 335110 “Electric Lamp Bulb and Part Manufacturing”. Therefore, P(DVD) or P(NAICS=423990)=10% and P(Lamp) or P(NAICS=335110)=1%.

(2) Method 18160C_{PUT} can compute for any set of PUT and/or PUT_{S} the conditional probability of a Transaction in a first Class of Objects of which a Candidate Object of Interest is a member given one or more Transactions in a second Class of Objects, where the Transaction in the first Class of Objects typically occurs concurrently, i.e., within a predefined time period, with one or more Transactions in the second Class of Objects for any reason, e.g., the object purchased in a first Class of Objects NAICS code 524126 “Automobile Insurance Carriers, Direct” or MCC code 6300 “Insurance Sales and Underwriting” typically occurs concurrently with the object purchased in a second Class of Objects NAICS code 336111 “Automobile Manufacturing” or MCC code 5511 “Automobile and Truck Dealers”, because a motor vehicle must have automobile insurance. In one embodiment, the relationship can be expressed as: P(Transaction_{COO(1)}|Transaction(s)_{COO(i≠COO(1)}), where Timing(Transaction_{COO(1)})˜Timing(Transaction(s)_{COO(i≠COO(1)}). The limitation of the Transaction in a first Class of Objects occurring concurrently with one or more Transactions in a second Class of Objects can be expressed in one embodiment as Date(Transaction_{COO(1)})−Date(Transaction_{COO(i≠COO(1)})≦d, where d is a predefined number of days and can vary for any reason, including, but not limited to, the type of Class of Objects, e.g., d can be larger for a plurality of Classes of Objects whose Transactions require more time to execute like purchasing an automobile and automobile insurance than for a plurality of Classes of Objects whose Transactions require less time to execute like peanut butter and jelly.

In an exemplary computation of step Method 18160C_{PUT}M6A(2), Method 18160C_{PUT} can compute for each Candidate Class of Objects determined at 18160C_{PUT}M5A the conditional probability P(Transaction_{COO(1)}|Transaction(s)_{COO(i≠COO(1)}) where Timing(Transaction_{COO(1)})≅Timing(Transaction(s)_{COO(i≠COO(1)}). Method 18160C_{PUT} can determine that the conditional probability is significant if it exceeds a predefined threshold.

For example, assume that the set of related Classes of Objects determined at 18160C_{PUT}M5A comprises four Classes of Objects: NAICS code 336111 “Motor Vehicle Body Manufacturing”, NAICS code 524126 “Automobile Insurance Carriers, Direct”, NAICS code 3363 “Motor Vehicle Parts Manufacturing”, and NAICS code 335110 “Electric Lamp Bulb and Part Manufacturing”. Method 18160C_{PUT} can compute for each pair of Classes of Objects the conditional probability P(Transaction_{COO(1)}|Transaction(s)_{COO(i≠COO(1)}). In a set of PUT_{S}, a sample of users can execute concurrently over a given time period, e.g., within one month, 98,602 Transactions buying an object with NAICS code 524126 and 100,000 Transactions buying an object with NAICS code 336111. Therefore, P(Transaction_{COO=336111})|Transaction(s)_{COO=524126})=P(Transaction_{COO=336111}∩Transaction_{COO=524126})/P(Transaction(s)_{COO=524126})=100%. Assume further that P(Transaction_{COO=336111})|Transaction(s)_{COO=3363})=15% and P(Transaction_{COO=336111})|Transaction(s)_{COO=335110})=2%. If the predefined threshold for is 50%, then Method 18160C_{PUT} can determine that P(Transaction_{COO=336111})|Transaction(s)_{COO=524126}) is significant.

After determining which P(Transaction_{COO(1)}|Transaction(s)_{COO(i≠COO(1)}) is significant in a set of related Classes of Objects, Method 18160C_{PUT} can compute for each Candidate Object of Interest in a set of PUT for the user transmitting a User Request the conditional probability of a Candidate Object of Interest given the inclusion of one or more Transactions of an object in a related Class of Objects, which can be expressed as:

P(Candidate Object of Interest_{COIεCOO(1)}|Transaction(s)_{COO(2)}), where Time(Transaction_{COO(1)})≈Time(Transaction(s)_{COO(2)}) and P(Transaction_{COO(1)}|Transaction(s)_{COO(2)}) is significant Equation (3)

Method 18160C_{PUT} can compute the conditional probability through any means, including, but not limited to: (a) computing a conditional probability which is a continuous value by setting the conditional probability if there exists one or more Transactions in the second Class of Objects in a PUT equal to, e.g., P(Transaction_{COO(1)}|Transaction(s)_{COO(2)}) in a PUT_{S}; or (b) computing a conditional probability which is a discrete value by setting the conditional probability equal to, e.g.:

$$P ( x ) = \{ \begin{matrix}1 , & ∃ \geq 1 Transaction ε C O O ( 2 ) \\ 0 , & Otherwise ,\end{matrix}$$

where

P(x)=P(Candidate Object of Interest_{COIεCOI(1)}|Transaction(s)_{COO(2)}) Equation (4)

By generating either of two discrete values depending on whether there exists at least one Transaction in a second Class of Objects, Equation (4) can simplify the method of computing P(COI). Particularly for Classes of Objects with higher unit prices, the purchase by a user of a single object in the Class of Objects can increase the probability the user means a word string related to the Class of Objects.

In the present example, the identification of one or more Transactions in Class of Objects

NAICS code 524126 “Automobile Insurance Carriers, Direct” in a set of PUT leads Method 18160C_{PUT} to compute P(Candidate Object of Interest_{COIεCOO=336111}|Transaction(s)_{COO=524126}) to equal 100% if computing a continuous value or 1 if computing a discrete value. In the present example, the existence of a significant concurrent relationship in a PUT_{S} between Transactions in the Class of Objects “Motor Vehicle Body Manufacturing” and Transactions in the Class of Objects “Automobile Insurance Carriers, Direct” suggests that the existence of a Transaction in the Class of Objects “Automobile Insurance Carriers, Direct” in a PUT of the user transmitting a User Request including a Candidate Object of Interest “Eclipse” means the word string “Eclipse” probably refers to a motor vehicle manufactured by Mitsubishi. In other words, the user buying an automobile insurance policy within the last month means he/she probably means Eclipse is a motor vehicle.

(3) Method 18160C_{PUT} can compute for any set of PUT and/or PUT_{S} the conditional probability of a Candidate Object of Interest being a member of a first Class of Objects given one or more Transactions in a second Class of Objects, where the Transaction in the first Class of Objects typically occurs after—and not concurrently with—one or more Transactions in the second Class of Objects for any reason. In one embodiment, the conditional probability can be expressed as:

P(Candidate Object of Interest_{COIεCOO(1)}|Transaction(s)_{COO(2)}), where Time(Transaction_{COO(1)})>Time(Transaction(s)_{COO(2)}) and P(Transaction_{COO(1)}|Transaction(s)_{COO(2)}) is significant Equation (5)

For example, a user can purchase an automobile part for a given automobile model typically after the user purchases the automobile model. Method 18160C_{PUT} can execute the same type of methods to compute the conditional probability in Method 18160C_{PUT}M6A(3) as those used to compute the conditional probability in Method 18160C_{PUT}M6A(2).

(4) Method 18160C_{PUT} can compute for any set of PUT and/or PUT_{S} the conditional probability of a Candidate Object of Interest being a member of a first Class of Objects given the timing of: (a) one or more Transactions in a second Class of Objects; and/or (b) any event related to Transactions in the first Class of Objects (“Event”). An Event can be any event whose timing is correlated with Transactions in a Class of Objects. For example, purchases of textbooks can be highly correlated with the beginning of a college semester or purchases of flowers can be highly correlated with the date, Mother's Day. In a first embodiment, the conditional probability can be expressed as:

P(x)=P(Candidate Object of Interest_{COIεCOO(1)}|Transaction(s)_{COO(2)}), where P(x) ∝ Time(Transaction(s)_{COO(2)}) and P(Transaction_{COO(1)}|Transaction(s)_{COO(2)}) is significant Equation (6)

In a second embodiment, the conditional probability can be expressed as:

P(x)=P(Candidate Object of Interest_{COIεCOO(1)}|Transaction(s)_{CCO(1)}∝_{EVENT}), where Transaction(s) in the first Class of Objects∝Time(Event) Equation (7)

In a set of PUT_{S} over a given time period, e.g., one year, a sample of users can execute Transactions in a first Class of Objects given the timing of Transactions in a second Class of Objects or the timing of an Event according to an exemplary time schedule (“Time Decay Schedule”). Method 18160C_{PUT} can estimate the dampening effect of time or generate a Time Decay Schedule through a variety of means, including, but not limited to, the following. First, Method 18160C_{PUT} can parse a data structure, e.g., Retailer Data Structure 33500 and/or Payment Data Structure 33700, to generate a table comparing the timing of Transactions in a first Class of Objects given the timing of Transactions in a second Class of Objects or the timing of an Event, e.g., classifying the timing of Transactions in the “Textbook” Class of Objects by week before or after an Event like the beginning of a college semester. For example, a table can show that over a given four-month period 50% of Transactions purchasing a textbook occur in the first week after the beginning of a college semester, 25% occur in the second week, 15% occur in the third week, 8% occur in the fourth week, and 2% occur in the fifth and remaining weeks. Second, Method 18160C_{PUT} can use any method to construct a function that is a best fit solution to a set of data, e.g., the timing of Transactions in a first Class of Objects given the timing of Transactions in a second Class of Objects or the timing of an Event.

Method 18160C_{PUT} can execute the same type of methods to compute the conditional probability in Method 18160C_{PUT}M6A(4) as those used to compute the conditional probability in Method 18160C_{PUT}M6A(2).

(5) Method 18160C_{PUT} can compute for any set of PUT and/or PUT_{S} the conditional probability of a Candidate Object of Interest being a member of a first Class of Objects given one or more prior Transactions in the same Class of Objects. In one embodiment, the conditional probability can be expressed as:

P(Candidate Object of Interest_{COIεCOO(1)}|Transaction(s)_{COO(1)}), Equation (8)

In a first example, a user can request an object “Starbucks® coffee beans” in a first Class of Objects UPC Manufacturer ID assigned to Starbucks®, given one or more prior Transactions in the same Class of Objects. Method 18160C_{PUT} can apply any method of estimating the dampening effect of a prior Transaction related to time.

In a second example, in a set of PUT over a given time period, e.g., one year, a user can execute 12 Transactions buying an object in the Class of Objects “Vitamins, uncompounded, manufacturing” with an exemplary identifier NAICS code 325411 “Medicinal and Botanical Manufacturing”. The larger the number of PUT and/or PUT_{S} in a Class of Objects ceteris paribus, the more reliable the estimate of P(Candidate Object of Interest_{COIεCOO(1)}|Transaction(s)_{COO(1)}). Method 18160C_{PUT} can apply any method, e.g., the set enumeration method or any other method, to estimate P(Candidate Object of Interest_{COIεCOO(1)}|Transaction(s)_{COO(1)}) for any object or Class of Objects for which the frequency of Transactions follows a non-periodic function. Method 18160C_{PUT} can apply any method to estimate P(Candidate Object of Interest_{COIεCOO(1)}|Transaction(s)_{COO(1)}) for any object or Class of Objects for which the frequency of Transactions follows a periodic function. In the present example, Method 18160C_{PUT} can compute for a set of 12 Transactions (e.g., where some number of Transactions occurred on the 1^{st} of each month, another number of Transactions occurred on the 8^{th} of each month, and the remaining number of Transactions occurred on the 23^{rd} of each month) the conditional probability of purchasing an object in the Class of Objects “Vitamins” with the given frequency of Transactions.

Method 18160C_{PUT} can execute the same type of methods to compute the conditional probability in Method 18160C_{PUT}M6A(5) as those used to compute the conditional probability in Method 18160C_{PUT}M6A(2).

(6) Method 18160C_{PUT} can compute for any set of PUT and/or PUT_{S} the conditional probability of a Candidate Object of Interest being a member of a first Class of Objects given one or more Transactions at a Class of Retailers. In one embodiment, the conditional probability can be expressed as:

P(Candidate Object of Interest_{COIεCOO(1)}|Transaction(s)_{MCC(i)}), where P(Transaction_{COO(1)}|Transaction(s)_{MCC(i)}) is significant Equation (9)

For example, a user can purchase objects offered by a retailer, which can be classified as a Class of Retailers utilizing any Object Classification System, e.g., MCC. Method 18160C_{PUT} can execute the same type of methods to compute the conditional probability in Method 18160C_{PUT}M6A(6) as those used to compute the conditional probability in Method 18160C_{PUT}M6A(2).

(7) Method 18160C_{PUT} can compute for any set of PUT and/or PUT_{S} the conditional probability of a Candidate Object of Interest being a member of a first Class of Objects which is a subclass of Superclass A given one or more Transactions in a second Class of Objects which is also a subclass of Superclass A. In one embodiment, the conditional probability can be expressed as:

P(Candidate Object of Interest_{COIεCOO(1)}|Transaction(s)_{COO(2)}), where COO₁ε COOᵢ and COO₂ε COOᵢ and P(Transaction_{COO(1)}|Transaction(s)_{COO(2)}) is significant Equation (10)

For example, a user can purchase an object “Soup A” in a first Class of Objects NAICS code 311422 “Specialty Canning” which is a subclass of Superclass NAICS code 31142 “Fruit and Vegetable Canning, Pickling, and Drying” given one or more Transactions in a second Class of Objects NAICS code 311423 “Soup Mixes Made in a Dehydration Plant” which is also a subclass of Superclass NAICS code 31142. Method 18160C_{PUT} can execute the same type of methods to compute the conditional probability in Method 18160C_{PUT}M6A(7) as those used to compute the conditional probability in Method 18160C_{PUT}M6A(2).

(8) Method 18160C_{PUT} can compute for any set of PUT and/or PUT_{S} the conditional probability of a Candidate Class of Interest or Candidate Vendor of Interest being a first Class of Objects given one or more Transactions in a second Class of Objects which is a subclass of the first Class of Objects. In a first embodiment, the conditional probability can be expressed as:

P(Candidate Class of Interest_{COI=COO(1)}|Transaction(s)_{COO(2)}), where COO₂ε COO₁ and P(Transaction_{COO(1)}|Transaction(s)_{COO(2)}) is significant Equation (11)

For example, a user can request “Find the soup with the lowest price, x attribute, and y attribute” where the group of NAICS codes 311412, 311422, 311423, 311711, and/or 311712 constitute a first Class of Objects comprising most or all soup objects, given one or more Transactions in a second Class of Objects NAICS code 311423 “Soup Mixes Made in a Dehydration Plant” which is a subclass of the group of NAICS codes constituting soup objects.

In a second embodiment, the conditional probability can be expressed as:

P(Candidate Vendor of Interest_{VOI ε COO(1)}|Transaction(s)_{COO(1)}), where COO₁=Set of Product IDs in Manufacturer ID class in the UPC Object Classification System, Equation (12)

For example, a user can request “Buy Starbucks® coffee beans”. The existence in the user PUT of one or more Transactions with a Product ID which is an element of the set of Manufacturer ID assigned to Starbucks® can increase the probability the user means the word string “Starbucks®” and not the word string “star struck”.

Method 18160C_{PUT} can execute the same type of methods to compute the conditional probability in Method 18160C_{PUT}M6A(8) as those used to compute the conditional probability in Method 18160C_{PUT}M6A(2).

(9) Method 18160C_{PUT} can compute for any set of PUT and/or PUT_{S} the conditional probability of a Candidate Object of Interest being a member of a first Class of Objects given the probability density function (“PDF”) of the unit prices of objects purchased in the same or other related Classes of Objects. In one embodiment, the conditional probability can be expressed as:

P(Candidate Object of Interest_{COIεCOO(1)}|PDF(TransactionUnitPrice_{COO(i)})) Equation (13)

For example, in a set of PUT over a given time period, a user can execute n number of Transactions in a Class of Objectsᵢ, like “Hotel” where the identifier, e.g., the MCC, can equal any value between 3501 and 3780. Suppose that, for the P(unitPrice_{COO=HOTEL}), P[a≦UnitPrice≦b]=90% where a=$75/night and b=$125/night. Therefore, the probability in the set of PUT in the “Hotel” Class of Objects that the average UnitPrice_{HOTEL(XYZ)} equals $300/night can equal less than 10%. If any method described herein generates a Candidate Object of Interest with the name “Hotel XYZ”, the P(COI==“Hotel XYZ”|P(PDF(TransactionUnitPrice_{COO=HOTEL}) can equal less than 10%. Method 18160C_{PUT} can execute the same type of methods to compute the conditional probability in Method 18160C_{PUT}M6A(9) as those used to compute the conditional probability in Method 18160C_{PUT}M6A(2).

(10) Method 18160C_{PUT} can compute for any set of PUT and/or PUT_{S} the conditional probability of a Candidate Object of Interest being a member of a first Class of Objects given the conditional PDF of the unit prices of objects purchased in a Class of Objects given the purchasing power of the user. In one embodiment, the conditional probability can be expressed as:

P(Candidate Object of Interest_{COIεCOOm(1)}|ConditionalPDF(TransactionUnitPrice_{COO(i)}) given User Purchasing Power) Equation (14)

Method 18160C_{PUT} can use any metric to estimate the Purchasing Power of the user, including, but not limited to, the credit available on any Payment Method, the value of one or more Payment Accounts, and/or the income of the user over any given time period. For example, in a set of PUT_{S} over a given time period, a sample of users can execute 100,000 Transactions buying an object in the Class of Objects “Motor Vehicle” with an exemplary identifier NAICS code 336211 “Motor Vehicle Body Manufacturing”, where the set of unit prices (UP) for each of the 100,000 Transactions equals T, or UPεT. In the same set of PUT_{S}, the set of Purchasing Power (PP) of the users equals S, or PPεS, and the set of unit prices for any given set of users with a given Purchasing Power equals R. Then, in one embodiment, the conditional PDF of UP given PP=PP_{USER} can be expressed as:

P(UPεR|PP=PP_{USER})=∫_{R}(PDF(UP|PP)*dUP,PPεS Equation (15)

Method 18160C_{PUT} can execute the same type of methods to compute the conditional probability in Method 18160C_{PUT}M6A(10) as those used to compute the conditional probability in Method 18160C_{PUT}M6A(2).

(11) Method 18160C_{PUT} can compute for any set of PUT and/or PUT_{S} the conditional probability of a Candidate Object of Interest having a value of one or more attributes given the value of the one or more attributes in a plurality of Transactions of the same and/or different Objects of Interest. In one embodiment, the conditional probability can be expressed as:

P(Candidate Object of interest_{ATTRIBUTE)=X}|Attribute(s)_{VALUE=X for OOI(1,2,3, . . . n)}), where n is the number of Objects of Interest in a set of PUT which have similar values of one or more attributes of the Candidate Object of Interest Equation (16)

The value of one or more attributes of an Object of Interest purchased in a first Transaction can be significantly correlated with the value of the one or more attributes of the same and/or different Object of Interest purchased in a second or additional Transaction. In a first example, the attribute “Size” of the object “XYZ pants” purchased in a first Transaction can have the value “Medium”, which is probably the same value as the “Size” attribute of the object “ABC pants” purchased in a second Transaction. In a second example, the attribute “Sodium Content” of the object “XYZ Soup” purchased in Transactions in the “Soup” Class of Objects can have the value “Low≦140 mg”, which is probably the same value as the “Sodium Content” of the object “XYZ Chips” purchased in Transactions in the “Snack Food” Class of Objects. Knowing the common attribute values of objects across Classes of Objects can reduce the search space of Candidate Objects of Interest, Candidate Classes of Interest, and/or Candidate Classes of Objects. For example, a significant correlation of the value “Low≦140 mg” for the attribute “Sodium Content” across a plurality of Classes of Objects in a PUT data structure can reduce the probability that a user is transmitting a User Request related to an Object of Interest with high “Sodium Content”.

In one embodiment, the correlation among values in attribute-value pairs for any given attribute in a set of PUT and/or PUT_{S} can be expressed as follows:

ρ_{V1,V2}=Corr(V1,V2)=[cov(V1,V2)]/[σ_{V1}*σ_{V2}]=E[(V1−μ_{V1})*(V2−μ_{V2})]/[σ_{V1}*σ_{V2}] Equation (17)

where V1 is the value of an attribute of among objects purchased in a first Class of Objects, V2 is the value of the attribute of objects purchased in a second or additional Class of Objects, σ_{V1} and σ_{V2} are the standard deviations of V1 and V2, respectively, and μ_{V1} and μ_{V2} are the expected values of V1 and V2, respectively.

While the application illustrates the computation of the correlation of attribute-value pairs in Equation (17), the invention is not limited to that embodiment. The invention can enable the computation of the attribute-value pair correlation through a variety of means, including, but not limited to: (a) any other method of computing a correlation even if the relationship is not linear; and/or (b) other methods of computing a correlation among more than two random variables, e.g., through the computation of a correlation matrix of n random variables V1, V2, . . . V_{N}.

Method 18160C_{PUT} can execute the same type of methods to compute the conditional probability in Method 18160C_{PUT}M6A(11) as those used to compute the conditional probability in Method 18160C_{PUT}M6A(2).

At 18160C_{PUT}M7A, Method 18160C_{PUT} can generate an equation specifying the P(COI) as a function of any data, e.g., PUT and/or PUT_{S}, one or more relationships among a plurality of Classes of Objects in PUT and/or PUT_{S}, and/or any other factors, including, but not limited to: (a) any other factors related to PUT and/or PUT_{S}; and/or (b) any factors not directly related to PUT and/or PUT_{S}, including, but not limited to: (i) the UI; (ii) the UL; and/or (iii) the UD attributes. In one embodiment, P(COI) can be expressed as follows:

P(Candidate Object of Interest)=((# of Transactions_{COI}/Σᵢⁿ of Transactions_{COO=i})*W₁)+(P(Candidate Object of Interest_{COIεCOO(1)}|Transaction(s)_{COO(2)})*W₂)+(P(Candidate Object of Interest_{COIεCOO(1)}|Transaction(s)_{COO(2)})*W₃)+(P(Candidate Object of Interest_{COIεCOO(1)}|Transaction(s)_{COO(2)})*W₄)+(P(Candidate Object of Interest_{COI εCOO(1)}|Transaction(s)_{COO(2)})*W₅)+(P(Candidate Object of Interest_{COIεCOO(1)}|Transaction(s)_{CCO(1)}∝_{EVENT})*W₆)+(P(Candidate Object of Interest_{COIεCII(1)}|Transaction(s)_{COO(1)})*W₇)+(P(Candidate Object of Interest_{COIεCOO(1)}|Transaction(s)_{MCC(i)})*W₈)+(P(Candidate Class of Interest_{COI=COO(1)}|Transaction(s)_{COO(2)})*W₉)+(P(Candidate Vendor of Interest_{VOIεCOO(1)}|Transaction(s)_{COO(1)})*W₁₀)+(P(Candidate Object of Interest_{COIεCOO(1)}|PDF(TransactionUnitPrice_{COO(i)}))*W₁₁)+(P(Candidate Object of Interest_{COIεCOO(1)}|ConditionalPDF(TransactionUnitPrice_{COO(i)})*W₁₂)+(P(Candidate Object of Interest_{ATTRIBUTE)=X|Attribute(s)}_{VALUE=X for OOI(1,2,3, . . . n)})*W₁₃) Equation (18)

where:

n is the number of Classes of Objects in the data structure storing PUT;

P(Candidate Object of Interest_{COIεCOO(1)}|Transaction(s)_{COO(2)}), where Time(Transaction_{COO(1)})≅Time(Transaction(s)_{COO(2)}) and the conditional probability associated with W₂ can be computed in one embodiment in accordance with Equation (3);

P(Candidate Object of Interest_{COIεCOO(1)}|Transaction(s)_{COO(2)}), where Time(Transaction_{COO(1)})>Time(Transaction(s)_{COO(2)}) and the conditional probability associated with W₃ can be computed in one embodiment in accordance with Equation (5);

P(Candidate Object of Interest_{COIεCOO(1)}|Transaction(s)_{COO(2)}), where P(x)∝Time(Transaction(s)_{COO(2)}) and the conditional probability associated with W₄ can be computed in one embodiment in accordance with Equation (6);

P(Candidate Object of Interest_{COIεCOO(1)}|Transaction(s)_{CCO(1)}∝_{EVENT}), where Transaction(s) in the first Class of Objects∝Time(Event) and the conditional probability associated with W₅ can be computed in one embodiment in accordance with Equation (7);

P(Candidate Object of Interest_{COIεCOO(1)}|Transaction(s)_{COO(1)}), where the conditional probability associated with W₆ can be computed in one embodiment in accordance with Equation (8);

P(Candidate Object of Interest_{COIεCOO(1)}|Transaction(s)_{MCC(i)}), where the conditional probability associated with W₇ can be computed in one embodiment in accordance with Equation (9);

P(Candidate Object of Interest_{COIεCOO(1)}|Transaction(s)_{COO(2)}), where COO₁εCOOᵢ and COO₂εCOOᵢ and the conditional probability associated with W₈ can be computed in accordance with Equation (10);

P(Candidate Class of Interest_{COI=COO(1)}|Transaction(s)_{COO(2)}), where COO₂εCOO₁ and the conditional probability associated with W₉ can be computed in accordance with Equation (11);

P(Candidate Vendor of Interest_{COIεCOO(1)}|Transaction(s)_{COO(1)}), where COO₁=Set of Product IDs in the class of Manufacturer ID in the UPC Object Classification System and the conditional probability associated with W₁₀ can be computed in accordance with Equation (12);

P(Candidate Object of Interest_{COIεCOO(1)}|PDF(TransactionUnitPrice_{COO(i)})) and the conditional probability associated with W₁₁ can be computed in accordance with Equation (13);

P(Candidate Object of Interest_{COIεCOO(1)}|ConditionalPDF(TransactionUnitPrice_{COO(i)}) and the conditional probability associated with W₁₁ can be computed in accordance with Equation (14);

P(Candidate Object of Interest_{ATTRIBUTE)=X}|Attribute(s)_{VALUE=X for OOI(1,2,3, . . . n)}) and the conditional probability associated with W₁₁ can be computed in accordance with Equation (16);

and Wᵢ is the weight assigned by Method 18160C_{PUT} to each Candidate Object of Interest conditional probability.

While the application illustrates the computation of P(COI) in Equation (18), the invention is not limited to that embodiment. While Equation (18) specifies a particular sum of products of the terms, the invention is not limited to that embodiment. The invention can generate a score and/or rank for each Candidate Object of Interest through any means or formulae including some, all, additional, different, related, and/or equivalent terms in any combination.

At 18160C_{PUT}M8A, Method 18160C_{PUT} can limit the search space for one or more of the factors in Equation (18) in a first iteration of Method 18160C_{PUT} to those related to the initial set of Classes of Objects generated in 18160C_{PUT}M5A. If Method 18160C_{PUT} can generate a satisfactory solution, e.g., a Candidate Object of Interest whose score exceeds a predefined threshold at 18160C_{PUT}M12, the method can terminate. If Method 18160C_{PUT} does not generate a satisfactory solution and executes a second or subsequent iteration, then Method 18160C_{PUT} can expand the search space for one or more factors to those data, factors, and/or attributes related to an expanded set of Classes of Objects.

At 18160C_{PUT}M9A, Method 18160C_{PUT} can compute a score and/or rank for each Candidate Object of Interest.

At 18160C_{PUT}M12, Method 18160C_{PUT} can compare each score against a predefined threshold.

At 18160C_{PUT}M13A, if the score exceeds the predefined threshold, Method 18160C_{PUT} can select as the most probably Object of Interest the Candidate Object of Interest or select the highest scoring and/or ranking Candidate Object of Interest regardless of whether the score exceeds the predefined threshold.

At 18160C_{PUT}M13B, if the score does not exceed the predefined threshold, Method 18160C_{PUT} can execute a second or subsequent iteration by expanding the data, factors, and/or attributes evaluated to those related to an expanded set of Classes of Objects, data types, and/or any other factor. Method 18160C_{PUT} can expand the search space through a variety of means, including, but not limited to, the following. First, selecting the search space in 18160C_{PUT}M5A to include the initial set of Classes of Objects and those Classes of Objects one or more degrees of separation from each Class of Objects in the initial set, e.g., limiting the initial set of Classes of Objects in Method 18160C_{PUT}M6A(2), to NAICS code 524126 “Automobile Insurance Carriers, Direct”, can limit the search space to those Transactions related to vendors classified in NAICS as a direct automobile insurance carrier. However, a Transaction of another type of insurance policy, e.g., a life insurance policy, offered by a vendor also offering an automobile insurance policy could have led the user to transmit a User Request including a word string related to a motor vehicle. Method 18160C_{PUT} can expand the search space by including Transactions related to other Classes of Objects, e.g., in the same NAICS code 524126 or in the superclass NAICS code 52412. Also, the Object Classification System could have made errors in classifying objects or be over-inclusive or under-inclusive in assigning objects to a given class. Second, adding new factors or subtracting existing factors in Equation (18) can expend the search space.

At 18160C_{PUT}M14B, Method 18160C_{PUT} can go to 18160C_{PUT}M9A.

While the application illustrates Method 18160C_{PUT} as computing P(COI) in Equation (18), the invention is not limited to that embodiment. The invention can enable different embodiments of Method 18160C_{PUT} to compute P(CCI) and/or any attribute related to an Object of Interest and/or Class of Interest.

While the application illustrates the execution of Method 18160C_{PUT} to generate a set of COO_{PUT}, compute P(COI), and/or compute P(CCO) to increase the probability of recognizing an Object of Interest and/or a Class of Interest in a User Request, the invention is not limited to that embodiment. The invention can execute Method 18160C_{PUT} to achieve any objective, including, but not limited to: (a) recognizing any word string transmitted by a user even if it is not part of a User Request; (b) identifying a Candidate Object of Interest and/or Candidate Class of Interest even if it is not part of a User Request, e.g., when determining which object or class for which an entity can transmit to the user an Offer without a User Request, which can be executed in one embodiment starting at 18160C_{PUT}M4B; (c) determining the timing, placement, and/or any other attribute of an Offer which can increase the probability a user will respond to the Offer, which can be executed in one embodiment starting at 18160C_{PUT}M4C; and/or (d) determining the price of an object and/or value of an Offer which can increase the probability a user will buy the object and/or respond to the Offer, respectively, which can be executed in one embodiment starting at 18160C_{PUT}M4D. Method 18160C_{PUT} can execute the same type of methods to compute the conditional probability in starting at 18160C_{PUT}M4B, 18160C_{PUT}M4C, 18160C_{PUT}M4D, and/or any other step as those used to compute the conditional probabilities in 18160C_{PUT}M6A. Method 18160C_{PUT} can analyze a PUT and/or PUT_{S} to increase the probability of identifying and/or determining what a user will buy, when he/she will want to buy it, at what price he/she will be likely to buy it, where he/she will buy it, and/or any other attribute of an object and/or Class of Objects.

Method 18000 can compute P(COI|UIᵢ) through any means, including, but not limited to: (a) executing the following steps, including, but not limited to: (i) identifying the set of User Interests; (ii) generating a vocabulary of word strings associated with each interest, e.g., if an interest is “golf”, candidate word strings can include “club” or “course”; (iii) comparing the recognized word string against the data structure including word strings associated with each interest; and/or (iv) computing the conditional probability by executing the set enumeration method or any other method.

Method 18000 can compute P(COI|ULᵢ) through any means, including, but not limited to: (a) executing the following steps, including, but not limited to: (i) identifying the User Location; (ii) generating a vocabulary of word strings associated with the identified User Location, e.g., if the User Location is a set of geographical coordinates in which there is one “XYZ Golf Store” and one “XYZ Movie Theater”, including in the vocabulary the word strings “XYZ Golf Store” and “XYZ Movie Theater”; (iii) comparing the recognized word string against the data structure including word strings associated with the User Location; and/or (iv) computing the conditional probability by executing the set enumeration method or any other method.

Method 18000 can compute P(COI|UDᵢ) through any means, including, but not limited to: (a) executing the following steps, including, but not limited to: (i) identifying the set of User Demographic attributes; (ii) generating a vocabulary of word strings associated with each attribute, e.g., if an attribute is “homeowner”, candidate word strings can include “homeowner insurance” or “mortgage refinancing”; (iii) comparing the recognized word string against the data structure including word strings associated with each attribute; and/or (iv) computing the conditional probability by executing the set enumeration method or any other method.

At 18180C, Method 18000 can transmit to Vocabulary V the set of candidate word strings identified at 18160C.

Method 18000 can enable the transformation of a physical and tangible object, i.e., a signal received from a first device, e.g., Device 11100, and/or an input received from a user, e.g., speech, into a different state, e.g., display of data on the first device or a second device related to the signal or any other object. Any signal transmitted by a first device, e.g., Device 11100, can have a specific function or use. For example, TV 02100, can transmit an audio signal carrying speech, music, and/or any other type of audio as part of the Content displayed or any EMF whose processing can identify the source device or the Content displayed. Method 18000 can transform the signal into something new with a different function or use. For example, Method 18000 can: (a) receive the audio signal; (b) receive speech from a user related to an Object of Interest associated with the current audio signal or a prior audio signal; (c) process the audio signal, the speech, and/or a combination thereof to identify the source device or the Content displayed; (d) identify the likely Object of Interest; and/or (e) display on the first device or second device one or more Offers related to the Object of Interest.

The application illustrates the transformation of a physical and tangible object received from a first device, e.g., Device 11100, and/or an input received from a user, e.g., speech, into a different state, e.g., display on the first device or a second device of data related to the signal or any other object. However, the invention is not limited to that embodiment. The invention can transform a physical or tangible object received from any device or apparatus described herein. For example, the invention can transform an image displayed on a print publication and captured by Image Transceiver 11540 into a different state utilizing any methods described herein. Also, the invention can transform a physical or tangible object received from any device or apparatus described herein into any different type of state. Not only can the invention transform the physical or tangible object into a state, i.e., data related to the signal or any other object which is displayed on the first device or a second device, the invention can transform the object into any different type of state, which can include, but is not limited to: (a) a purchase of an Object of Interest; (b) a paper-based coupon; (c) the value of an Offer stored in a Retailer Server 11620, which can be redeemed at a PHY POS 11920; and/or (d) the value of an Offer stored in a WD 02202, which can be redeemed at a PHY POS 11920.

In example (a), the invention can transform: (i) a signal received from a first device, e.g., an audio signal from TV 02100, and/or an input from a user, e.g., a request “Buy XYZ object” in the form of speech; into (ii) data representing the object XYZ and instructions for executing the purchase of XYZ object; and (iii) automatic purchase of object XYZ at Retailer Server 11620 or Web Server 11910.

In example (b), the invention can transform: (i) a signal received from a first device, e.g., an audio signal from TV 02100, and/or an input from a user, e.g., a request “Print XYZ coupon” in the form of speech; into (ii) data representing the coupon and instructions for printing the coupon; and (iii) automatic printing by Printer 11810 of a paper-based coupon 11820.

In example (c), the invention can transform: (i) a signal received from a first device, e.g., an audio signal from TV 02100, and/or an input from a user, e.g., a request “Get XYZ coupon” in the form of speech; into (ii) data representing the coupon and instructions for transmitting to and storing at Retailer Server 11620; and (iii) automatic redemption of the coupon at the purchase of object XYZ at PHY POS 11920.

In example (d), the invention can transform: (i) a signal received from a first device, e.g., an audio signal from TV 02100, and/or an input from a user, e.g., a request “Get XYZ coupon” in the form of speech; into (ii) data representing the coupon and instructions for transmitting to any storage in WD 02202, e.g., NFC Module 11574; and (iii) automatic redemption of the coupon at the purchase of object XYZ at PHY POS 11920.

While the application illustrates Method 18000 processing user speech and/or ambient audio, the invention is not limited to that embodiment. The invention can process a User Request received with or without any ambient audio. The invention can process a User Request received in any form, including, but not limited to: (a) speech; (b) text, e.g., text included in a text message, an instant message, a search query, an email, or a file like a shopping list; (c) handwriting; (d) image; and/or (e) multimedia, e.g., a multimedia message.

In example (b), the invention can at 18100 receive a signal carrying Messaging Data 11572A in, e.g., a text message, in addition to or in lieu of Speech 11512 as well as any other data which can be utilized to recognize a User Request, e.g., Ambient Audio 11514. Method 18000 can process Ambient Audio 11514 from 18120 through 18220B1/18200B2. Method 18000 can process any User Data from 18140C through 18180C. Method 18000 can at 18120 utilize any method to separate Messaging Data 11572A from other data, e.g., Ambient Audio 11514 and/or User Data. At 18140A, instead of executing acoustic model matching of the observed acoustic data reflecting the user speech signal, Method 18000 can utilize any method to execute a model matching the observed text data reflecting Messaging Data 11572A. At 18160A, Method 18000 can apply any method to decode the HMM, i.e., identify a plurality of potential text data maximizing p(O|W). For example, Messaging Data 11572A can include a word string, “Buy movieng ticket”. The word “movieng” can be a misspelling of the word “movie” or “moving”. Method 18000 can apply any method to decode the HMM as well as utilize any data processed from Ambient Audio 11514, User Data, or any other data to determine if the user intended to buy a “movie ticket” or a “moving ticket”.

In the case where a user of a Client Device 11200, e.g., WD 02202, is viewing Content displayed on a media device, e.g., TV 02100, while speaking a User Request, identifying the Content displayed on the media device can increase the probability of recognizing the User Request. To the extent a user speaks a User Request for an Object of Interest related to Content displayed, identifying the displayed Content can narrow the search space for Candidate Objects of Interest to the objects displayed during the media program currently displayed, one or more media programs previously displayed on the same logical and/or physical channel, and/or one or more media programs previously displayed on logical and/or physical channels previously viewed by the user (“Candidate Media Programs”). The invention can utilize any apparatuses, methods, and/or CPPs to identify the Candidate Media Programs, e.g., those described in U.S. patent application Ser. No. 12/107,649, “Methods and Apparatus Related to Content Sharing Between Devices”.

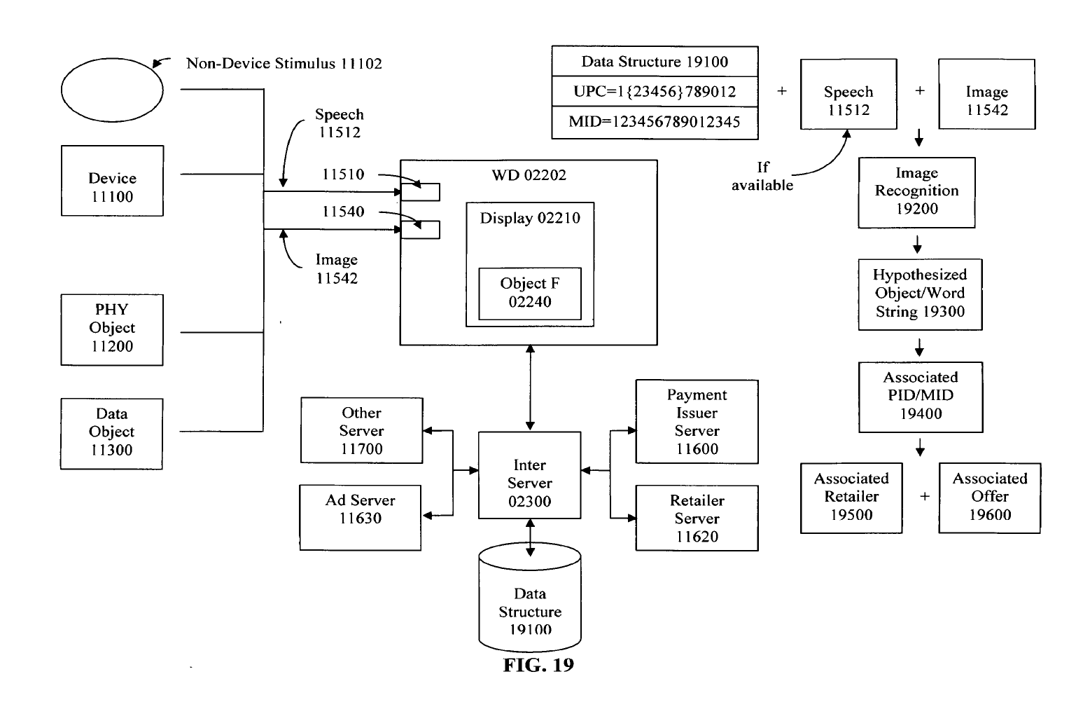

FIG. 19 depicts a block diagram of an exemplary apparatus, Apparatus 19000, enabling the identification of an image, still or moving, of an object of interest, according to one embodiment.

Apparatus 19000 can comprise: (a) a memory, e.g., Memory 01120; (b) a processor, e.g., Processor 01040; and/or (c) a module, e.g., Object ID Engine 33310, stored in the memory and executable on the processor which can: (i) recognize an image input utilizing any CPP, e.g., Image Recognition Module 19200, which can recognize any data type, including, but not limited to: (1) an alphanumeric character string; (2) an object, e.g., a picture of the object in a still image; and/or (3) an object, e.g., a picture of the object in a frame of a moving image; (ii) generate a set of candidate word strings based on identifying the image and/or analyzing User Data; and/or (iii) recognize a speech input and identify one or more Objects of Interest and/or one or more Classes of Interest. In another embodiment, Apparatus 19000 can comprise one or more of the above components located in another Data Processing System, e.g., Inter Server 02300.

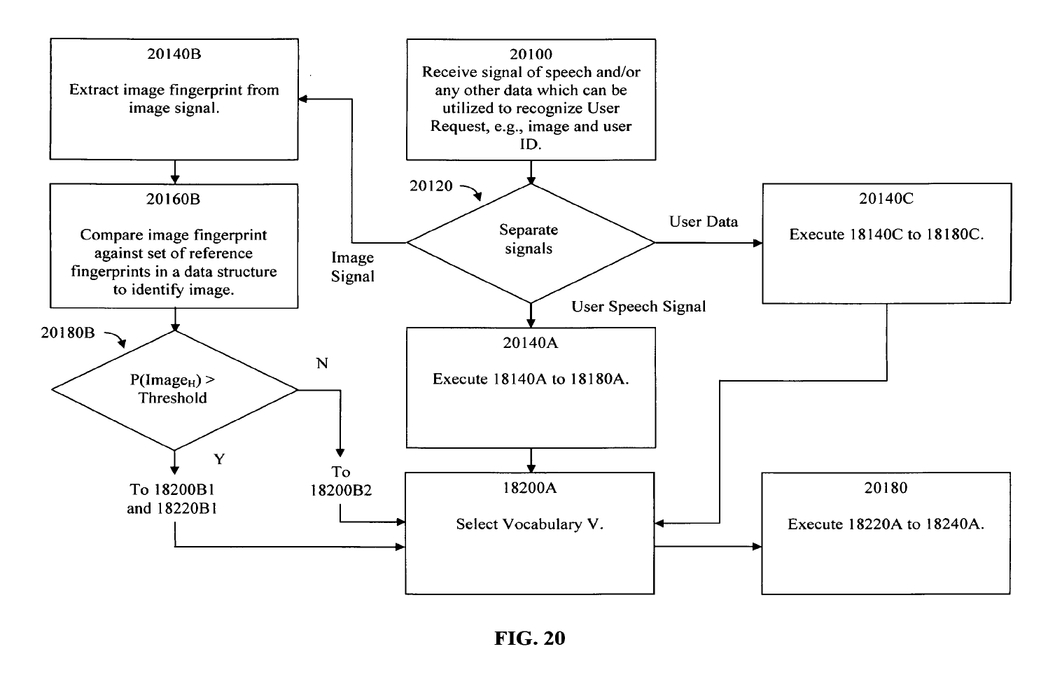

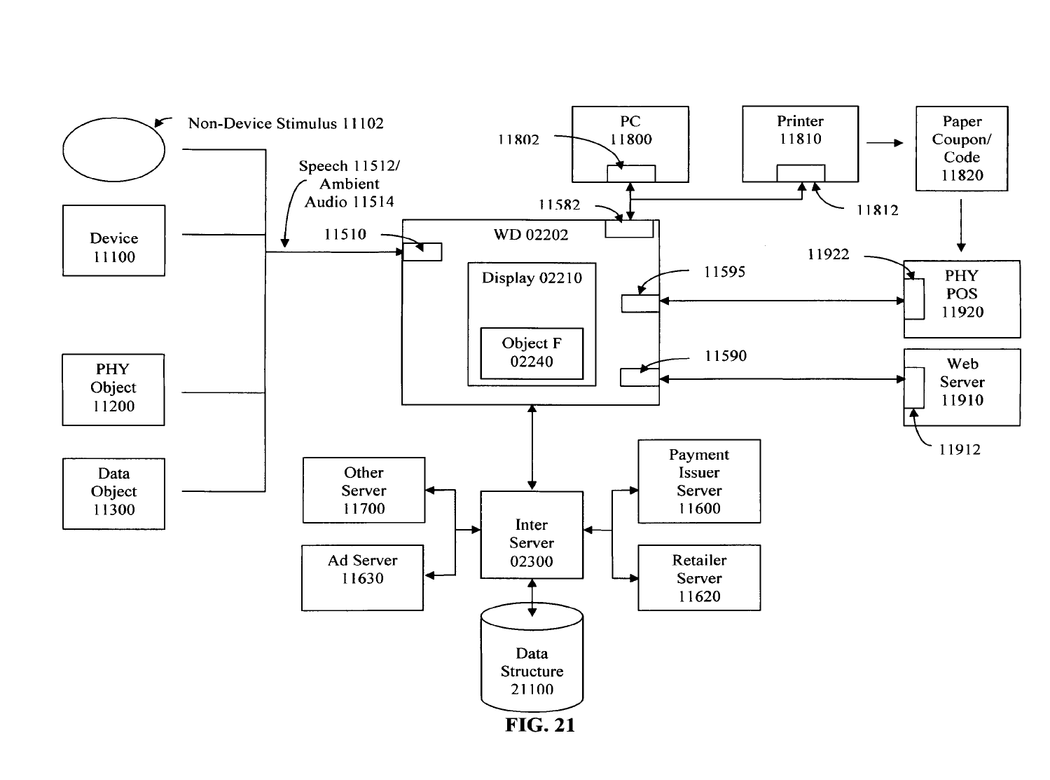

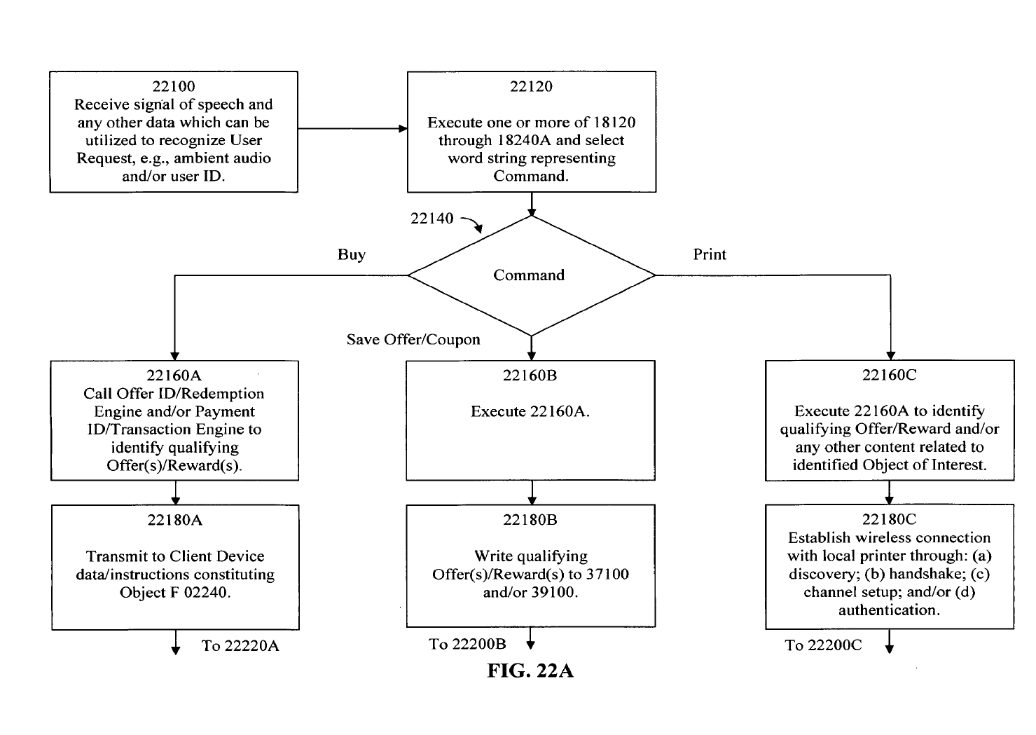

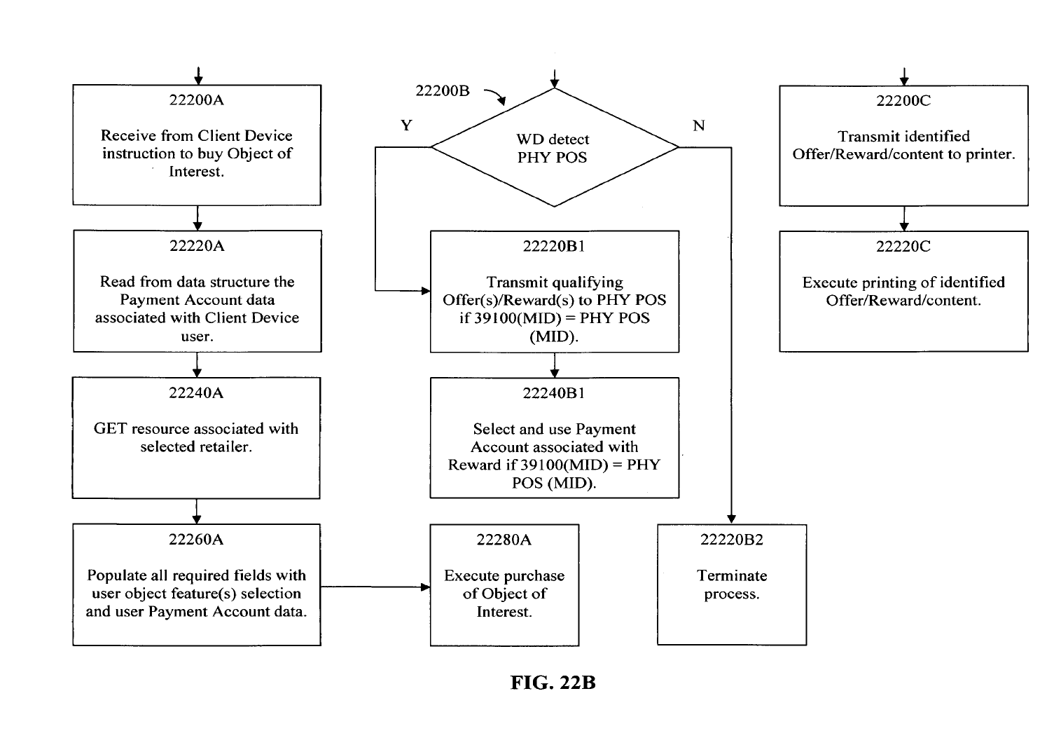

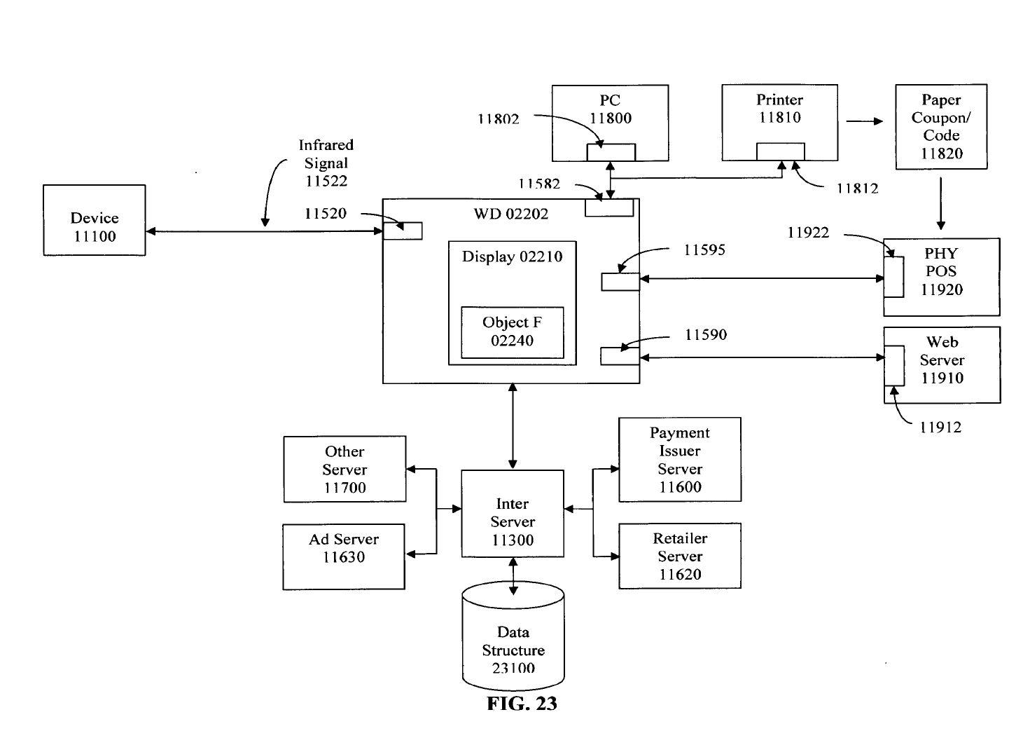

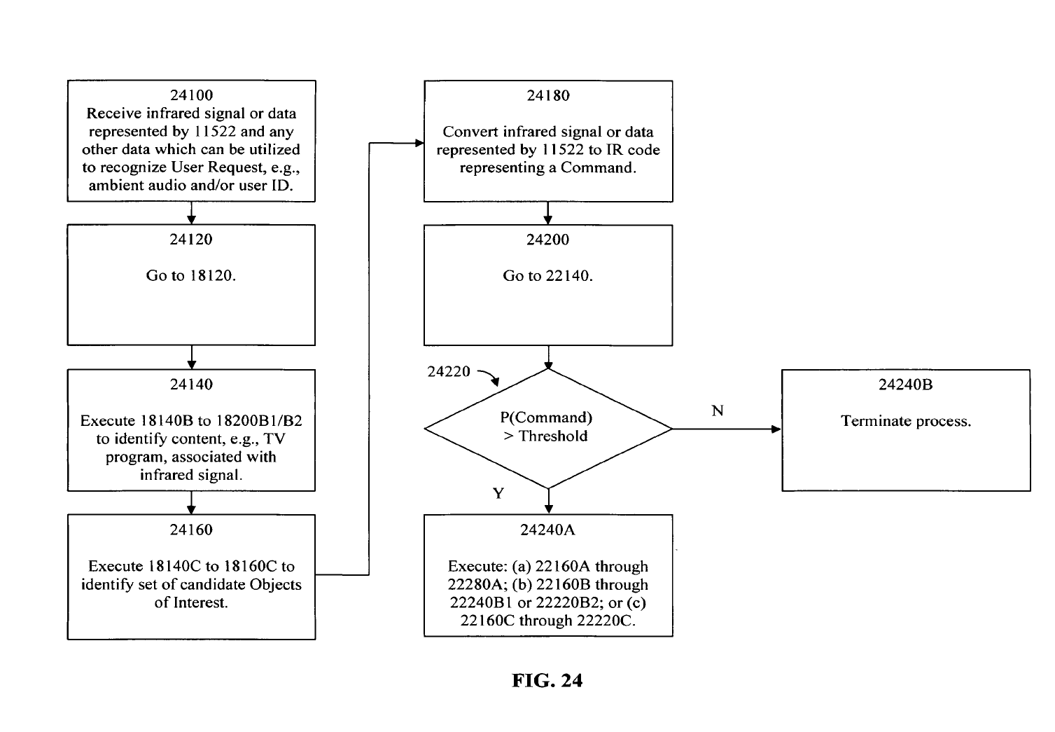

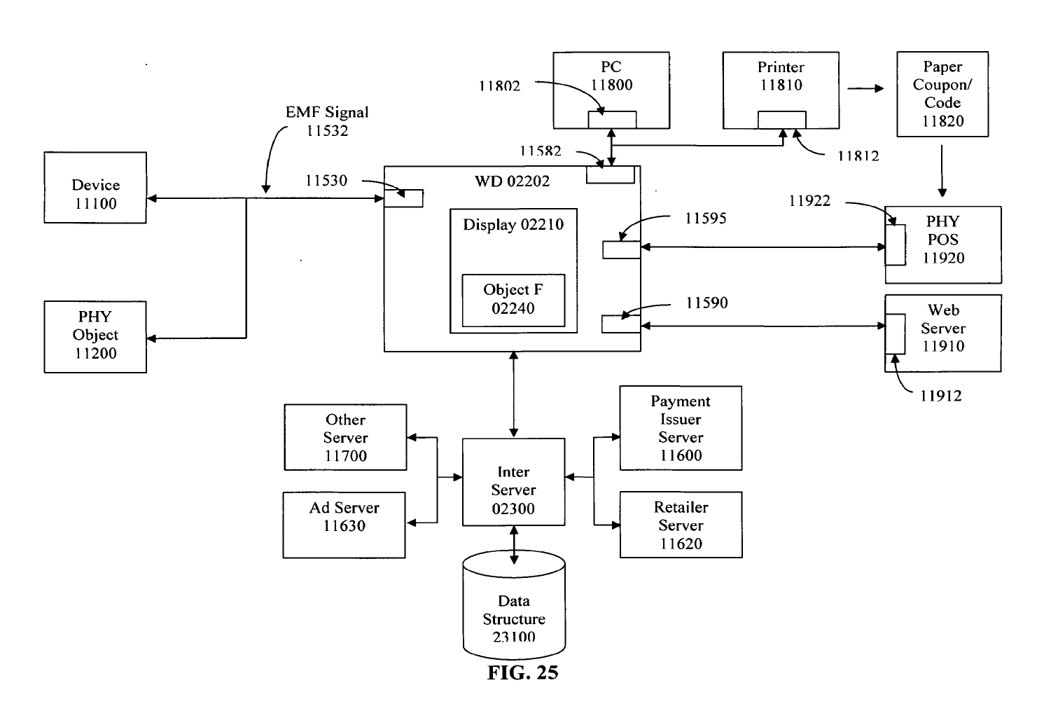

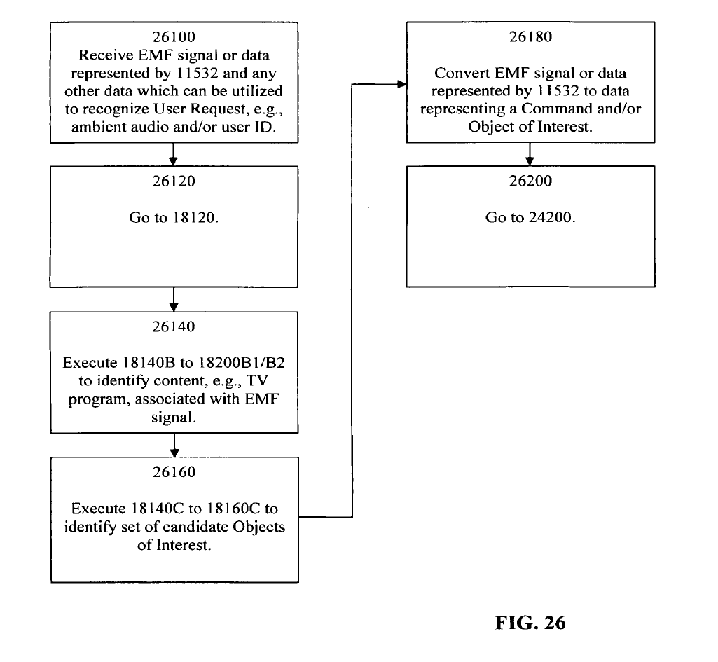

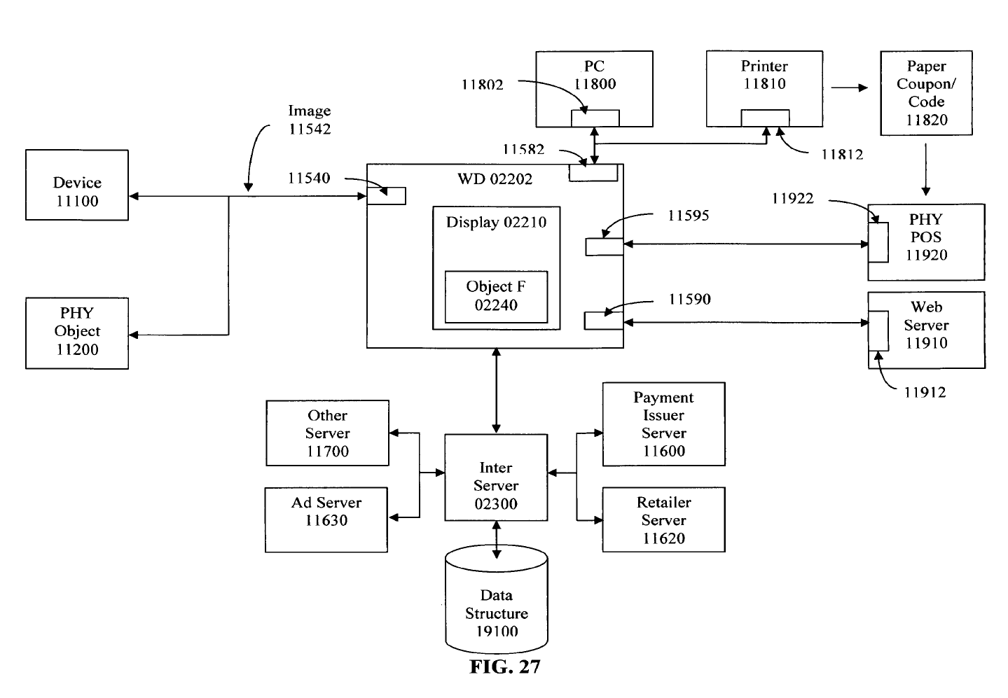

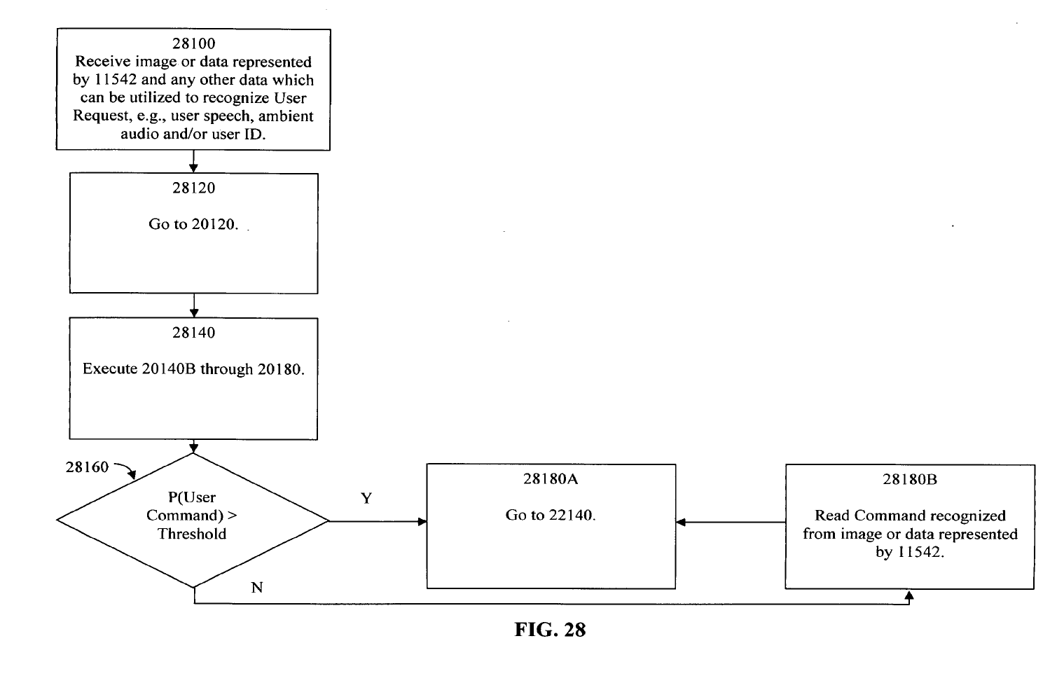

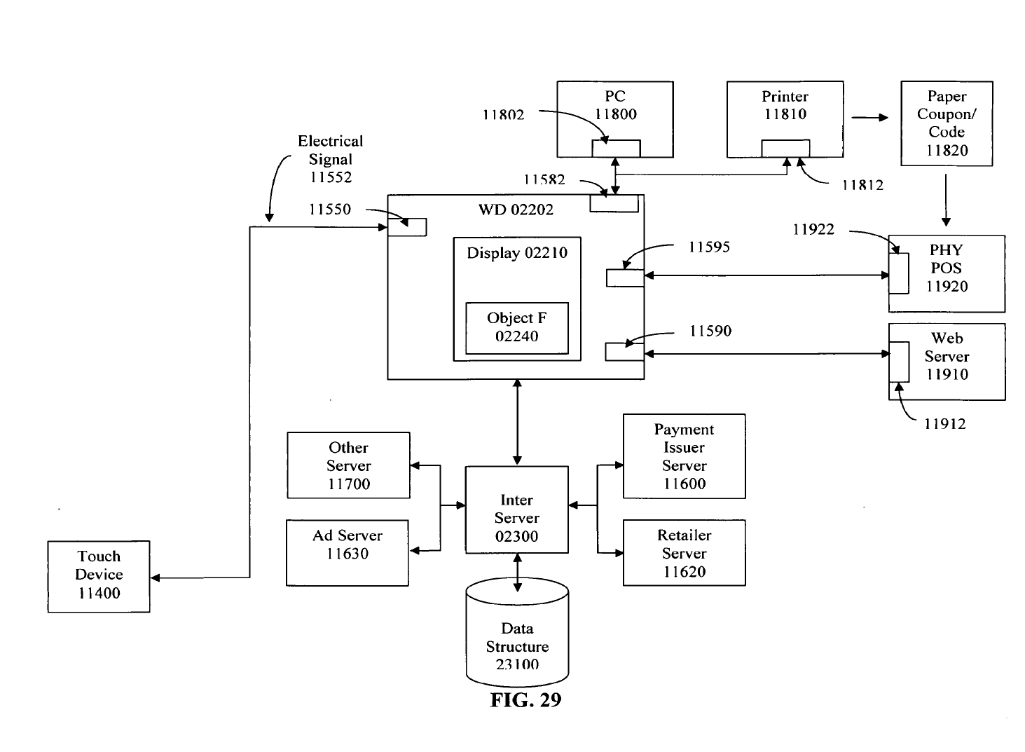

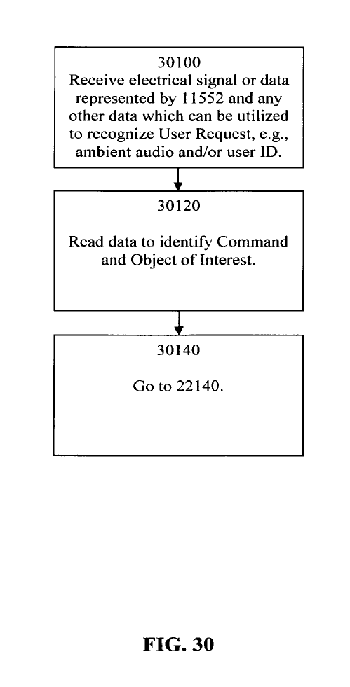

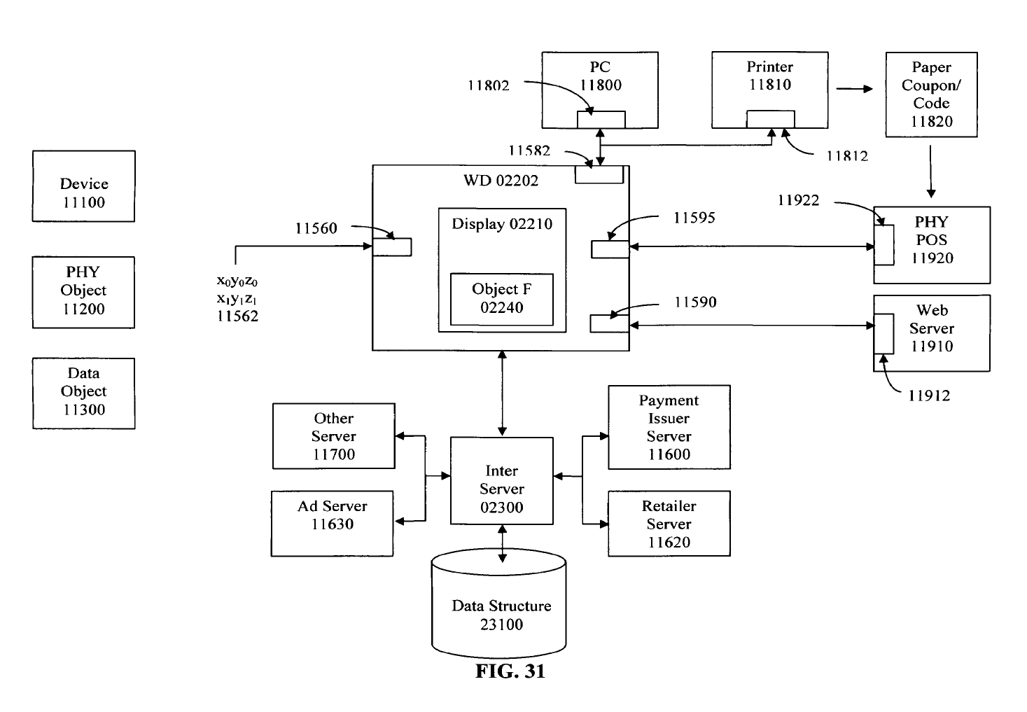

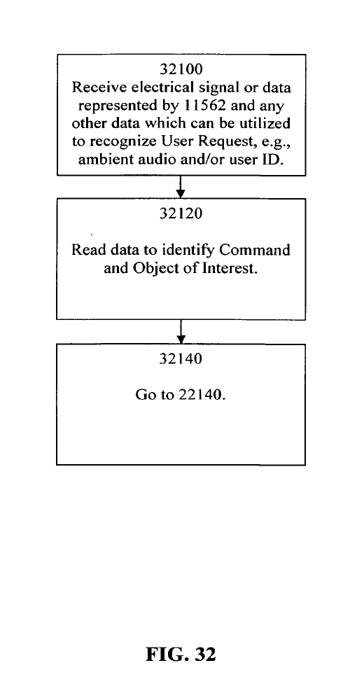

FIG. 20 depicts a flowchart of an exemplary computer-implemented method, Method 20000, that when executed can enable the identification of an image, still or moving, of an object of interest, according to one embodiment. At 20100, Method 20000 can receive a signal and/or data from any Client Device 14200, e.g., WD 02202, which can comprise one or more of the following, including, but not limited to: (a) a RF signal comprising at least one of the following: (i) the speech utterance of the user of WD 02202, e.g., Speech 11512; and/or (ii) Ambient Audio 11514; (b) an image, static or moving, of an Object of Interest, e.g., Image 11542, and/or (c) any other data Method 20000 can utilize to recognize the User Request, e.g., Data Structure 19100 and/or any User Data.

At 20120, Method 20000 can separate the incoming signal(s) and/or data and process each signal and/or data.

At 20140B, Method 20000 can extract an image fingerprint from Image 11542 utilizing any method.

At 20160B, Method 20000 can compare the image fingerprint against a set of reference fingerprints in a data structure to identify Image 11542.

At 20180B, Method 20000 can determine if there is a match enabling the identification of Image 11542. For example, Method 20000 can compute if the probability of hypothesized Image, P(Image_{H}), exceeds a predefined threshold. If Method 20000 can identify Image 11542, it can proceed to 18200B1. Otherwise, it can proceed to 18200B2.

### Implementation Engines

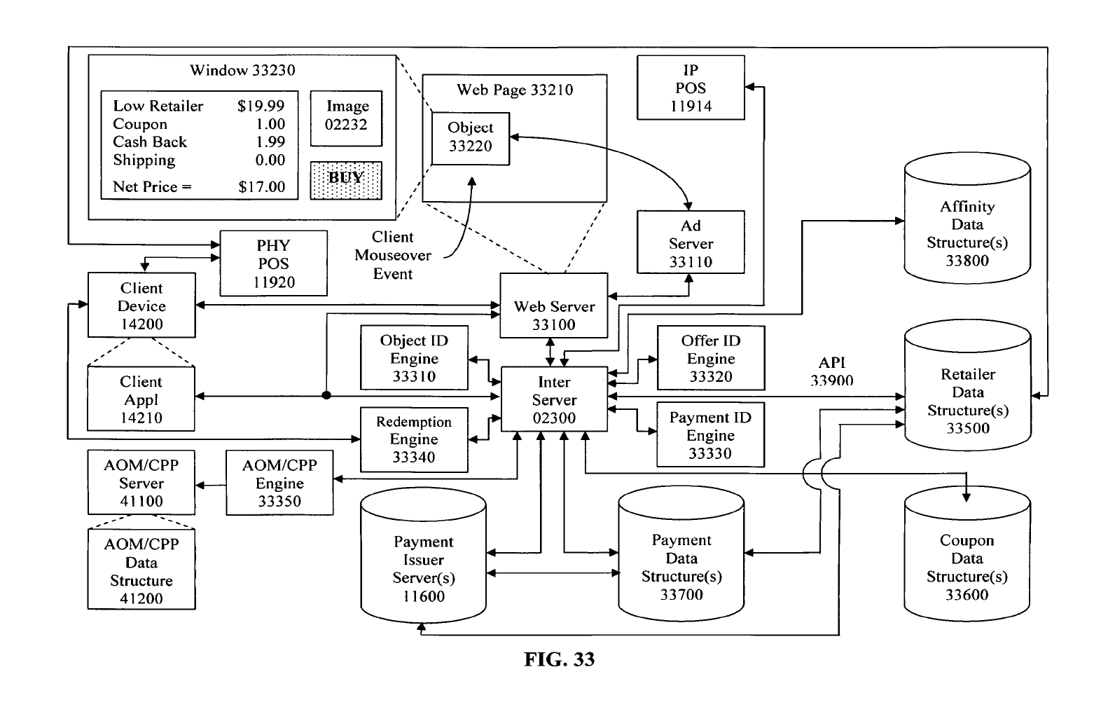

FIG. 33 depicts a block diagram of an exemplary apparatus, Apparatus 33000, enabling the transformation of an object, an electronic image of an object, or data representing an object displayed on a device, e.g., a personal computer, a television, or a wireless device, into a different state, i.e., data representing characteristics of or associated with the object, e.g., display and/or redemption of one or more offers related to the object or the execution of a Transaction related to the object, through the selection by any means of the object, an electronic image of the object, or data representing the object, according to one embodiment. The apparatus can implement the entities described herein by utilizing a subset of the following components, any combination of the components, or additional, related, alternative, and/or equivalent components. The apparatus can include, but is not limited to, the following components not disclosed earlier.

Web Server 33100 can be any Data Processing System capable of executing a variety of functions and/or instructions, including, but not limited to: (a) exchanging data with one or more Client Devices 14200 over any communications protocol, e.g., HTTP; (b) serving to Client Device 14200 one or more documents, e.g., Web Page 33210, which can display one or more Media Objects 33220 which may or may not be served by Ad Server 33110 and can be Content in any form promoting an object, e.g., Object 02120, which can be any form, including, but not limited to: (i) an image file, e.g., a jpg or gif image; (ii) a Flash object; (iii) one or more frames constituting a video file; (iv) text in a document, e.g., an article or an email; and/or (v) an email; and/or (c) exchanging data with one or more Ad Servers 33110 over any communications protocol, e.g., HTTP. While the application illustrates Web Server 33100 as a Data Processing System exchanging data with other Data Processing Systems over a network, e.g., the Internet, the invention is not limited to that embodiment. Web Server 33100 can be any Data Processing System capable of transmitting to one or more Client Devices 14200 for display a document, electronic or non-electronic, including a Media Object 33220 with which the invention can associate a Window 33230. For example, a TV 02100 or a physical billboard can display an electronic document or non-electronic document, respectively, including a Media Object 33220 with which the invention can associate a Window 33230. Ad Server 33110 can be any Data Processing System capable of executing a variety of functions and/or instructions, including, but not limited to: (a) exchanging data with one or more Web Servers 33100; (b) receiving and/or processing a request from one or more Client Devices 14200; and/or (c) transmitting to Client Device 14200 one or more documents related to Media Object 33220.

Ad Server 33110 can be a Data Processing System operated by any entity, including, but not limited to: (a) an entity which manufactures, distributes, and/or sells the object promoted in Media Object 33220; and/or (b) an entity, e.g., an advertising network, which: (i) buys and/or places advertisements on behalf of a plurality of advertisers; and/or (ii) sells advertisements on behalf of a plurality of publishers.

Web Page 33210 can be any document capable of being distributed over a network, e.g., the World Wide Web, and can be displayed on Display 12000 of any Client Device 14200, e.g., PC/WD Display 02210 or TV Display 02110. Web Page 33210 can display one or more Media Objects 33220.

Media Object 33220 can be any set of data which can display, represent, and/or promote an Object of Interest and/or a Class of Interest. While FIG. 33 illustrates Media Object 33220 as an object contained in Web Page 33210, the invention is not limited to that embodiment. In a first alternative embodiment, Media Object 33220 can be a string of text representing an Object of Interest or Class of Interest, e.g., the word string “Disney® Snow White DVD” representing an Object of Interest or the word string “DVD” representing Class of Interest. In a second embodiment, Media Object 33220 can be any representation of a code identifying or containing data related to the Object of Interest, e.g., an N-Dimension Code like a barcode identifying a Disney® Snow White DVD. In a third embodiment, Media Object 33220 can an image of an Object of Interest or Class of Interest, e.g., an image of a box containing the Disney® Snow White DVD representing an Object of Interest or an image of a DVD player representing a Class of Interest. Media Object 33220 can be any type of image of an Object of Interest or Class of Interest, including, but not limited to: (a) an image displayed in any kind of medium, including, but not limited to: (i) an electronic medium, e.g., TV Display 02110, or PC/WD Display 02210; and/or (ii) a non-electronic medium, e.g., a print publication; and/or (b) an image of an Object of Interest or Class of Interest in physical form displayed in any display connected to a Client Device 14200, e.g., Viewfinder 01302. In a fourth embodiment, Media Object 33220 can be a sample of audio whose extraction, decoding, recognition, and/or other processing can lead to the recognition of an audio Object of Interest, e.g., a song. In a fifth embodiment, Media Object 33220 can be a sample of speech whose extraction, decoding, recognition, and/or other process can lead to a hypothesized word string representing a command and an Object of Interest, e.g., “Buy Disney® Snow White DVD”, or a Class of Interest. In a sixth embodiment, Media Object 33220 can be a sample of video, e.g., an advertisement displayed on a TV 02100 whose content primarily promotes an Object of Interest or an advertisement in the form of a Product Placement, whose extraction, decoding, recognition, and/or other processing can lead to the recognition of an Object of Interest or a Class of Interest. In a seventh embodiment, Media Object 33220 can be any combination of text, code, image, audio, speech, video, and/or any other data type whose extraction, decoding, recognition, and/or other processing can lead to the recognition of an Object of Interest or a Class of Interest.

Window 33230 can be any document, window, or pop-up capable of presenting any data related to Media Object 33220, e.g., Object F 02240. Client Device 14200 can display Window 33230 in response to any event, including, but not limited to: (a) the placement of a cursor over Media Object 33220, e.g., when a mouse pointer enters an element; (b) the detection of a finger, pointer, stylus, or any other object over Media Object 33220; (c) the recognition of a code identifying an Object of Interest displayed in Media Object 33220, e.g., a barcode identifying the Object of Interest; (d) the recognition of a word string representing Media Object 33220 in the form of speech inputted into Microphone 01260 and/or text inputted into Keypad 01220; (e) the detection of a command received over any wireless channel, e.g., when a remote control device transmits to a TV 02100 a command selecting Media Object 33220; and/or (f) the selection of any option in a menu. Window 33230 can be displayed based on any rule, e.g., on any mouseover event, or only when Media Object 33220 is of a certain type, e.g., a Flash object or HTML5 Video object. While the application illustrates the display of Window 33230 in response to an event associated with Media Object 33220, which in turn can be transmitted by Ad Server 33110, the invention is not limited to that embodiment. The invention can display Window 33230 in response to an event not associated with any action by Ad Server 33110.

Retailer Data Structure 33500 can be any data structure associated with Retailer Server

11620. In the preferred embodiment, Retailer Data Structure 33500 can be associated with an API enabling a Data Processing System, e.g., Inter Server 02300, to access the stored data, which can include, but are not limited to: (a) an object ID uniquely identifying each object offered; (b) an object description; (c) an object specification; (d) one or more object images; (e) object availability; and/or (f) object pricing, which can be selected and displayed in Object G: Retailer 02242. In another embodiment, a crawler can copy one or more pages including data from Retailer Data Structure 33500 and/or index the data to enable retrieval of one or more data.

Coupon Data Structure 33600 can be any data structure associated with Other Server 11700. In the preferred embodiment, Coupon Data Structure 33600 can be associated with an API enabling a Data Processing System, e.g., Inter Server 02300, to access the stored data, which can include, but are not limited to: (a) an object ID uniquely identifying each object for which there is one or more Offers displayed in, e.g., Object H: Coupon 02244; (b) one or more Offers displayed in, e.g., Object H: Coupon 02444, and associated with each object. In another embodiment, a crawler can copy one or more pages including data from Coupon Data Structure 33600 and/or index the data to enable retrieval of one or more data.

Payment Data Structure 33700 can be any data structure associated with Payment Issuer Server 11600. In the preferred embodiment, Payment Data Structure 33700 can be associated with an API enabling a Data Processing System, e.g., Inter Server 02300, to access the stored data, which can include, but are not limited to: (a) a merchant ID uniquely identifying each Retailer offering an Object of Interest; (b) a MCC uniquely identifying the category of the Retailer offering an Object of Interest; (c) an object ID uniquely identifying each object offered through Payment Issuer Server 11600; (d) data describing one or more Offers displayed in, e.g., Object I: Reward 02246, and related to any object and/or Retailer; (e) data describing any terms and conditions which must be met to qualify for redemption of the Offer; and/or (f) data related to one or more Payment Accounts held by the user of Client Device 14200. In another embodiment, a crawler can copy one or more pages including data from Payment Data Structure 33700 and/or index the data to enable retrieval of one or more data.

Affinity Data Structure 33800 can be any data structure associated with Other Server 11700. In the preferred embodiment, Affinity Data Structure 33800 can be associated with an API enabling a Data Processing System, e.g., Inter Server 02300, to access the stored data, which can include, but are not limited to: (a) an object ID uniquely identifying each object for which there is one or more Offers displayed in, e.g., Object J: Affinity 02248; (b) one or more Offers displayed in, e.g., Object J: Affinity 02448, and associated with each object. In another embodiment, a crawler can copy one or more pages including data from Affinity Data Structure 33800 and/or index the data to enable retrieval of one or more data. Enabling a Data Processing System, e.g., Inter Server 02300, to exchange data with one or more servers and/or data structures, e.g., Retailer Data Structure 33500, Coupon Data Structure 33600, Payment Data Structure 33700, Affinity Data Structure 33800, and/or Payment Issuer Server 11600, can yield a variety of benefits, including, but not limited to, the following benefits. First, having an Inter Server 02300 retrieve one or more Offers stored on other Data Processing Systems and processing or filtering those Offers related to an Object of Interest can save the user of Client Device 14200 time and effort to search and query directly one or more Data Processing Systems. Second, having an Inter Server 02300 act as a proxy server for a Client Device 14200 to execute a purchase of an Object of Interest can save time and be more convenient for a user of Client Device 14200, particularly a device into which it can be difficult to input the selection of a plurality of Object Attributes and the relatively large amount of data required to execute a typical credit/debit card purchase, e.g., a WD 02202. Having an Inter Server 02300 automatically populate those fields necessary to execute a purchase of an Object of Interest presented by a Retailer Server 11620 can be faster and simpler for a user of Client Device 14200 than him/her populating those fields directly.

API 33900 can be any interface enabling a Data Processing System, e.g., Inter Server 02300, to read data and/or instructions from and/or write data and/or instructions to another Data Processing System, e.g., Retailer Data Structure 33500, Coupon Data Structure 33600, Payment Data Structure 33700, Affinity Data Structure 33800, and/or Payment Issuer Server 11600.

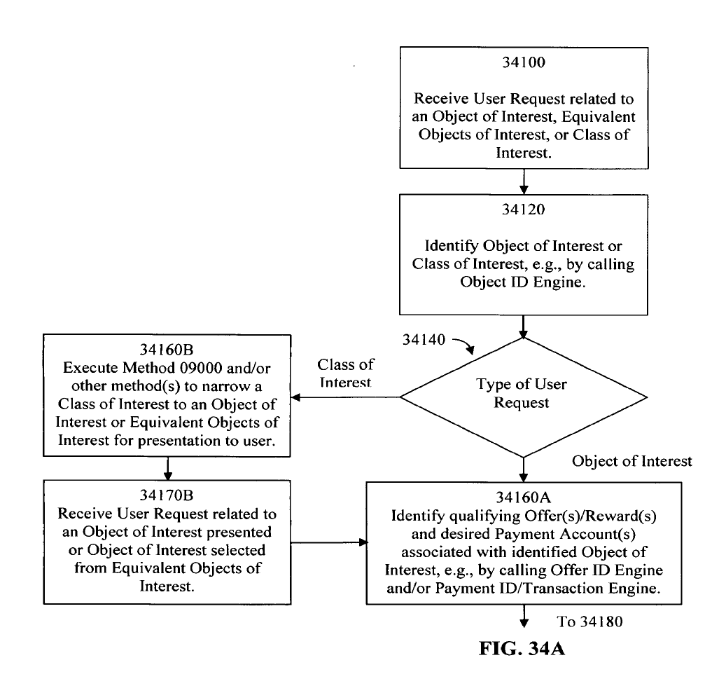

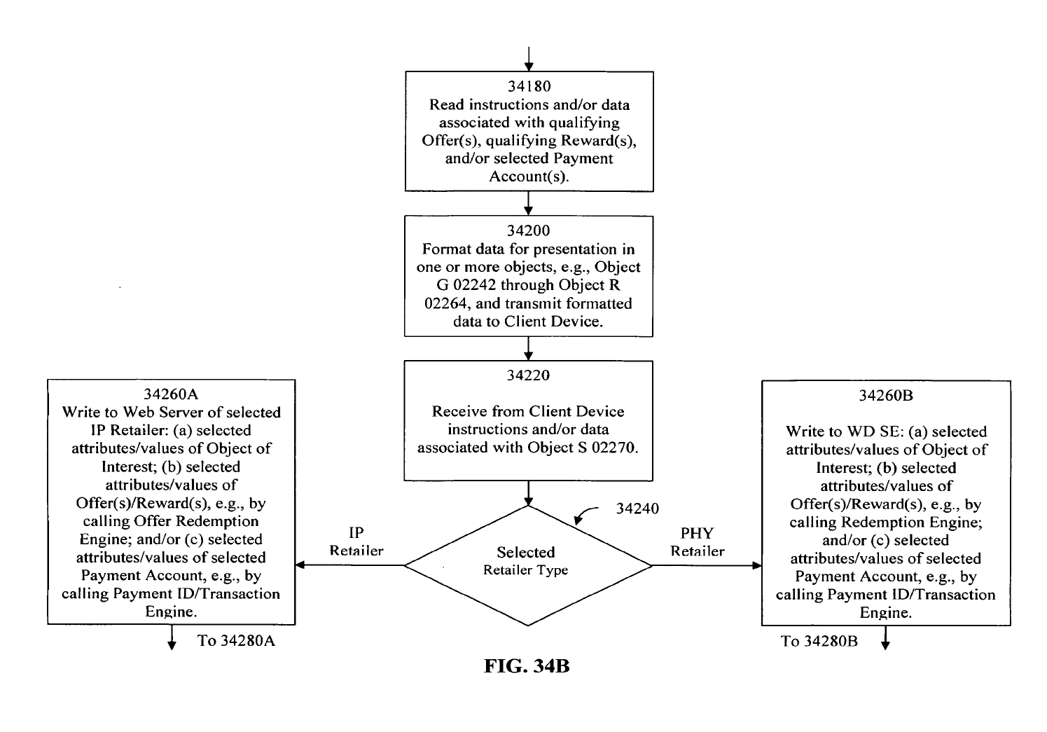

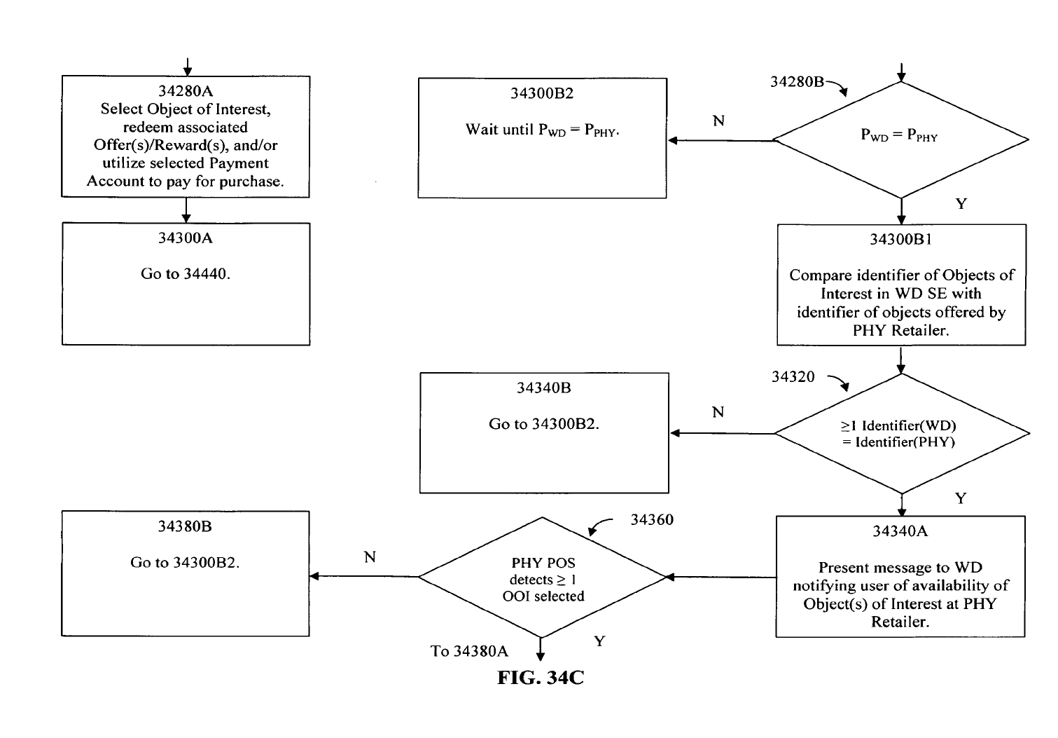

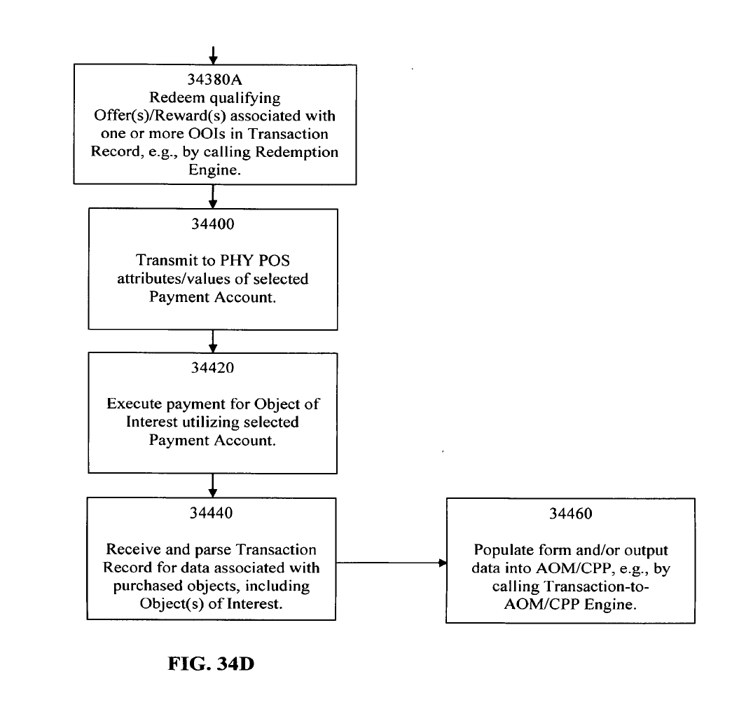

FIGS. 34A-34D depict a flowchart of an exemplary computer-implemented method, Method 34000, that when executed can enable the transformation of an object, an electronic image of an object, and/or data representing an object displayed on a device, e.g., a personal computer, a television, or a wireless device, into a different state, i.e., data representing characteristics of or associated with the object, e.g., display and/or redemption of one or more offers related to the object and/or execution of a transaction related to the object, through the selection by any means of the object, an electronic image of the object, or data representing the object, according to one embodiment. The flowchart refers to the apparatus and structures depicted in FIG. 33. However, the method is not limited to those embodiments. The method can implement the steps described herein utilizing a subset of the components, any combination of the components, or additional, related, alternative, and/or equivalent components depicted in FIG. 33 and/or elsewhere in the application. The method can execute a subset of the steps, any combination of the steps, the steps in different order, and/or additional, related, alternative, or equivalent steps.

At 34100, Method 34000 can receive from a Client Device 14200, e.g., WD 02202, a User Request related to an Object of Interest or a Class of Interest.

At 34120, Method 34000 can utilize any method, e.g., any method enabled by Object ID Engine 33310, to identify an Object of Interest or a Class of Interest described in a User Request.

At 34140, Method 34000 can determine the type of User Request by applying logic to compare and/or utilizing any comparator component capable of comparing the hypothesized words in the User Request with word strings in one or more vocabularies comprising word strings constituting potential Objects of Interest (“Candidate Object Vocabulary”) and/or Classes of Interest (“Candidate Class Vocabulary”). The invention can generate a Candidate Object Vocabulary and/or Candidate Class Vocabulary by executing any method, e.g., Method 34140, which can include, but is not limited to, the following steps.

At 34140A, Method 34140 can define a candidate object as any object associated with an Object Identifier, i.e., any object which can be purchased at a Retailer, including, but not limited to, an IP POS 11914 and/or PHY POS 11920. A user of Client Device cannot purchase a generic “jeans” or even a “Levi's® jeans”. An IP POS 11914 or PHY POS 11920 can execute a Transaction for the purchase of only an object associated with an Object Identifier, e.g., a Levi's® jeans which is a specific model, e.g., a “Straight Leg 505® Jeans”, a specific size, e.g., medium, and comprises a specific set of attributes, e.g., a navy blue color.

At 34140B, Method 34140 can receive a corpus of data, which can include, but are not limited to: (a) a data structure: (i) specifying one or more objects which can be purchased; and (ii) accessible on a public set of resources, e.g., the World Wide Web, where an exemplary data structure can be one or more web pages specifying objects which can be purchased at an IP Retailer; and/or (b) a data structure: (i) specifying one or more objects which can be purchased at an IP Retailer and/or a PHY Retailer; and (ii) accessible through an API 33900.

Method 34140 can identify the objects which can be purchased at an IP Retailer and/or PHY Retailer through any means, including, but not limited to: (a) reading in a data structure operated by a Retailer an identifier associated with an object, e.g., a UPC or SKU; and/or (b) crawling a data structure operated by an IP Retailer to identify those objects which can be entered into a shopping cart.

At 34140C, Method 34140 can parse the corpus of data to identify the names of the objects specified.

At 34140D, Method 34140 can associate with each object specified one or more word strings other than the object name which a user of Client Device 14200 can use to identify the object. Method 34140 can identify these other word strings by utilizing wildcard searches or other methods.

At 34140E, Method 34140 can generate a Candidate Object Vocabulary by including the object names identified at 34140C and/or the other word strings identified at 34140D.

At 34140F, Method 34140 can define a candidate class as a word string representing any class of objects a user of Client Device 14200 will likely use to describe a Class of Interest.

At 34140G, Method 34140 can receive a corpus of data, which can include, but are not limited to: (a) a data structure: (i) specifying one or more classes of objects which can be purchased; and (ii) accessible on a public set of resources, e.g., the World Wide Web, where an exemplary data structure can be one or more web pages including a list of classes of objects which can be purchased at an IP Retailer; and/or (b) a data structure: (i) specifying one or more classes of objects which can be purchased at an IP Retailer and/or a PHY Retailer; and (ii) accessible through an API 33900.

At 34140H, Method 34140 can parse the corpus of data to identify the names of the classes of objects specified.

At 34140I, Method 34140 can associate with each class of object specified one or more word strings other than the name of the class of objects which a user of Client Device 14200 can use to identify the class of interest. Method 34140 can identify these other word strings by utilizing wildcard searches or other methods.

At 34140J, Method 34140 can generate a Candidate Class Vocabulary by including the class of objects names identified at 34140H and/or the other word strings identified at 34140I.

After the generation of a Candidate Object Vocabulary and Candidate Class Vocabulary, Method 34000 can apply logic to compare and/or utilize any comparator component capable of comparing the hypothesized words in a User Request with word strings in the Candidate Object Vocabulary and/or Candidate Class Vocabulary. If there is a match with a word string in the Candidate Object Vocabulary, Method 34000 can determine that the User Request includes an Object of Interest. If there is a match with a word string in the Candidate Class Vocabulary, Method 34000 can determine that the User Request includes a Class of Interest.

At 34160B, Method 34000 can execute any method, e.g., Method 09000, to narrow a Class of Interest to an Object of Interest or Equivalent Objects of Interest for presentation to the user of Client Device 14200, e.g., WD 02202.

At 34170B, Method 34000 can receive a User Request related to an Object of Interest presented or an Object of Interest selected by the user of Client Device 14200 from the one or more Equivalent Objects of Interest presented.

At 34160A, Method 34000 can for an Object of Interest identified at either 34140 or 34170B utilize any method, e.g., any method enabled by Offer ID Engine 33320 and/or Payment ID/Transaction Engine 33330, to identify one or more qualifying Offers or Rewards associated with the identified Object of Interest and/or a desired Payment Account which can pay for the purchase of the identified Object of Interest.

At 34180, Method 34000 can read any instructions and/or data associated with the one or more qualifying Offers, one or more qualifying Rewards, and the selected Payment Account identified by Offer ID Engine 33320 and/or Payment ID/Transaction Engine 33330. In one embodiment, Method 34000 can classify the instructions and/or data into two classes: (a) instructions and/or data for presentation to the user of Client Device 14200 in one or more objects, e.g., Object G 02242 through Object R 02264, at 34200; or (b) instructions and/or data in temporary storage and for processing if the user of Client Device 14200 decides to execute a Transaction related to the Object of Interest, at either 34260A or 34260B. An example of the first class of instructions and/or data is the value of a coupon identified by Offer ID Engine 33320, which Object H 02244 can display. An example of the second class of instructions and/or data is the coupon code associated with the identified coupon, which Offer Redemption Engine 33340 can process at an IP Retailer or a PHY Retailer.

At 34200, Method 34000 can format the data for presentation to the user of Client Device 14200 in one or more objects, e.g., Object G 02242 through Object R 02264, and transmit the formatted data to Client Device 14200. Method 34000 can format the data for presentation in one or more formats, e.g., Format 03000A through Format 03000F. For example, Format 03000D can display the identity of an entity making an Offer related to the Object of Interest, e.g., Disney®, which can offer a coupon to “Save $10 Off the Diamond Edition Blue-ray & DVD Combo Pack” for Snow White. Method 34000 can: (a) parse the instructions and/or data associated with the identified Offer for a first attribute whose value is the name of the entity making the Offer, e.g., “Disney®”, and a second attribute whose value is the value of the Offer, e.g., “$10”; (b) store the respective attribute-value pairs in Object H 02244; and/or (c) write the value of each attribute in the respective field in the respective format. For example, in Format 03000D, Method 34000 can write the value “Disney®” to field 03000D3B1 and the value “$10” to field 03000D3B2.

At 34220, Method 34000 can receive from Client Device 14200 any instructions and/or data associated with Object S 02270, which the user of Client Device 14200 can select to execute a decision to purchase the Object of Interest.

At 34240, Method 34000 can determine the type of Retailer selected by the user of Client Device 14200 by reading the identity of the Retailer specified in Object G 02242. If the Retailer specified is an IP Retailer, Method 34000 can proceed to 34260A. If the Retailer specified is a PHY Retailer, Method 34000 can proceed to 34260B.

At 34260A, Method 34000 can write to a data structure operated by the IP Retailer, e.g., at or through IP POS 11914, one or more data, including, but not limited to, the following. First, Method 34000 can write the value of each Object Attribute and/or any identifier of the Object of Interest. For example, once a user of Client Device 14200, e.g., WD 02202, specifies the values of the Object Attributes needed to identify an Object of Interest sold by a Retailer, e.g., a computer manufactured by XYZ vendor which is a model XYZ with X monitor size, Y memory size, and Z estimated battery life, Method 34000 can write the values to the Retailer through any method, which can include, but is not limited to, selecting buttons identifying, selecting images indicating, and/or filling in data fields specifying, a value of an attribute. Second, Method 34000 can write the value of each attribute of a qualifying Offer and/or Reward by executing one or more methods enabled by Offer Redemption Engine 33340. Third, Method 34000 can write the value of each attribute of a selected Payment Account by executing one or more methods enabled by Payment ID/Transaction Engine 33330.

At 34280A, Method 34000 can select the Object of Interest, e.g., enter the Object of Interest into a shopping cart, redeem the qualifying Offer(s) and/or Reward(s) associated with the Object of Interest, and/or credit the selected Payment Account for payment of the Object of Interest.

At 34300A, Method 34000 can proceed to 34440.

At 34260B, Method 34000 can write to a data structure, e.g., in SE 41300, of Client Device 14200, e.g., WD 02202, one or more data, including, but not limited to, the following. First, Method 34000 can write the value of each Object Attribute and/or any identifier of the Object of Interest. For example, Method 34000 can write a UPC or SKU uniquely identifying the Object of Interest. Storing the Object of Interest identifier can enable the invention to determine if an object selected by the user of a WD 02202 in a PHY Retailer is the same as the Object of Interest. Second, Method 34000 can write the value of each attribute of a qualifying Offer and/or Reward by executing one or more methods enabled by Offer Redemption Engine 33340. Third, Method 34000 can write the value of each attribute of a selected Payment Account by executing one or more methods enabled by Payment ID/Transaction Engine 33330.

At 34280B, Method 34000 can determine whether the WD 02202 is in the vicinity of a PHY Retailer offering at least one Object of Interest requested by the user of WD 02202. Method 34000 can execute any method to make the determination, including, but not limited to, the following methods.

First, Method 34000 can utilize a Location Detector 11579 in WD 02202 to monitor the communications addresses uniquely identifying a Data Processing System transmitting a short-range wireless signal received by WD 02202. The application defines a Short-Range Wireless Signal as a wireless signal carrying data that is transmitted (either actively or passively) by a Data Processing System located at a PHY Retailer, i.e., a physical store, which can include, but is not limited to: (a) a Data Processing System located at a physical store transmitting a WLAN signal; (b) a Data Processing System located at a physical store transmitting a Bluetooth signal; and/or (c) a PHY POS 11920. The Data Processing System can be, e.g., a WLAN access point transmitting a Short-Range Wireless Signal capable of being received by any Data Processing System, e.g., WD 02202, entering the physical store. Location Detector 11579 can monitor the communications addresses associated with each received Short-Range Wireless Signal, where the communications addresses can be in any form, including, but not limited to, an IP address, and/or a Media Access Control (MAC) address. Location Detector 11579 can apply logic to compare and/or utilize any comparator component capable of comparing the received communications addresses with addresses listed in a data structure storing addresses of Data Processing Systems located at PHY Retailers. If there is a match, Method 34000 can proceed to 34300B1. If there is not a match, Method 34000 can proceed to 34300B2 and wait until Location Detector 11579 detects a communications addresses associated with a received Short-Range Wireless Signal matching a stored communications address.

Second, Method 34000 can utilize a Location Detector 11579 in WD 02202 to monitor the geographical position of WD 02202, P_{WD}, e.g., by accessing location data of WD 02202 from a geolocation API specified by the W3C®. The application defines P_{PHY} as the coverage area of a Data Processing System, e.g., a WLAN access point, transmitting a Short-Range Wireless Signal. Method 34000 can determine if P_{WD} is within P_{PHY} by applying logic to compare and/or utilizing any comparator component capable of comparing any metric specifying P_{WD} with any metric specifying P_{PHY}. Method 34000 can maintain a data structure storing the set of P_{PHY} through any means, including, but not limited to: (a) storing the set of P_{PHY} in a WD 02202; (b) storing the set of P_{PHY} in another Data Processing System, e.g., Inter Server 02300, which WD 02202 can access over a network, e.g., the Internet; and/or (c) storing in a WD 02202 a set of P_{PHY} which can vary dynamically depending on P_{WD}, e.g., for any given P_{WD}, Method 34000 can store only those P_{PHY} within a predefined radius of P_{WD}, which can limit the set of P_{PHY} a WD 02202 can store and, therefore, limit the amount of WD 02202 Memory 01120 needed to store the set of P_{PHY}. If P_{WD} is within P_{PHY}, then Method 34000 can proceed to 34000B1. If P_{WD} is not within P_{PHY}, then Method 34000 can proceed to 34300B2.

At 34300B1, Method 34000 can apply logic to compare and/or utilize any comparator component capable of comparing the identifiers of any Objects of Interest stored in a WD 02202 data structure, e.g., SE 41300, with the identifiers of any objects offered by the PHY Retailer operating the Data Processing System transmitting the Short-Range Wireless Signal. The identifiers of any objects offered by the PHY Retailer can be stored in any data structure located in a Data Processing System, e.g., Retailer Server 11620, which WD 02202 can access either directly or indirectly through another Data Processing System, e.g., the Data Processing System transmitting the Short-Range Wireless Signal.

At 34320, Method 34000 can determine whether the physical store of the PHY Retailer offers at least one object which matches any Object of Interest stored in a WD 02202 data structure, e.g., SE 41300. If the data structure storing the identifiers of objects offered by the PHY Retailer includes an identifier of at least one object matching an identifier of an Object of Interest stored in a WD 02202 data structure, then Method 34000 can proceed to 34340A and transmit a message to WD 02202 notifying the user of the availability of one or more Objects of Interest at the PHY Retailer. If not, the Method 34000 can proceed to 34340B. While the application illustrates 34340A as transmit a message presenting the availability of one or more Objects of Interest at the PHY Retailer, the invention is not limited to that embodiment. The invention can transmit a message notifying the user of anything related to objects offered by the PHY Retailer and/or the PHY Retailer, including, but not limited to: (a) Offer(s) and/or Reward(s) associated with any object offered by the PHY Retailer; and/or (b) a Loyalty Program offered by the PHY Retailer, including the opportunity either to sign up for the Loyalty Program or to register Transactions on a Loyalty Program to which the user has already subscribed.

At 34360, Method 34000 can determine whether the user of WD 02202 has selected for purchase at least one Object of Interest by applying logic to compare and/or utilizing any comparator component capable of comparing the identifiers of any Objects of Interest stored in a data structure including Objects of Interest requested by the user of Client Device 14200, e.g., WD 02202, (“User Requested Objects of Interest”) with the identifiers of the objects in the Final Transaction Record, which the application defines as a receipt listing for each object purchased in any Retailer, including, but not limited to, a IP Retailer and/or a PHY Retailer, in the Transaction at least: (a) an identifier of the object purchased; and/or (b) a net price paid for the object purchased. In another embodiment, Method 34000 can compare any User Requested Objects of Interest with the identifiers of the objects in the Proposed Transaction Record, which the application defines as a data structure listing for each object presented at an IP POS 11914 and/or PHY POS 11920 before execution of the Transaction at least: (a) an identifier of the object to be purchased; and/or (b) a net price charged by the Retailer. Method 34000 can execute the comparison upon receiving from either the IP POS 11914 and/or PHY POS 11920 the Proposed Transaction Record or Final Transaction Record. Method 34000 can compare either the identifiers of all User Requested Objects of Interest or the identifiers of a subset of the User Requested Objects of Interest, e.g., those Objects of Interest associated with at least one Offer or Reward. Identifying only those Objects of Interest purchased in a given Transaction associated with at least one Offer or Reward can enable the invention to redeem automatically the Offer and/or Reward in the Transaction. Identifying all objects purchased in a given Transaction even if they are not an Object of Interest or associated with at least one Offer or Reward can enable the invention to output to one or more AOM/CPP data related objects purchased. If there is at least one User Requested Object of Interest matching an object in the Final Transaction Record, Method 34000 can proceed to 34380A. If not, Method 34000 can proceed to 34380B.

At 34380A, Method 34000 can redeem automatically any qualifying Offer(s) and/or Reward(s) associated with one or more Objects of Interest specified in the Final Transaction Record by utilizing any method, e.g., any method enabled by Offer Redemption Engine 33340.

At 34400, Method 34000 can transmit to PHY POS 11920 the attributes and values associated with a Payment Account achieving a desirable level of savings and which can be selected by any method, e.g., any method enabled by Payment ID/Transaction Engine 33330.

At 34420, Method 34000 can execute payment for the Object of Interest and/or some or all of the objects in the Transaction by utilizing the selected Payment Account.

At 34440, Method 34000 can receive and parse the Final Transaction Record for any data associated with the purchased objects, including one or more purchased Objects of Interest. Because the invention can automatically populate forms and/or output to AOM/CPP data related to any objects purchased, Method 34000 can parse the Final Transaction Record for data associated with purchased objects that may not have been an Object of Interest or an Object of Interest associated with at least one Offer and/or Reward. For example, a user deciding to deduct medical and dental expenses from his/her taxable income would value outputting to a tax form the data associated with a purchased medical or dental object even if he/she had not redeemed an Offer or Reward associated with the purchased object.

At 34460, Method 34000 can automatically populate a form and/or enter data into an AOM/CPP related to data originally from or processed from a Final Transaction Record by utilizing any method, e.g., any method enabled by Transaction-to-AOM/CPP Engine 33350.

### Object Identification Engine

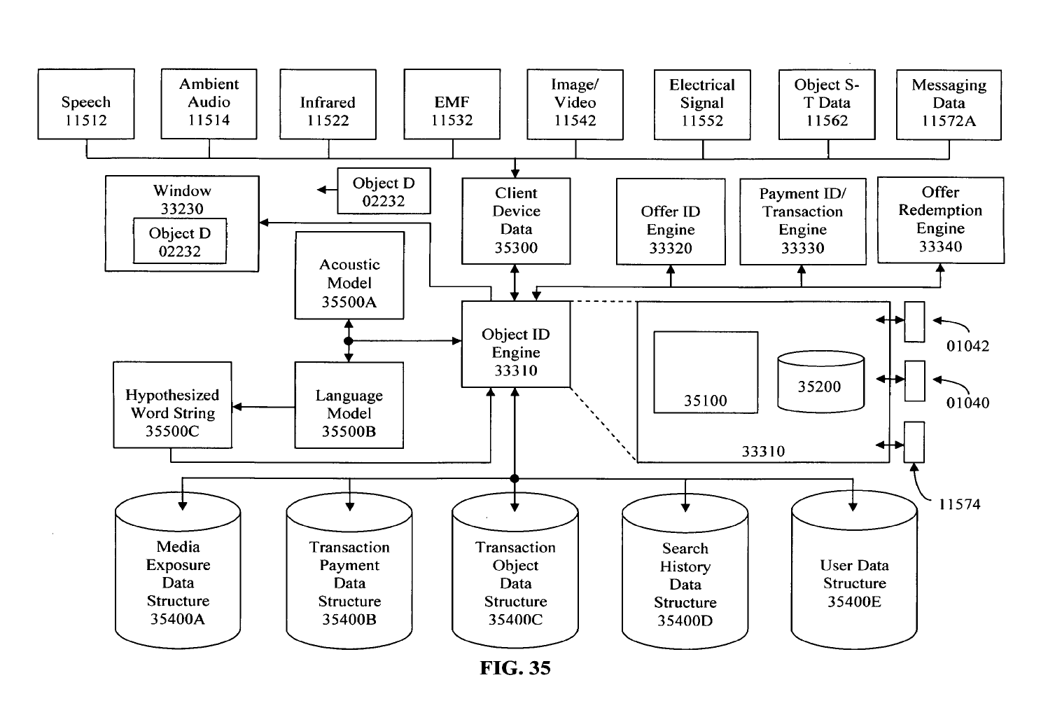

FIG. 35 depicts a block diagram of an exemplary article of manufacture or computer program product, Object ID Engine 33310, capable of identifying one or more objects of interest, according to one embodiment. The AOM/CPP can implement the methods described herein by utilizing a subset of the following components, any combination of the components, or additional, related, alternative, and/or equivalent components, and can include, but is not limited to, the following components not disclosed earlier.

Object ID Engine 33310 can be any AOM/CPP which can identify one or more Objects of Interest, e.g., Object 02120 or Media Object 33220, one or more Equivalent Objects of Interest, and/or one or more Classes of Interest utilizing any method described herein. Identifying accurately an Object of Interest or Equivalent Object of Interest can enable: (a) any Data Processing System, e.g., Inter Server 02300 or Client Device 14200, to look up one or more Offers related to the Object of Interest for any output, e.g., display in Object F 02240; and/or (b) a client device, e.g., Client Device 14200, to purchase the Object of Interest.

While the application illustrates Object ID Engine 33310 as capable of identifying an Object of Interest, Equivalent Object of Interest, and/or Class of Interest, the invention is not limited to that embodiment. The invention can enable Object ID Engine 33310 to identify anything of interest to the user of Client Device 14200, including, but not limited to: (a) an Object of Interest; (b) an Equivalent Object of Interest; (c) a Class of Interest; (d) a Vendor of Interest; (e) a Brand of Interest; and/or (f) a Retailer of Interest.

Object ID Engine 33310 can comprise: (a) a memory, e.g., Memory 01120; (b) a processor, e.g., Processor 01040; (c) a data structure, e.g., Data Structure 35100, stored in the memory and executable on the processor which can receive, store, and/or transmit data related to identifying one or more Objects of Interest, one or more Equivalent Objects of Interest, and/or Classes of Interest; and/or (d) Rules Data Structure 35200, stored in the memory and executable on the processor which can store rules, instructions, and/or functions, e.g., Method 36000A, for using the data in Data Structure 35100 and/or any other data to identify one or more Objects of Interest, Equivalent Objects of Interest, and/or Classes of Interest.

The invention can couple Object ID Engine 33310 to any Data Processing System, e.g., Inter Server 02300 and/or Client Device 14200. In any Client Device 14200, e.g., WD 02202, Object ID Engine 33310 can be stored in, and/or can utilize the memory, processor, transceiver, and/or any other component of, any module or component of Client Device 14200, including, but not limited to: (a) NFC Module 11574; (b) Component 11576; and/or (c) Memory 01120. In any Data Processing System which is not a Client Device 14200, e.g., Inter Server 02300, Object ID Engine 33310 can be stored in, and/or can utilize the memory, processor, transceiver, and/or any other component of, any module or component of the Data Processing System. While the invention couples Object ID Engine 33310 to one Data Processing System, it is not limited to that embodiment. The invention can distribute the functions, instructions, and/or data executed by Object ID Engine 33310 across a plurality of Data Processing Systems.

The invention can configure Object ID Engine 33310 to receive data, including, but not limited to: (a) Client Device Data 35300, which can include any data received from Client Device 14200, which in turn can include, but are not limited to: 11512, 11514, 11522, 11532, 11542, 11552, 11562, and/or 11572A; (b) Media Exposure Data Structure 35400A, which can include data identifying any media and/or Content to which the user of Client Device 14200 was exposed; (c) Transaction Payment Data Structure 35400B, which can include data identifying any Transactions executed by the user of Client Device 14200; (d) Transaction Product Data Structure 35400C, which can include data identifying any objects purchased, queried, and/or used by the user of Client Device 14200; (e) Search History Data Structure 35400D, which can include data identifying any objects included in search queries by the user of Client Device 14200; and/or (f) User Data Structure 35400E, which can include any data identifying one or more interests, demographic characteristics, location, and/or any other data related to and/or of the user of Client Device 14200.

The invention can configure Object ID Engine 33310 to: (a) transmit data and/or instructions to any recognition engine module, e.g., a module including Acoustic Model 35500A and/or Language Model 35500B, which can output Hypothesized Word String 35500C; and/or (b) receive from any recognition engine module one or more outputs, e.g., Hypothesized Word String 35500C.

FIG. 36A1 and FIG. 36A2 depict a flowchart of an exemplary computer-implemented method, Method 36000A, that when executed can enable the identification of one or more objects of interest, according to one embodiment. The flowchart refers to the apparatus and structures depicted in FIG. 35. However, the method is not limited to those embodiments. The method can implement the steps described herein utilizing a subset of the components, any combination of the components, or additional, related, alternative, and/or equivalent components depicted in FIG. 35 and/or elsewhere in the application. The method can execute a subset of the steps, any combination of the steps, the steps in different order, and/or additional, related, alternative, or equivalent steps.

At 36000A1, Method 36000A can receive one or more signals and/or data, including, but not limited to: (a) any input by the user of Client Device 14200; (b) any data from Client Device 14200; and/or (c) any User Data.

At 36000A2, Method 36000A can process each type of signal and/or data.

If the data received at 36000A1 is any signal representing an analog signal in the form of audio, e.g., 11512 and/or 11514, Method 36000A at 36000A3A can utilize any method to recognize a word string spoken by the user of Client Device 14200 related to the Object of Interest. Also, Method 36000A can utilize any method to process and/or identify any other audio input, e.g., recognize Ambient Audio 11514. For example, 11512 and/or 11514 can comprise a User Request related to the Object of Interest.

At 36000A4A, Method 36000A can utilize an acoustic model to generate a set of candidate word strings. In particular, Method 36000A can compute the probability of the acoustic output given a word string, P(O|W). Also, Method 36000A can compute the probability of the hypothesized Ambient Audio, P(Ambient Audio_{H}).

At 36000A5A, Method 36000A can utilize a language model to generate a set of candidate word strings. In particular, Method 36000A can compute the probability of the word string, P(W). Method 36000A can utilize additional data received from 36000A8 to increase the probability of identifying the word string and/or the Object of Interest.

If the data received at 36000A1 is any signal representing an analog signal in the form of an image or video, e.g., 11542, Method 36000A at 36000A3B can utilize any method to recognize an image or video received from Client Device 14200. For example, 11542 can be image associated with a User Request related to an Object of Interest.

At 36000A4B, Method 36000A can utilize any method to compute the probability of the hypothesized Image, P(Image_{H}) or hypothesized Video, P(Video_{V}). If Method 36000A can identify the image or video received and read any Command and/or Object of Interest specified in the recognized image, then it can proceed to 36000A11.

Method 36000A can parse any data in Image 11542 to help identify the potential Object of Interest, where the data can include, but is not limited to: (a) each object in Image 11542; (b) any Content in Image 11542; and/or (c) any data surrounding a frame in which one or more objects in Image 11542 appears. For example, identifying a word string in the image which can be distinguished from other words, e.g., font size, different color, and/or location, can increase the probability of identifying the potential Object of Interest. Because many companies trademark their logos, the invention can compare a symbol against a trademark database and identify any associated company name.

Method 36000A can determine a frame in Image 11542 by measuring if the difference in any parameter of Image 11542 between the area inside a boundary, typically, a square or rectangle, and the area outside a boundary, exceeds any predefined threshold. That is, a user of Client Device 14200 can typically record an image of an Object of Interest as part of an advertisement. The media in which a user of Client Device 14200 can record an image of an Object of Interest can be a print publication, a billboard, or a product package. The Object of Interest is typically one object in a frame, e.g., a square or rectangle containing text and image related to the Object of Interest. A user can typically record Image 11542 in a printed publication which includes data outside the frame, which if identified can be used to identify the publication in which the advertisement appears. A user can typically record Image 11542 of a billboard which includes data outside the frame, which if identified and combined with Client Device 14200 location can be used to identify the billboard promoting the Object of Interest.

If the data received at 36000A1 is any signal representing digital data, e.g., 11522, 11532, 11552, 11562, and/or 11572A, Method 36000A at 36000A3C can utilize any method to detect a Command. For example, Method 36000A can receive: (a) an IR code converted from Infrared Signal 11522 which represents a Command; (b) an Electrical Signal 11552 which can be converted to an URL linking to a Retailer, which the invention can infer as a Buy Command; and/or (c) an Electrical Signal 11532 which utilizing the NFC protocol carries data stored in a NFC tag related to data about an Object of Interest contained in a product package.

At 36000A4C, Method 36000A can determine the type of event stimulus associated with the data received at 36000A1. That is, a user can transmit a User Request at: (a) the time when he/she is exposed to an object displaying the Object of Interest (“Current Media Exposure” or 36000A4C1); or (b) after he/she is exposed to one or more objects displaying the Object of Interest (“Prior Media Exposure” or 36000A4C2). Viewing a web page, reading a printed publication, walking past a billboard, or seeing a product package in a Retailer aisle can be typical examples of Current Media Exposure, i.e., opportunities enabling the user to transmit a User Request while he/she is exposed to the object displaying the Object of Interest. On the other hand, it can be atypical for a user to transmit a User Request for an Object of Interest while he/she is viewing a promotion displaying the Object of Interest on television or viewing a video on the Internet, listening to the promotion on radio, or driving past a billboard for the promotion given the short duration of video or audio advertisements or speed at which he/she is driving. In that case, a user is likely to transmit a User Request after exposure to the media displaying the Object of Interest.

At 36000A5B1, Method 36000A can receive data identifying the Current Media Exposure and Object of Interest to which a User Request refers and select the referred Object of Interest. For example, a Client Device 14200 selection of a hyperlink associated with an object (e.g., a Flash object) displayed on a first web page can GET a resource displaying the Object of Interest (e.g., a second web page displayed by a Retailer) to which the hyperlink displayed on the first web page refers. Method 36000A can utilize any method to identify the Object of Interest, including, but not limited to: (a) parsing the domain name in the URL of the retrieved resource where the URL is an address of the entity promoting the Object of Interest, e.g., when Disney® promotes a Snow White DVD in a Flash object whose associated hyperlink can be, e.g., www.disney.com/snow white DVD; (b) executing a plurality of steps, including, but not limited to: (i) selecting the hyperlink where the URL is an address of an intermediary between the first web page and the second web page, e.g., a network or exchange of publishers and advertisers; (ii) retrieving the resource, e.g., the second web page displayed by an advertiser, to which the intermediary directs the originating Data Processing System; and/or (iii) parsing the domain name in the URL of the retrieved resource; and/or (c) parsing the resource retrieved to identify potential Objects of Interest, e.g., by parsing the source page of the retrieved resource to search for potential Objects of Interest. In some examples, selecting the hyperlink associated with an object, e.g., Media Object 33220, displayed on a first web page can GET a resource displaying on a second web page the means for purchasing the same object displayed in Media Object 33220, i.e., a specific object which can be identified by an unique code, e.g., UPC or SKU. In those examples, getting the resource can be equivalent to identifying the Object of Interest. In other examples, selecting the hyperlink associated with an object, e.g., Media Object 33220, can GET a resource displaying on a second web page a plurality of objects offered by the vendor promoted in the object displayed on the first web page. For example, Media Object 33220 can display an Object of Interest, e.g., a cruise from origin A to destination B, whose hyperlink selection can GET a resource displaying on a second web page cruises, in general, offered by the advertiser, or even the cruise from origin A to destination B. However, a user cannot purchase a generic cruise or even a cruise from origin A to destination B. A user can purchase only a cruise with the minimum number of Object Attributes required to select a specific object which can be purchased, e.g., the minimum number of Object Attributes enabling the entering of an object into a shopping cart. The invention can utilize any method described herein to narrow a class of objects displayed on a Retailer web site to an object with the minimum number of Object Attributes needed to enable a purchase. For example, if Media Object 33220 displays a cruise from origin A to destination B and the hyperlink selection leads to a second web page displaying a plurality of cruises, the invention can utilize any method described herein to select a cruise from origin A to destination B leaving on a specific date and arriving on a specific date, with a specific class of accommodations, and a set of activities.

At 36000A5B2, Method 36000A can utilize additional data received from 36000A8 to identify the probable Prior Media Exposure and/or probable Object of Interest.

At 36000A6, Method 36000A can read one or more data structures, e.g., 35400A, 35400B, 35400C, 35400D, and/or 35400E, to identify one or more events related to a candidate hypothesized word string and/or Object of Interest. To facilitate the comparison of the predictive value of different types of events and any associated computing, Method 36000A can at 36000A7 convert a plurality of event types to a common format type. It can be difficult comparing the predictive value of prior search queries as represented by keywords with the predictive value of prior purchases as represented by UPC. Associating any keyword related to a potential Object of Interest or within a potential Class of Interest with the related UPC or MID can enable the direct comparison of the predictive value of both prior search queries stored in Search History Data Structure 35400D and prior purchases stored in Transaction Payment Data Structure 35400B.

At 36000A8, Method 36000A can apply any algorithm, rule, and/or method stored in Rules Data Structure 35200 to compute the probability of a word string given one or more eventsᵢ, P(W|Eᵢ), and/or the probability of an Object of Interest given one or more eventsᵢ, P(OOI|Eᵢ), where event, can be one or more events of type, related to a potential word string and/or Object of Interest.

In a first embodiment, Method 36000A can at 36000A8 apply the following method by executing a variety of steps, including, but not limited to: (a) reading one or more data structures storing data on any type of event to identify one or more events related to a candidate word string and/or Object of Interest; (b) converting each event to a common format type; and/or (c) using any algorithm, rule, and/or method to determine the probability of a candidate word string given the event or a candidate Object of Interest given the event.

In a first example, Method 36000A can read Media Exposure Data Structure 35400A to identify in a given time period one or more media exposures related to candidate word strings and/or Objects of Interest, which can include, but are not limited to: (a) the times when a user of Client Device 14200 was exposed to a candidate Object of Interest on TV 02100 where each event can be associated with an Ad-ID, e.g., the display of an advertisement promoting a Snow White DVD and its associated Ad-ID; and/or (b) the times when Client Device 14200 retrieved a web page related to a candidate Object of Interest where each event can be associated with a domain name, e.g., the retrieval of a web page displaying a Snow White DVD and its associated domain name, www.disney.com.

In a second example, Method 36000A can read Transaction Payment Data Structure 35400B to identify in a given time period one or more Transactions related to candidate word strings and/or Objects of Interest.

In a third example, Method 36000A can read any data structure to identify one or more events related to candidate word strings and/or Objects of Interest.

After identifying each related event, Method 36000A can convert the related events to a common format type. For example, Method 36000A can convert into a common format type, e.g., NAICS, a plurality of different event types, e.g., exposures to TV events, each of which is associated with an Ad-ID, exposures to web pages, each of which is associated with a domain name, and Transactions, each of which is associated with an UPC.

In the example, Method 36000A can: (a) count the frequency of exposures and/or Transactions; (b) attribute a weight to each different type of event, where the weights can vary depending on a variety of factors, including, but not limited to: (i) each exposure to a TV event related to a candidate Object of Interest can be less important than each exposure of a web page related to a candidate Object of Interest in part because a user typically passively views TV events and typically actively retrieves web pages; (ii) each media exposure related to a candidate Object of Interest can be less important than each Transaction related to a candidate Object of Interest in part because a purchase typically requires greater commitment, ceteris paribus, of the user; (iii) an event occurring more closely to the time of the User Request can be more important than an event occurring less closely, ceteris paribus; and/or (iv) an event related to a candidate Object of Interest in the same class of objects can be more important than an event related to a candidate Object of Interest in a different class of objects, e.g., two events can be classified in the same class, e.g., NAICS code 7139, “Other Amusement and Recreation Industries”, but an event, e.g., a prior purchase of a membership in an exercise club, classified in subclass NAICS code 713940, “Fitness and Recreational Sports Centers”, can be more important than an event, e.g., a prior purchase of a membership in a golf club, classified in subclass NAICS code 713910, “Golf Courses and Country Clubs”, where the candidate word string is “Join Chelsea Piers” and the entity located at Chelsea Piers in New York City is classified as a “Fitness and Recreational Sports Centers”; (c) adjust each event by a weight; and/or (d) compute a weighted average of the plurality of converted events.

In a second embodiment, Method 36000A can at 36000A8 apply the following method by executing a variety of steps, including, but not limited to: (a) reading one or more data structures, e.g., Transaction Product Data Structure 35400C, storing any type of data related to potential Objects of Interest and/or Classes of Interest, which can include, but are not limited to, any parameter associated with an Object of Interest, e.g., its price, color, size, shape, material, and/or mass; (b) computing a range, confidence interval, and/or any other measure of reliability of an estimate associated with each parameter, whose value can vary with each parameter, type of Object of Interest or Class of Interest, and/or any other factor, e.g., there can typically be a wider variance in or standard deviation of the price of a SUV than that of the length, width, or height of a SUV, or there can typically be a wider variance in or standard deviation of the price of different jewelry products than that of the price of different breakfast cereals; (c) comparing the value of one or more parameters of a set of Candidate Objects of Interest and/or Candidate Classes of Interest with the value of the parameter of an Object of Interest in a data structure, e.g., 35400C; and/or (d) determining if any difference in the values exceeds a predefined threshold. For example, Method 36000A can generate at 36000A5A or 36000A5B2 a hypothesized word string “Equinox fitness club”. Method 36000A can read from Transaction Product Data Structure 35400C the class “fitness club” and the price range associated with fitness clubs. The average annual cost of membership of a fitness club could be $1,000, ±50%. If Method 36000A generated a set of two Candidate Objects of Interest, a fitness club with the brand name Equinox and a motor vehicle with the brand name Equinox, comparing the value of the price parameter for the Equinox motor vehicle against the confidence interval of the price of the fitness club class can enable Method 36000A to reject the Equinox motor vehicle as the hypothesized Object of Interest.

In a third embodiment, Method 36000A can at 36000A8 apply the following method by executing a variety of steps, including, but not limited to: (a) parsing the image of a frame promoting an Object of Interest; (b) utilizing any method to identify one or more discrete objects in the frame (“Frame Discrete Objects”), e.g., a symbol, a structure, or a thing; (c) reading a data structure including images of trademarks, logos, and/or other graphic and/or word mark (“Object Mark”); (d) comparing the set of Frame Discrete Objects to the set of Object Marks; (e) determining if any discrete object matches any Object Mark; (f) if there is a match, identifying a word string included in the Object Mark and/or a word string near and/or associated with the Object Mark in the frame; and/or (g) generating a hypothesized Object of Interest equal to the identified word string. Some advertisements can display a number of words which can make it difficult to identify the name of the product, brand, vendor, and/or Retailer. Because most advertisers want to promote their brand as well as a specific product, they are likely to include the image of an Object Mark in the frame of any advertisement.

At 36000A9, Method 36000A can apply logic to compare and/or utilize any comparator component capable of comparing each word, in a User Request where the number of words >1 to classify each word as a Command, Object of Interest, Class of Interest, or any other element of a User Request. Method 36000A can utilize any method, including methods disclosed in U.S. patent application Ser. No. 12/370,536, to increase the probability of identifying the Object of Interest in the case where the number of words >1. Method 36000A can utilize any method to generate a score of the probability that a word, in the User Request identified in 36000A5A is the Object of Interest given the other word(s), in the User Request.

At 36000A10, Method 36000A can select the highest ranking word or word string as the Object of Interest.

In one example illustrating the execution of 36000A9 and 36000A10, Method 36000A can at 36000A5A generate a hypothesized word string “Find the cheapest gas station within five miles”. Method 36000A can utilize any set of rules to classify and/or associate words. For example, an exemplary rule for classifying a Command is to select the first word as long as it is in the class “verb”, which can reflect the typical manner of speech or an instruction to the user for inputting a User Request. An exemplary rule for classifying a word is to associate any word in the class “adjective” with a word or word string constituting a noun immediately before or after. So the exemplary rule can classify the word “cheapest” as more likely to modify the word string “gas station” than the word “the”, because “gas station” is a noun. An exemplary rule for classifying an Object of Interest is to select any word or word string constituting a noun within n number of words after a Command.

At 36000A5A, Method 36000A can utilize any method to generate a hypothesized word string which reflects an acoustic model and a language model, whose computing can in turn reflects one or more events that can help predict the likely intent of the user. In one embodiment, Method 36000A can generate a hypothesized word string by computing the argmax P(O|W)*P(W|Eᵢ).

At 36000A5B2, Method 36000A can generate a hypothesized Object of Interest whose computing can reflect one or more events that can help predict the likely intent of the user.

At 36000A11, Method 36000A can select: (a) the Command identified in the word string hypothesized in 36000A5A and/or detected in 36000A3C; (b) the Object of Interest identified in the word string hypothesized in 36000A5A, detected in 36000A5B1, and/or identified in 30310A3E3B; and/or (c) any other element of the User Request identified in the word string hypothesized in 36000A5A.

At 36000A12, Method 36000A can output the selected Object of Interest and any associated data and/or instructions to any object, function, module, and/or entity, including, but not limited to: (a) Object D: Image 02232; (b) Offer ID Engine 33320; (c) Payment ID/Transaction Engine 33330; (d) Offer Redemption Engine 33340; and/or (e) Transaction to AOM/CPP Engine 33350.

While the application illustrates Method 36000A as identifying and selecting an Object of Interest, the invention is not limited to that embodiment. The invention can utilize any method described herein, e.g., Method 36000A, to select a Class of Interest. For example, Method 36000A can identify and select the word string or object “gas station” in a User Request.

A Media Object 33220 which includes an identifier of an Object of Interest can enable the accurate association of one or more Offers and/or Rewards with the Object of Interest, because there is typically only one unique identifier for the Object of Interest, e.g., a UPC or a SKU assigned by a vendor to a unique object. Media Object 33220 can include an Object of Interest identifier either directly, e.g., by displaying the identifier, or indirectly, e.g., by embedding the identifier within a symbol, e.g., an N-Dimension Code, which can be converted to an identifier. If Media Object 33220 does not include an identifier of an Object of Interest, there can be some uncertainty surrounding the exact Object of Interest promoted by a Media Object 33220.

FIG. 36B1, FIG. 36B3, and FIG. 36B3 depict a flowchart of an exemplary computer-implemented method, Method 36000B, that when executed can enable the identification of one or more objects of interest promoted by a media object, according to one embodiment. The flowchart refers to the apparatus and structures depicted in FIG. 35. However, the method is not limited to those embodiments. The method can implement the steps described herein utilizing a subset of the components, any combination of the components, or additional, related, alternative, and/or equivalent components depicted in FIG. 35 and/or elsewhere in the application. The method can execute a subset of the steps, any combination of the steps, the steps in different order, and/or additional, related, alternative, or equivalent steps.

In the case where a Media Object 33220 is associated with an identifier, e.g., an Ad-ID code, which includes an attribute identifying the object, brand, vendor, Retailer, and/or any other thing promoted by the Media Object 33220 (“Promoted Object”), the invention can identify the Promoted Object by reading the attribute and its value identifying the Promoted Object, e.g., the name and/or an identifier of the Promoted Object. In the case where a Media Object 33220 is not associated with an identifier including an attribute identifying the Promoted Object, it can be harder to identify the Promoted Object. Even where a Media Object 33220 is associated with an identifier including an attribute identifying the Promoted Object, an entity displaying the Media Object 33220 may not want to display the attribute because of, e.g., aesthetic reasons, or a Data Processing System, e.g., a Client Device 14200 or an Inter Server 02300, may not be able to read the attribute. Identifying the Promoted Object through other means may be necessary.

A user of Client Device 14200 can be interested in an Object of Interest while or after viewing a Media Object 33220 promoting the Object of Interest. In the case of a Current Media Exposure, the user of Client Device 14200 can express interest in the Object of Interest while the Media Object 33220 is displayed on Client Device 14200 or any another Data Processing System, e.g., TV 02100 or PC 11800, in the vicinity of Client Device 14200. In the case of one or more Prior Media Exposures, the user of Client Device 14200 can express interest in the Object of Interest after Client Device 14200 or any other Data Processing System stops displaying the Media Object 33220 promoting the Object of Interest. If there is no Media Object displayed on Client Device 14200 or any other Data Processing System in the vicinity of Client Device 14200 at the time of a User Request, the invention can identify one or more potential Media Objects which could have stimulated the user of Client Device 14200 to make a User Request (“Candidate Media Objects”) by executing methods and/or utilizing apparatuses disclosed in U.S. patent application Ser. No. 12/107,649 and/or U.S. patent application Ser. No. 12/370,536.

A Media Object 33220 can vary in the amount and/or form of data presented ranging from simple, e.g., a text string specifying one word describing the Object of Interest, to complex, e.g., a combination of text, image, video, and/or audio including a plurality of words and non-word objects describing the Object of Interest. The simpler the Media Object 33220, the easier it is to identify the Object of Interest promoted by the Media Object 33220. The more complex the Media Object 33220, the harder it is to identify the Object of Interest promoted by the Media Object 33220.

Method 36000B can identify an Object of Interest and/or a Class of Interest promoted by one or more Media Objects 33220 by executing a variety of functions, including, but not limited to: (a) analyzing the content of the Media Object 33220 promoting the Object of Interest and/or Class of Interest selected by a user of Client Device 14200 and/or the content of Candidate Media Objects 33220; (b) analyzing a Forward Link (defined herein), if available; (c) analyzing the content of the Destination Resource (defined herein), if available; and/or (d) analyzing the User Request, if available.

At 36000B1, Method 36000B can identify one or more Media Objects 33220 and its location, timing, and/or other attribute in any type of resource, which can include, but is not limited to, a document, file, and/or channel, displayed by a Data Processing System. Identifying a Media Object 33220 and its location, timing, and/or other attribute can enable the invention to detect an event selecting an Object of Interest and/or the Media Object 33220.

In a first embodiment, a web page displayed by a Data Processing System, e.g., a TV 02100, PC 11800, or WD 02202, can include one or more Media Objects. Identifying the location of the Media Object displayed in the web page can enable the detection of an event selecting the Media Object 33220 when a device selecting the Media Object 33220 moves within the boundaries of the Media Object 33220. Method 36000B can execute any method to identify the Media Object 33220 location. An exemplary method can include, but is not limited to, the following steps: (a) when a browser or other application loads a resource, e.g., a web page, scan the web page for one or more Media Objects through any means, e.g., by parsing the source page of the web page to search for Media Objects, which can be identified through any means, e.g., identifying tags describing an object, its source address, and/or its location; and/or (b) generate a temporary or permanent table storing identified Media Objects and their associated positions and/or boundaries, e.g., the location of the set of pixels forming a plurality of boundaries.

In a second embodiment, a video program displayed by a Data Processing System, e.g., a TV 02100, PC 11800, or WD 02202, can include one or more Media Objects. Identifying the logical and/or physical channel of the network transmitting the Media Object, e.g., TV channel 7 transmitting a program or advertisement representing the Media Object 33220, i.e., an advertisement promoting an Object of Interest, can enable the detection of an event selecting an Object of Interest. Method 36000B can utilize any method to identify a Media Object 33220, including, but not limited to, any methods disclosed in U.S. patent application Ser. No. 12/107,649 and/or U.S. patent application Ser. No. 12/370,536.

At 36000B2, Method 36000B can detect any event selecting an Object of Interest and/or a Media Object 33220 promoting an Object of Interest.

Method 36000B can utilize any method to detect an event selecting an Object of Interest and/or a Media Object 33220 promoting an Object of Interest. In the example of the first embodiment of 36000B1, Method 36000B can detect when any pointer moves over a displayed Media Object 33220. For example, when a cursor, finger, or any other type of pointer moves within the boundaries of a displayed Media Object 33220 whose boundaries are stored in a temporary or permanent table, Method 36000B can: (a) identify the position of the pointer, e.g., by linking to a module in the Data Processing System operating system which can identify cursor position, identify the detection of a finger or other object over a touch sensitive display, e.g., by linking to a module in the Data Processing System operating system which can detect such event, and/or identify any other type of event selecting an Object of Interest and/or a Media Object 33220 promoting an Object of Interest; and/or (b) call a module which can execute one or more functions, including, but not limited to: (i) the functions described in the remaining steps of Method 36000B; and/or (ii) the functions described elsewhere in the application. To avoid generating an excessive number of calls or detecting events not intended by the user of Client Device 14200 to select a Media Object 33220, Method 36000B can require the placement of the pointer over a Media Object for at least a predefined duration before calling modules to identify the Object of Interest promoted in the Media Object 33220 or an event, e.g., a right click of a mouse, in addition to the movement of the pointer within the boundaries of the displayed Media Object 33220.

Method 36000B can utilize any method to determine if a Media Object is promoting an Object of Interest, including, but not limited to: (a) identifying the word string “ad” or “commercial” in the Media Object; (b) identifying any word string typically associated with a promoted object or brand like the character “®”, “™”, “^{SM}”, or any image typically associated with a promoted object or brand like a logo; (c) determining the placement of the Media Object relative to other objects in a document and applying rules for the medium in which the Media Object is detected, e.g., most web documents place advertisements in certain positions like the top of the document or the right side of the document, or most television networks place advertisements in a time slot separate from the program and typically in a group of contiguous time slots commonly known as a pod; (d) parsing a source file or any other metadata associated with the Media Object for any word strings and/or communications addresses indicating that the Media Object promotes an object, e.g., a hyperlink like, http://www.advertisementnetwork.com/clk;1234567890;?http://www.objectpromoted.com; and/or (e) parsing a source file or any other metadata associated with the Media Object for any tags enabling interactivity with the Media Object since many advertisers want a user of Client Device 14200 to interact with a Media Object. While the application illustrates Method 36000B as including one or more steps receiving a Media Object, the invention is not limited to that embodiment. The invention can detect the selection of a Media Object, even if a Data Processing System, e.g., WD 02202, does not receive the Media Object. That is, Method 36000B can identify an Object of Interest promoted in a Media Object even if a Data Processing System, e.g., WD 02202, receives metadata related to the Media Object instead of the Media Object itself. For example, if a first Data Processing System, e.g., WD 02202, receives any metadata related to a Media Object displayed on a second Data Processing System, e.g., a TV 02100, Method 36000B can identify an Object of Interest promoted in the displayed Media Object in part by recognizing the Media Object utilizing any methods disclosed herein.

At 36000B3, Method 36000B can apply logic to identify and/or utilize any component capable of identifying the type of Media Object detected. In a first example, a web browser typically associates with a mouseover event the hyperlink associated with the Media Object. Parsing the hyperlink can enable the determination of the type of Media Object. In a second example, selecting a television advertisement with a remote control device can be associated with a rule specifying a video Media Object. While the application illustrates 36000B2 as classifying a received Media Object into one of four Media Object types, Image Object, Video Object, Audio Object, or Text Object, the invention is not limited to that embodiment. The invention can classify a received Media Object as a plurality of Media Objects, e.g., as both a Video Object and an Audio Object to which it can apply rules enabled by both Video Object Analysis Module and Audio Object Analysis Module, respectively. Also, the invention can classify a received Media Object into any type of Media Object and apply rules utilizing methods equivalent to those enabled by Image Object Analysis Module, Video Object Analysis Module, Audio Object Analysis Module, and/or Text Object Analysis Module to generate candidate names of vendor, Retailer, brand, and/or object and/or narrow the search space of Candidate Objects of Interest.

At 36000B4A, Method 36000B can execute any method, e.g., any method enabled by Image Object Analysis Module, to generate any type of name, including, but not limited to: (a) Candidate Vendor Names, which the application defines as a set of vendor names, both actual and/or similar, which can be narrower than the set of all vendor names and to which any method can be applied to identify a hypothesized and/or actual name of a vendor producing the Object of Interest; (b) Candidate Retailer Names, which the application defines as a set of Retailer names, both actual and/or similar, which can be narrower than the set of all Retailer names and to which any method can be applied to identify a hypothesized and/or actual name of a Retailer offering the Object of Interest; (c) Candidate Brand Names, which the application defines as a set of brand names, both actual and/or similar, which can be narrower than the set of all brand names and to which any method can be applied to identify a hypothesized and/or actual name of a brand associated with an Object of Interest; (d) Candidate Object Names, which the application defines as a set of object names, both actual and/or similar, which can be narrower than the set of all object names and to which any method can be applied to identify a hypothesized and/or actual name of an Object of Interest; and/or (e) Candidate Classes of Objects, which the application defines as a set of Classes of Objects, which can be narrower than the set of all Classes of Objects and to which any method can be applied to identify a hypothesized Class of Objects. While the application illustrates the generation of Candidate Vendor Names, Candidate Retailer Names, Candidate Brand Names, Candidate Object Names, and/or Candidate Classes of Objects, the invention is not limited to that embodiment. The invention can generate a set of any type of data whose processing can lead to the identification of the Object of Interest promoted in the received Media Object.

Image Object Analysis Module, Video Object Analysis Module, Audio Object Analysis Module, and Text Object Analysis Module can each be a CPP separate from or part of Rules Data Structure 35200.

At 36000B4B, Method 36000B can execute any method, e.g., any method enabled by Video Object Analysis Module, to generate Candidate Vendor Names, Candidate Retailer Names, Candidate Brand Names, Candidate Object Names, and/or Candidate Classes of Objects.

At 36000B4C, Method 36000B can execute any method, e.g., any method enabled by Audio Object Analysis Module, to generate Candidate Vendor Names, Candidate Retailer Names, Candidate Brand Names, Candidate Object Names, and/or Candidate Classes of Objects.

At 36000B4D, Method 36000B can execute any method, e.g., any method enabled by Audio Object Analysis Module, to generate Candidate Vendor Names, Candidate Retailer Names, Candidate Brand Names, Candidate Object Names, and/or Candidate Classes of Objects.

At 36000B5, Method 36000B can apply any method to narrow the search space of Candidate Object Names to Search Space₁. While Method 36000B can apply any method, Method 36000B at 36000B5 can focus on the following methods processing the relationship among Candidate Vendor Names, Candidate Retailer Names, Candidate Brand Names, Candidate Object Names, Candidate Classes of Objects, and/or Proximate Content to generate Search Space₁. These methods can include, but are not limited to, the following.

First, Method 36000B can generate one more Candidate Object Names in Search Space₁ by focusing on Candidate Object Names which have some relationship with Candidate Vendor Names. Method 36000B can limit the search space of Candidate Object Names to those names of objects which are produced by an identified vendor. In a first example, if Image Object Analysis Module generates from the Media Object a Candidate Object Name “Object Name A” and a Candidate Vendor Name “Vendor Name B” with approximately equivalent levels of confidence, Method 36000B can determine if Vendor Name B produces Object Name A. If Vendor Name B produces Object Name A, Method 36000B can increase a score and/or rank of Object Name A, which can increase the probability of Object Name A being the name of the true Object of Interest. If not, Method 36000B can decrease a score and/or rank of Object Name A, which can decrease the probability of Object Name A being the name of the true Object of Interest. In a second example, Video Object Analysis Module can generate from the Media Object a Candidate Vendor Name “Vendor Name B” with a higher level of confidence than that associated with the generated Candidate Object Name “Object Name A”. In the second example, Image Object Analysis Module can identify a symbol representing a logo of Vendor Name B and an image representing a Class of Objects A, e.g., a motor vehicle, and Audio Object Analysis Module can generate a hypothesized word string, “Vendor Name B”. If the object analysis modules generate a Candidate Object Name “Object Name A” which is in a Class of Objects B, e.g., a soft drink, and Vendor Name B does not product Object Name A, Method 36000B can decrease the probability of Object Name A being the name of the true Object of Interest.

Method 36000B can generate one or more Candidate Object Names in Search Space₁ by executing any method, including, but not limited to, a method applying logic to compare and/or utilizing any comparator component capable of comparing the set of Candidate Object Names and set of Candidate Vendor Names. Method 36000B can apply an analysis including, but not limited to, the following steps: (a) define CVN as the set of Candidate Vendor Names generated by any module described at 36000B4A-36000B4D, which can be limited to those Candidate Vendor Names for which Method 36000B has computed a level of confidence or any other measure of error exceeding or falling below a predefined threshold; (b) for each Candidate Vendor Name, CVNᵢ, query a data structure associating the Candidate Vendor Name with an identifier, e.g., the Manufacturer ID represented by a subset of digits in a UPC; (c) look up the objects produced by the vendor, e.g., by looking up the Product IDs represented by a subset of digits in a UPC assigned by the vendor identified by the Manufacturer ID or CVN, where the set of Product IDs is Product ID_{CVN}; (d) convert each Candidate Object Name, which can be limited to those Candidate Object Names for which Method 36000B has computed a level of confidence or any other measure of error exceeding or falling below a predefined threshold, to a Product ID, where the set of Product IDs is Product ID_{CON}; and/or (e) apply logic to compare and/or utilize any comparator component capable of comparing Product ID_{CVN} against Product ID_{CON} to identify any matching Candidate Object Names.

Second, Method 36000B can generate one or more Candidate Object Names in Search Space₁ by focusing on Candidate Object Names which have some relationship with Candidate Retailer Names. Method 36000B can limit the search space of Candidate Object Names to those names of objects which are offered by an identified Retailer. In an example, if Image Object Analysis Module generates from the Media Object a Candidate Object Name “Object Name A” and a Candidate Retailer Name “Retailer Name B” with approximately equivalent levels of confidence, Method 36000B can determine if Retailer Name B sells Object Name A. If Retailer Name B sells Object Name A, Method 36000B can increase a score and/or rank of Object Name A, which can increase the probability of Object Name A being the name of the true Object of Interest. If not, Method 36000B can decrease a score and/or rank of Object Name A, which can decrease the probability of Object Name A being the name of the true Object of Interest. For example, the generation of a Candidate Retailer Name “Auto Store” and two Candidate Object Names, “Speedy oil filter” and “Speedy coffee filter”, and limitation of the search space of Candidate Object Names to those names of objects offered by Auto Store can increase a score and/or rank of the Candidate Object Name “Speedy oil filter”.

Method 36000B can generate one or more Candidate Object Names in Search Space₁ by executing any method, including, but not limited to, a method applying logic to compare and/or utilizing any comparator component capable of comparing the set of Candidate Object Names and set of Candidate Retailer Names. Method 36000B can apply an analysis including, but not limited to, the following steps: (a) define CRN as the set of Candidate Retailer Names generated by any module at 36000B4A-36000B4D, which can be limited to those Candidate Retailer Names for which Method 36000B has computed a level of confidence or any other measure of error exceeding or falling below a predefined threshold; (b) for each Candidate Retailer Name, CRNᵢ, query a data structure associating the Candidate Retailer Name with an identifier, e.g., the MID; (c) look up the objects sold by the Retailer, e.g., by looking up the Product IDs stored by the Retailer, e.g., stored in Retailer Server 11620, where the set of Product IDs is Product ID_{CRN}; (d) convert each Candidate Object Name, which can be limited to those Candidate Object Names for which Method 36000B has computed a level of confidence or any other measure of error exceeding or falling below a predefined threshold, to a Product ID, where the set of Product IDs is Product ID_{CON}; and/or (e) apply logic to compare and/or utilize any comparator component capable of comparing Product ID_{CRN} against Product ID_{CON} to identify any matching Candidate Object Names.

Third, Method 36000B can generate one or more Candidate Object Names in Search Space₁ by focusing on Candidate Object Names which have some relationship with Candidate Brand Names. Method 36000B can limit the search space of Candidate Object Names to those names of objects which are in a class of identified brands. In an example, if Image Object Analysis Module generates from the Media Object a Candidate Object Name “Object Name A” and a Candidate Brand Name “Brand Name B” with approximately equivalent levels of confidence, Method 36000B can determine if Object Name A is in the class of Brand Name B. If the class of Brand Name B includes Object Name A, Method 36000B can increase a score and/or rank of Object Name A, which can increase the probability of Object Name A being the name of the true Object of Interest. If not, Method 36000B can decrease a score and/or rank of Object Name A, which can decrease the probability of Object Name A being the name of the true Object of Interest.

Method 36000B can generate one or more Candidate Object Names in Search Space₁ by executing any method, including, but not limited to, a method applying logic to compare and/or utilizing any comparator component capable of comparing the set of Candidate Object Names and set of Candidate Brand Names. Method 36000B can apply an analysis including, but not limited to, the following steps: (a) define CBN as the set of Candidate Brand Names generated by any module at 36000B4A-36000B4D, which can be limited to those Candidate Brand Names for which Method 36000B has computed a level of confidence or any other measure of error exceeding or falling below a predefined threshold; (b) for each Candidate Brand Name, CBNᵢ, query a data structure associating the Candidate Brand Name with an identifier; (c) look up the objects in the class of Candidate Brand Name, e.g., by looking up the Product IDs associated with each CBNᵢ, where the set of Product IDs is Product ID_{CBN}; (d) convert each Candidate Object Name, which can be limited to those Candidate Object Names for which Method 36000B has computed a level of confidence or any other measure of error exceeding or falling below a predefined threshold, to a Product ID, where the set of Product IDs is Product ID_{CON}; and/or (e) apply logic to compare and/or utilize any comparator component capable of comparing Product ID_{CBN} against Product ID_{CON} to identify any matching Candidate Object Names.

Fourth, Method 36000B can generate one or more Candidate Object Names in Search Space₁ by focusing on Candidate Object Names which have some relationship with the Candidate Classes of Objects. Method 36000B can limit the search space of Candidate Object Names to those names of objects which are in a class of identified Classes of Objects. In an example, if Image Object Analysis Module generates from the Media Object a Candidate Object Name “Object Name A” and a Candidate Class of Objects “Class of Objects B” with approximately equivalent levels of confidence, Method 36000B can determine if Object Name A is in the class of Class of Objects B. If the class of Class of Objects B includes Object Name A, Method 36000B can increase a score and/or rank of Object Name A, which can increase the probability of Object Name A being the name of the true Object of Interest. If not, Method 36000B can decrease a score and/or rank of Object Name A, which can decrease the probability of Object Name A being the name of the true Object of Interest. For example, the generation of one Candidate Class of Objects “Motor Vehicle” and two Candidate Object Names, “Rabbit” and “Turtle”, and limitation of the search space of Candidate Object Names to those names of objects in the Class of Objects “Motor Vehicle” can increase a score and/or rank of the Candidate Object Name, “Rabbit”, because a motor vehicle vendor produces a model named “Rabbit” and no motor vehicle vendor produces a model named “Turtle”.

Method 36000B can generate one or more Candidate Object Names in Search Space₁ by executing any method, including, but not limited to, a method applying logic to compare and/or utilizing any comparator component capable of comparing the set of Candidate Object Names and set of Candidate Classes of Objects. Method 36000B can apply an analysis including, but not limited to, the following steps: (a) define CCN as the set of Candidate Classes of Objects generated by any module at 36000B4A-36000B4D, which can be limited to those Candidate Classes of Objects for which Method 36000B has computed a level of confidence or any other measure of error exceeding or falling below a predefined threshold; (b) for each Candidate Class of Objects, CCNᵢ, query a data structure associating the Candidate Class of Objects with an identifier, e.g., the NAICS code for object categories, in general, and the MCC for Retailer categories; (c) look up the objects in the class of Candidate Class of Objects, e.g., by looking up the type of objects associated with each CCNᵢ, where the set of object types is Object Type_{CCN}; (d) convert each Candidate Object Name, which can be limited to those Candidate Object Names for which Method 36000B has computed a level of confidence or any other measure of error exceeding or falling below a predefined threshold, to an Object Type, where the set of Object Types is Object Type_{CON}; and/or (e) apply logic to compare and/or utilize any comparator component capable of comparing Object Type_{CCN} against Object Type_{CON} to identify any matching Candidate Object Names.

Fifth, Method 36000B can generate one or more Candidate Object Names in Search Space₁ by focusing on Candidate Object Names and/or Candidate Retailer Names which have some relationship with any pricing data recognized in the Media Object. The application defines Media Object Pricing Data as any data representing a price identified in the Media Object. Media Object Pricing Data can be limited to any string which can represent a price of an object, e.g., a numeric string following a currency symbol, where the currency symbol is the national currency utilized in the nation in which the Media Object is displayed, e.g., “$49.99” identified in a Media Object placed in a web site or TV channel displayed in the United States. Method 36000B can limit the search space of Candidate Object Names to those names of objects whose unit price falls within a predefined confidence interval. That is, if a Media Object promoting an Object of Interest includes Media Object Pricing Data, the Media Object probably promotes an object whose unit price is related to the Media Object Pricing Data. In a first example, a Media Object is unlikely to promote a chewing gum whose unit price is $1.99 and include Media Object Pricing Data equal to “$19,999”. In a second example, a Media Object is unlikely to promote an motor vehicle whose unit price is $19,999 and include Media Object Pricing Data equal to “$1.99”.

Method 36000B can generate one or more Candidate Object Names in Search Space₁ by executing any method, including, but not limited to, a method applying logic to compare and/or utilizing any comparator component capable of comparing the set of Candidate Object Names and set of Media Object Pricing Data. Method 36000B can apply an analysis including, but not limited to, the following steps: (a) recognize one or more Media Object Pricing Data in the Media Object; (b) compute for each Candidate Object Name any measure of distribution of the unit price of the object offered by a plurality of Retailers, e.g., a PDF describing the probability of the occurrence of the random variable, the unit price of the candidate object; (c) compare the PDF with the recognized Media Object Pricing Data to estimate the probability of the Candidate Object Name identifying the Promoted Object given the recognized Media Object Pricing Data, or P(CONᵢ|PDF(Media Object Pricing Data)); and/or (d) calculate and/or adjust a score and/or rank of a Candidate Object Name depending on the conditional probability. In another embodiment, Method 36000B can at step (b) compute for each Candidate Object Name a value equal to the number of digits in a currency string representing any measure of the average unit price of the candidate object or the Class of Objects in which the candidate object falls (“Currency String Digits”). For example, if the average, e.g., median, unit price of a 12-piece package of Candidate Object Name, “Wrigley Eclipse®” offered by Retailers is $1.99, then Method 36000B can compute a Currency String Digits value equal to “1” dollar digit and “2” cents digits. If the average, e.g., median, unit price of a standard “Mitsubishi Eclipse®” offered by Retailers is $19,999, then Method 36000B can compute a Currency String Digits value equal to “5” dollar digit.

In a first example, Method 36000B can calculate a score for each of two Candidate Object Names as follows: (a) recognize the Media Object Pricing Data “$19,999”; (b) compute for a first Candidate Object Name, “Wrigley Eclipse®” a PDF, f(x₁), describing the probability of the occurrence of the unit price of Wrigley Eclipse® gum, x₁, in the set of unit prices offered by, e.g., Retailers selling Wrigley Eclipse® gum; (c) compute for a second Candidate Object Name, “Mitsubishi Eclipse®” a PDF, f(x₂), describing the probability of the occurrence of the unit price of Mitsubishi Eclipse® motor vehicles, x₂, in the set of unit prices offered by, e.g., Retailers selling Mitsubishi Eclipse® motor vehicles; (d) compare the PDF f(x₁) and f(x₂) of each Candidate Object Name with the recognized Media Object Pricing Data “$19,999” e.g., where the value “$19,999” represents a value equal to 3σ above the median unit price of x₁ and a value equal to 0.1σ below the median unit price of x₂; (e) calculate a score of Candidate Object Name, “Wrigley Eclipse®” related to, e.g., the confidence interval associated with a value equal to 3σ above the median unit price of x₁ like 1%; and/or (f) calculate a score of Candidate Object Name, “Mitsubishi Eclipse®” related to, e.g., the confidence interval associated with a value equal to 0.1σ below the median unit price of x₂ like 99%. In a second example, Method 36000B can calculate a score for each Candidate Object Name by comparing the number of Currency String Digits for each Candidate Object Name to the number of currency string digits in the recognized Media Object Pricing Data in cases where there is less need for a precise score or insufficient data exists to compute PDFs for the unit prices of candidate objects.

Sixth, Method 36000B can generate one or more Candidate Object Names in Search Space₁ by focusing on Candidate Object Names which have some relationship with the Proximate Content. The application defines Proximate Content as the Content and/or attributes of the people and/or physical setting in the proximity of the Media Object in any dimension, which can include space, time, viewer attribute, physical location attribute, and/or any other dimension determining the placement of a Media Object. In a first embodiment, Proximate Content_{STATIC} can include static media comprising any combination of text and/or images, e.g., a web page displaying text and/or images in a Data Processing System, e.g., a TV 02100, PC 11800, or WD 02202, in the proximity of a Media Object promoting an Object of Interest. In a second embodiment, Proximate Content_{DYNAMIC} can include dynamic media comprising any combination of video and/or audio, e.g., a web page, television channel, or radio channel displaying video and/or audio in a Data Processing System, e.g., a TV 02100, PC 11800, or WD 02202, in the proximity of a Media Object promoting an Object of Interest. In a third embodiment, Proximate Content_{VIEWER} can include data describing one or more attributes of the one or more viewers of a Media Object. In a fourth embodiment, Proximate Content_{PHY}_{_{—}}_{LOC} can include data describing one or more attributes of the physical location of a Data Processing System, e.g., a TV 02100, PC 11800, or WD 02202, displaying a Media Object. The difference between Proximate Content_{VIEWER} and Proximate Content_{PHY}_{_{—}}_{LOC} can be illustrated by different types of events, e.g., a sporting event or a political convention, hosted at different types of locations, e.g., a large setting like an arena or stadium or a smaller setting like a bar or restaurant. The nature of the event hosted by an arena or stadium can generate a different set of values of attributes of the viewers, e.g., people interested in a sport or people interested in politics, of any Media Object displayed in arena, e.g., on an arena electronic or non-electronic billboard, which can determine a different Proximate Content_{VIEWER} even though the Proximate Content_{PHY}_{_{—}}_{LOC} for the arena is the same. The nature of the location hosting an event can generate a different set of values of attributes of the location, e.g., an arena with tens of thousands of people with a demographic profile similar to that of the dozens of people in a bar who can be strongly interested in alcohol consumption, which can determine a different Proximate Content_{PHY}_{_{—}}_{LOC} even though the Proximate Content_{VIEWER} for the locations can be the same.

Method 36000B can generate one or more Candidate Object Names in Search Space₁ by executing any method, including, but not limited to, a method applying logic to compare and/or utilizing any comparator component capable of comparing the set of Candidate Object Names and set of Proximate Content. Method 36000B can apply an analysis including, but not limited to, the following steps: (a) identify the type of Proximate Content in the proximity of the Media Object promoting an Object of Interest; (b) generate a set of attributes describing the Proximate Content, e.g., age, gender, and/or content subject matter; (c) parse the Proximate Content to identify and/or assign the value of each attribute, e.g., for a web page displaying an article about classical music located on a web site targeted at seniors, Method 36000B can assign the value=Senior for the attribute=age, the value=music for the attribute=“subject_matter”, and the value=classical for the attribute=music_type; (d) compute for each Candidate Object Name any measure of the set of attributes describing the typical user or the subject matter of the candidate object, e.g., assigning for a candidate object which is a music recording the value=“music publisher” for the attribute=“Class of Object” or the value=512230 for the attribute=NAICS; (e) compare the attribute value(s) of the Candidate Object Name with the attribute value(s) of the Proximate Content to estimate the probability of the Candidate Object Name identifying the Promoted Object given the identified Proximate Content, or P(CONᵢ|Attribute_Value(Proximate_Content)); and/or (f) calculate and/or adjust a score and/or rank of a Candidate Object Name depending on the conditional probability. For example, a Candidate Object Name “Mighty Morphin Power Rangers” would have a lower score and/or rank than a Candidate Object Name “Mozart Plano Recital” given Proximate Content with the above attribute values.

Seventh, Method 36000B can generate one or more Candidate Object Names in Search Space₁ by focusing on Candidate Object Names which have some relationship with an Object of Interest identified in a User Request, if available. In the case of a Current Media Exposure, Method 36000B can generate Candidate Object Names in Search Space₁ by applying logic to compare the name of the identified Object of Interest with the set of Candidate Object Names generated by analyzing the displayed Media Object. In the case of one or more Prior Media Exposures, Method 36000B can generate Candidate Object Names in Search Space₁ by applying logic to compare the name of the identified Object of Interest with the set of Candidate Object Names generated by analyzing the Candidate Media Objects.

Method 36000B can generate one or more Candidate Object Names in Search Space₁ by executing any method, including, but not limited to, a method executing steps, including, but not limited to: (a) identifying one or more Candidate Object Names generated by analyzing the displayed Media Object or Candidate Media Objects; and/or (b) applying logic to compare and/or utilizing any comparator component capable of comparing the generated Candidate Object Names against the name of the identified Object of Interest to identify any matching Candidate Object Names.

At 36000B6, Method 36000B can determine the type of Media Object based on whether it includes or is associated with a Forward Link, which the application defines as an element specifying the relationship between the source resource, i.e., the Media Object, and a Destination Resource, i.e., a resource to which a user viewing the Data Processing System displaying the Media Object can connect by selecting the Forward Link. In a first example, a user of Client Device 14200, e.g., PC 11800 or WD 02202, selecting a Forward Link associated with a Media Object, e.g., a video promoting Object A, displayed in web page A can connect to web page B providing more information about Object A. In a second example, a user of Client Device 14200, e.g., TV 02100, selecting through any means a Forward Link associated with a Media Object, e.g., a video promoting Object A, displayed in TV logical channel 7 can connect to any resource, e.g., another TV logical channel, a web page B displayed on TV 02100, or a web page B displayed on another Data Processing System, e.g., PC 11800 or WD 02202, providing more information about Object A. If the Media Object includes or is associated with a Forward Link, Method 36000B can proceed to 36000B7A. If not, Method 36000B can proceed to 36000B7B.

At 36000B7A, Method 36000B can parse the Forward Link associated with the Media Object to identify Candidate Vendor Names, Candidate Retailer Names, Candidate Brand Names, Candidate Object Names, and/or Candidate Classes of Objects. Method 36000B can read the Forward Link through any means, including, but not limited to: (a) for a web page, (i) linking to a module in a browser loading the web page which can detect and/or display the URL specified in the Forward Link; and/or (ii) parsing the source page of the web page displaying the Media Object to search for the URL specified in the Forward Link; and/or (b) linking to a table in a set-top box storing one or more Forward Links associated with any Media Object displayed in TV 02100, and/or parsing the Forward Link. Because many web administrators may use abbreviations and/or alternate spellings of names of Destination Resources in a URL specified in the Forward Link, Method 36000B can use any method to identify in the URL any names similar to Candidate Vendor Names, Candidate Retailer Names, Candidate Brand Names, Candidate Object Names, and/or Candidate Classes of Objects.

At 36000B8, Method 36000B can apply logic to compare and/or utilize any comparator component capable of comparing: (a) the set of Candidate Object Names inferred from the Candidate Vendor Names, Candidate Retailer Names, Candidate Brand Names, Candidate Object Names, and/or Candidate Classes of Objects generated at 36000B7A; with (b) the Candidate Object Names in Search Space₁. If there is a match, Method 36000B can proceed to 36000B10A, where it can narrow Search Space₁ to Search Space₂, which can comprise matching Candidate Object Names. If there is not a match, Method 36000B can proceed to 36000B10B.

At 36000B10B, Method 36000B can select the Forward Link associated with the Media Object to connect to the Destination Resource.

At 36000B11, Method 36000B can parse the Destination Resource to identify Candidate Vendor Names, Candidate Retailer Names, Candidate Brand Names, Candidate Object Names, and/or Candidate Classes of Objects utilizing any method, e.g., by calling any module described in 36000B4A-36000B4D. For example, a Media Object promoting a CD reproducing Mozart plano concerto no. 20 can include a Forward Link whose selection can connect to a web page including data related to one or more vendors, brands, and/or Retailers producing and/or selling the CD. Method 36000B can execute any method, including, but not limited to, any method enabled by Image Object Analysis Module, Video Object Analysis Module, Audio Object Analysis Module, and/or Text Object Analysis Module, to generate a set of Candidate Vendor Names, Candidate Retailer Names, Candidate Brand Names, Candidate Object Names, and/or Candidate Classes of Objects.

At 36000B12, Method 36000B can apply logic to compare and/or utilize any comparator component capable of comparing: (a) the set of Candidate Object Names inferred from the Candidate Vendor Names, Candidate Retailer Names, Candidate Brand Names, Candidate Object Names, and/or Candidate Classes of Objects generated at 36000B11; with (b) the Candidate Object Names in Search Space₂. If there is a match, Method 36000B can proceed to 36000B14A, where it can narrow Search Space₂ to Search Space₃, which can comprise matching Candidate Object Names. If there is not a match, Method 36000B can proceed to 36000B15.

At 36000B15, Method 36000B can generate a score and/or rank for each Candidate Object Name in Search Space₃, Search Space₂, and/or Search Space₁ utilizing any method of scoring or ranking which reflects the probability of any given Candidate Object Name being the name of the Object of Interest promoted in a Media Object.

In a first embodiment, Method 36000B can generate a score and/or rank for each Candidate Object Name in a search space, e.g., Search Space₃, by computing a conditional probability, P(Candidate Object Name|Names of Objects). Method 36000B can compute the conditional probability by executing the set enumeration method or any other method. Method 36000B can count the number of times any given Candidate Object Name is cited in Search Space₁, Search Space₂, and/or Search Space₃, P(CON), and the number of names of objects, e.g., the total number of Product IDs in the set Product ID_{CVN}, P(NOO). Method 36000B can compute P(Candidate Object Name|Names of Objects) to equal P(CON)/P(NOO). The incidence of P(CON) in, e.g., Search Space₃, will probably be small, because: (a) the number of word strings in any Media Object promoting an Object of Interest will probably be small given the small size dimensions of most Media Objects in the form of image and/or text or the short time dimensions of most Media Objects in the form of video and/or audio; and (b) after the one or more filters applied to an original set of Candidate Object Names, Search Space₃ will probably include a small number of citations of any given Candidate Object Name. While a low incidence can mean that the difference between any two P(CONᵢ) may not be statistically significant, applying one or more filters described herein means that any remaining or the highest scoring or ranking Candidate Object Name is probably the name of the true Object of Interest.

In a second embodiment, Method 36000B can generate a score and/or rank for each Candidate Object Name in a search space, e.g., Search Space₃, which can be expressed as follows:

P(Candidate Object Name)=(P(CON|CVN)*CL_{CVN}*W₁)+(P(CON|CBN)*CL_{CBN}*W₂)+(P(CON|CRN)*CL_{CRN}*W₃)+(P(CON|CCOO)*CL_{CCOO}*W₄)+(P(CON|MOPD)*CL_{MOPD}*W₅)+(P(CON|OOI_{UR}*CL_{UR}*W₆)+(P(CON|PC)*CL_{PC}*W₇) Equation (19)

where P(CON|CVN) is the conditional probability of a Candidate Object Name generated by any object analysis module given the Candidate Vendor Names generated by any object analysis module; P(CON|CBN) is the conditional probability of a Candidate Object Name generated by any object analysis module given the Candidate Brand Names generated by any object analysis module; P(CON|CRN) is the conditional probability of a Candidate Object Name generated by any object analysis module given the Candidate Retailer Names generated by any object analysis module; P(CON|CCOO) is the conditional probability of a Candidate Object Name generated by any object analysis module given the Candidate Classes of Objects generated by any object analysis module; P(CON|MOPD) is the conditional probability of a Candidate Object Name generated by any object analysis module given the Media Object Pricing Data generated by any object analysis module; P(CON|OOI_{UR}) is the conditional probability of a Candidate Object Name generated by any object analysis module given the identified Object of Interest in a User Request if available; P(CON|PC) is the conditional probability of a Candidate Object Name generated by any object analysis module given the Proximate Content if available; CLᵢ is the confidence level associated with each Candidate Object Name conditional probability where i can be CVN, CBN, CRN, CCOO, MOPD, OOI, and PC; and W, is the weight assigned by Method 36000B to each Candidate Object Name conditional probability. While the application illustrates Equation (19) as computing P(Candidate Object Name) as a function of the factors, CLᵢ, and Wᵢ described herein, the invention is not limited to that embodiment. The invention can compute P(Candidate Object Name) as a function of any additional or equivalent conditional probabilities P(CON|Factorᵢ) and its respective CLᵢ and Wᵢ, where Factorᵢ can be any factor for which Method 36000B can collect and/or generate data and where the data represents information which has some relationship to the Candidate Object Name. While Equation (19) specifies a particular sum of products of the terms, the invention is not limited to that embodiment. The invention can generate a score and/or rank for each Candidate Object of Interest through any means or formulae including some, all, additional, different, related, and/or equivalent terms in any combination.

A conditional probability can have either a discrete or continuous value. For example, if Method 36000B recognizes a CVN, e.g., “Vendor A”, and a CON, e.g., “Object A”, it can assign to P(CON|CVN) a discrete value equal to 0% if Vendor A does not produce Object A and a discrete value equal to 100% if Vendor A does produce Object A. If Method 36000B identifies a Media Object Pricing Data and computes for one or more Candidate Object Names a PDF, it can assign to P(CON|CVN) a continuous value representing the probability of the Candidate Object Name identifying the Promoted Object given the recognized Media Object Pricing Data.

Method 36000B can generate a CLᵢ which reflects the reliability of the value(s) generated for each factor by any object analysis module and/or any other method described herein. CLᵢ can be generated and/or adjusted for any factor, including, but not limited to, the following. First, Method 36000B can assign a higher CL to a Candidate Brand Name recognized by a plurality of object analysis modules, e.g., both Audio Object Analysis Module and Image Object Analysis Module, than a Candidate Brand Name recognized by one of the plurality of object analysis module. Second, Method 36000B can assign a higher CL to a Candidate Brand Name recognized with higher frequency by an object analysis module than a Candidate Brand Name recognized with lower frequency by the same object analysis module. Third, Method 36000B can assign a higher CL to any Candidate Classes of Objects generated by a Video Object Analysis Module than those generated by an Audio Object Analysis Module, because the greater amount of data displayed in a 30-second video object is more likely to enable the identification of a Class of Objects than the data displayed in a 30-second audio object. For example, a Video Object Analysis Module can display both the sound and image of a motor vehicle moving, while an Audio Object Analysis Module can transmit only the sound of a motor vehicle moving. Fourth, Method 36000B can assign a CL to any value, e.g., CONᵢ, CBNᵢ, or MOPDᵢ, depending on the reliability of the communications channel through which Client Device 14200 received the value. In one case, a Client Device 14200 can receive a sample of the audio transmitted by another Data Processing System in the vicinity, e.g., TV 02100, which is distorted by significant noise in the communications channel, i.e., other speakers or background audio in the room. In this case, Method 36000B can generate a CL, by weighting any value received through a communications channel subject to noise above a predefined threshold by, e.g., the signal-to-noise ratio (SNR) of the channel adjusted for a normalization factor.

Method 36000B can generate weights, Wᵢ, which reflect the importance of each factor evaluated by any object analysis module and/or any other method described herein. Method 36000B can generate a set of weights at each level of analysis and across different levels of analysis. That is, Method 36000B can generate a set of weights enabling the computation of a score and/or rank after executing any level of analysis (“Horizontal Weights”), e.g., generating Search Space₁ at 36000B5. Method 36000B can also generate a set of weights enabling the computation of a score and/or rank after executing different levels of analysis (“Vertical Weights”), e.g., generating a set of weights reflecting the importance of each level of analysis. For example, Method 36000B can generate a set of weights reflecting the importance of data received at different steps, e.g., the receiving of a User Request, the analysis of a Media Object at 36000B1-36000B5, the analysis a Forward Link at 36000B6-36000B10B, and/or the analysis of a Destination Resource at 36000B11-36000B14A.

Method 36000B can determine an initial set of weights through any means, including, but not limited to: (a) computer simulation; (b) empirical measurements of the relationship between Object Names and one or more parameters in a Media Object; and/or (c) theoretical modeling.

Method 36000B can determine a subsequent set of weights through any means, including, but not limited to, executing a method of adjusting weights based on: (a) using an initial set of weights to compute a score and/or rank of the generated Candidate Object Names; (b) selecting the Candidate Object Name with the highest score and/or rank; (c) comparing the Candidate Object Name with the name of the Object of Interest identified through any means, including, but not limited to: (i) reading data obtained through any means identifying the Object of Interest provided by the entity producing the Media Object, e.g., in data like the Ad-ID; and/or (ii) reading data identifying the Object of Interest provided by one or more humans in the Media Object or a sample of representative Media Objects; (d) computing a measure reflecting the differences between the Candidate Object Name selected and the Object of Interest; and/or (e) selecting a different set of weights which can reduce the measure.

Method 36000B can compute and apply a normalization factor to set the sum of the weights, Wᵢ, used to compute a score and/or rank to equal a fixed sum, e.g., 1.0 or 100%.

In generating a set of Horizontal Weights, Method 36000B can assign a weight, Wᵢ, for the effect each factor can have on the score and/or rank of a Candidate Object Name. Some factors can be more important than other factors. In a first example, a recognized Candidate Vendor Name and/or Candidate Brand Name in a Media Object can be of major importance in the score and/or rank of a Candidate Object Name, because most Media Objects promoting an Object of Interest will typically include the name of at least the vendor producing the Object of Interest or the brand associated with the Object of Interest for reasons, including, but not limited to: (a) a vendor can believe that customers are willing to buy an object because of its association with a positive image of the vendor and/or brand; and/or (b) a vendor can want to improve the image of the vendor and/or brand by raising its awareness. In a second example, a recognized Candidate Class of Objects can be of major importance in the score and/or rank of a Candidate Object Name, because most Media Objects promoting an Object of Interest will include an image and/or other data related to the Object of Interest. In the second example, a vendor producing the “Mitsubishi Eclipse®” is much more likely to include an image of a motor vehicle than an image of a package of gum related to the object “Wrigley Eclipse®”. The values of attributes of Proximate Content can be of minor importance, because, in cases where the Proximate Content is a home page of a general portal, identifying the values likely does not add information increasing the probability of identifying the Object of Interest promoted by a Media Object placed in the home page.

In generating a set of Vertical Weights, Method 36000B can assign a weight, Wᵢ, for the effect each level of analysis can have on the score and/or rank of a Candidate Object Name. Some levels of analysis can be more important than other levels of analysis. For example, a Candidate Object Name recognized in a User Request and/or selected Media Object can be of major importance in the score and/or rank of a Candidate Object Name, because an object to which a user of Client Device 14200 refers in a User Request and/or selects in a Media Object can be direct evidence of the object in which he/she is interested. The Forward Link can be of minor importance, because many Forward Links include data which may not include direct references to the Promoted Object. A Destination Resource may or may not be of significant importance, because in cases where the Destination Resource is, e.g., a web page displaying the Object of Interest promoted by the originating Media Object 33220, it can provide direct evidence of the Promoted Object, and in cases where the Destination Resource is, e.g., a web page displaying the home page of the vendor producing the Media Object 33220, it may not provide direct evidence of the Promoted Object.

Method 36000B can generate a different set of weights, Wᵢ, depending on any factor, including, but not limited to, the following. A first factor can be the type of Media Object 33220 selected, e.g., while an audio Media Object can include a sound logo, it cannot include an image logo, which can make it harder to identify a Candidate Vendor Name and/or Candidate Brand Name than a video Media Object which can include both a sound logo and an image logo. A second factor can be the type of identified Candidate Class of Objects, e.g., an Object of Interest in the form of a good or service which can be represented by physical objects can be easier to identify in a Media Object than an Object of Interest which may not be easily represented by physical objects. For example, an Object of Interest which is in the motor vehicle Class of Objects can be represented in a Media Object 33220 by one or more images of a motor vehicle or an Object of Interest which is in the surgery Class of Objects can be represented in a Media Object 33220 by one or more images of surgical instruments or an operating room. An Object of Interest which is in the consulting services Class of Objects can be harder to identify in a Media Object because it can be difficult to identify or attribute physical objects which are unique to a consulting service.

At 36000B16, Method 36000B can select as the Identified Object of Interest the Candidate Object Name with the highest score and/or rank.

At 36000B17, Method 36000B can output for further processing the Identified Object of Interest to any module, including, but not limited to: (a) Object D 02232 for presentation of the Identified Object of Interest to the user of Client Device 14200; (b) Offer ID Engine 33320 for identification of one or more Offers associated with the Identified Object of Interest; (c) Payment ID/Transaction Engine 33330 for identification of one or more Payment Accounts whose selection can reduce the price paid for the Identified Object of Interest; (d) Offer Redemption Engine 33340 for redemption of one or more Offers associated with the Identified Object of Interest; and/or (e) Transaction to AOM/CPP Engine 33350 for output to a form and/or one or more other AOM/CPP any data related to the transaction.

While the application illustrates the methods executed by Method 36000B and apparatuses enabling the execution of Method 36000B, the invention is not limited to their execution or enablement by Method 36000B. Any method disclosed by the invention can execute the methods described herein and/or be enabled by the apparatuses described herein. In an example, any method and/or apparatus disclosed by the invention can execute and/or enable the methods enabled by Image Object Analysis Module, Video Object Analysis Module, Audio Object Analysis Module, and/or Text Object Analysis Module to analyze an image, video, audio, and/or text, respectively, to identify an object and/or a Class of Objects promoted in the image, video, audio, and/or text, respectively. For example, Method 18000 can analyze prior media exposures at 18140C to generate a set of, e.g., Candidate Objects of Interest, to determine a hypothesized word string uttered by a user of Client Device 14200. Method 18000 can execute Method 36000B to analyze the set of Media Objects to generate at 18160C a set of word strings, e.g., Candidate Objects of Interest.

While the application illustrates Method 36000B as identifying an Object of Interest promoted in a Media Object, the invention is not limited to that embodiment. The invention can identify any object promoted in a Media Object associated with any data specified in Object F 02240. In one example, there can be Offer(s) and/or Reward(s) associated with not an Object of Interest, in particular, but a Vendor of Interest, Brand of Interest, or Retailer of Interest promoted in the Media Object. For example, a Payment Issuer Server 11600 can offer a Reward for using a Payment Account to purchase any object sold by a Retailer of Interest, including objects other than the Object of Interest promoted in the Media Object. Identifying the Retailer of Interest in the example can enable the invention to identify a Reward offered which can decrease the price paid for the Object of Interest.

While the application illustrates Method 36000B as generating a score and/or rank for each Candidate Object Name in a search space, e.g., Search Space₁ or Search Space₃, the invention is not limited to that embodiment. The invention can generate a score and/or rank for each Candidate Object Name by executing any method of generating a search space and/or analyzing any data and/or factors, e.g., any methods described in Method 18160C_{PUT}. For example, the invention can execute the same type of methods to compute any conditional probability in Method 36000B as those used to compute one or more conditional probabilities in Method 18160C_{PUT}.

### Offer Identification Engine

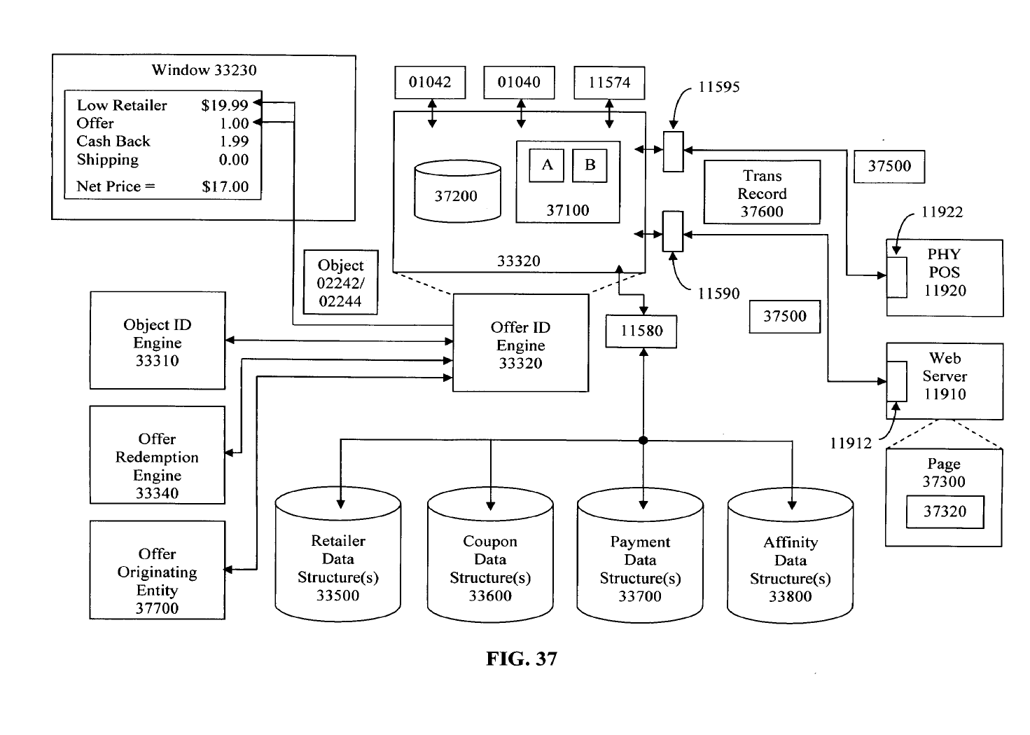

FIG. 37 depicts a block diagram of an exemplary article of manufacture or computer program product, Offer ID Engine 33320, enabling the transformation of an object, an electronic image of an object, and/or data representing an object into a different state, i.e., the automatic identification of one of more qualifying offers related to an object of interest and/or a class of interest, according to one embodiment. The AOM/CPP can implement the methods described herein by utilizing a subset of the following components, any combination of the components, or additional related, alternative, and/or equivalent components not disclosed earlier.

Offer ID Engine 33320 can be any AOM/CPP which can identify one or more Offers associated with an Object of Interest and/or a Class of Interest utilizing any method described herein. Identifying one or more Offers associated with an Object of Interest and presenting the identified Offers in, e.g., Object F 02240, can enable a user of Client Device 14200 to view conveniently the savings associated with the Object of Interest.

Offer ID Engine 33320 can comprise: (a) a memory, e.g., Memory 01120; (b) a processor, e.g., Processor 01040; (c) a data structure, e.g., Data Structure 37100, stored in the memory and executable on the processor which can receive, store, and/or transmit data related to identifying one or more Offers associated with an Object of Interest and/or Class of Interest; and/or (d) Rules Data Structure 37200, stored in the memory and executable on the processor which can store rules, instructions, and/or functions, e.g., Method 38000A, for using the data in Data Structure 37100 and/or any other data to identify and/or redeem one or more Offers associated with an Object of Interest and/or Class of Interest.

The invention can couple Offer ID Engine 33320 to any Data Processing System, e.g., Inter Server 02300 and/or Client Device 14200. In any Client Device 14200, e.g., WD 02202, Offer ID Engine 33320 can be stored in, and/or can utilize the memory, processor, transceiver, and/or any other component of, any module or component of Client Device 14200, including, but not limited to: (a) NFC Module 11574; (b) Component 11576; and/or (c) Memory 01120. In any Data Processing System which is not a Client Device 14200, e.g., Inter Server 02300, Offer ID Engine 33320 can be stored in, and/or can utilize the memory, processor, transceiver, and/or any other component of, any module or component of the Data Processing System. While the invention couples Offer ID Engine 33320 to one Data Processing System, it is not limited to that embodiment. The invention can distribute the functions, instructions, and/or data executed by Offer ID Engine 33320 across a plurality of Data Processing Systems.

The invention can configure Offer ID Engine 33320 to receive data, including, but not limited to: (a) Client Device Data 35300, which can include any data received from Client Device 14200, which in turn can include, but are not limited to: 11512, 11514, 11522, 11532, 11542, 11552, 11562, and/or 11572A; (b) Retailer Data Structure 33500; (c) Coupon Data Structure 33600; (d) Payment Data Structure 33700; (e) Affinity Data Structure 33800; and/or (f) User Data Structure 35400E.

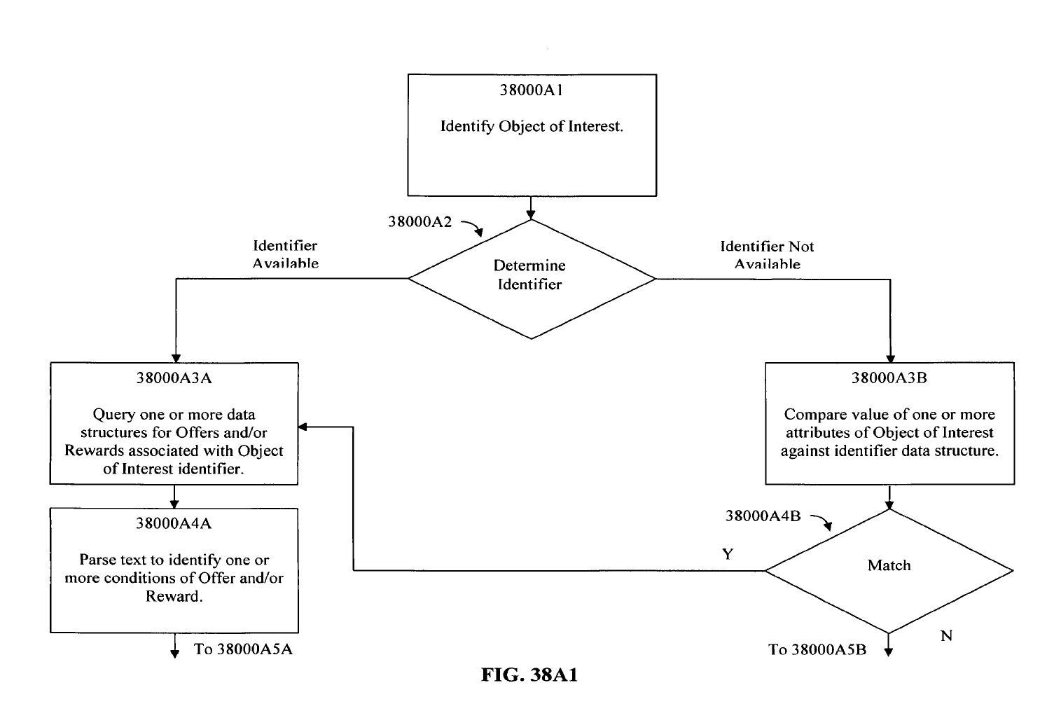

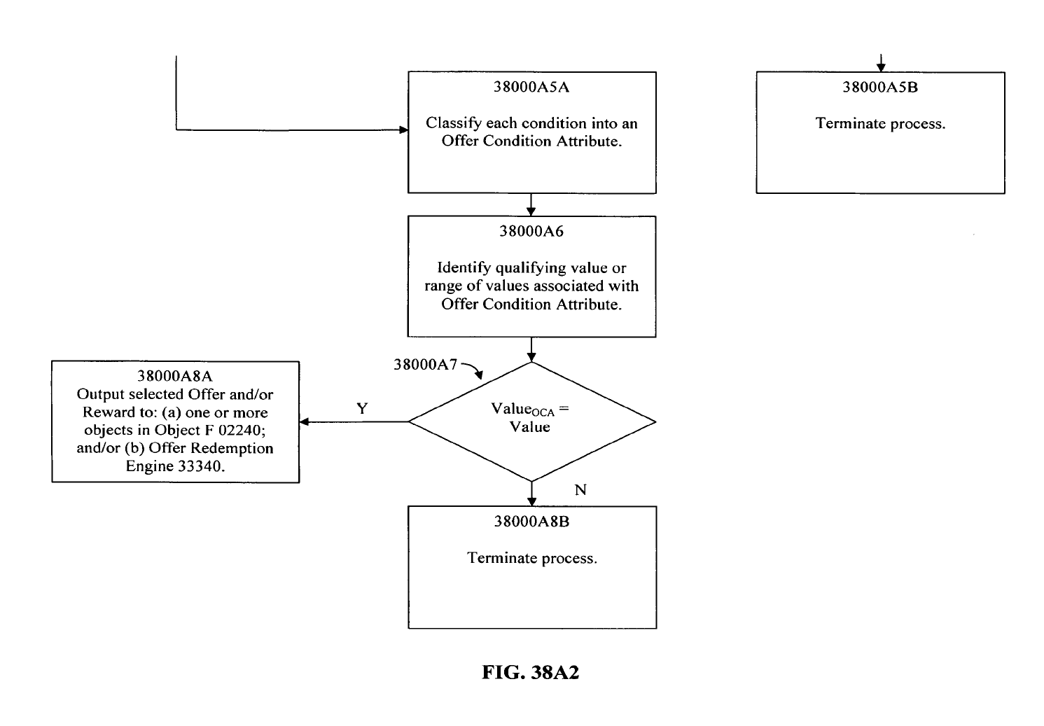

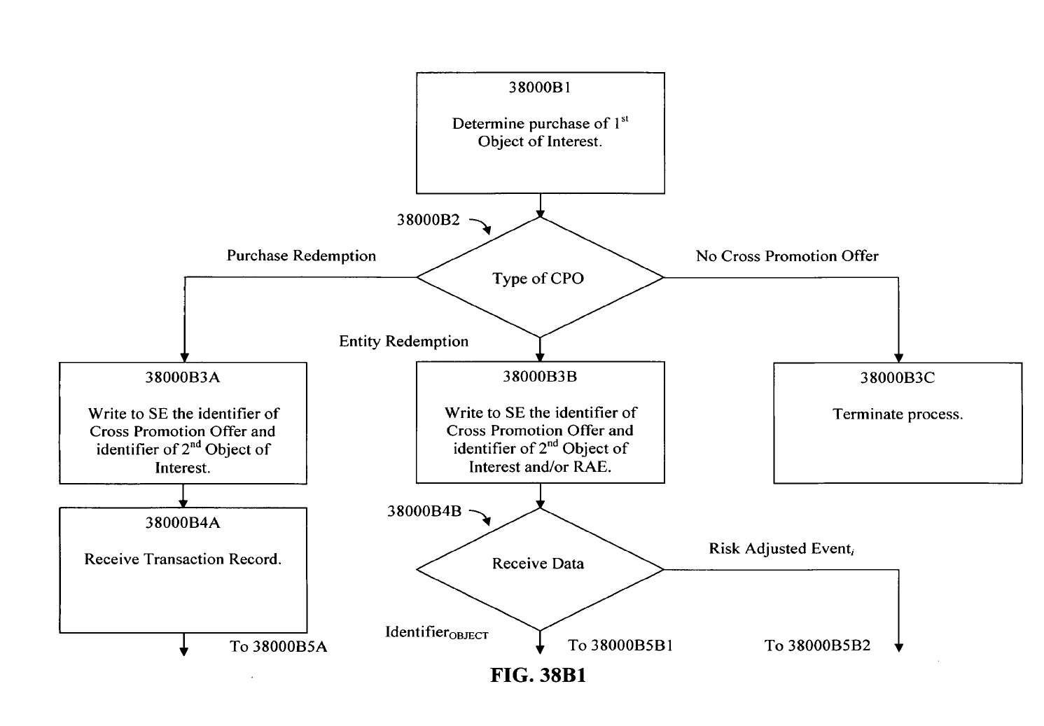

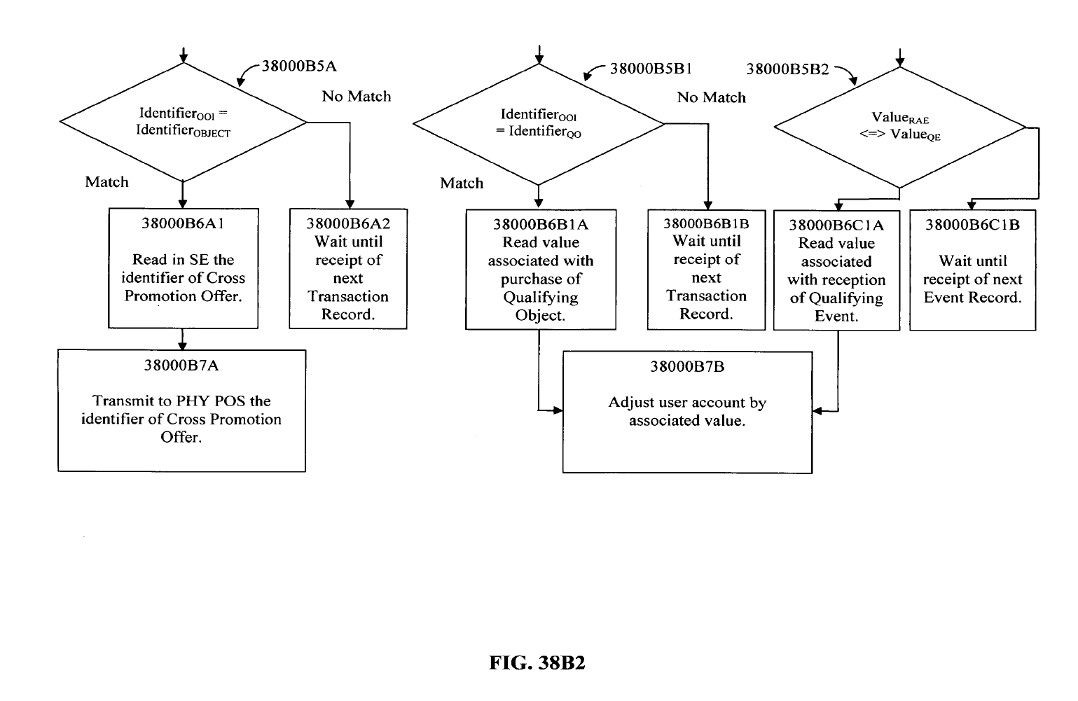

FIG. 38A1 and FIG. 38A2 depict a flowchart of an exemplary computer-implemented method, Method 38000A, that when executed can enable the automatic identification of one or more qualifying offers related to an object of interest and/or a class of interest, according to one embodiment. The flowchart refers to the apparatus and structures depicted in FIG. 37. However, the method is not limited to those embodiments. The method can implement the steps described herein utilizing a subset of the components, any combination of the components, or additional, related, alternative, and/or equivalent components depicted in FIG. 37 and/or elsewhere in the application. The method can execute a subset of the steps, any combination of the steps, the steps in different order, and/or additional, related, alternative, or equivalent steps.

At 38000A1, Method 38000A can execute any method described herein to identify an Object of Interest.

At 38000A2, Method 38000A can determine if there is an identifier associated with the Object of Interest, e.g., a UPC where the Object of Interest is typically a good or a MID where the Object of Interest is a Retailer.

At 38000A3B, Method 38000A can apply logic to compare and/or utilize any comparator component capable of comparing the value of one or more attributes of the identified Object of Interest against the value of the same attributes in a data structure storing objects and their attributes. For example, a data structure can include a record specifying for the object “The Twilight Saga Eclipse DVD”: (a) one or more attributes for the object, e.g., a first attribute name “genre” and the value “romance”, and a second attribute name “writer” and the value “Stephenie Meyer”; and/or (b) any identifier associated with the object. Method 38000A can execute any method to identify the value of one or more attributes of the identified Object of Interest.

At 38000A4B, Method 38000A can determine if there is a match of the value of each attribute. If there is a match, Method 38000A can proceed to 38000A3A. Otherwise, it can proceed to 38000A5B and terminate the process.

At 38000A3A, Method 38000A can query one or more data structures, e.g., Retailer Data Structure(s) 33500, Coupon Data Structure(s) 33600, Payment Issuer Server(s) 11600, and/or Affinity Data Structure(s) 33800, to identify one or more Offers and/or Rewards associated with each Object of Interest identifier.

At 38000A4A, Method 38000A can parse the text describing the one or more Offers and/or Rewards to identify one or more conditions of each Offer and/or Reward.

At 38000A5A, Method 38000A can classify each condition into an Offer Condition Attribute, which the application defines as a property of the Offer whose value must meet a predefined condition, which can include, but is not limited to: (a) any range of dates within which the Offer must be redeemed, where the data type is typically a date or timestamp; (b) any limitation on the number of units of the associated object which can be purchased in a single Transaction, where the data type is typically an integer; (c) any location in which the Offer must be redeemed, where the data type is typically an alphanumeric character string, e.g., a state abbreviation or zip code; (d) any demographic characteristic of the user transmitting a User Request, e.g., his/her age; and/or (e) any requirement of membership of an entity, e.g., the organization making the Offer and/or Reward.

While the application defines an Offer Condition Attribute as a limiting property of an Offer, the invention is not limited to that embodiment. The invention can define an Offer Condition Attribute to include a limiting property of any method of reducing and/or any entity offering the price of an Object of Interest and/or Class of Interest, including, but not limited to: (a) a Retailer, e.g., a Retailer like a buying club limiting the population of users who can purchase an Object of Interest; (b) a Reward, e.g., a Reward redeemable only in a given Class of Retailers; (c) an Affinity group, e.g., an Offer redeemable only by users who are members of the Affinity group; (d) a Rebate, e.g., a Rebate redeemable only during a predefined time period; (e) a Shipping Offer, e.g., a Shipping Offer limiting the set of qualifying destination addresses; and/or (f) a Tax incentive, e.g., an incentive redeemable for a given Class of Objects.

At 38000A6, Method 38000A can identify the value or range of values associated with each Offer Condition Attribute specified in the Offer and/or Reward.

At 38000A7, Method 38000A can apply logic to compare and/or utilize any comparator component capable of comparing a value for each Offer Condition Attribute received, collected, generated, and/or computed by the invention against the value or range of values specified in the Offer and/or Reward. For example, Method 38000A can: (a) parse a Final Transaction Record for a date or timestamp of the Transaction and compare the date or timestamp against the value or range of values in an Offer Condition Attribute, e.g., “Qualifying Dates”; (b) parse the Final Transaction Record for the number of units of an Object of Interest purchased in the Transaction and compare the unit number against the value in an Offer Condition Attribute, e.g., “Limit Quantity”; (c) parse the Final Transaction Record for the location of the Transaction or determine the location of the WD 02202 at the time of the Transaction and compare the location value against the value in an Offer Condition Attribute, e.g., “Qualifying States”; (d) parse one or more Identification Form(s) 41319, e.g., a driver license, for the value associated with the attribute, e.g., “date of birth”, and compare the computed age value against the value in an Offer Condition Attribute, e.g., “under 18”, or the age associated with a term, e.g., “Senior”; and/or (e) parse one or more forms specifying the membership of the user in a group, company, organization, or any entity making the Offer and/or Reward, e.g., Loyalty Account 41312, Affinity Account 41313, and/or Insurance Account 41314, and compare the value, e.g., the entity name like “AAA” or any identifier associated with the entity against the value in an Offer Condition Attribute, e.g., “AAA Member”. If there is a match, Method 38000A can proceed to 38000A8A. Otherwise, it can proceed to 30000A8B and terminate the process.

At 38000A8A, Method 38000A can determine that the user and/or Transaction qualifies for the Offer and/or Reward and output the selected one or more Offers and/or Rewards to: (a) one or more objects in Object F 02240; and/or (b) Offer Redemption Engine 33340.

For example, Method 38000A can output to: (a) 03000D3B1 an alphanumeric string representing the name of the entity making a qualifying Offer; (b) 03000D3B2 a currency string representing the value of the Offer associated with 03000D3B1; (c) 03000D3C1 an alphanumeric string representing the name of the affinity group making a qualifying Offer; (d) 03000D3C2 a currency string representing the value of the Offer associated with 03000D3C1; (e) 03000E4 an alphanumeric string representing a description of an offered discount, e.g., a discount because the value of a user demographic attribute, e.g., age, falls within a range of values required to qualify for a Retailer discount; and/or (f) a row or column associated with 03000E4 a currency string representing the value of the associated Offer.

While the application illustrates the identification of a qualifying Offer and/or Reward related to an Object of Interest and/or a Class of Interest, the invention is not limited to that embodiment. The invention can enable the identification of a qualifying Offer and/or Reward related to any type of attribute, including, but not limited to: (a) an Offer and/or Reward which can be redeemed only at a given Retailer and/or Class of Retailers; (b) an Offer and/or Reward which can be redeemed only by a given type of user, e.g., only college students or only seniors.

FIG. 38B1 and FIG. 38B2 depict a flowchart of an exemplary computer-implemented method, Method 38000B, that when executed can enable the identification and/or redemption of one or more qualifying offers on a second object of interest if a user purchases a first object of interest, according to one embodiment. The flowchart refers to the apparatus and structures depicted in FIG. 37. However, the method is not limited to those embodiments. The method can implement the steps described herein utilizing a subset of the components, any combination of the components, or additional, related, alternative, and/or equivalent components depicted in FIG. 37 and/or elsewhere in the application. The method can execute a subset of the steps, any combination of the steps, the steps in different order, and/or additional, related, alternative, or equivalent steps.

At 38000B1, Method 38000B can determine the purchase of a first Object of Interest.

At 38000B2, Method 38000B can apply logic to compare and/or utilize any comparator component capable of comparing the identifier of the first Object of Interest purchased against one or more identifiers in a data structure storing identifiers of one or more objects associated with an Offer related to a second or additional Object of Interest (“Cross Promotion Offer”). If there is no match, Method 38000B can proceed to 38000B3C and terminate the process. If there is at least one match, Method 38000B can proceed for each matching object to any process, including, but not limited to: (a) a process starting at 38000B3A for any Cross Promotion Offer which can be redeemed by a purchase of the second or additional Object of Interest, e.g., a Cross Promotion Offer providing a discount in the price of a second Object of Interest like a prequel DVD after the purchase of a first Object of Interest like a ticket to a movie “Eclipse”; (b) a process starting at 38000B3B for any Cross Promotion Offer which can be redeemed only by the execution of a method by a Data Processing System associated with the entity making the Cross Promotion Offer, e.g., a Cross Promotion Offer providing a decrease in a second Object of Interest like periodic insurance premium after the purchase of a first Object of Interest like an object of which the entity encourages the purchase and/or detection of an event by any Data Processing System associated with the user.

At 38000B3A, Method 38000B can write to SE 41300 the identifier(s) of a Cross Promotion Offer and the identifier of the associated second and/or additional Object of Interest. In another embodiment, Method 38000B can write the identifier of a Cross Promotion Offer and the identifier of the associated second and/or additional Object of Interest to a Data Processing System capable of executing the redemption of the Cross Promotion Offer, e.g., a Retailer Server 11620 and/or Payment Issuer Server 11600.

At 38000B4A, Method 38000B can receive from any Data Processing System, e.g., IP POS 11914 and/or PHY POS 11920, a Proposed Transaction Record or Final Transaction Record.

At 38000B5A, Method 38000B can apply logic to compare and/or utilize any comparator component capable of comparing the identifier(s) of the second and/or additional Objects of Interest stored in SE 41300 or any other Data Processing System, e.g., Inter Server 02300, with the identifier(s) of the one or more objects in the Proposed Transaction Record or Final Transaction Record. In a first embodiment, Method 38000B can execute the comparison through a WD 02202 comparing the identifiers to determine a match. In a second embodiment, Method 38000B can execute the comparison through another Data Processing System, e.g., Inter Server 02300 comparing the identifiers to determine a match. If there is no match, Method 38000B can proceed to 38000B6A2 and wait until receipt of the next Proposed Transaction Record or Final Transaction Record. If there is a match, Method 38000B can proceed to 38000B6A1.

At 38000B6A1, Method 38000B can read in SE 41300 or any data structure in another Data Processing System, e.g., Inter Server 02300, the identifier of the Cross Promotion Offer associated with the matching second or additional Object of Interest.

At 38000B7A, Method 38000B can transmit to IP POS 11914 and/or PHY POS 11920 the identifier of the Cross Promotion Offer for redemption.

At 38000B3B, Method 38000B can write to SE 41300 or any data structure in another Data Processing System, e.g., Inter Server 02300, the identifier of the Cross Promotion Offer and: (a) the identifier of the second and/or additional Object of Interest; (b) data related to one or more Risk Adjusted Events (“Event Record”); and/or (c) any other data which can lead a vendor to adjust the pricing of an object offered by the vendor. The application defines a Risk Adjusted Event as any event which can affect the risk of the occurrence of an outcome, where the outcome can be any activity related to a cost. The outcomes can include, but are not limited to: (a) an outcome related to the health of a user, e.g., the diagnosis of a disease, against which a user can purchase a health insurance policy to insure; and/or (b) an outcome related to the condition of an asset, e.g., damage of an automobile or a home, against which a user can purchase an automobile insurance policy or homeowner insurance policy, respectively, to insure.

A Risk Adjusted Event can include any event which can be detected and measured as either a continuous value or a discrete value, e.g., the event occurs or does not occur. A Risk Adjusted Event can include, but is not limited to: (a) a change in the weight of a user; (b) a change in the body mass of a user; (c) the purchase and/or consumption of any object, e.g., cigarettes, in excess of a predefined threshold which can lead a vendor of an object, e.g., a health insurance policy, to adjust the object pricing, e.g., health insurance premium; (d) an action related to an asset in excess of a predefined threshold, e.g., the velocity of an automobile exceeding a speed limit in a given location; and/or (e) the occurrence or lack of occurrence of an event related to an asset, e.g., the detection of the active operation of a home security system.

At 38000B4B, Method 38000B can receive any type of data which can cause a vendor to adjust the pricing of an object, e.g., an insurance policy, including, but not limited to: (a) the identifier of a first object purchased by a user, e.g., the purchase of membership in a qualified exercise club with an associated identifier like the MID of the exercise club, or the purchase of an installation of a qualified home security system with an associated identifier like the MID of the home security system vendor, which the vendor has specified can increase or decrease the price of the second object offered by the vendor, e.g., a health insurance policy or homeowner insurance policy, respectively; and/or (b) any data related to a Risk Adjusted Event which the vendor has specified can increase or decrease the price of an object offered by the vendor, e.g., a health insurance policy or automobile insurance policy.

Method 38000B can receive the data from any Data Processing System, including, but not limited to: (a) Client Device 14200, which can transmit data measuring any metric which can lead a vendor to adjust an offered object pricing, e.g., the purchase of an automobile security system like a LoJack® GPS system leading a vendor to decrease the price of an automobile insurance policy; (b) a Data Processing System operated by an entity authorized to transmit data measuring any metric which can lead a vendor to adjust an offered object pricing, e.g., the transmission of data measuring the weight of a user by a physician participating in the health insurance plan of which the user is a member; and/or (c) a Data Processing System capable of transmitting to another Data Processing System operated by a vendor, either directly or indirectly through any Data Processing System, e.g., Client Device 14200, any data measuring any metric of an apparatus which can lead the vendor to adjust an offered object pricing, e.g., any device monitoring any attribute of an automobile like a GPS system detecting the velocity of an automobile exceeding a speed limit in a given location leading a vendor to increase the price of an automobile insurance policy.

If Method 38000B receives the identifier of a second and/or additional Object of Interest through any means, e.g., receiving a Final Transaction Record specifying the purchase of the second and/or additional Object of Interest from any Data Processing System, e.g., WD 02202, Payment Issuer Server 11600, and/or Retailer Server 11620, it can proceed to 38000B5B1. If Method 38000B receives data related to one or more Risk Adjusted Events, it can proceed to 38000B5B2.

At 38000B5B1, Method 38000B can apply logic to compare and/or utilize any comparator component capable of comparing the identifier of the first Object of Interest purchased, Identifier_{OOI}, against one or more identifiers in a data structure storing identifiers of one or more objects associated with a Cross Promotion Offer, which the application defines as Identifier_{QO} or a Qualifying Object Identifier. If Method 38000B determines there is at least one match, it can proceed to 38000B6B1A. If there is no match, Method 38000B can proceed to 38000B6B1B and wait until receipt of the next Final Transaction Record.

At 38000B6B1A, Method 38000B can read any value associated with the purchase of a Qualifying Object, which reflects the adjustment in pricing of a second Object of Interest specified by the vendor of the second Object of Interest promoted in a Cross Promotion Offer.

At 38000B7B, Method 38000B can adjust the account of the user to reflect the adjustment in pricing of the second Object of Interest or the object offered by the vendor to reflect either: (a) the value associated with the purchase of a Qualifying Object at 38000B6B1A; or (b) the value associated with the reception of a Qualifying Event at 38000B6C1A.

At 38000B5B2, Method 38000B can apply logic to compare and/or utilize any comparator component capable of comparing the value of a Risk Adjusted Event, Value_{RAE}, against one or more a value or range of values in a data structure storing one or more attribute-value pairs related to any Risk Adjust Event, which the application defines as Value_{QE} or a Qualifying Event Value. If Method 38000B determines that the Value_{RAE} meets a given Value_{QE}, i.e., is more than, equal to, or less than a given Value_{QE}, or falls inside or outside a given range of Value_{QE}, depending on the predefined thresholds specified by the vendor, Method 38000B can proceed to 38000B6C1A. If Method 38000B determines that the Value_{RAE} does not meet a given Value_{QE}, Method 38000B can proceed to 38000B6C1B and wait until receipt of the next Event Record.

At 38000B6C1A, Method 38000B can read any value associated with the reception of a Qualifying Event, which reflects the adjustment in pricing of the object offered by the vendor.

In an embodiment where the vendor offers any type of object in an insurance Class of Objects, Method 38000B can enable the vendor to determine a probability of an outcome occurring as a function of one or more Risk Adjusted Events detected. Current risk assessment models typically used by insurance vendors focus on data that is static, e.g., demographic attributes like age and gender, self-reported conditions typically obtained through user surveys, and/or administrative data like prior claims. Method 38000B can enable an insurance vendor to receive, store, and/or process data that is dynamic and enable the vendor to improve the accuracy of estimating the risk of an outcome occurring.

While the application illustrates the applying of Method 38000B to an object in the form of an insurance policy, the invention is not limited to that embodiment. The invention can apply Method 38000B to any type of object, including, but not limited to: (a) any type of insurance policy; (b) any type of object purchased by a user but where the user does not assume full ownership until a later time, e.g., upon full repayment of a loan associated with the purchase like a mortgage associated with a home; and/or (c) any type of object leased by a user, e.g., an automobile.

Method 38000B can yield a variety of benefits, including, but not limited to: (a) redeeming automatically a Cross Promotion Offer when a user purchases a first Object of Interest, e.g., a vendor of a health insurance policy can: (i) promote in a Cross Promotion Offer a decrease in the price of a user's health insurance premium if the user purchases a membership in a qualified exercise club; and (ii) execute Method 38000B to redeem automatically the Cross Promotion Offer after receiving a Final Transaction Record specifying purchase of the exercise club membership; and/or (b) adjusting automatically the pricing of an object offered by a vendor when a user, Client Device 14200, and/or any other Data Processing System transmits any data related to one or more Risk Adjusted Events, e.g., a vendor of a health insurance policy can: (i) promote in an Offer a decrease in the price of a user's health insurance premium if the user consumes, and not just purchase, a membership in a qualified exercise club by using the services, e.g., run x miles on a treadmill; and (ii) execute Method 38000B to adjust the pricing of the user's health insurance premium depending on the amount of exercise performed.

### Payment Identification/Transaction Engine

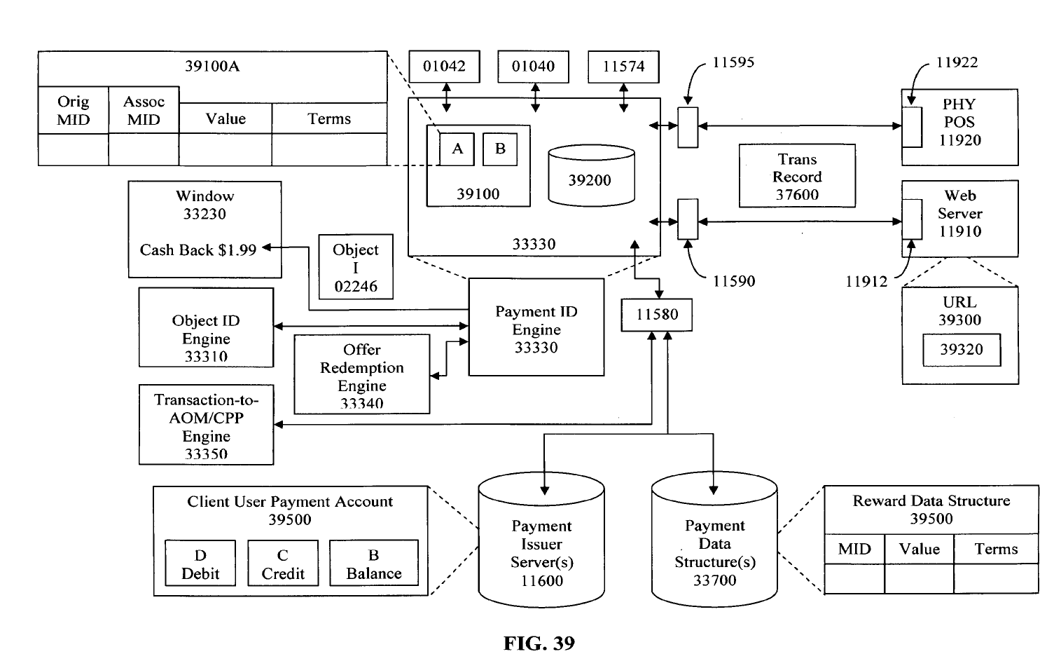

FIG. 39 depicts a block diagram of an exemplary article of manufacture or computer program product, Payment ID/Transaction Engine 33330, enabling the transformation of an object, an electronic image of an object, and/or data representing an object into a different state, i.e., automatic selection of a payment account, deposit or transfer of cash into a payment account, and/or redemption of earned reward currency related to a purchase of the object of interest, according to one embodiment. The AOM/CPP can implement the methods described herein by utilizing a subset of the following components, any combination of the components, or additional, related, alternative, and/or equivalent components, and can include, but is not limited to, the following components not disclosed earlier.

Payment ID/Transaction Engine 33330 can comprise: (a) a memory, e.g., Memory 01120; (b) a processor, e.g., Processor 01040; (c) a data structure, e.g., Data Structure 39100, stored in the memory and executable on the processor which can receive, store, and/or transmit data related to: (i) one or more Objects of Interest identified by Object ID Engine 33310; (ii) one or more Rewards related to the Object(s) of Interest; (iii) one or more Offers related to the Object(s) of Interest; (iv) one or more Payment Accounts held by the user of Client Device 14200; (v) one or more Transaction Record 37600 associated with each object purchased; and/or (vi) one or more attributes specified by AOM/CPP Server 43100; and/or (d) Rules Data Structure 39200, stored in the memory and executable on the processor which can store rules, instructions, and/or functions, e.g., Method 40000A and/or Method 40000B, for computing, processing, and/or displaying Object(s) of Interest, Reward(s) related to the Object(s) of Interest; Offer(s) related to the Object(s) of Interest, Payment(s) related to the Object(s) of Interest, and/or Payment Account(s) held by the user of Client Device 14200. Payment ID/Transaction Engine 33330 can be located in any Data Processing System, e.g., WD 02202 and/or Inter Server 02300. Rules Data Structure 39200 can be customized by any entity, including, but not limited to: (a) the user of Client Device 14200; and/or (b) Payment Issuer Server 11600. The rules can be set or reset in any manner, including, but not limited to: (a) default settings at installation; and/or (b) customized by the user through changing one or more settings in an interface.

The invention can couple Payment ID/Transaction Engine 33330 to any Data Processing System, e.g., Inter Server 02300 and/or Client Device 14200. In any Client Device 14200, e.g., WD 02202, Payment ID/Transaction Engine 33330 can be stored in, and/or can utilize the memory, processor, transceiver, and/or any other component of, any module or component of Client Device 14200, including, but not limited to: (a) NFC Module 11574; (b) Component 11576; and/or (c) Memory 01120. In any Data Processing System which is not a Client Device 14200, e.g., Inter Server 02300, Payment ID/Transaction Engine 33330 can be stored in, and/or can utilize the memory, processor, transceiver, and/or any other component of, any module or component of the Data Processing System. While the invention couples Payment ID/Transaction Engine 33330 to one Data Processing System, it is not limited to that embodiment. The invention can distribute the functions, instructions, and/or data executed by Payment ID/Transaction Engine 33330 across a plurality of Data Processing Systems.

Data Structure 39100A can receive, store, and/or transmit data related to: (a) one or more Retailers and/or its associated MID; (b) an attribute specifying if the type of Retailer, e.g., IP Retailer or PHY Retailer; (c) one or more Offers and/or Rewards and their associated identifiers; (d) an attribute specifying if a Retailer and/or Offer is associated with one or more other Offers, e.g., a co-promotion where the purchase of a first object from Retailer A (“Originating Offer”) can qualify for a discount on the purchase of a second object from Retailer B (“Associated Offer”); (e) an identifier of the entity making the Originating Offer, e.g., the MID of Retailer A; (f) an identifier of the entity making the Associated Offer, e.g., the MID of Retailer B; (g) the value of the Offer; and/or (h) one or more terms and/or conditions which must be met to qualify for the Offer.

Data Structure 39100B can receive, store, and/or transmit data related to one or more Payment Accounts held by the user transmitting a User Request.

URL 39300 can be a resource, e.g., a document or web page, displayed by Web Server 11910.

Field 39320 can be a field in any resource whose value and/or selection can be an input utilized by Web Server 11910 to execute the purchase of an object.

Client User Payment Account 39400 can be any data structure which can receive, store, and/or transmit data related to one or more users of Client Device 14200. The data can include, but are not limited to: (a) an amount which can be debited to a Payment Account in any Transaction; (b) an amount which can be credited to a Payment Account in any Transaction; and/or (c) an amount which represents the balance in a Payment Account, before or after any Transaction.

Reward Data Structure 39500 can be any data structure which can receive, store, and/or transmit data related to one or more objects for which a Payment Issuer Server 11600 can associate one or more Rewards.

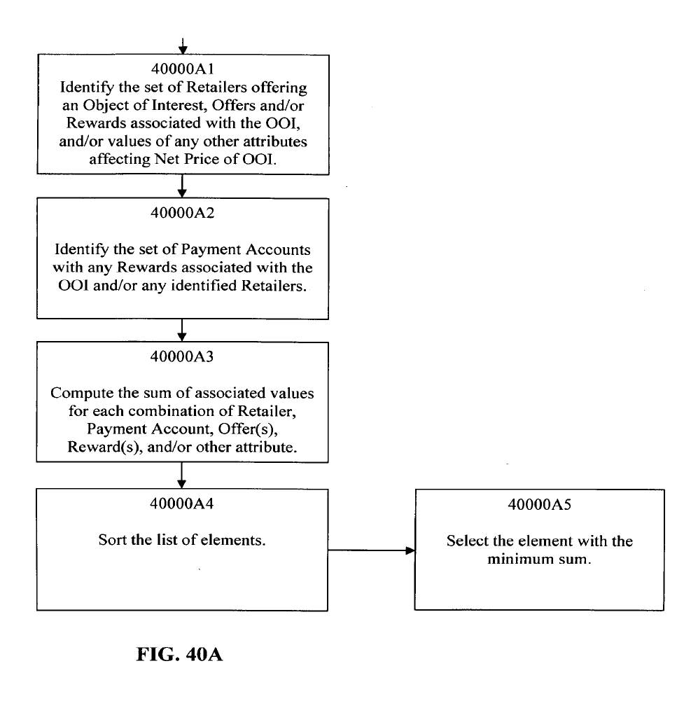

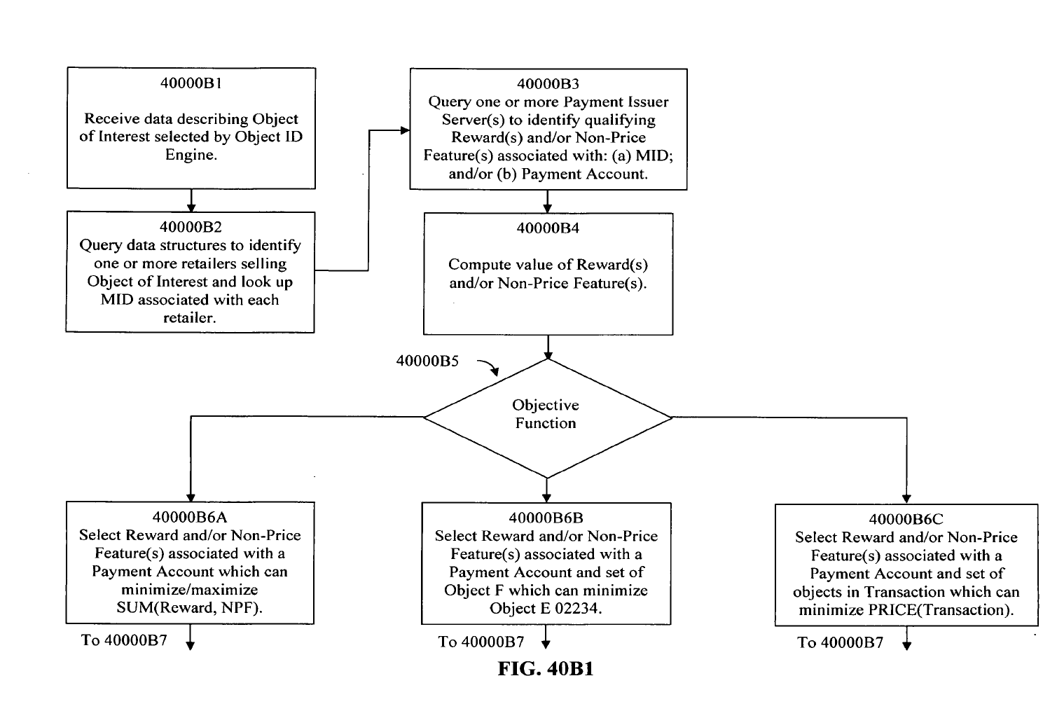

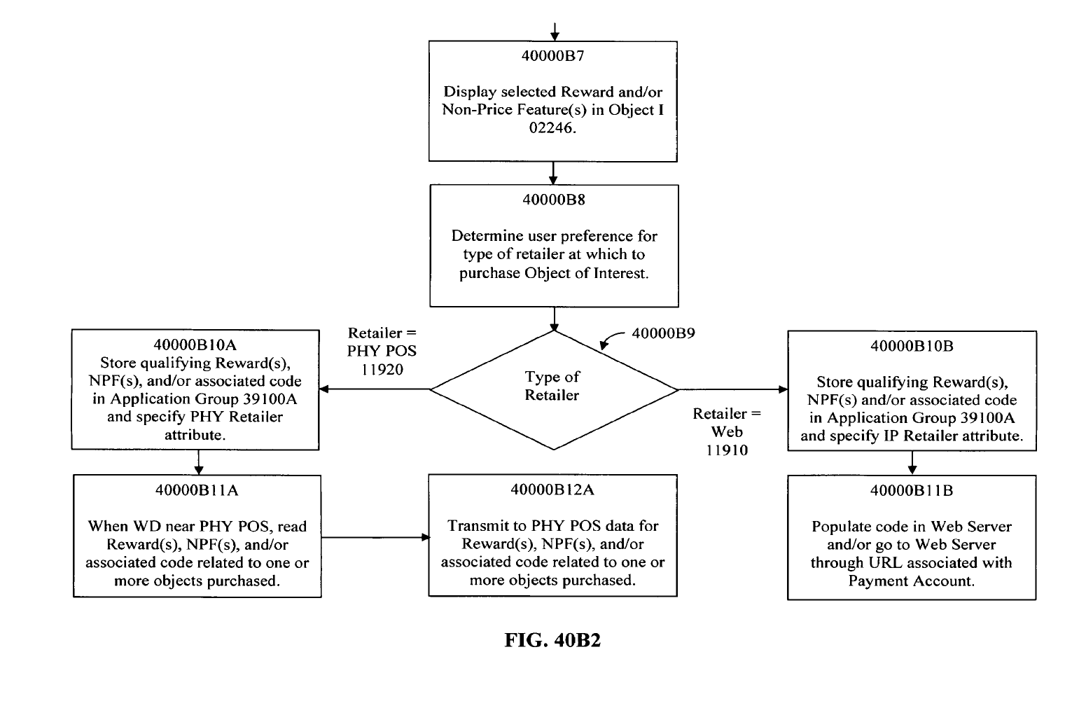

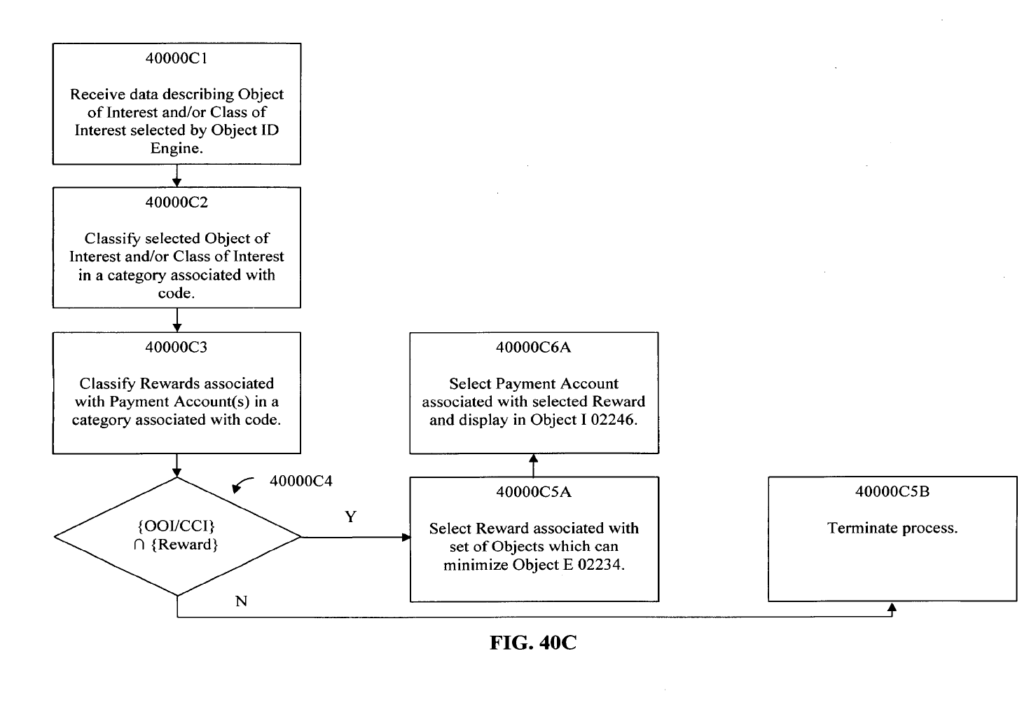

FIG. 40A depicts a flowchart of an exemplary computer-implemented method, Method 40000A, that when executed can enable the transformation of an object, an electronic image of an object, and/or data representing an object into a different state, i.e., the automatic selection of a payment account whose reward value, in combination with the price offered by a retailer and/or the value of one or more offers and/or other rewards related to the object of interest, can achieve a desirable level of savings, according to one embodiment. The flowchart refers to the apparatus and structures depicted in FIG. 39. However, the method is not limited to those embodiments. The method can implement the steps described herein utilizing a subset of the components, any combination of the components, or additional, related, alternative, and/or equivalent components depicted in FIG. 39 and/or elsewhere in the application. The method can execute a subset of the steps, any combination of the steps, the steps in different order, and/or additional, related, alternative, or equivalent steps.

At 40000A1, Method 40000A can identify the set of: (a) Retailers offering an Object of Interest; (b) one or more Offers which any method, e.g., Method 38000A, determines as qualifying for the purchase of the Object of Interest at any Retailer identified at (a); (c) one or more Rewards which any method, e.g., Method 38000A, determines as qualifying for the purchase of the Object of Interest at any Retailer identified at (a); and/or (d) any other factor which can affect the Net Price of the Object of Interest, e.g., the values of one or more other objects in Object F 02240.

At 40000A2, Method 40000A can identify the set of Payment Accounts with any Rewards associated with the Object of Interest and/or any Retailer identified at 40000A1(a).

At 40000A3, Method 40000A can compute the sum of the value associated with each attribute at 40000A1(a), 40000A1(b), 40000A1(c), 40000A1(d), and 40000A2. For example, Method 40000A can compute the sum of the price offered for the Object of Interest by a first Retailer, the value of a first Offer, the value of a first Reward, the value of a first type of tax attribute, e.g., a state sales tax, the value of a second type of tax attribute, e.g., a federal income tax deduction associated with purchase of the Object of Interest, the value of a shipping cost, and/or the value of a Reward associated with a first Payment Account. Selection of the highest value of a Reward per se may not necessarily lead to the minimal value of Object P 02260. For example, a first set of Object G 02242 through Object O 02258 including a lower value Reward can lead to a lower value of Object P 02260 than a second set of Object G 02242 through Object O 02258 including a higher value Reward. Method 40000A can select the Reward associated with the set of Object G 02242 through Object 02258 which can lead to a minimum value of Object P 02260.

At 40000A4, Method 40000A can apply any method of sorting a list to sort the values of each element of the list.

At 40000A5, Method 40000A can select the element with a desired value, e.g., the minimum Net Price of the Object of Interest.

FIG. 40B depicts a flowchart of an exemplary computer-implemented method, Method 40000B, that when executed can enable the transformation of an object, an electronic image of an object, and/or data representing an object into a different state, i.e., the automatic selection of a payment account whose reward values and the equivalent cash value of non-price features, in combination with the price offered by a retailer and/or the value of one or more offers and/or other rewards related to the object of interest, can achieve a desirable level of savings, according to one embodiment. The flowchart refers to the apparatus and structures depicted in FIG. 39. However, the method is not limited to those embodiments. The method can implement the steps described herein utilizing a subset of the components, any combination of the components, or additional, related, alternative, and/or equivalent components depicted in FIG. 39 and/or elsewhere in the application. The method can execute a subset of the steps, any combination of the steps, the steps in different order, and/or additional, related, alternative, or equivalent steps.

At 40000B4, Method 40000B can compute the value of one or more Rewards and/or

Non-Price Features. In one embodiment, Method 40000B can enable a user to compare more easily the value offered by a first Payment Account over a second Payment Account. Method 40000B can convert each Non-Price Feature of a Payment Account into a cash value equivalent to the cash value of any Rewards associated with the Payment Account. For example, Payment Account A can offer a Non-Price Feature of paying for the first checked bag when the Payment Account A is used for a Transaction on Airline A, but not Airline B, and Payment Account B can offer x % cash back on the purchase of any ticket on Airline B. Method 40000B can: (a) query one or more data structures storing the price charged by Airline A and Airline B for the first checked bag, the price charged by Airline A and Airline B for the seat type requested by a user; (b) read for each airline the respective prices; (c) compute the Net Price of the purchase of the seat type offered by Airline A using Payment Account A less the value of the price charged by Airline A for the first checked bag; (d) compute the Net Price of the seat type offered by Airline B using Payment Account B less the value of the x % cash back; and/or (e) compare the Net Price of purchasing an Airline A ticket and the Net Price of purchasing an Airline B ticket.

FIG. 40C depicts a flowchart of an exemplary computer-implemented method, Method 40000C, that when executed can enable the transformation of an object, an electronic image of an object, and/or data representing an object into a different state, i.e., automatic selection of a payment account based on a predefined rule which can identify the set of candidate payment accounts and select a payment account based on one or more codes associated with an object of interest, class of interest, and/or any other element in a user request, according to one embodiment. The flowchart refers to the apparatus and structures depicted in FIG. 39. However, the method is not limited to those embodiments. The method can implement the steps described herein utilizing a subset of the components, any combination of the components, or additional, related, alternative, and/or equivalent components depicted in FIG. 39 and/or elsewhere in the application. The method can execute a subset of the steps, any combination of the steps, the steps in different order, and/or additional, related, alternative, or equivalent steps.

At 40000C1, Method 40000C can receive data describing an Object of Interest and/or Class of Interest selected by Object ID Engine 33310, e.g., the name and/or identifier of the Object of Interest and/or Class of Interest.

At 40000C2, Method 40000C can classify the selected Object of Interest and/or Class of Interest in a class associated with a code with which any Rewards associated with one or more Payment Accounts held by the user of Client Device 14200 can be classified. Method 40000CE can identify one or more codes associated with a class into which the method can classify both: (a) a selected Object of Interest and/or Class of Interest; and (b) the objects associated with Rewards. In a first example, one type of Rewards can be associated with a specific Retailer, e.g., 10% off the price offered by Retailer A. In a second example, another type of Rewards can be associated with an Object Category, e.g., lost luggage reimbursement when using a Payment Account to purchase a travel ticket, auto rental insurance when using a Payment Account to rent a motor vehicle, or a Reward points when using a Payment Account to purchase gasoline. A conventional search engine can query a data structure including all Rewards and Non-Price Features and present all results including and/or related to one or more words in the Object of Interest in a User Request. However, in the example where the User Request is “Find auto rental”, that approach can present not only a Non-Price Feature of auto rental insurance, but also a Reward associated with an auto parts Retailer, which would probably not be related to the User Request.

Method 40000C can classify the selected Object of Interest and/or Class of Interest in a Class of Objects reflecting the intent of the user. For example, if the selected Class of Interest is “auto rental”, Method 40000B can classify “auto rental” in the Class of Objects NAICS code 532111 “Passenger Car Rental”.

At 40000C3, Method 40000C can classify any Reward and/or Non-Price Feature associated with one or more Payment Accounts held by the user of Client Device 14200 in a Class of Objects in which the Reward is typically redeemed or the Non-Price Feature is typically consumed. That is, the issuer, e.g., Payment Issuer Server 11600, typically has data showing the MID associated with any redemption of a Reward or use of a Non-Price Feature. If data shows that users typically use a Non-Price Feature of auto rental insurance when they use the Payment Account in Transactions with an auto rental Retailer and not with an auto parts retailer as evidenced by the MID, then Method 40000C can classify a Non-Price Feature of auto rental insurance in the category “auto rental” and NAICS code 532111.

At 40000C4, Method 40000C can apply logic to compare and/or utilize any comparator component capable of comparing the codes of the set of selected Objects of Interest and/or Classes of Interest with the codes of the set of Rewards and/or Non-Price Features. If there are no common codes, Method 40000C can terminate the process at 4000005B. If there are common codes, Method 40000C can proceed to 4000005A, where it can select: (a) the Reward associated with the set of Object G 02242 through Object O 02258 which can yield a desired value of “Net Price”, e.g., the minimum Net Price, in Object E 02234; and/or (b) the Non-Price Feature(s) selected by the user of Client Device 14200.

At 40000B6A, Method 40000C can select the Payment Account associated with the Reward selected and display in Object I 02246 data identifying the Payment Account (e.g., notifying the user that use of the Payment Account can reduce the Net Price) and/or instructions enabling the utilization of the Payment Account (e.g., automatically populating the Payment Account data in 39400).

### Offer Redemption Engine

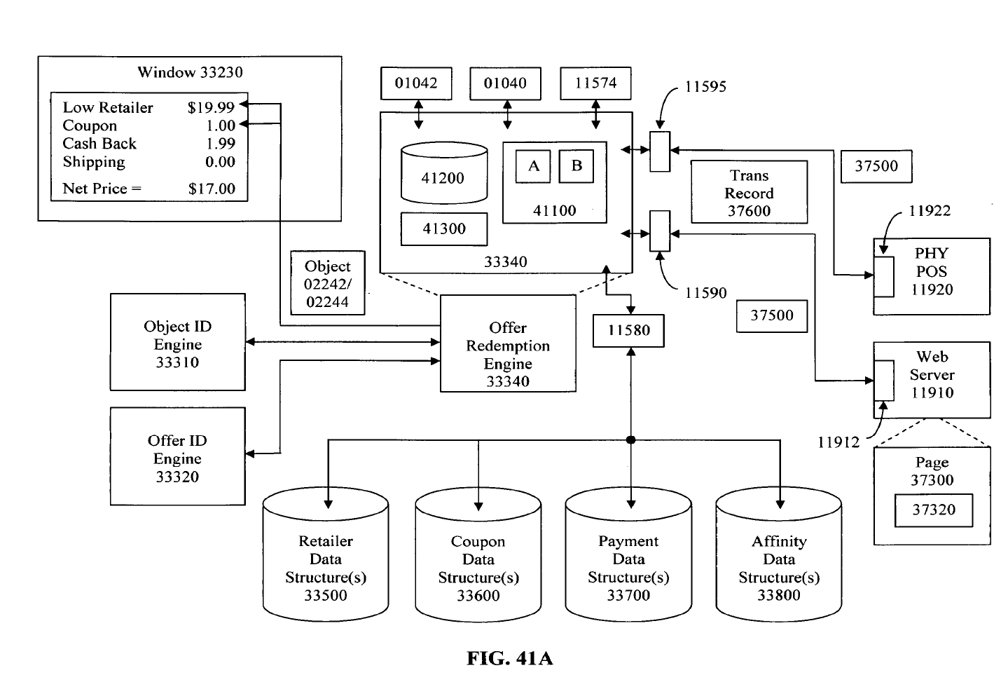

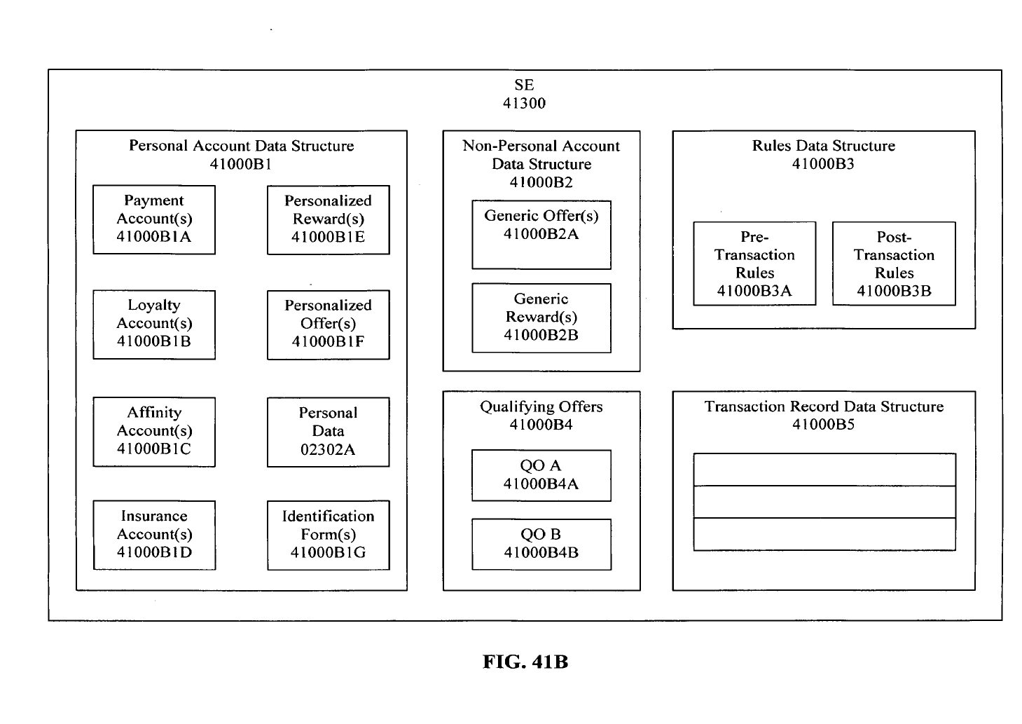

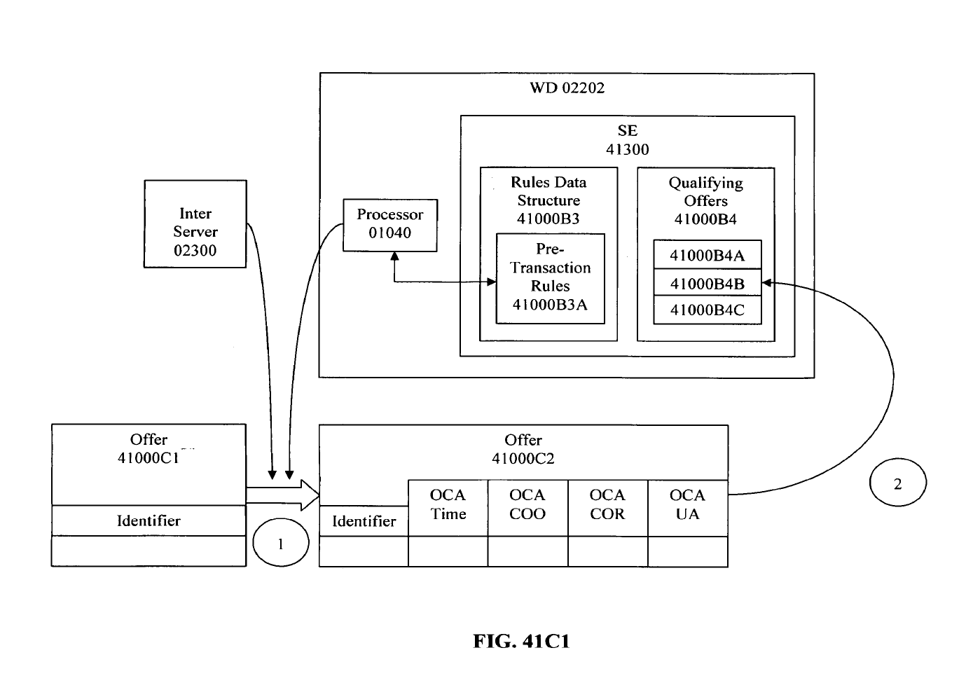

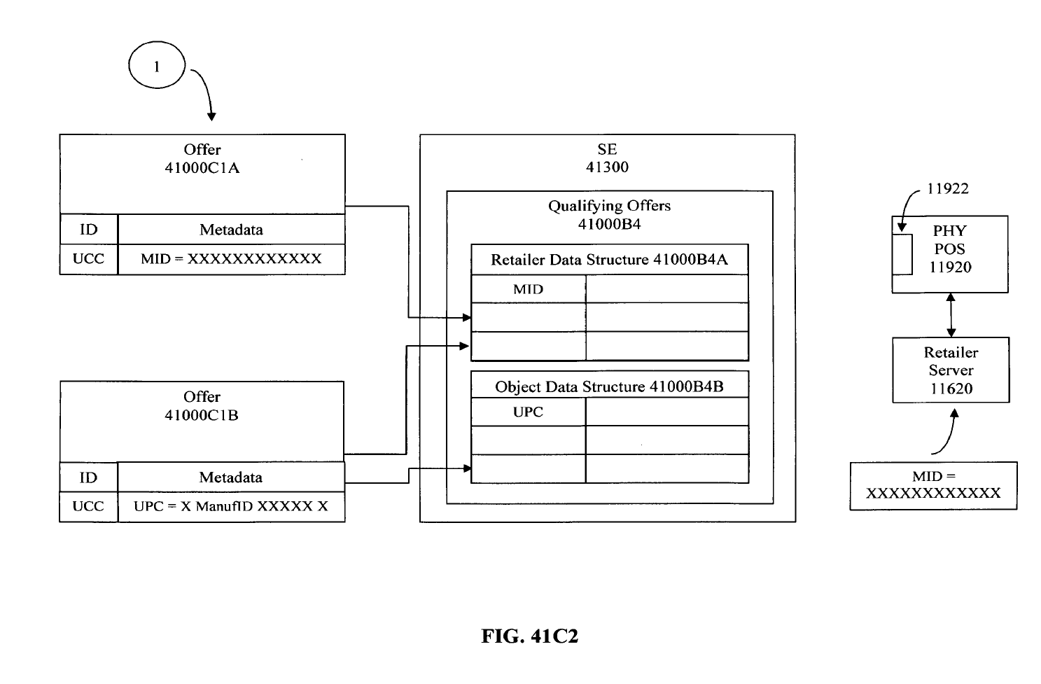

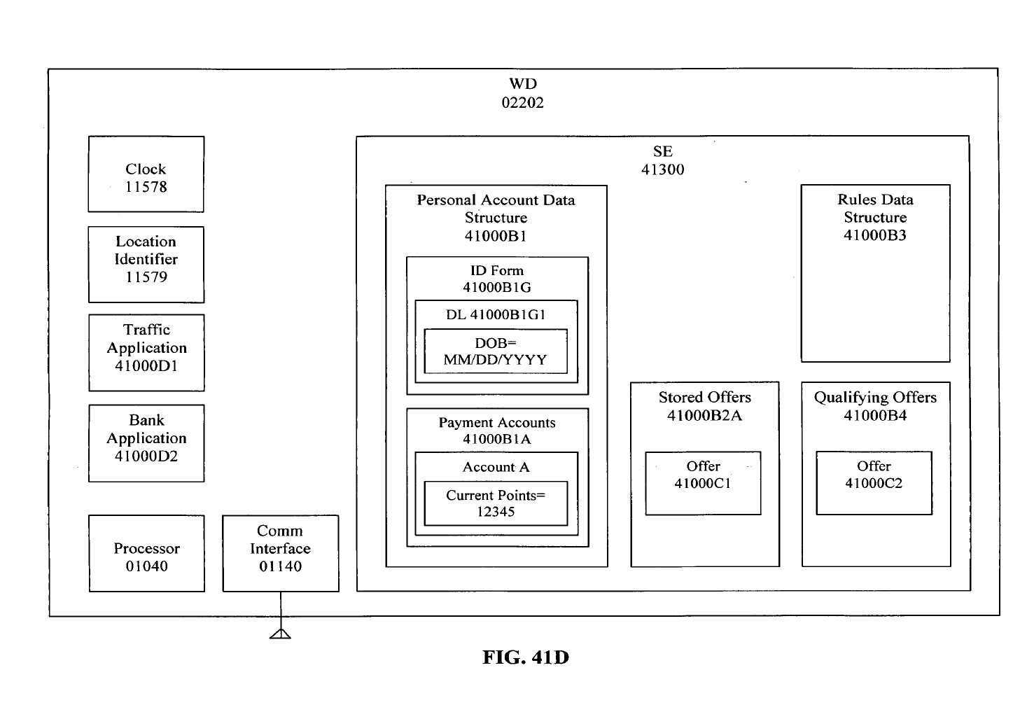

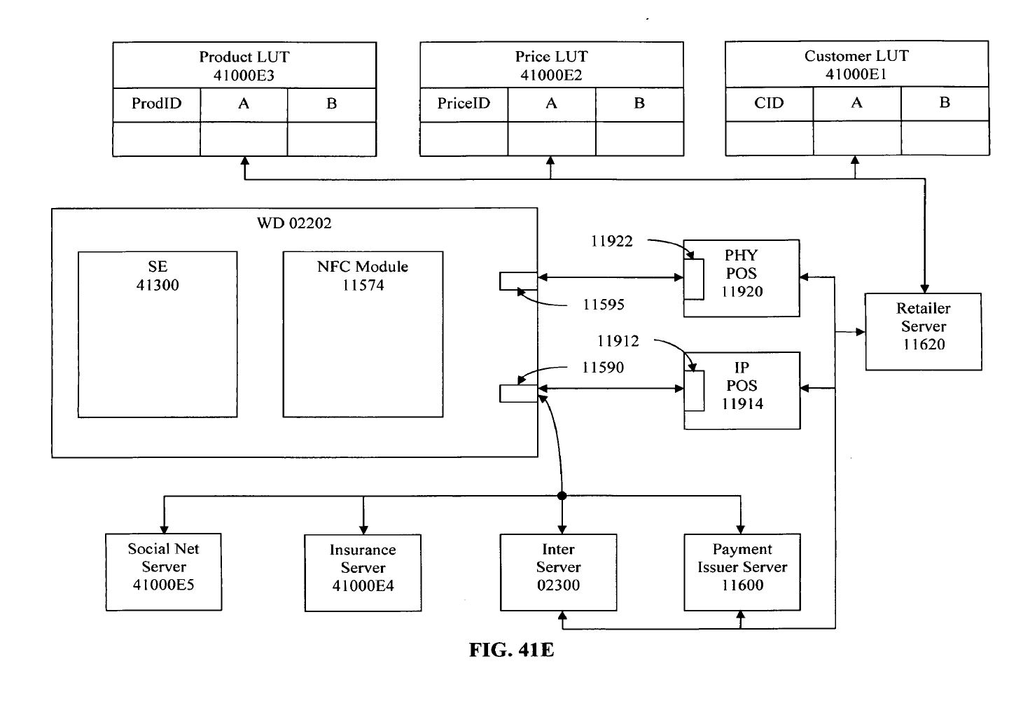

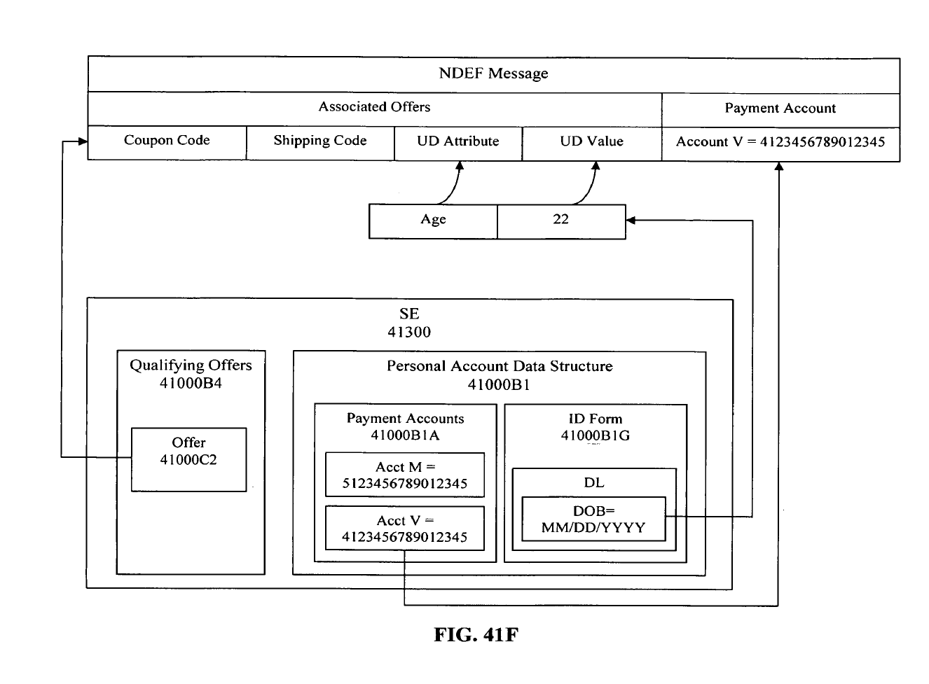

FIG. 41A depicts a block diagram of an exemplary article of manufacture or computer program product, Offer Redemption Engine 33340, enabling the transformation of an object, an electronic image of an object, and/or data representing an object into a different state, i.e., the automatic redemption of one of more qualifying offers and/or rewards related to an object of interest, according to one embodiment. The AOM/CPP can implement the methods described herein by utilizing a subset of the following components, any combination of the components, or additional related, alternative, and/or equivalent components not disclosed earlier.

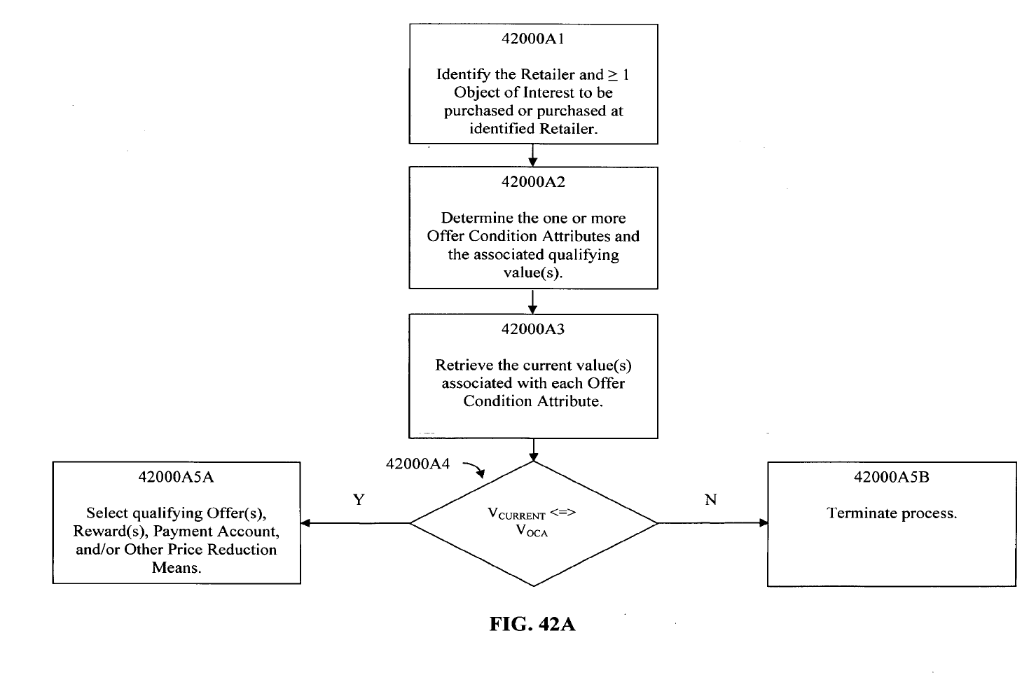

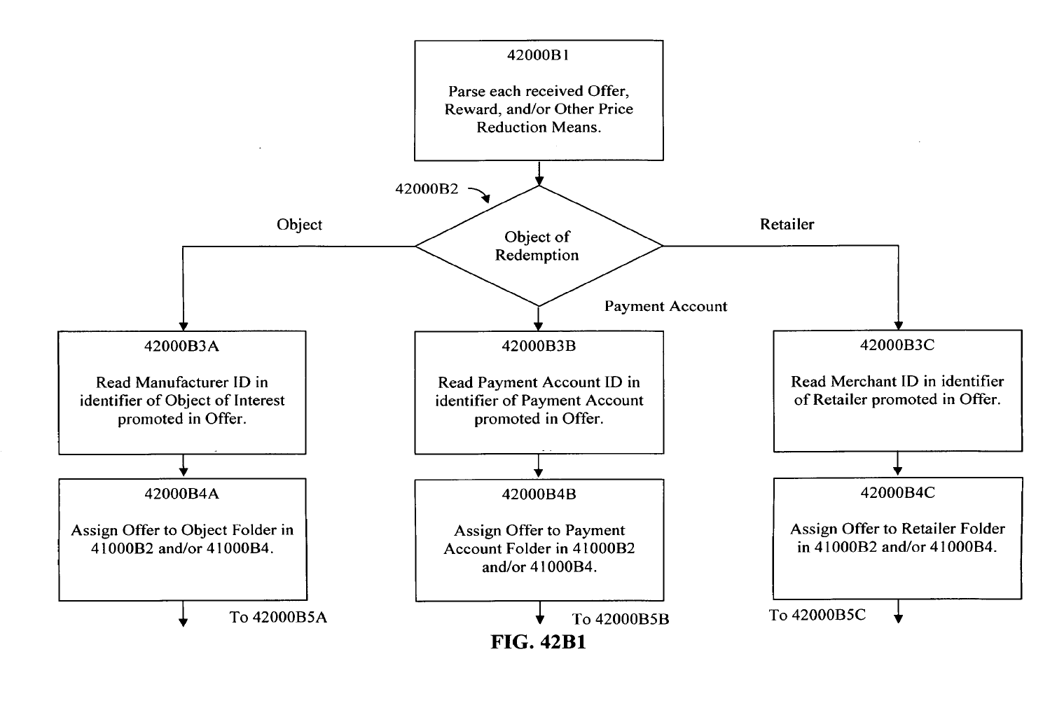

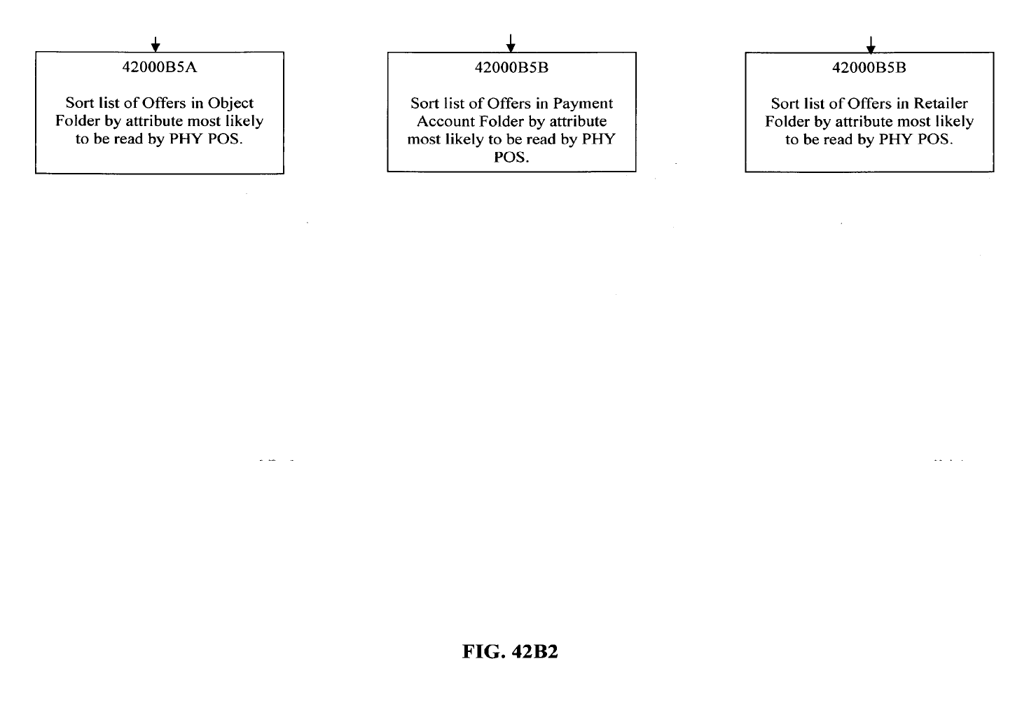

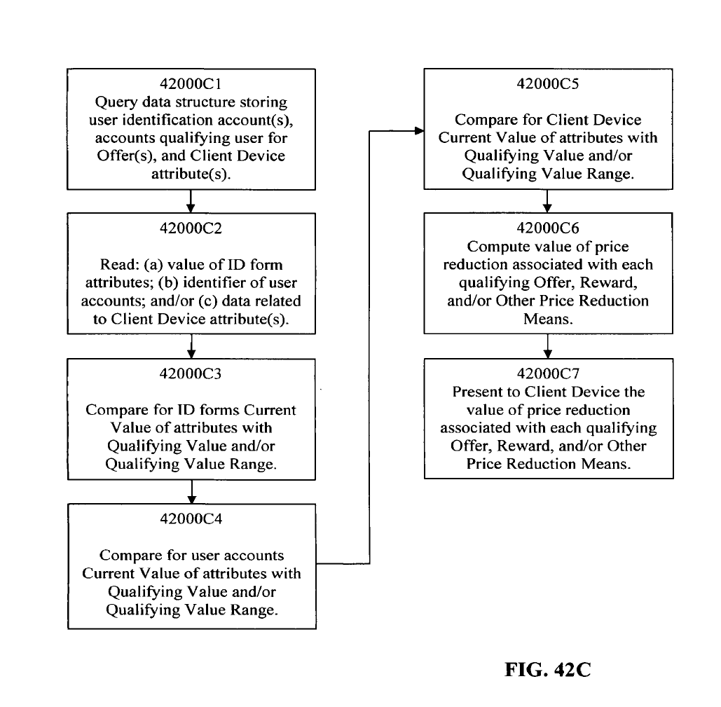

Offer Redemption Engine 33340 can comprise: (a) a memory, e.g., Memory 01120; (b) a processor, e.g., Processor 01040; (c) a data structure, e.g., Data Structure 41100, stored in the memory and executable on the processor which can receive, store, and/or transmit data related to identifying and/or redeeming one or more Offers associated with an Object of Interest and/or Class of Interest; (d) Rules Data Structure 41200, stored in the memory and executable on the processor which can store rules, instructions, and/or functions, e.g., Method 42000, for using the data in Data Structure 41100 and/or any other data to identify and/or redeem one or more Offers associated with an Object of Interest and/or Class of Interest; and/or (e) Secure Element 41300, which the application describes in more detail in FIG. 41B through FIG. 42B.

The invention can couple Offer Redemption Engine 33340 to any Data Processing System, e.g., Inter Server 02300 and/or Client Device 14200. In any Client Device 14200, e.g., WD 02202, Offer Redemption Engine 33340 can be stored in, and/or can utilize the memory, processor, transceiver, and/or any other component of, any module or component of Client Device 14200, including, but not limited to: (a) NFC Module 11574; (b) Component 11576; and/or (c) Memory 01120. In any Data Processing System which is not a Client Device 14200, e.g., Inter Server 02300, Offer Redemption Engine 33340 can be stored in, and/or can utilize the memory, processor, transceiver, and/or any other component of, any module or component of the Data Processing System. While the invention couples Offer Redemption Engine 33340 to one Data Processing System, it is not limited to that embodiment. The invention can distribute the functions, instructions, and/or data executed by Offer Redemption Engine 33340 across a plurality of Data Processing Systems, e.g., both WD 02202 and Inter Server 02300.

The invention can configure Offer Redemption Engine 33340 to receive data, including, but not limited to: (a) Client Device Data 35300, which can include any data received from Client Device 14200, which in turn can include, but are not limited to: 11512, 11514, 11522, 11532, 11542, 11552, 11562, and/or 11572A; (b) Retailer Data Structure 33500; (c) Coupon Data Structure 33600; (d) Payment Data Structure 33700; (e) Affinity Data Structure 33800; and/or (f) User Data Structure 35400E.

While the application illustrates Offer Redemption Engine 33340 as redeeming one or more Offers, the invention is not limited to that embodiment. The invention can redeem one or more Offers, Rewards, and/or any other means of reducing the price of at least one object of interest (“Other Price Reduction Means”).

Offer Redemption Engine 33340 can be any AOM/CPP which can redeem one or more Offers associated with an Object of Interest and/or a Class of Interest utilizing any method described herein. Redeeming automatically one or more Offers associated with an Object of Interest and/or displayed in, e.g., Object F 02240, can make it easier for the user of Client Device 14200 to save money.

The methods which can be executed by and/or apparatuses utilized by Offer Redemption Engine 33340 described herein can yield a variety of benefits, including, but not limited to, the following. First, reducing the search space of candidate Offers, Rewards, and/or Other Price Reduction Means can reduce the time for identifying Offers, Rewards, and/or Other Price Reduction Means which can be redeemed for a given Object of Interest purchased at a given Retailer. Some methods of executing a Transaction, e.g., any method exchanging data with a PHY POS 11920 over the NFC protocol must exchange data with 250 ms. A sufficiently large number of Offers, Rewards, and/or Other Price Reduction Means stored in SE 41300 can require more time to search and process than available for a given Transaction.

FIG. 41B depicts a block diagram of an exemplary apparatus, Apparatus 41000B, enabling the transformation of an object, an electronic image of an object, and/or data representing an object into a different state, i.e., the automatic redemption of one of more qualifying offers and/or rewards related to an object of interest, according to one embodiment. The apparatus can implement the methods described herein by utilizing a subset of the following components, any combination of the components, or additional related, alternative, and/or equivalent components not disclosed earlier.

Secure Element (SE) 41300 can execute any means of enabling the secure transmission, processing, storage, and/or reception of data and/or instructions, including, but not limited to: (a) any means of secure data exchange, e.g., any encryption and/or decryption means; and/or (b) any means of user authorization, e.g., recognition of username and/or password, and/or any method of recognizing a biometric attribute of the user. SE 41300 can include one or more CPPs comprising code which has been verified by one or more trusted service managers (TSM), e.g., Payment Issuer Server 11600.

In a first embodiment, SE 41300 can be in the form of a removable storage medium storing any data identifying one or more Payment Accounts, one or more Offers, one or more Rewards, one or more Loyalty Accounts, one or more Organization Accounts, one or more Insurance Accounts, and/or one or more Identification Accounts.

In a second embodiment, SE 41300 can be in the form of a non-removable storage medium storing any data identifying one or more Payment Accounts, one or more Offers, one or more Rewards, one or more Loyalty Accounts, one or more Organization Accounts, one or more Insurance Accounts, and/or one or more Identification Accounts.

In a third embodiment, SE 41300 can be in the form of secure folder in a baseband processor storing any data identifying one or more Payment Accounts, one or more Offers, one or more Rewards, one or more Loyalty Accounts, one or more Organization Accounts, one or more Insurance Accounts, and/or one or more Identification Accounts.

SE 41300 can include any data structure, including, but not limited to: (a) Payment Accounts 41000B1A, which can store any data related to one or more Payment Accounts which can be used to purchase one or more Objects of Interest; (b) Loyalty Accounts 41000B1B, which can store any data related to one or more Loyalty Accounts; (c) Affinity Accounts 41000B1C, which can store any data related to one or more Affinity Accounts; (d) Insurance Accounts 41000B1D, which can store any data related to one or more Insurance Accounts; (e) Personalized Rewards 41000B1E; (f) Personalized Offers 41000B1F; (g) Personal Data 02302A which can be a data structure including a subset of the data stored in Data Structure 02302 related to the user of Client Device 14200, e.g., WD 02202, wherein the data can include any data related to a user which any method described herein can process to affect the price of an Object of Interest and/or Class of Interest, including, but not limited to, name, street address, city, state, zip code, phone number, email address, billing address, and/or shipping address; and/or (h) Identification Forms 41000B1G, which can be any form identifying the user of Client Device 14200, e.g., WD 02202.

The invention can enable the secure transmission of the value of any attribute in Identification Form 41000B1G for any reason, including, but not limited to, determining if the user of Client Device 14200: (a) qualifies for an Offer, Reward, and/or Other Price Reduction Means related to an Object of Interest; (b) can purchase an Object of Interest, e.g., if the age of the user exceeds a predefined threshold like a legal minimum age requirement for the purchase an object like alcohol; and/or (c) can participate in an event, e.g., if the attendance at an event is limited to members of a group like students at a specific university.

Rules Data Structure 41000B3 can store any instructions enabling the automatic redemption of any Offer, Reward, and/or Other Price Reduction Means. It can include instructions for executing methods before a Transaction, e.g., methods of updating Offers, Rewards, and/or Other Price Reduction Methods stored in SE 41300, methods of identifying Offers, Rewards, and/or Other Price Reduction Methods most likely to be redeemed beforea WD 02202 is in the vicinity of a PHY POS 11920, and/or methods of parsing a Proposed Transaction Record. It can include instructions for executing methods after a Transaction, e.g., methods of parsing a Final Transaction Record.

Qualifying Offers 41000B4 can store one or more Offers, Rewards, and/or Other Price Reduction Methods processed by any method described herein.

FIG. 41C1 depicts a block diagram of an exemplary apparatus enabling the classification of each offer, reward, and/or other price reduction means to one or more classes of objects and/or classes of retailers, according to one embodiment. The apparatus can implement the methods described herein by utilizing a subset of the following components, any combination of the components, or additional related, alternative, and/or equivalent components not disclosed earlier.

Offer 41000C1 is an Offer received by any method described herein. Any method described herein can process Offer 41000C1 to add in addition to any data in Offer 41000C1 other data which can enable the reduction of the search space of candidate Offers, including, but not limited to, one or more Offer Condition Attributes and their respective values, e.g., the time period during which an Offer can be redeemed like OCA Time, the Class of Objects qualifying for redemption like OCA COO, the Class of Retailers at which the Offer can be redeemed like OCA COR, and an attribute of the user whose value must meet a Qualifying Value or Qualifying Value Range like OCA User Attribute (OCA UA).

FIG. 41C2 depicts a block diagram of an exemplary apparatus enabling the classification a plurality of offers to one or more classes of objects and/or classes of retailers, according to one embodiment.

FIG. 41D depicts a block diagram of an exemplary apparatus enabling the identification and/or determination of a set of qualifying offers, rewards, and/or other price reduction means by exchanging data with one or more components and/or computer program products of a wireless device, according to one embodiment.

FIG. 41E depicts a block diagram of an exemplary apparatus enabling the identification and/or determination of a set of qualifying offers, rewards, and/or other price reduction means by exchanging data with one or more components and/or computer program products of a data processing system other than a wireless device, according to one embodiment.

FIG. 41F depicts a diagram of an exemplary specification of a type of application data transmitted in compliance with a standard data exchange format, e.g., the NFC Data Exchange Format, according to one embodiment.

FIG. 42A depicts a flowchart of an exemplary method, Method 42000A, that when executed can enable the transformation of an object, an electronic image of an object, and/or data representing an object into a different state, i.e., the automatic redemption of one or more qualifying offers related to an object of interest, according to one embodiment. The flowchart refers to the apparatus and structures depicted in FIG. 41A through FIG. 41F. However, the method is not limited to those embodiments. The method can implement the steps described herein utilizing a subset of the components, any combination of the components, or additional, related, alternative, and/or equivalent components depicted in FIG. 41A through FIG. 41F and/or elsewhere in the application. The method can execute a subset of the steps, any combination of the steps, the steps in different order, and/or additional, related, alternative, or equivalent steps.

At 42000A1, Method 42000A can determine an identifier of the Retailer in the vicinity of a Wireless Device 14200 and the identifier of each of one or more Objects of Interest to be purchased or purchased at the identified Retailer.

At 42000A2, Method 42000A can determine the one or more Offer Condition Attributes associated with each Offer, Reward, and/or Other Price Reduction Means and the associated qualifying values. The application defines a Qualifying Value as the value specified by the entity making the Offer, Reward, and/or Other Price Reduction Means the user, any attribute associated with the user, the Transaction, any attribute of the Transaction, and/or any other requirement must meet to redeem the Offer, Reward, and/or Other Price Reduction Means. For example, an entity can require that only users whose age exceeds a predefined threshold can qualify for a price discount. The application defines a Qualifying Value range as the range of values specified that must be met to redeem the Offer, Reward, and/or Other Price Reduction Means. For example, an entity can require that an Offer must be redeemed within a timestamp starting on day X and ending on day Y.

At 42000A3, Method 42000A can detect, receive, collect, measure, process, store, and/or transmit the current value of any Offer Condition Attribute. The application defines the Current Value as the value of any attribute of the user of a Client Device 14200, any attribute of the Client Device 14200, any attribute of the Transaction, and/or any other requirement at the time, location, and/or any other attribute of the Transaction. In a first example, a Current Value of the user's age can equal the difference between the value of the current date and the value of the attribute “Date of Birth” read by Method 42000A in a Driver License 41000B1G1. In a second example, a Current Value of the number of points in a Reward program can equal the value of the attribute “Current Points” read by Method 42000A in Account A stored in Payment Accounts 41000B1A and/or Payment Issuer Server 11600.

At 42000A4, Method 42000A can apply logic to compare and/or utilize any comparator component capable of comparing for each Offer Condition Attribute the Current Value with the Qualifying Value. If for each Offer Condition Attribute, the Current Value meets, is greater than, or less than the Qualifying Value (depending on the requirement of the Qualifying Value) or falls within the Qualifying Value Range, Method 42000A can proceed to 42000A5A. If not, Method 42000A can proceed to 42000A5B and terminate the process.

At 42000A5A, Method 42000A can select the qualifying one or more Offers, Rewards, Payment Account, and/or Other Price Reduction Means and: (a) write them to Qualifying Offers Folder 41000B4; and/or (b) transmit them to a POS Device operated by the Retailer.

In another embodiment, Method 42000A can execute the following steps: (a) determining an identifier of the retailer in the vicinity of a wireless device integrated with or detachable from SE 41300; (b) determining the one or more Offer Condition Attributes limiting the applicability of any Offer, Reward, and/or Other Price Reduction Means; (c) identifying the type of value of each Offer Condition Attribute; (d) determining the one or more apparatuses, articles of manufacture, and/or computer program products capable of detecting, receiving, collecting, measuring, processing, storing, and/or transmitting Current Value for any Offer Condition Attribute; (e) retrieving the value from the one or more apparatuses, articles of manufacture, and/or computer program products; (f) comparing the retrieved Current Value with the Qualifying Value or Qualifying Value Range specified in each Offer Condition Attribute; (g) selecting the set of one or more Offers, Rewards, and/or Other Price Reduction Means for which the retrieved Current Value meets the Qualifying Value or Qualifying Value Range specified in each Offer Condition Attribute; (h) determining an identifier of each of one or more Objects of Interest to be purchased in a proposed transaction or purchased in an executed transaction; (i) comparing the identifier of each of one or more Objects of Interest to be purchased or purchased against the object identifier associated each Offer, Reward, and/or Other Price Reduction Means in the selected set; (j) comparing the identifier of the Retailer against the retailer identifier associated with each Offer, Reward, and/or Other Price Reduction Means in the selected set; and/or (k) selecting the one or more Offers, Rewards, and/or Other Price Reduction Means for redemption.

FIG. 42B1 and FIG. B2 depict a flowchart of an exemplary method, Method 42000B, that when executed can enable the assignment of each offer, reward, and/or other price reduction means to one or more classes of objects and/or classes of retailers, according to one embodiment. The flowchart refers to the apparatus and structures depicted in FIG. 41A through FIG. 41F. However, the method is not limited to those embodiments. The method can implement the steps described herein utilizing a subset of the components, any combination of the components, or additional, related, alternative, and/or equivalent components depicted in FIG. 41A through FIG. 41F and/or elsewhere in the application. The method can execute a subset of the steps, any combination of the steps, the steps in different order, and/or additional, related, alternative, or equivalent steps.

At 42000B1, Method 42000B can parse the data describing each received Offer, Reward, and/or Other Price Reduction Means.

At 42000B2, Method 42000B can apply logic to compare and/or utilize any comparator component capable of comparing any identifier of the entity making the Offer, Reward, and/or Other Price Reduction Means with a set of identifiers in a data structure storing identifiers of entities making Offers, Rewards, and/or Other Price Reduction Means. In one embodiment, Method 42000B can assign any identifier of the type identifying an object, e.g., UPC, as an entity of the type “Manufacturer”, any identifier of the type identifying a Retailer, e.g., MID, as an entity of the type “Retailer”, and/or any identifier of the type identifying a Payment Account, e.g., a word string describing the name of an entity enabling payment for a Transaction, like the name of the entity operating Payment Issuer Server 11600 or Payment Association Network Server 11610, as an entity of the type “Payment Account”. If Method 42000B determines that the Offer is related to a Manufacturer, it can proceed to 42000B3A. If Method 42000B determines that the Offer is related to a Payment Account, it can proceed to 42000B3B. If Method 42000B determines that the Offer is related to a Retailer, it can proceed to 42000B3C.

At 42000B3A, Method 42000B can read the identifier or any subset of the identifier to determine the identity of the manufacturer making the Offer, e.g., the Manufacturer ID in a UPC.

At 42000B4A, Method 42000B can assign the Offer to a folder storing Offers determined as made by a Manufacturer, e.g., an Object Folder stored in e.g., Generic Offers 41000B2A and/or Qualifying Offers 41000B4.

At 42000B5A, Method 42000B can sort the list of Offers in the Object Folder by the attribute most likely to be read by a POS Device, e.g., PHY POS 11920. For example, a PHY POS 11920 can search for any Offers within Object Folder by name of the object or an identifier of the object, e.g., its UPC.

At 42000B3B, Method 42000B can read the identifier or any subset of the identifier to determine the identity of the Payment Account entity making the Offer, e.g., the first digit of an account number or a word string specifying the name of the Payment Account entity.

At 42000B4B, Method 42000B can assign the Offer to a folder storing Offers determined as made by a Payment Account entity, e.g., a Payment Account Folder stored in, e.g., Generic Offers 41000B2A and/or Qualifying Offers 41000B4.

At 42000B5B, Method 42000B can sort the list of Offers in the Payment Account Folder by the attribute most likely to be read by a POS Device, e.g., PHY POS 11920. For example, a PHY POS 11920 can search for any Offers within Payment Account Folder by name of the payment entity or an identifier of the payment entity, e.g., the first digit of the Payment Account identifier which can identify the Payment Association Network.

At 42000B3C, Method 42000B can read the identifier or any subset of the identifier to determine the identity of the Retailer making the Offer, e.g., the MID.

At 42000B4B, Method 42000B can assign the Offer to a folder storing Offers determined as made by a Retailer, e.g., a Retailer Folder stored in, e.g., Generic Offers 41000B2A and/or Qualifying Offers 41000B4.

At 42000B5B, Method 42000B can sort the list of Offers in the Retailer Folder by the attribute most likely to be read by a POS Device, e.g., PHY POS 11920. For example, a PHY POS 11920 can search for any Offers within Retailer Folder by MID and/or MCC.

FIG. 42C depicts a flowchart of an exemplary method, Method 42000C, that when executed can enable the identification of one or more retailers, one or more qualifying offers and/or rewards, selection of a payment account, and/or identification of any other price reduction means related to at least one object of interest by reading a data structure, according to one embodiment. The flowchart refers to the apparatus and structures depicted in FIG. 41A through FIG. 41F. However, the method is not limited to those embodiments. The method can implement the steps described herein utilizing a subset of the components, any combination of the components, or additional, related, alternative, and/or equivalent components depicted in FIG. 41A through FIG. 41F and/or elsewhere in the application. The method can execute a subset of the steps, any combination of the steps, the steps in different order, and/or additional, related, alternative, or equivalent steps.

At 42000C1, Method 42000C can query a data structure storing data related to: (a) identification of a user, e.g., any form of user identification specifying one or more attributes whose value can qualify the user for an Offer, Reward, and/or Other Price Reduction Means related to an Object of Interest; (b) an account issued to a user, e.g., any account for which the processing of an account identifier can qualify the user for an Offer, Reward, and/or Other Price Reduction Means related to an Object of Interest; and/or (c) identification of any attribute of a Client Device 14200, e.g., data specifying the location of Client Device 14200, whose value can qualify the user for an Offer, Reward, and/or Other Price Reduction Means related to an Object of Interest.

At 42000C2, Method 42000C can read: (a) the value of the one or more attributes associated with the one or more identification forms; (b) the identifier of the one or more user accounts; and/or (c) the data specifying any attribute of the Client Device 14200.

At 42000C3, Method 42000C can compare the Current Value of the one or more attributes associated with the one or more identification forms against any Qualifying Value and/or Qualifying Value Range predefined by one or more entities making an Offer, Reward, and/or Other Price Reduction Means.

At 42000C4, Method 42000C can compare the name of the entity, an identifier of the entity, and/or any other attribute of the entity issuing the one or more user accounts against any data structure specifying the one or more entities for which membership can qualify a user for an Offer, Reward, and/or Other Price Reduction Means;

At 4200005, Method 42000C can compare the value of the one or more attributes associated with a Client Device 14200 against any Qualifying Value and/or Qualifying Value Range predefined by one or more entities making an Offer, Reward, and/or Other Price Reduction Means.

At 4200006, Method 42000C can compute the value of the price reduction associated with each qualifying Offer, Reward, and/or Other Price Reduction Means.

At 4200007, Method 42000C can present to Client Device 14200, e.g., WD 02202, the value of the price reduction associated with each qualifying Offer, Reward, and/or Other Price Reduction Means.

FIG. 42D depicts a flowchart of an exemplary method, Method 42000D, that when executed can enable the identification of one or more retailers, identification of one or more qualifying offers and/or rewards, selection of a payment account, and/or identification of any other price reduction means when entering a physical retailer, according to one embodiment. The flowchart refers to the apparatus and structures depicted in FIG. 41A through FIG. 41F. However, the method is not limited to those embodiments. The method can implement the steps described herein utilizing a subset of the components, any combination of the components, or additional, related, alternative, and/or equivalent components depicted in FIG. 41A through FIG. 41F and/or elsewhere in the application. The method can execute a subset of the steps, any combination of the steps, the steps in different order, and/or additional, related, alternative, or equivalent steps.

FIG. 42E depicts a flowchart of an exemplary method, Method 42000E, that when executed can enable the identification of one or more retailers, identification of one or more qualifying offers and/or rewards, selection of a payment account, and/or identification of any other price reduction means when receiving a proposed transaction record and transmitting such data to a physical point of sale, according to one embodiment. The flowchart refers to the apparatus and structures depicted in FIG. 41A through FIG. 41F. However, the method is not limited to those embodiments. The method can implement the steps described herein utilizing a subset of the components, any combination of the components, or additional, related, alternative, and/or equivalent components depicted in FIG. 41A through FIG. 41F and/or elsewhere in the application. The method can execute a subset of the steps, any combination of the steps, the steps in different order, and/or additional, related, alternative, or equivalent steps.

FIG. 42F depicts a flowchart of an exemplary method, Method 42000F, that when executed can enable the redemption of one or more qualifying offers and/or rewards, rewards related to the use of a payment account for a transaction, and/or any other price reduction means when receiving a final transaction record, according to one embodiment. The flowchart refers to the apparatus and structures depicted in FIG. 41A through FIG. 41F. However, the method is not limited to those embodiments. The method can implement the steps described herein utilizing a subset of the components, any combination of the components, or additional, related, alternative, and/or equivalent components depicted in FIG. 41A through FIG. 41F and/or elsewhere in the application. The method can execute a subset of the steps, any combination of the steps, the steps in different order, and/or additional, related, alternative, or equivalent steps.

### Transaction to AOM/CPP Engine

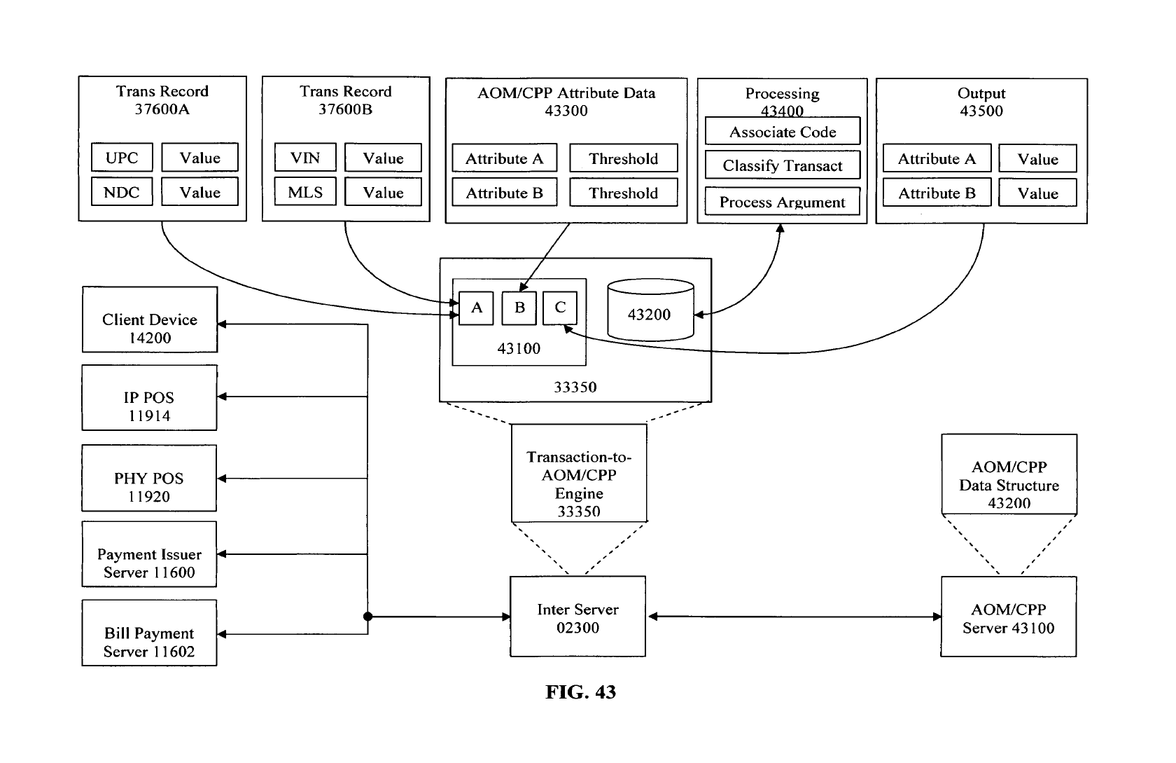

FIG. 43 depicts a block diagram of an exemplary article of manufacture or computer program product, Transaction to AOM/CPP Engine 33350, enabling the transformation of an object, an electronic image of an object, and/or data representing an object into a different state, i.e., (a) automatic processing, identification, and/or classification of transactions into one or more classes; (b) automatic population of a form with data related to the transaction; and/or (c) output to one or more other articles of manufacture or computer program products of data related to the transaction, according to one embodiment. The AOM/CPP can implement the methods described herein by utilizing a subset of the following components, any combination of the components, or additional, related, alternative, and/or equivalent components, and can include, but is not limited to, the following components not disclosed earlier.

Bill Payment Server 11602 can be any Data Processing System capable of executing a variety of functions and/or instructions enabling a user to manually or automatically pay an amount owed to one or more vendors by debiting a user Payment Account.

AOM/CPP Server 43100 can be any Data Processing System capable of executing a variety of functions and/or instructions, including, but not limited to: (a) generating a data structure for storing any data; (b) generating automatically a form including a plurality of attributes which represent one or more attributes in the data structure; (c) including through any means, e.g., eXtensible Markup Language (XML), with the form any identifier of one or more objects associated with each attribute, e.g., an UPC of an object whose purchase qualifies for a deduction associated with an attribute; (d) distributing to any Data Processing System, e.g., Inter Server 02300, the form through any channel, which can include, but is not limited to: (i) posting on Web Server 11910; (ii) transmitting in a message, e.g., email, to the user; and/or (iii) querying the user and receiving data in response to the queries in the form of speech, dual-tone multi-frequency (DTMF) signals, text, and/or any other form of input; (e) receiving from any Data Processing System, e.g., Inter Server 02300, a value associated with each attribute and automatically populating a data structure.

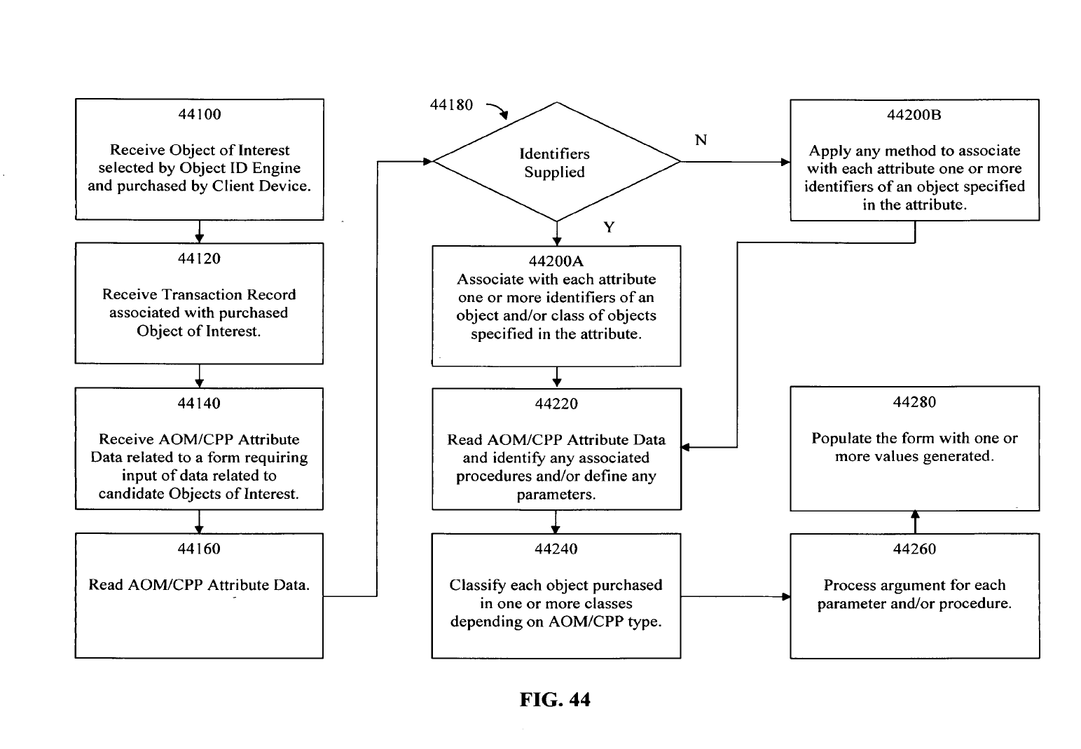

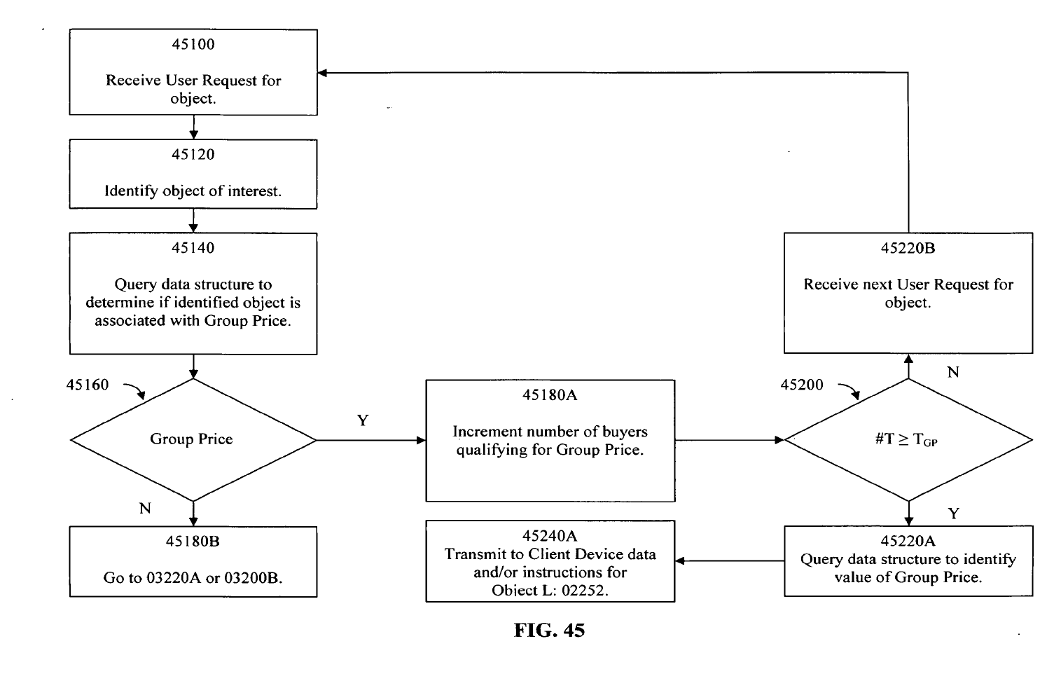

FIG. 44 depicts a flowchart of an exemplary computer-implemented method, Method 44000, that when executed can enable the transformation of an object, an electronic image of an object, and/or data representing an object into a different state, i.e., (a) automatic processing, identification, and/or classification of transactions into one or more classes; (b) automatic population of a form with data related to the transaction; and/or (c) output to one or more articles of manufacture or computer program products of data related to the transaction, according to one embodiment. The flowchart refers to the apparatus and structures depicted in FIG. 43. However, the method is not limited to those embodiments. The method can implement the steps described herein utilizing a subset of the components, any combination of the components, or additional, related, alternative, and/or equivalent components depicted in FIG. 43 and/or elsewhere in the application. The method can execute a subset of the steps, any combination of the steps, the steps in different order, and/or additional, related, alternative, or equivalent steps.

Assume that AOM/CPP Server 43100 can serve a tax form, Schedule A, which can include one line item querying the total medical and dental expenses incurred in the tax year. Assume that the tax code allows the deduction of: (a) bus, taxi, train, or plane fares primarily for medical care; (b) the actual cost of gas when a car is used for medical care or a standard medical mileage rate of $0.24 per mile; (c) fees for membership in a weight reduction group; and (d) total medical and dental expenses no more than 7.5% of the adjusted gross income (AGI).

At 44100, Method 44000 can receive an Object of Interest selected by Object ID Engine 33310 and purchased by the user of Client Device 14200 by debiting a Payment Account held by the user. In one example, Method 44000 can receive an Object of Interest “Jenny Craig®” identified in the word string “Sign up for Jenny Craig” where a membership is purchased by WD 02202 through the methods described herein.

At 44120, Method 44000 can receive from any Data Processing System and store in any data structure, e.g., Data Structure 43100A, one or more Transaction Records 37600 associated with the purchase of the Object of Interest. The Data Processing Systems can include, but are not limited to: (a) Client Device 14200, from which Method 44000 can receive a Transaction Record 37600 received from any Data Processing System, e.g., Web Server 11910 or PHY POS 11920; (b) IP POS 11914, from which Method 44000 can directly receive a Transaction Record 37600; (c) PHY POS 11920, from which Method 44000 can receive a Transaction Record 37600 directly or indirectly through any Data Processing System capable of exchanging data with PHY POS 11920; (d) Payment Issuer Server 11600, from which Method 44000 can receive a Transaction Record 37600; and/or (e) Bill Payment Server 11602, from which Method 44000 can receive a Transaction Record 37600 and/or which Method 44000 can parse a record of executed Transactions to identify data equivalent to the data in Transaction Record 37600.

Transaction Record 37600 can be any data structure in electronic form or paper form converted to electronic form, which stores one or more attribute-value pairs related to the purchase of one or more Objects of Interest. In one example, Transaction Record 37600A can include one or more attribute-value pairs depicting an identifier of an object, e.g., UPC or NDC for a medical good, or a code uniquely identifying a Retailer, e.g., MID for Jenny Craig® associated with a weight reduction group membership fee, and the price paid value associated with each identifier. In another example, Transaction Record 37600B can include one or more attribute-value pairs depicting an identifier of an object, e.g., VIN or MLS, and the price paid value associated with each object code. Method 44000 can parse any form, e.g., a purchase contract, to identify the price paid for a motor vehicle or a house.

At 44140, Method 44000 can receive from any Data Processing System, e.g., AOM/CPP Server 43100, and store in any data structure, e.g., Data Structure 43100B, one or more AOM/CPP Attribute Data 43300, which can be any data related to a form requiring the input of data related to Candidate Objects of Interest (“AOM/CPP Form”). AOM/CPP Attribute Data 43300 can constitute the data stored in AOM/CPP Data Structure 43200 and required to execute an action enabled by AOM/CPP Server 43100. The AOM/CPP Forms and their associated actions can include, but are not limited to: (a) a tax form whose completion and submission to a governmental entity can meet a filing requirement; (b) an insurance form whose completion and submission to an insurance carrier can meet a claim requirement or determine the exceeding of a threshold of deductible expenses; (c) a budget form whose completion can generate an itemization of type of expenses; (d) an employee expense reimbursement form whose completion and submission to an employer can meet a reimbursement requirement; and/or (e) a rebate form whose completion and submission to a Retailer can meet a rebate requirement.

At 44160, Method 44000 can read AOM/CPP Attribute Data 43300 associated with a specific AOM/CPP Form and associate with each attribute one or more identifiers of an object specified in the attribute. If at 44180 AOM/CPP Server 43100 supplies or the AOM/CPP Form defines the identifiers associated with each attribute, Method 44000 can at 44200A read the associated identifiers. If at 44180 AOM/CPP Server 43100 does not supply or the AOM/CPP Form does not define the identifiers associated with each attribute, Method 44000 can at 44200B apply any algorithm, rule, and/or method stored in Rules Data Structure 39200 to associate with each attribute one or more identifiers of an object specified in the attribute. The algorithms, rules, and/or methods can include, but are not limited to, the following. In one embodiment, Method 44000 can parse any document including instructions for completing the AOM/CPP Form to identify the object specified in the attribute and any exemplary objects. For example, a publication associated with a tax form typically includes examples of qualifying objects, e.g., “contact lenses”, “saline solution”, and “enzyme cleaner”, in the case of qualifying medical expenses. Method 44000 can identify codes by applying logic to compare and/or utilizing any comparator component capable of comparing the word strings identified in the publication with an identifier of an Object Category, e.g., NAICS, or an identifier of a Retailer category, e.g., MCC.

At 44200A and 44200B, Method 44000 can read AOM/CPP Attribute Data 43300 and associate with each attribute one or more identifiers of an object and/or class of objects specified in the attribute. For example, Method 44000 can associate with the Schedule A line item querying the total medical and dental expenses one or more identifiers associated with qualifying expenses, which can include, but are not limited to: (a) a code for which any associated purchase will automatically be processed as a qualifying expense, e.g., the purchase of a prescription drug uniquely identified by a NDC; and/or (b) a code for which any associated purchase can be manually selected as a qualifying expense, e.g., a bus fare primarily for medical care where the user can select as a qualifying expense.

At 44220, Method 44000 can read AOM/CPP Attribute Data 43300 and identify any associated procedures and/or define any parameters. For example, Schedule A line item can allow deductions of total medical and dental expenses no more than 7.5% of the AGI. If the sum of all arguments input at 44260 for the attribute of medical and dental expenses exceeds 7.5% of AGI, Method 44000 can populate the parameter equal to 7.5% of AGI.

At 44240, Method 44000 can classify each object purchased in one or more classes depending on the type of attribute and/or AOM/CPP Form. Method 44000 can parse each Transaction Record 37600 and classify one or more purchased objects listed in one or more classes. For example, if Method 44000 at 44200A associates with the Schedule A line item querying the total medical and dental expenses a code for “contact lenses”, it can classify any object purchased in any Transaction Record 37600 with a NAICS code 339115, which can be associated with the title “Contact lenses manufacturing”. At the same time, if Method 44000 at 44200A associates with an insurance form querying expenses to determine a deductible and contact lenses do not qualify, it can classify any contact lens purchase with a null value.

At 44260, Method 44000 can process one or more arguments for each parameter and/or procedure specified at 44220.

At 44280, Method 44000 can populate an AOM/CPP Form with one or more generated values.

### General

While the application illustrates various embodiments, it should be understood that they have been presented by way of example only, and not limitation. It will be apparent to a person skilled in the relevant art that various changes in form and detail can be made therein without departing from the spirit and scope of the invention. Thus, the breadth and scope of the claims should not be limited by any of the above-described exemplary embodiments, but should be defined only in accordance with the following claims and their equivalents.

The application includes headings herein for reference and to aid in locating certain sections. The application does not intend these headings to limit the scope of the concepts described therein. The application may apply the concepts in other sections throughout the entire specification.

The application illustrates data, folders, directories, instructions, functions, AOM, and/or CPPs (collectively “Data/Instructions”) as stored and/or executed on one or more Data Processing Systems operated by one or more entities offering an object to one or more customers. However, the invention is not limited to that embodiment. The invention can enable a third party to store and/or execute the Data/Instructions and make them available to any entity over a private or public network, e.g., the Internet. For example, a third party, e.g., a cloud provider, can provision to one or more entities a shared pool of computing resources storing and/or executing the Data/Instructions dynamically and on-demand.

The application illustrates how to format data, assign names to variables, and assign names to values that are written in the English language. However, the invention is not limited to that embodiment. The invention can write the data, variables, and values in alternative languages. The invention can modify the apparatuses, methods, and/or CPPs to operate with data, variables, and values in languages different from English.

The application illustrates how to recognize one or more word sequences spoken in the English language. However, the invention is not limited to that embodiment. The invention can recognize one or more word sequences spoken in any language.

The application illustrates how to determine the most probable objective, solution, or outcome, e.g., the most probable word string uttered by a user, the most probable Object of Interest in a User Request, or the most probable Class of Objects. The application executes methods and/or algorithms to determine these probabilities by specifying objective functions including one or more terms, e.g., conditional probabilities. However, the invention is not limited to that embodiment. The invention can enable the determination of any objective, solution, or outcome by specifying and executing any method and/or algorithm, including, but not limited to: (a) Bayes' theorem, e.g., to express the relationship between two conditional probabilities, and/or to utilize probabilities to classify objects or determine the relationship among Classes of Objects; and/or (b) neural networks, e.g., to express the relationship among objects in a plurality of layers of Classes of Objects. The invention can utilize any method, algorithm, or combination of methods and/or algorithms to determine any objective, solution, or outcome in the most effective means available.

The application discloses embodiments to enable a person skilled in the relevant art to make and use the invention. Various modifications to these embodiments will be readily apparent to a person skilled in the relevant art. The invention may apply the generic principles defined herein to other embodiments without departing from the spirit or scope of the invention. Thus, the invention does not intend to limit the embodiments shown herein, but accords the widest scope consistent with the principles and novel features disclosed herein.

The application reference to “invention” herein can refer to one or more embodiments.

1. A computer-implemented method, comprising:
receiving information related to an object of interest from a client device;
identifying the object of interest;
identifying at least one payment account to associate with the object of interest;
identifying at least one base price at which at least one retailer offers the object of interest;
searching for purchase incentives, including one or more of an offer and a reward associated with one or more of the object of interest, the at least one retailer, and the at least one payment account;
constructing one or more purchase solutions for the object of interest, each purchase solution including a base price and one or more of a payment account and a purchase incentive;
computing a net cost of the object of interest for each of the purchase solutions;
identifying the purchase solution having the lowest net cost; and
sending to the client device at least the lowest net cost purchase solution and a user-selectable prompt to purchase the object of interest in accordance with the lowest net cost purchase solution, including an instruction to cause the client device to display the lowest net cost purchase solution and the user-selectable prompt within a single display page of the client device.

2. The computer-implemented method of claim 1, wherein the sending of the lowest net cost purchase solution includes:
sending an indication of the retailer, the base price, an amount associated with the one or more of the payment account and the purchase incentive, and the corresponding net price, to be displayed within the single page of the client device.

3. The computer-implemented method of claim 2, wherein the sending of the lowest net cost purchase solution further includes:
sending one or more instructions to cause the client device to,
render the indication of the retailer and the base price with a linear relationship therebetween,
render an indication of a purchase incentive amount and a corresponding indication of a basis for the purchase incentive with a linear relationship therebetween,
render the indication of a reward associated with the payment account and a corresponding indication of a basis for the reward with a linear relationship therebetween, and
render the base price, the purchase incentive amount, the payment account reward, and the net price with a linear and tabular relationship therebetween.

4. The computer-implemented method of claim 1, further including:
receiving a request from the client device, in response to the user-selectable prompt, to purchase the object of interest in accordance with the lowest net price purchase solution; and
executing a transaction to purchase the object of interest in accordance with the lowest net price purchase solution.

5. The computer-implemented method of claim 4, wherein the executing of the purchase transaction includes:
executing a payment to the retailer from a payment account when the lowest net price purchase solution specifies the payment account; and
redeeming a purchase incentive when the lowest net price purchase solution specifies the purchase incentive.

6. The computer-implemented method of claim 5, wherein the seller is a physical retailer.

7. The computer-implemented method of claim 5, wherein the purchase incentive includes a price discount associated with at least one of the object of interest and the retailer, and wherein the executing of the purchase transaction includes:
redeeming the price discount with respect to at least one of the retailer and a manufacturer of the product of interest.

8. The computer-implemented method of claim 5, wherein the purchase incentive includes a reward associated with one or more of the retailer and the payment account, and wherein the executing of the purchase transaction includes:
redeeming the reward with respect to at least one of the retailer and the payment account.

9. The computer-implemented method of claim 1, wherein the sending includes sending a text message to the client device.

10. The computer-implemented method of claim 1, wherein:
the receiving of the information includes receiving a list of a plurality of objects of interest;
the identifying of the object of interest, the identifying of at least one payment account, the identifying of at least one base price, the searching for purchase incentives, the constructing of a plurality of purchase solutions, the computing of a net price, and the identifying of the purchase solution having the lowest net price, are performed with respect to each of the objects of interest; and
the sending is performed with respect to each of the corresponding lowest net price purchase solutions, and includes instructions to cause the client device to display each of the lowest net price purchase solutions within a corresponding single display page of the client device.

11. The computer-implemented method of claim 10, wherein the list of the plurality of objects of interest includes a shopping list.

12. The computer-implemented method of claim 1, wherein:
the receiving includes receiving information related to an object of interest from a wireless client communication device; and
the sending includes sending the lowest net cost purchase solution and user-selectable prompt to be displayed within the single display page of the wireless client communication device.

13. The computer-implemented method of claim 1, wherein the identifying of the object of interest from the information includes:
classifying one or more prior user transactions to one or more classes of objects in accordance with an object classification system;
identifying a plurality of candidate objects of interest;
generating a search space to encompass the classes of objects to which the one or more transactions are classified;
examining the search space for relationships amongst and within the classes of objects of the search space;
computing, for each candidate object of interest, a probability of one or more of the candidate object of interest, based on one or more of factors; and
identifying the object of interest from a highest computed probability.

14. The computer-implemented method of claim 13, wherein the computing of the probabilities includes:
computing the probabilities as a function of one or more of prior user activity and relationships amongst the candidate classes of objects.

15. The computer-implemented method of claim 13, wherein the computing of the probabilities includes:
computing the probabilities as a function of prior user transactions stored in one or more data structures.

16. The computer-implemented method of claim 15, wherein the computing of the probabilities further includes:
computing the probabilities as a function of prior user transactions stored in one or more of,
a payment issuer data structure that stores user transactions, and
a retailer data structure that stores user transactions.

17. The computer-implemented method of claim 13, wherein the classifying includes:
classifying the one or more transactions as a function of a classification system.

18. The computer-implemented method of claim 17, wherein the classifying further includes:
classifying the one or more transactions as a function of one or more of,
a MCC,
a MID,
a UPC,
a NAICS, and
an Ad-ID standard.

19. An apparatus, comprising:
a system to receive information related to an object of interest from a client device;
a system to identify the object of interest;
a system to identify at least one payment account to associate with the object of interest;
a system to identify at least one base price at which at least one retailer offers the object of interest;
a system to search for purchase incentives, including one or more of an offer and a reward associated with one or more of the object of interest, the at least one retailer, and the at least one payment account;
a system to construct one or more purchase solutions for the object of interest, each purchase solution including a base price and one or more of a payment account and a purchase incentive;
a system to compute a net cost of the object of interest for each of the purchase solutions;
a system to identify the purchase solution having the lowest net cost; and
a system to send to the client device at least the lowest net cost purchase solution and a user-selectable prompt to purchase the object of interest in accordance with the lowest net cost purchase solution, including an instruction to cause the client device to display the lowest net cost purchase solution and the user-selectable prompt within a single display page of the client device.

20. A computer program product comprising a computer readable medium having computer program product logic stored thereon, including:
logic to cause a processor to receive information related to an object of interest from a client device;
logic to cause the processor to identify the object of interest;
logic to cause the processor to identify at least one payment account to associate with the object of interest;
logic to cause the processor to identify at least one base price at which at least one retailer offers the object of interest;
logic to cause the processor to search for purchase incentives, including one or more of an offer and a reward associated with one or more of the object of interest, the at least one retailer, and the at least one payment account;
logic to cause the processor to construct one or more purchase solutions for the object of interest, each purchase solution including a base price and one or more of a payment account and a purchase incentive;
logic to cause the processor to compute a net cost of the object of interest for each of the purchase solutions;
logic to cause the processor to identify the purchase solution having the lowest net cost; and
logic to cause the processor to send to the client device at least the lowest net cost purchase solution and a user-selectable prompt to purchase the object of interest in accordance with the lowest net cost purchase solution, including an instruction to cause the client device to display the lowest net cost purchase solution and the user-selectable prompt within a single display page of the client device.

21-71. (canceled)
